(19) United States
(12) Patent Application Publication
(10) Pub. No.: US 2022/0076253 A1
(43) Pub. Date: Mar. 10, 2022

(54) COMPUTATION MIXING

(71) Applicant: David CHAUM, Sherman Oaks, CA (US)

(72) Inventor: David CHAUM, Sherman Oaks, CA (US)

(21) Appl. No.: 17/398,255

(22) Filed: Aug. 10, 2021

Related U.S. Application Data
(60) Provisional application No. 63/195,138, filed on May 31, 2021.
(60) Provisional application No. 63/188,419, filed on May 13, 2021.
(60) Provisional application No. 63/183,049, filed on May 2, 2021.
(60) Provisional application No. 63/177,738, filed on Apr. 21, 2021.
(60) Provisional application No. 63/141,689, filed on Jan. 26, 2021.
(60) Provisional application No. 63/139,768, filed on Jan. 20, 2021.
(60) Provisional application No. 63/138,907, filed on Jan. 19, 2021.
(60) Provisional application No. 63/138,444, filed on Jan. 16, 2021.
(60) Provisional application No. 63/137,281, filed on Jan. 14, 2021.
(60) Provisional application No. 63/133,319, filed on Jan. 2, 2021.
(60) Provisional application No. 63/130,660, filed on Dec. 26, 2020.
(60) Provisional application No. 63/121,594, filed on Dec. 4, 2020.
(60) Provisional application No. 63/118,924, filed on Nov. 28, 2020.
(60) Provisional application No. 63/118,736, filed on Nov. 26, 2020.
(60) Provisional application No. 63/112,771, filed on Nov. 12, 2020.
(60) Provisional application No. 63/111,553, filed on Nov. 9, 2020.
(60) Provisional application No. 63/107,989, filed on Oct. 30, 2020.
(60) Provisional application No. 63/105,328, filed on Oct. 25, 2020.
(60) Provisional application No. 63/104,992, filed on Oct. 23, 2020.
(60) Provisional application No. 63/093,882, filed on Oct. 20, 2020.
(60) Provisional application No. 63/090,266, filed on Oct. 11, 2020.
(60) Provisional application No. 63/090,213, filed on Oct. 10, 2020.
(60) Provisional application No. 63/087,285, filed on Oct. 4, 2020.
(60) Provisional application No. 63/075,193, filed on Sep. 6, 2020.

(51) Int. Cl. G06Q 20/38; G06Q 20/36; H04L 9/32

(52) U.S. Cl. CPC G06Q 20/3825; G06Q 20/3674; H04L 2209/56; H04L 9/3257; G06Q 20/3829; G06Q 20/389

(57) ABSTRACT

A cryptographic protocol is provided that allows principals to securely realize a wide range of financial products simply via the protocol conducted between their respective phone apps. No other entities need play a role and no fees need be paid. A commitment fee is required to prevent the counterparty being spoofed and the system being discredited. If a party reneges during a transaction, that party is refunded their value and at least a share of a penalty levied on the reneging party.

### FIELD OF THE INVENTION

A cryptographic protocol is provided that allow at least two parties using at least one ledger to transfer a value from a first ledger account.

### BACKGROUND ART

Today people are paying $40bn annually in fees for trading numbers that they control through keys that they hold. These fees are charged by intermediaries. Not only do the intermediaries generally offer those making trades only limited portions of market pricing and liquidity but they introduce custody risk and even delay settlement for larger trades. The challenge to achieve direct trading of crypto currencies is mainly security: effective thwarting of attacks by third-parties as well as traders and infrastructure provides. These attacks include the gamut from spoofing to theft and even extortion. Therefore, there is a need to provide a solution that solves these security issues conveniently across all crypto currencies without intermediaries.

### SUMMARY OF THE INVENTION

One aspect of the invention allows trading of any crypto currency, smartphone-to-smartphone, without fees. In this aspect, three kinds of infrastructure can be used. One kind of infrastructure can be a dedicated cryptocurrency, which could have an exemplary name like LQF. This is used like a deposit, earnest money or what can be called a “commitment” fee as backing for each offer or bid. But when the transaction completes, each party's LQF commitment is returned back to them. Absent such commitment fees, spurious cancelation of trades might render the system unattractive for use. But with such commitments, counterparties are incentivized to complete agreed transactions, since otherwise the party that stops moving forward knows it will lose LQF.

A second type of infrastructure that can be employed uses matcher nodes. Offers and bids are posted by traders to servers; in turn the servers notify traders immediately that have expressed interest in particular types of posts. Matchers are independently operated and paid in LQF for their various functions, including by bounties for commitments caught backing more than one offer or bid. For each pair of cryptoassets to be traded, multiple matcher nodes are designated. More heavily traded pairs can share the load across more matchers, but even obscure pairs will have multiple matchers to ensure high reliability across the board.

The third and final type of infrastructure can be a collection of entities called “refund agents.” These are only contacted rarely, by a party that has funded a transaction upon learning that the counterparty has stopped moving forward. Refund agents earn LQF by allowing legitimate refunds, but cannot themselves gain access to funds.

The cryptographic protocol that allows the transfer of values involving at least two parties is designed to prevent attacks on it. Attacks could be attempted by third-parties, traders, and/or infrastructure provides. Attacks include the gamut of spoofing, front-running, default, extortion and even outright theft. At each instant during a swap, however, only certain types of attack apply.

Before any swap is agreed, third-party spammers could attack the servers performing matching. However, the redundancy of these servers, plus the fact that all messages to them are to be signed by the owners of related LQF, makes such so-called “denial of service” attacks considerably easier to protect against than even for a typical website.

During the initial advertising of a swap, a party may be using an invalid commitment. But this will be detected before traders' smartphones get too far into the mutual cryptographic protocol that they will conduct till the trade is settled. During this protocol, if either phone fails to send a valid message by the appropriate deadline, that party will lose committed LQF. This protocol establishes joint-custody “holding accounts” and randomly selects pseudonymous “refund agents.” The parties, at this point, are to fund the holding accounts with the values to be swapped. If only one of the counterparties funds, however, a majority of anonymously-selected refund agents can exercise the only power that they have to decrypt the signature that transfers the value in the holding account back to the account of the party from which it came.

Once both parties have funded, a series of “probability games” are conducted automatically between their phones. The only way one smartphone could cheat in such games offers ridiculously bad odds. Each phone is allowed to place a bet on any one but only one of, say, 25, games. If a phone attempts to cheat but has selected any of the 24 losing games, it loses both the amount to be swapped and the stake; only in the case that the phone is lucky enough to have bet on the winning game of the 25 does it stand to potentially gain, but then only at most the amount of the swap.

The blockchain or ledger account hosting LQF, since its tokens must be held during trades and in reserve for quick response to trading opportunities, has very favorable tokenomics. Such blockchains have well proven incentives, performance, and protection against cheating. This leaves incentives for, performance of, and potential cheating by, the refund agents and matcher nodes.

The refund agents are publicly listed, but each has multiple pseudonyms, which are established by special cryptographic mixing. These pseudonyms are used by traders to provide secret keys to refund agents, but only if one party to a trade funds and the other party does not. If a majority of refund agents receiving these secret keys come forward, they first verify that only one party funded. They then use the keys to reconstruct the signature that returns the value to that single funding party. They receive LQF fees for this from the stake of the counterparty. Cooperation of multiple refund agents is needed to transfer and decrypt keys to any individual agent, making it infeasible for traders to cheat by secretly colluding with agents. Those agents who don't contribute in refunding can be identified when pseudonym sets are later opened, allowing the roster to be updated based on agent performance.

The matcher nodes each handle one or more “pairs” of asset types. Popular such pairs may have many dedicated matchers balancing the load. Some matchers may serve more than one pair, since even the least frequently traded pairs each have multiple matchers. The smartphone of a trader interested in a particular pair of digital assets always connects to multiple matchers and cross-checks that they are all reporting the same offers and bids. This transparency also prevents matchers from front-running using information about trades. Matchers are rewarded in part by bounties for catching traders trying to use the same commitment in more than one transaction, whether for the same pair or across pairs.

With this inventive technology, principals can securely realize a wide range of financial products simply via protocols conducted between their respective phone apps—no other entities need play a role and no fees need be paid. A simple swap is illustrative. Suppose Bobbi has Bitcoin and Elliot has Ethereum, each in its own account on the respective ledger, but they want to swap. The inventive cryptographic solution can be divided into three sub-problems: (a) avoiding the who-goes-first dilemma; (b) providing a commitment fee to prevent the counterparty being spoofed and the system being discredited; and (c) refunding Bobbi, plus a share of a penalty levied from Elliot, in case Elliot reneges—or vice versa.

The who-goes-first problem (a) was solved decades ago using a series of iterations in a way that works in theory when each participant's potential computing resources are the same. The inventive solution also uses multiple iterations, but it hides from both parties which single wildcard iteration completes the transaction. If either party tries to cheat in any other iteration, they lose the commitment fee (b), making the average loss to a cheater a multiple of the commitment fee. As part of transaction completion (c), the commitment fees are returned to the parties.

Such swaps can be useful for trading, where they obviate the need for exchanges that take custody and/or make settlements, limit exposure to global pricing or liquidity, and extract fees one way or another. Payments within a ledger are a basic function of ledgers. Payments between ledgers can be carried out by adapting a swap, making the prospective payee's account the destination account of one leg of the swap. This can be combined with a short-term but full-value commitment fee, giving the payment in effect immediate finality.

The inventive cryptographic protocol also improves some existing cryptographic custody systems by adding pre-authorized transfers to a specific destination—but only if a majority of agents agree. The agents can be something like escrow agents, but they cannot divert funds from the pre-arranged destinations. Agents are from an approved list, with suitable screening, reputations, and incentives. Yet the agents can be randomly chosen while kept mutually anonymous to the parties, so that agents and parties cannot corrupt each other.

All manner of other financial products—loans, futures, options—can be realized using these building blocks. Whenever a phase according to the rules defining the product requires a combined change of ownership, the swap technology can be used. Where the rules of the product say that a party should do something, and that party does not do it by the prescribed deadline, prearranged provisions allow agents to redistribute commitment fees while refunding parties.

A more detailed description of the cryptographic protocol that permits the transfer of value involving one or more ledger accounts is as follows.

A cryptographic protocol between at least two parties is provided that uses at least one ledger, the at least one ledger comprised of ledger accounts, with transfers between the ledger accounts performed according to transfer signatures authenticated using public keys associated with the respective ledger accounts. The cryptographic protocol is able to allow parties to create public keys corresponding ledger accounts of the at least one ledger, wherein the cryptographic protocol at least cooperating in creating a first public key corresponding to a first ledger account. The cryptographic protocol can at least cooperate in creating a plurality of partial transfer signatures related to the ledger account public key of the first ledger account. The plural partial transfer signatures are allowed by the cryptographic protocol to be encrypted such that substantially these keys are decryptable using keys at least including those of at least a first collection of refund agents. A first quorum rule determines the selections of partial transfer signatures that are sufficient to develop at least a transfer signature for transferring value from the first ledger account corresponding to the first public key to at least a different ledger account on the first ledger.

The cryptographic protocol can also allow cooperation of the at least two parties to form at least one transfer signature with the first ledger account as the source account of the transfer.

This cooperation forming the at least one transfer signature can also include the following:

the cryptographic protocol allowing previously undisclosed information known to at least one of the at least two parties to the cryptographic protocol to be made known to at least a different party to the cryptographic protocol, the previously undisclosed information unknown initially to the at least a different party to the cryptographic protocol, such that when the previously undisclosed information is known to the at least a different party to the cryptographic protocol, the at least a different party to the cryptographic protocol enabled to form at least one transfer signature having the first ledger account as source account of the corresponding transfer;

such that the first destination account of the first transfer signature at least in part selectable by at least one of the at least two parties.

such that the first destination account of the first transfer signature selected at least in part by the cryptographic protocol and outside the control of either one of the at least two parties.

the cryptographic protocol allowing at least two of the parties to cooperate in creating a public key corresponding to a second ledger account.

The cryptographic protocol that allows at least two of the parties to cooperate in creating a public key corresponding to a second ledger account can include:

the cryptographic protocol at least cooperating in creating a second plurality of partial transfer signatures related to at least a public key of the second ledger account;

the second plural partial transfer signatures allowed by the cryptographic protocol to be encrypted such that substantially these keys can be decrypted at least in part by refund agents using keys at least including those of a second collection of refund agents; and

such that a second quorum rule determines the selections of the second partial transfer signatures that are sufficient to develop at least a transfer signature for transfer from the second ledger account to at least a ledger account different from the first ledger account and different from the second ledger account, and

optionally the additional capability such that the combination of the first quorum rule and the second quorum rule ensuring a predetermined minimum number of refund agents in the intersection of substantially any quorum allowed simultaneously by the first quorum rule and any quorum allowed by the second quorum rule.

The cryptographic protocol that allows at least two of the parties to cooperate in creating a public key corresponding to a second ledger account can include:

the cryptographic protocol allowing at least a first of the at least two parties to provide first previously undisclosed information, related to the first ledger account, to at least a second of the at least two parties;

the cryptographic protocol allowing the at least second of the at least two parties to provide second previously undisclosed information, related to the second ledger account, to the at least first of the at least two parties;

such that the at least first of the at least two parties substantially prevented from readily and without penalty obtaining the second previously undisclosed information, unless the second of the at least two parties substantially allowed by the at least first of the at least two parties to readily obtain the first previously undisclosed information;

such that the combination of the first previously undisclosed information when known to the second of the at least two parties substantially allows the second of the at least two parties to promulgate a transfer signature with a first ledger account as source account; and

such that the combination of the second previously undisclosed information when known to the at least first of the at least two parties substantially allows the at least first of the at least two parties to promulgate a transfer signature with a second ledger account as source account; and optionally;

the cryptographic protocol allowing for provision for multiple rounds, wherein the provisions for at least one round including allowing each of the at least two parties to provide authentication of a contribution to the round in advance of the round, the provision for at least one of the rounds including allowing for coordinated exchange, between the at least two parties, of delay encrypted contributions to the round, such that at least one round of the multiple rounds should reveal the first previously undisclosed information to at least the second of the at least two parties and reveal the second previously undisclosed information to at least the first of the at least two parties,

such that the cryptographic protocol substantially hides from the at least two parties which round is the at least substantially one round that would reveal previously undisclosed account information, and such that the cryptographic protocol allows for provision of penalty to at least a one of the at least two parties in case it were shown to provide invalid input to at least one round.

The cryptographic protocol that allows at least two of the parties to cooperate in creating a public key corresponding to a second ledger account can include:

the cryptographic protocol allowing the designation of at least a third ledger account by cooperation of at least a third party of the at least two parties with at least a second of the two parties;

such that the at least third party of the at least two parties differs from at least a first one of the at least two parties and differs from at least a second one of the at least two parties;

the cryptographic protocol allowing a transfer from the first ledger account to the third ledger account; and

such that the role of the at least a first one of the at least two parties in at least a portion of the cryptographic protocol is substantially handed over from the at least a first one of the at least two parties to the at least third party of the at least two parties.

The cryptographic protocol cooperation forming the at least one transfer signature can also include the cryptographic protocol being responsive to cryptographic authentication by at least a quorum of parties from a third collection of parties attesting that at least one party conducting the cryptographic protocol has deviated from following the cryptographic protocol, and optionally, the cryptographic protocol and include a third collection of parties in effect predetermined.

A second cryptographic protocol is also disclosed that is similar to the first one but also includes features relating to undisclosed information to be used as part of the transfer of value. More particularly, the cryptographic protocol is between at least two parties using at least one ledger, the at least one ledger comprised of ledger accounts, with transfers between the ledger accounts performed according to transfer signatures authenticatable using public keys associated with the respective ledger accounts. The cryptographic protocol is able to allow parties to create public keys corresponding to ledger accounts of the at least one ledger, including:

the cryptographic protocol at least cooperating in creating a first public key corresponding to a first ledger account;

the cryptographic protocol at least cooperating in creating a second public key corresponding to a second ledger account;

the cryptographic protocol allowing at least a first of at least two parties to provide first previously undisclosed information, related to the first ledger account, to at least a second of the at least two parties;

the cryptographic protocol allowing the at least second of the at least two parties to provide second previously undisclosed information, related to the second ledger account, to the at least first of the at least two parties;

such that the combination of the first previously undisclosed information when known to the second of the at least two parties substantially allows the second of the at least two parties to promulgate a transfer signature with a first ledger account as source account; and

such that the combination of the second previously undisclosed information when known to the at least first of the at least two parties substantially allows the at least first of the at least two parties to promulgate a transfer signature with a second ledger account as source account.

such that at least the first of the at least two parties substantially prevented from readily and without penalty obtaining the second previously undisclosed information, unless the second of the at least two parties substantially allowed by the at least first of the at least two parties to readily obtain the first previously undisclosed information.

The second cryptographic protocol can include the cryptographic protocol allowing the at least two parties to make an exchange of the first previously undisclosed information and the second previously undisclosed information and such that the first party verifiably substantially obtains the second transfer signature information item if and only if the second party substantially obtains the first transfer signature information.

The second cryptographic protocol that involves the exchange can further include one or both of:

the cryptographic protocol allowing at least each of the at least two parties to at least substantially verify that the exchange, if aborted by one of the two parties, leaves each of the at least two parties, at least with substantially similar probability, and at least with substantially similar amounts of computation, to arrive at the respective transfer signature information; and

the cryptographic protocol allowing the at least two parties at least to substantially verify in advance that if the exchange were to be aborted by at least one of the at least two parties, at least some evidence would result that the cryptographic protocol was substantially aborted by the at least one aborting party.

The cryptographic protocol that involves the at least some evidence can include the cryptographic protocol allowing the evidence authenticated by at least one of the at least two parties that has aborted the cryptographic protocol to be developed by at least a different one of the at least two parties to the cryptographic protocol, such that the evidence allowing substantial irrefutability of a penalty to the at least one party aborting the cryptographic protocol.

The cryptographic protocol involving the penalty can also include the cryptographic protocol providing for multiple rounds;

the provisions for at least one round by the cryptographic protocol including allowing each of at least two parties to provide authentication of a committed contribution to the at least one round in advance of the at least one round;

the provision for at least one round to allow for coordinated exchange, between the at least two parties, of delay encrypted contributions to that round;

such that the contributions to the at least one round should both reveal the first previously undisclosed information to at least one of the at least two parties and reveal the second previously undisclosed information to a different one of the at least two parties;

such that the cryptographic protocol substantially hides from the at least two parties which round should both reveal the first previously undisclosed information to at least a one of the two parties and reveal the second previously undisclosed information to a different one of the at least two parties; and

such that at least a part of the information to be exchanged during at least one round allowing verification of consistency between at least one committed contribution by a party and the information to be revealed by that party in completing the round without aborting the round by that party.

The invention also includes the method of one of the parties or refund agents involved in the transfer of value using any of the cryptographic protocols described above as part of a successful transfer of value from one party to another, transfer of values between parties, or transfer of a value to a third party, when three parties are involved, or a return of value to a party if the transfer is not completed for some reason, or application of a penalty to a party responsible for an aborted protocol completion and transfer.

More particularly with respect to the method, the method of transferring value between accounts using the cryptographic protocol between at least two parties of claim comprises at least one of the at least two parties participating in the cryptographic protocol to transfer the value from the first ledger account.

The method of transferring value between accounts using the cryptographic protocol between at least two parties can also one of the first collection of refund agents participating in the cryptographic protocol as part of an attempted transfer of the value from the first ledger account.

The method can further allow the cryptographic protocol in terms of cooperation of the at least two parties to form at least one transfer signature with the first ledger account as the source account of the transfer, the at least two of the parties to cooperate in creating a public key corresponding to a second ledger account, at least cooperating in creating a second plurality of partial transfer signatures related to at least a public key of the second ledger account; the second plural partial transfer signatures allowed by the cryptographic protocol to be encrypted such that substantially these keys can be decrypted at least in part by refund agents using keys at least including those of a second collection of refund agents; and such that a second quorum rule determines the selections of the second partial transfer signatures that are sufficient to develop at least a transfer signature for transfer from the second ledger account to at least a ledger account different from the first ledger account and different from the second ledger account, and wherein at least one of the at least two parties participates in the cryptographic protocol to transfer the value from the second ledger account to at least a ledger account different from the first ledger account and different from the second ledger account.

Another method using the cryptographic protocol allows cooperation of the at least two parties to form at least one transfer signature with the first ledger account as the source account of the transfer, at least two of the parties to cooperate in creating a public key corresponding to a second ledger account; and the designation of at least a third ledger account by cooperation of at least a third party of the at least two parties with at least a second of the two parties; such that the at least third party of the at least two parties differs from at least a first one of the at least two parties and differs from at least a second one of the at least two parties; the cryptographic protocol allowing a transfer from the first ledger account to the third ledger account; such that the role of the at least a first one of the at least two parties in at least a portion of the cryptographic protocol is substantially handed over from the at least a first one of the at least two parties to the at least third party of the at least two parties, and wherein at least one of the at least two parties participating in the cryptographic protocol to transfer the value from the first ledger account to a third ledger account.

Another method of transferring value between accounts using the second cryptographic protocol between at least two parties, the method comprising at least one of the at least two parties participating in the cryptographic protocol to transfer the value between ledger accounts, or at least one of the at least two parties participating in the cryptographic protocol to transfer the value from the first ledger account.

### BRIEF DESCRIPTION OF THE DRAWINGS

FIG. 1 shows exemplary overall flowcharts of multiparty computations using mixing.

FIGS. 2A-J show exemplary overall flowcharts of multiparty computations using mixing. FIG. 2A is an overall functional multiplication (or division) of values under multiplicative blinding; FIG. 2B is detailed multiplication of values under multiplicative blinding; FIG. 2C is an overall functional addition (or subtraction) of values under additive blinding; FIG. 2D is detailed addition of values under additive blinding; FIG. 2E is an overall functional changing additive blinding to multiplicative blinding; FIG. 2F is detailed changing of additive blinding to multiplicative blinding FIG. 2G is an overall functional changing multiplicative blinding to additive blinding; FIG. 2H is detailed changing of multiplicative blinding to additive blinding; FIG. 2I is an overall functional greater (or less) than determining selection between two paths; and FIG. 2J is an overall functional greater than determining selection between two paths.

FIG. 3 is a detailed example of a particular instance of a multiparty computation is provided for clarity and concreteness.

FIGS. 4A-E are detailed examples shown of a setup and optional cut-and-choose for a multiparty computation. FIG. 4A is the column of pseudonyms of nodes; FIG. 4B is the optional commitment by the prover to the assignment of the operation of one of multiple sets of operations to one of multiple example sets of pseudonyms; FIG. 4C is the opening for optional audit of an example set of operations assigned to an example set of pseudonyms; FIG. 4D is the transfer of instructions from the prover to the pseudonym holders; and FIG. 4E is example transfers of value between pseudonym holders.

FIGS. 5A-B are detailed exemplary embodiments for a double-blinding multiparty computation. FIG. 5A is an example addition of double-blinded values; FIG. 5B is an example conversion from additive blinding to multiplicative blinding in a double blinding system.

FIGS. 6A-C are exemplary additive to multiplicative operation graphs. FIG. 6A is the graph already described with reference to FIG. 5B but with its inputs and outputs and internal nodes labeled; FIG. 6B is the full table of the graph of FIG. 6B; and FIG. 6C is a compact representation of the operation of FIGS. 6A and 6B.

FIG. 7 is an exemplary overall combination block diagram and protocol overview.

FIGS. 8A-B are exemplary overall flowcharts. FIG. 8A is the assigning of computation parts to nodes the nodes communicating in conducting the computation while inhibiting other types of access to the nodes conducting the computation. FIG. 8B includes the options for changing encryption of messages between nodes and the introduction of nodes that hide which nodes perform operations.

FIG. 9 is a flowchart for an exemplary distributed computation system.

FIG. 10 is an exemplary distributed computation system is shown as a combination block diagram and cryptographic protocol schematic.

FIG. 11 is an exemplary distributed atomic swap system shown in combination block diagram and cryptographic protocol schematic.

FIG. 12 is an exemplary flowchart of a distributed atomic swap system.

FIG. 13 is an exemplary computation for a distributed atomic swap system shown in combination block diagram and cryptographic protocol schematic.

FIG. 14 is an exemplary atomic swap cryptographic protocol shown in combination flowchart and protocol schematic.

FIG. 15 is an exemplary recovery cryptographic protocol shown in combination flowchart and protocol schematic.

FIG. 16 is an exemplary verifiable recovery cryptographic protocol shown in combination flowchart and protocol schematic.

FIG. 17 is an exemplary digital outcry cryptographic protocol with refund shown in combination cryptographic schematic and block diagram.

FIG. 18 is an exemplary digital outcry cryptographic protocol shown in combination flowchart and protocol schematic.

FIG. 19 is an exemplary digital outcry cryptographic protocol shown in combination cryptographic schematic and block diagram.

FIG. 20 is an exemplary digital outcry cryptographic protocol shown in combination flowchart and protocol schematic.

FIGS. 21A-B are detailed exemplary embodiments of a what may here be called a “verifiable offline key transfer” and a related distribution is shown in combination cryptographic schematic and block diagram, as well as flowchart. The notation of FIG. 21A is known in the art and introduced more specifically in various other patents of the present applicant and will be readily understood. All the elements are residue classes either in the group, such as a so-called Diffie-Hellman group, or in the group of the exponent, as will also readily be appreciated. FIG. 21 shows the distribution, as being typical of flowcharts.

FIG. 22 is a detailed exemplary embodiment of a verifiable offline key transfer and distribution protocol shown in combination flowchart and protocol schematic.

FIG. 23 is a detailed exemplary embodiment of a cryptographic protocol for value swap with verifiable offline key transfer shown in combination cryptographic schematic and block diagram in accordance with aspects of the present invention.

FIG. 24 is an exemplary cryptographic protocol for value swap is shown in combination flowchart and protocol schematic.

FIG. 25 is an exemplary anti-spoofing cryptographic protocol shown in combination flowchart and protocol schematic.

FIGS. 26A-B are exemplary detailed cryptographic protocols, flowcharts, block diagrams and blockchain data diagrams for transaction negotiations. FIG. 26A shows three example parties exchanging messages to negotiate potential transactions and including value that can be considered “staked” related to those transactions; FIG. 26B shows the same transactions message detail and also including blockchain data state storage for each stake.

FIG. 27 is an exemplary combination detailed flowchart and block diagram for transaction negotiation.

FIG. 28 is an exemplary cross-chain atomic swap cryptographic protocol shown in combination flowchart and protocol schematic.

FIG. 29 is an exemplary staking for swapping cryptographic protocol shown in combination flowchart and protocol schematic.

FIGS. 30A-B are exemplary anti-blocking cryptographic protocols shown in combination flowchart and protocol schematic. FIG. 30A is the impinging on stake of the party missing deadlines for participating in the protocols properly. FIG. 30B is wallet ID's the returning of value to a party that funded a holding account when the counterparty did not fund the respective holding account.

FIGS. 31A-C are exemplary detailed cryptographic protocols, flowcharts, block diagrams and blockchain data diagrams for transaction negotiations. FIG. 31A is the initial offer. FIG. 31B includes the bids by two example parties. FIG. 31C shows the corresponding accept by the party making the initial offer of one of the bids.

FIGS. 32A-C are exemplary detailed cryptographic protocols, flowcharts, block diagrams and blockchain data diagrams for transaction settlements. FIG. 32A is the initial offer. FIG. 32B includes the bids by two example parties. FIG. 32C shows the corresponding accept by the party making the initial offer of one of the bids.

FIG. 33 is an exemplary detailed cryptographic protocol, flowchart, block diagram and blockchain data diagrams for transaction data stored on chain.

FIG. 34 is exemplary detailed cryptographic protocol, flowchart, block diagram and blockchain data diagrams for random selection of pseudonymous refund agents.

FIG. 35 is an exemplary detailed cryptographic protocol, flowchart, block diagram and blockchain data diagrams for storing and validating and time stamping messages forwarded by matchers.

FIGS. 36A-E are exemplary detailed cryptographic protocols, flowcharts, block diagrams and blockchain data diagrams for access tree structures. FIG. 36A is an “AND” node. FIG. 36B is an “OR” node. FIG. 36C is what can here be called here an “oblivious transfer” or “OT” node. FIG. 36D is what can here be called a “range reduction” or “RR” node. FIG. 36E is an access tree from root to leaves.

FIG. 37 is an exemplary detailed flowchart, cryptographic protocol, and block diagram for access tree structure traversal.

FIGS. 38A-B are exemplary detailed cryptographic protocols, flowcharts, and block diagrams for protocol examples. FIG. 38A is an oblivious transfer protocol for an OT node. FIG. 38B is proof of encrypted share protocol.

FIG. 39 is an exemplary detailed flowchart, cryptographic protocol, and block diagrams for overall swap systems.

FIGS. 40A-B are exemplary detailed flowchart, cryptographic protocol, and block diagrams for variations and enhancements of the overall swap. FIG. 40A is includes variants and also optional enhancements for commits and refunds. FIG. 40B includes an access tree steps and structure.

FIG. 41 is an exemplary detailed cryptographic protocols, flowcharts, and block diagrams for a probability-game release protocol.

FIG. 42 is an exemplary detailed flowchart, cryptographic protocol, and block diagram for overall fair swap.

FIG. 43 is an exemplary detailed flowchart, cryptographic protocol, and block diagrams for overall fair swap.

FIG. 44 is an exemplary detailed cryptographic protocol, flowchart, block diagram and blockchain data diagrams for random selection of pseudonymous refund agents with intermediaries.

FIGS. 45A-B are exemplary detailed flowcharts, cryptographic protocols, and block diagrams for provider anonymity with intermediary systems and variations. FIG. 45A is one example description of insertion of intermediaries between providers and users. FIG. 45B is a second example description of insertion of intermediaries between providers and users.

FIGS. 46A-C are exemplary detailed cryptographic protocols, block diagrams and ledger data diagrams for value swaps and payments. FIG. 46A is the funding of two respective holding accounts.

FIG. 46B is a swap by releasing control of the respective holding accounts. FIG. 46C is a swap releasing respective signatures for value transfer or a payment release one of the signatures to a payee. 46D is a swap releasing one signature for value transfer and the other to holding account or a payment release one of the signatures to a payee and the other to a holding account.

FIGS. 47A-B are exemplary detailed flowcharts, cryptographic protocols, and block diagrams for swap and/or payment. FIG. 47A is a swap between two parties. FIG. 47B includes options and swaps between parties as well as for payments to third parties.

FIG. 48 is an exemplary detailed cryptographic protocol, block diagram and ledger data diagrams for value swap and payment

FIG. 49 is an exemplary detailed flowchart, cryptographic protocol, and block diagrams for provider anonymity with intermediary systems and variations.

FIG. 50 is an exemplary detailed combination cryptographic protocol diagram, block diagram, flowchart and blockchain diagram for an immediate value transfer system with translation and variations.

FIG. 51 is an exemplary detailed flowchart, cryptographic protocol, and block diagrams for an immediate value transfer system with translation and variations.

FIGS. 52A and 52B are a combination cryptographic protocol diagrams, block diagrams, and flow charts for a cryptographic pre-defined value exchange protocol. FIG. 52A shows the overall cryptographic protocols and exemplary formulas. FIG. 52B is a flowchart for aspects of the operation of FIG. 52A.

FIGS. 53A-53C are exemplary detailed flowchart, cryptographic protocol, and block diagrams for swap and/or payment. FIG. 53A is a transfer from one account to another account; FIG. 53B is transferring from at least a second account to a third account; and FIG. 53C is verifiable fair exchange with pre-arranged and delegated and escrowed transfers.

FIG. 54 is exemplary detailed flowchart, cryptographic protocol, and block diagrams for margin accounts and futures and options.

FIGS. 55A-G are combination cryptographic protocol diagrams and notational exemplary elements. FIG. 55A is ledger account with multiple input and output transfers and curly-bracket notation introduced. FIG. 55B is a party funded account transferred to a planned account by parties. FIG. 55C is an account transferred to a planned account by agents. FIG. 55D shows account openings to a party by parties and by agents. FIG. 55E shows account openings to everyone by parties and by agents. FIG. 55F is the transfer to a party both by an agent and by parties. FIG. 55G is multiple coordinated transfers.

FIGS. 56A-D are cryptographic diagrammatic and notational example combinations. FIG. 56A is a mutual transfer between two parties. FIG. 56B is an account that can both be added to by one party and that can be refunded by mutual agreement of a second party. FIG. 56C is one party providing value to a second party, secured by value from the first party that the first party can increase and cooperation of both parties can decrease. FIG. 56D is one party providing value to a second party, secured by value from the first party that the second party can increase and cooperation of both parties can decrease.

FIGS. 57A-C are cryptographic diagrammatic and notational example combinations of exemplary elements. FIG. 57A is one party handing over its role to a third party while maintaining a second party. FIG. 57B is a mutual rotation transfer between three parties. FIG. 57C is a mutual transfer or non-transfer decided at a later time. FIG. 57D is one party escrowing a second amount for a third party and offering a second party a first amount to transfer a related amount to a third party that will unlock the escrow.

FIGS. 58A-G are combination cryptographic protocol diagrams and notational exemplary elements. FIG. 58A is a generic transfer from a ledger account to the benefit of a party. FIG. 58B is transfer between two joint accounts. FIG. 58C is transfer of value from a joint account to account of a party. FIG. 58D is transfer of control from a joint account to a party. FIG. 58E is transfer by agents from a joint account to the benefit of a party. FIG. 58F is an example of multiple transfers in and out. FIG. 58G is shows overlap between agent quora. FIG. 58H is a notation for describing transfers between accounts. FIG. 58I is an exemplary two-ledger coordinated.

FIGS. 59A-C are cryptographic diagrammatic and notational example combinations of exemplary elements. FIG. 59A is an exemplary arrangement related to a basic swap. FIG. 59B is an exemplary arrangement related to a handover between parties. FIG. 59C is an account that can at least be increased from time to time by one party. FIG. 59D is an exemplary collateralized loan or repo.

FIGS. 60A-D are cryptographic diagrammatic and notational example combinations of exemplary elements.

FIGS. 61A-C are combination flow-chart and block diagrams for exemplary refund agent and transfer signature aspects of the cryptographic protocols. FIG. 61A is a flowchart for allowing the creation and provision of partial keys. FIG. 61B shows allowing the creation of a transfer signature. FIG. 64C is a flowchart for allowing transfer of previously undisclosed information.

FIGS. 62A-E are combination flow-chart and block diagrams for exemplary aspects of forming of signatures, accounts, partial keys and quora of the cryptographic protocols. FIG. 62A is a flowchart for allowing the selection of transfer signatures. FIG. 62B shows allowing the uncontrolled creation of a destination account. FIG. 62C is a flowchart for allowing the creation of a second ledger account. FIG. 62D is a flowchart for allowing the creation and provision of a second set of partial keys. FIG. 62E shows a flowchart for allowing overlap in refund agent quora.

FIG. 63 is a combination flow-chart and block diagram for an exemplary exchange cryptographic protocol.

FIGS. 64A-C are combination flow-chart and block diagrams for exemplary aspects of forming of handover and attesting in accordance with aspects of the present invention will be described. FIG. 64A is a flowchart for allowing handover of accounts. FIG. 64B shows a flowchart for allowing use of attesting by other parties. FIG. 67C is a flowchart for allowing attesting parties to be pre-determined.

FIG. 65 is a combination flow-chart and block diagram for an exemplary variation on an exchange cryptographic protocol.

FIGS. 66A-D are combination flow-chart and block diagrams for exemplary aspects of fair exchange by and evidence of abort of the cryptographic protocols. FIG. 66A is a flowchart for allowing verifiable exchange. FIG. 66B shows allowing verification that abort will result in fairness.

FIG. 66C shows allowing verification that abort will result in evidence. FIG. 66D shows a flowchart for allowing the development of evidence and penalty for abort.

FIG. 67 is a combination flow-chart and block diagram for an exemplary alternate variation on an exchange cryptographic protocol.

### DETAILED DESCRIPTION OF THE INVENTION

Detailed descriptions of some exemplary embodiments and aspects will now be provided that are believed sufficient for those of skill in the art to make and use but without any limitation implied or otherwise on the scope of the invention, which is limited solely by the claims.

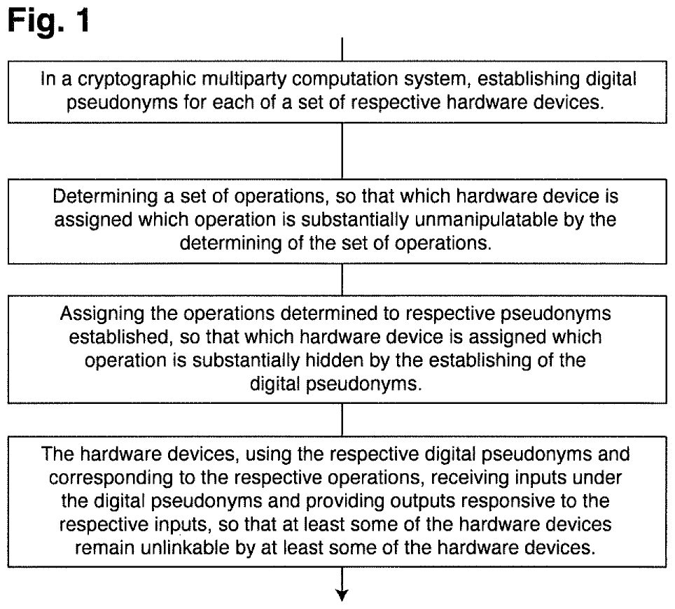

Turning now to FIG. 1, exemplary overall flowcharts of multiparty computations using mixing are provided in accordance with at least some aspects of the teachings of the present invention. The steps, which need not be distinct in time or in the specific order shown, include statements of properties believed achieved.

A first box shows that a set of hardware devices each establish, or have established for them, a digital pseudonym. (Here, such “hardware devices” may also be referred to here as “nodes” and/or “parties” and/or “owners” of digital pseudonyms) In some examples, this can be by each hardware device developing at least one private key and then inputting corresponding public keys to an initial round of mixing, the output of the initial round of mixing defining the pseudonyms of the respective hardware devices.

More generally, as is known in the art as will be appreciated, what may here be called a “public key digital pseudonyms” or just “digital pseudonym” or, even just “pseudonym” for short, of a hardware device is any naming of the device that keeps its identity hidden among a set of such devices. Other examples include multiparty protocols that result in public keys unlinkable to particular participants and/or physical shuffling of objects with hidden indicia in a ceremony, as are known. When the identity of the devices is indicated by or associated with a so-called “public key” or the like, the device can, and is often believed uniquely capable of in the cryptographic art, decrypt messages encrypted with the public key and also form digital signatures verifiable with that public key.

Communication with the owner of a pseudonym is here recommended and best done in a way that does not what will here be called “link” the pseudonym to the owner of or the instance of the hardware device; thus, a pseudonym may here be said to be “unlinkable.”

When messages are to be sent to the owner of a pseudonym, such as the assignment of an operation to a pseudonym (or even the sending of a value from one pseudonym owner to another during a computation, as described elsewhere here), there are various ways anticipated to accomplish this while mainly or practically or statistically preventing linking. An example is to publish or otherwise make the messages available in a form where each is labeled by the respective pseudonym of the intended recipient pseudonym owner. When the message content is to remain hidden from other than the intended recipient pseudonym owner, it can be encrypted with the public key of the pseudonym, as is well known in the cryptographic art, and can then be decrypted by the intended recipient.

When messages are to be sent by the owner of a pseudonym, such as the sending of a value from one pseudonym to another during a computation, as described elsewhere here, there are various ways anticipated to accomplish this without at least with high-probability and practically linking the sender pseudonym to the actual sender device. An example is by the use of a mix network, as will be understood. The input batch of the mix includes a number of such messages, each encrypted with the public key of the recipient pseudonym and labeled by that pseudonym. The resulting items of the output batch may here be called “unlinkable” to the items of the input batch. The potential recipients scan the output batch to locate any items labeled by their respective public keys, however, this is done ideally or best in a way, such as privately in their own computer, that does not reveal which if any matches they find.

The what may here be called “establishing” of digital pseudonyms by a set of hardware devices can also be accomplished using mixing, as mentioned elsewhere here, and now further described generally. For instance, a dedicated mix can accept an input batch entry from each hardware device and each output batch item can then be the digital pseudonym of the unlinkable entity that created the corresponding input batch entry. Accordingly, it may here be said that the “mixing” “hides” the correspondence between the “input batch” entries, which may be linked to the respective hardware device that sent them, and the pseudonyms of the “output batch,” which should remain “unlinkable” to the respective hardware devices. Pseudonyms can be established in various other ways, such as from other pseudonyms, physical ceremonies, other multiparty protocols, etc. A central party, as just additional example, can use a blind signature protocol to validate pseudonyms that can later be used by those who blind, submit, and then unblind them, as will be understood.

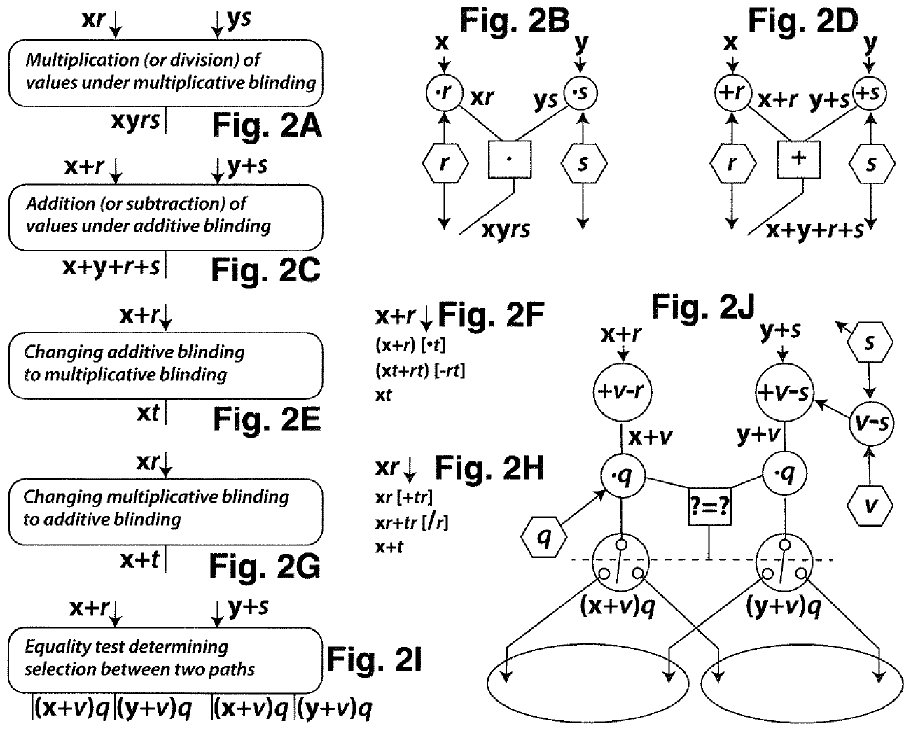

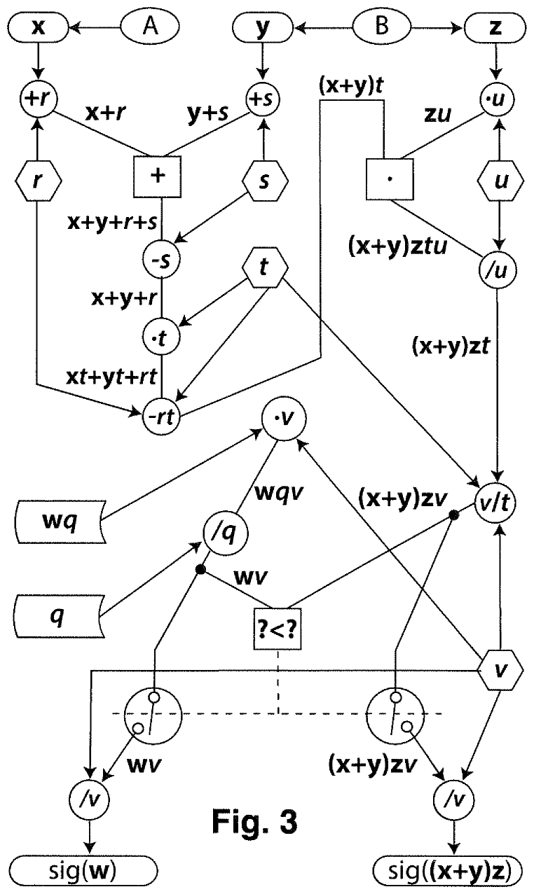

A second box shows an orchestrator, for example, of the computation making known operations per pseudonym. What will here be called an “instruction” and/or an “operation” and/or “processing step” may here be said to be “performed” and/or “carried out” and/or “executed,” as will be understood by those of skill in the computer arts. In some examples such operations can for clarity as just some examples for instance include: decrypting encrypted inputs to the computation, signing outputs of the computation, multiplying values within the computation, adding values within the computation, making decisions between sets of operations based on values within the computation, blinding values used in other instructions, unblinding values used in other instructions, saving encrypted values for later computation instances and/or recovering encrypted values saved by earlier or parallel instances. As further illustration of some non-limiting example operations are detailed with reference to FIG. 2 and to FIG. 3. Operations can, in some examples for instance, also include indication of input source and/or output recipient pseudonyms and/or positions. Some operations may include what may here be called “trigger” conditions, such as when having received sufficient inputs from other nodes and/or orchestrators and/or published values, or possibly other sources, as will be understood.

A third box shows the what may here be called “assigning” of the operations as to the respective pseudonyms. As just one example for clarity, if the pseudonyms are considered in a randomized and unpredictable order, such as is believed would apply to the lexicographic order or the order of the output batch of the mixing where they were established as described earlier, then the ordering of the list of operations can be assigned in order: first pseudonym to first operation, second pseudonym to second operation, and so forth. In other non-limiting examples, for instance, after the operations are no longer changeable, a random draw or the like can be used in, or influence, the assignment of or “mapping” of operations to pseudonyms. The hardware devices can scan the operations for any that correspond to them, thereby learning the respective instructions while remaining unlinkable.

What may here be called “confidential” or “secret” values that are mainly non-public and/or secret and/or otherwise not generally known, can be input to and/or included in computations, as will be appreciated, in some examples at least. Such values can be encrypted, by those holding them, using the public key pseudonyms of the nodes, as mentioned. This can be, for instance, be a complete value per node and/or what may here be called a “multisig,” the confidential value is divided into more than one part and then reconstituted later by combining the parts, as is known in the cryptographic art, such as by X-OR as proposed Feistel and/or as secret sharing and/or by blinding some values and including the blinding values as other values, and/or various combinations or the like.

In some examples what may here be called “blinding” factors, summands or values are arrived at by the nodes and in other examples they may be supplied by a party here called the “orchestrator” and/or the “prover.” It will be understood, however, that more than one entity and/or computer and/or party playing the role of orchestrator is anticipated and a single orchestrator is referred to for concreteness and clarity. In other examples, multisig values can be provided by other parties, be encryptions left from earlier/different computation instances for another computation instance, and/or provided as output to multiple parties.

A fourth box shows, the hardware devices, using the respective digital pseudonyms and corresponding to the respective operations, receiving inputs under the digital pseudonyms and providing outputs responsive to the respective inputs.

When a node receives sufficient input values, according to the instruction it is processing, it can compute the corresponding output and supply it as the instruction directs. As an example, for instance, an instruction may direct supply of the result to a particular pseudonym position in the particular pseudonym ordering as already mentioned; the information can be encrypted using the public key of the recipient pseudonym and ideally sent by mutually untraceable means, such as is believed provide by mixing, to a published output batch that is unlinkably scanned by the recipient, as mentioned. Examples of such operations will be described with reference to FIG. 2 and FIG. 3.

Turning now to FIG. 2A-J, exemplary overall flowcharts of multiparty computations using mixing are provided in accordance with at least some aspects of the teachings of the present invention. FIG. 2A is an overall functional multiplication (or division) of values under multiplicative blinding; FIG. 2B is detailed multiplication of values under multiplicative blinding; FIG. 2C is an overall functional addition (or subtraction) of values under additive blinding; FIG. 2D is detailed addition of values under additive blinding; FIG. 2E is an overall functional changing additive blinding to multiplicative blinding; FIG. 2F is detailed changing of additive blinding to multiplicative blinding FIG. 2G is an overall functional changing multiplicative blinding to additive blinding; FIG. 2H is detailed changing of multiplicative blinding to additive blinding; FIG. 2I is an overall functional greater (or less) than determining selection between two paths; and FIG. 2J is an overall functional greater than determining selection between two paths.

Not shown for clarity, as will be appreciated, is that values are sent between nodes by use of pseudonyms, such as through a mix net where senders and recipients can operate under pseudonyms, as will be understood.

Values can be represented by various known techniques. For example, residue classes modulo a large prime are believed to allow addition and multiplication as well as multiplicative and additive blinding. As another example, as is known in the signal-processing art additive and multiplicative blinding can be by statistical means. Other representations may take advantage of the hidden code paths for re-normalization of values.

Referring now to FIG. 2A, two inputs are shown x and y, each is separately blinded by respective factors r and s. The output is the product xy but still with the blinding factors r and s, so it is shown as xyrs.

Referring to related FIG. 2B, two inputs are shown x and y. At the next stage, each is blinded separately blinded by respective factors r and s, by separate nodes shown in hexagon. Then the product is formed, shown with the dot “·” in the diagram, and the output is xyrs.

Referring to FIG. 2C, addition (or subtraction) of values under additive blinding. The inputs are the values x and y, but each blinded by the respective additive terms r and s. Then the output is the sum of all four, x+y+r+s.

Referring to related FIG. 2D, the two inputs are shown being additively blinded at the first diagram horizontal level by r and s, respectively. Again, the blinding parameters, in this case addends, are shown being known to the nodes represented as hexagons and also being supplied to later stages for unblinding, as indicated by downward arrows.

Referring to FIG. 2E, the additive blinded x shown as the input, x+r, is transformed into multiplicative blinded out, xt, so as to then be suitable for multiplication (division) already described or comparison to be described with reference to FIGS. 2I and 2J.

Referring to related FIG. 2F, the first expression is the input x+r, as already mentioned. Then, in this example, the multiplicative blinding factor t, shown using square bracket IF notation, is multiplied in. This then results in two terms, one of which is divided out. The final result is xt.

Referring to FIG. 2G, the multiplicative blinding of x shown as the input, xr, is transformed into additive blinding output, x+t, so as to then be suitable for addition (subtraction) already described or comparison to be described with reference to FIGS. 2I and 2J.

Referring to related FIG. 2H, the first expression is the input xr, as already mentioned. Then, in this example, the blinding factor tr, shown using square bracket “H” notation, is multiplied in. This then results in two terms, xr and tr, and the common r is then shown divided out, such as by multiplying by the additive inverse of r. The final result is x+t.

Referring to FIG. 2I, the equality test is shown, though, greater than or equal, less than, and less than or equal are also anticipated, and believed achievable, at least with high accuracy probability and/or limited leakage of information about the values. The two inputs, x and y, are shown independently additively blinded, x+r and y+s. On the output are two separate code segments, one on the left and the other on the right, each with inputs (x+v)q and (y+v)q, as will be further described with reference to FIG. 2J.

The flow of control in the execution of the computation can take one of the two paths in some examples; in other examples, for instance and without limitation, both paths can be followed but one can be marked by values so as not to deliver an output. In some example uses of the inventive concepts disclosed here, which code path is taken can be revealed and the code path not taken it is believed need not be executed in those instances. In other example uses, without limitation, it may be desirable that which code path is taken is not revealed but which code path is what may here be referred to as “hidden.” In case of a hidden code path, the same number of operations and/or types of operations can be arranged to be performed for the one or more alternate paths, such as in the known example of so-called “constant time” implementation of cryptographic primitives. If only one path produces an output, and the operations are the same, which path was followed it is believed can be hidden by, for example, re-convergence of the control paths into one or more shared output nodes.

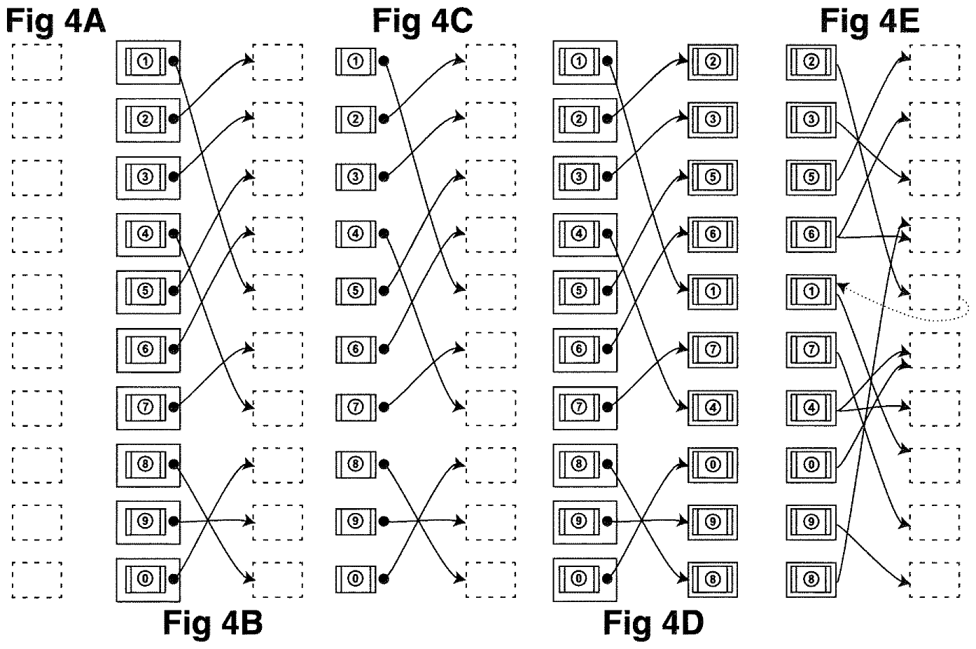

In a related aspect, as will be appreciated, a node performing an operation associated with a particular outcome of a test may not know the outcome of the test because the particular what may here be called “position” of the operation being performed by that node within the particular arrangement of operations making up the instance of the computation is what may here be called “obscured.” It is believed that some of the optional aspects to be disclosed with reference to FIG. 4 can facilitate obscuring positions from nodes.

As one example use of an obscured code portion, when blinding is not perfect, different positions may be exposed to differently imperfect blinding of values, so even though a node may be able to see the particular blinded value, it does not in effect know which blinding imperfection it is seeing. As another non-limiting example of obscured code, also not shown for clarity, but as will be readily understood, two sequences of operations in different legs after a condition can differ in the choice of permutation of values and operations. For instance, either additive or multiplicative blinding, for instance, can be applied to characters or bits separately of at least two elements; then the elements are permuted in ways that differ per leg; then the elements are unblinded in a way that takes the permutation into account so that the same value is used to unblind as was used to blind. It is believed that in this way a permutation of a character string, vector or other array of values can be affected with believed perfect blinding. (Permutation without changing blinding may it is believed allow the same value to be seen by multiple nodes and leak information about the permutation used.)

Referring finally with reference to this sheet to related FIG. 2J, an example detailed equality comparison with selection between two code paths is shown. Some blinding factors are shown explicitly in hexagons while others are not shown for clarity. The inputs, x and y, are shown as additively blinded, x+r and y+s, respectively, as in FIG. 2I. The transformation to (x+v)q and (y+v)q, respectively, before the test is believed an example of what is believed ideally, in case desired, of including two unknowns per comparand to prevent the node performing the test from learning for instance the quotient or difference of the comparands, as will be appreciated. An example way to obtain the desired blinding is shown where an additive term is computed first to both cancel the existing term while at the same time including the common term v. Referring to the more fully elaborated right-hand input, accordingly, additive inverses of s and v are combined additively first, as shown, and then combined with the input by a separate operation. Then the additional common blinding factor q is multiplied in. (Details on the left-hand input are similar, as will be understood; also, the sources of some of the blinding factors are not repeated for clarity as will be appreciated.)

The comparison is shown as “?=T” and it is shown controlling a code path choice, via a dashed line, using an adaption of standard electrical schematic notation for double-pole double-throw switches, as will be appreciated. Accordingly, in the case x is equal y, the operation path on the left is executed by an example convention, shown as the large oval, with xq+vq from the left switch, and for completeness and clarity, yq+vq from the right switch; similarly, in the case x unequal y, the operation path on the right is executed with vq from the left switch, and for completeness and clarity, yq+vq from the right switch.

Turning now to FIG. 3, a detailed example of a particular instance of a multiparty computation is provided for clarity and concreteness in accordance with aspects of the teachings of the invention. The example is of course not to be taken to be limiting in any way at all, under any theory, as will be understood, and is instead intended to provide some clarity and concreteness as will be appreciated before more general descriptions and variations and additional aspects are disclosed in detail here.

Three input variable, x, y, z, are supplied, the first by party A and the second and third by party B, as can be seen. Such inputs can be provided by multisig, as already mentioned but not shown here for clarity (although stored value w is shown provided by multisig). The input x is then what may here be called and will be understood as “blinded additively” by r; the value y is shown blinded additively by s. (In some examples the prover can, for instance, provide r and r+y separately, such as when a cut and choose establishes that the r is used consistently, as will be understood.) Similarly, B provides input to the computation z, which is then what may here be called “blinded multiplicatively” as will be understood, by being multiplied, such as in a modular arithmetic system by u.

The next layer down in the illustrative example for clarity includes an addition and a multiplication, as will be seen. The addition of the two additively blinded values x+r and y+s already mentioned includes the blinding addends, which are then removed by subtraction but intermingled with the multiplicative blinding for the next step. The nodes with the blinding addends/factors are shown as hexagons and deliver their secrets (which they can generate themselves) to the respective other nodes as shown by the lines with arrows. First s is removed by subtraction, then t is included multiplicatively, then rt is removed by subtraction, leaving xt+yt as a first input to the multiply.

The second input to the multiply, the other multiplicand, is zu, the u multiplicative blinding of the input z. The resulting product, xztu+yztu is first unblinded by dividing u out, yielding xzt+yzt. Then t is replaced by v, through blinding by the quotient of v over t, yielding xzv+yzv. This is then to be compared with wv, which is formed from the previously saved output of an earlier instance of the process: wq and the multiplicative inverse of q, by first blinding with v and then unblinding with q.

The result of the comparison between wv and xzv+yzv, then determines which signature, after unblinding by v, is output: the signature on the less-than side is on w and the signature on the greater than side is on xz+yz. (As already explained with reference to FIG. 2, the node performing the test may be able to determine the quotient of the two comparands, but for clarity in the example this imperfection is tolerated.) In some examples, the number of steps can be kept the same but certain operations can be marked as dummy so that the timing and/or number of steps is not revealed, as will be understood.

Turning now to FIG. 4, a detailed example is shown of a setup and optional cut-and-choose for a multiparty computation in accordance with aspects of the teachings of the invention. FIG. 4A is the column of pseudonyms of nodes; FIG. 4B is the optional commitment by the prover to the assignment of the operation of one of multiple sets of operations to one of multiple example sets of pseudonyms; FIG. 4C is the opening for optional audit of an example set of operations assigned to an example set of pseudonyms; FIG. 4D is the transfer of instructions from the prover to the pseudonym holders; and FIG. 4E is example transfers of value between pseudonym holders.

Inconsistencies or incorrectness in what may here be called “code” or “operations,” can it is believed be handled in at least two different example approaches. In a first approach as will be appreciated, if and to the extent that the what instructions are public or otherwise known to the nodes, for instance, then they may be considered already approved and error or cheating free. In a second approach, if and to the extent that the instructions contain some confidential or secret information, such as already mentioned, then the orchestrator may supply these values in encrypted form to the nodes. In some examples of this second approach the values sent can be audited in parts, such as by a so-called and as will here be called “cut and choose” protocol. The sets opened in cut and choose are generally sufficient to establish at least with adequate probability that the values are properly formed, but not enough at least with high-probability to reveal too much if anything about the secrets later used.

In some setting and/or examples some portions of the instructions may be considered confidential and yet some properties may be desired to be established about them. One approach, in an aspect of the present invention, is to commit to various versions of the instructions, allow a random audit of portions of the committed values in order to establish some confidence of the properties desired, and then to what may here be called “open” or decrypt the commitments in such a way that the corresponding pseudonym holders receive them.

Referring to FIG. 4A, the column of dashed-line boxes represents a set of pseudonym holders. Some examples cut and choose structures can use a single set of pseudonyms with multiple sets of operations; however, it is believed then that only a single set of nodes or what may also be here called “pseudonym holders” will perform the operations. In other examples, there can be more than one set of pseudonym holders and more than one set of operations.

It is believed advantageous, in at least some embodiments, that the orchestrator (comprised of one or more parties) may be at least inhibited from if not ideally prevented from manipulating the assignment of which operations are to be performed by which nodes. In some examples, a list of operations can be published or committed in advance of, for instance, mixing those results in the pseudonyms. Then the permutation induced by the mixing, which is presumably random and hard to manipulate, makes it difficult for the orchestrator to influence the assignment. In other examples, the assignment can be made to the pseudonyms in an at least partly manipulatable order, such as lexicographic order, and then a permutation is ideally determined in a way that is at least difficult for the orchestrator to manipulate. For instance, a public random draw or the like can be used to make the mapping. In such cases, the mapping can it is believed also ideally be hidden from public view but committed by the orchestrator, such as permuted or influenced by an earlier committed value (not shown for clarity) by the orchestrator, so as to be still un-manipulatable by the orchestrator but also unknown even when the random draw is public. Accordingly, the examples shown in this FIG. 4A through 4D include such a permutation formed by and committed to by the orchestrator that is later revealed at least to the respective nodes.

Optional steps 4B and 4C are believed to disclose how the optional cut-and-choose of proposed instructions can be achieved.

Referring to optional FIG. 4B, a column of pseudonyms as described with reference to FIG. 4A is again present, on the left; however, on the right a set of commitments to operations by a prover are shown. These latter are made up of an outer layer of encryption for the commitment, as will be understood, that contains the operation (shown using adapted flowchart notation) with the specific pseudonym slot (either, as mentioned, for instance, lexicographic or output batch order) that is to perform the operation if the set of operations is not opened in audit. Arrows redundantly for clarity indicate the particular pseudonym holders that will correspond to the respective operations.

Referring to optional FIG. 4C, an example column opened in audit is depicted. The outer encryption being removed reveals both which pseudonyms each operation was to transfer to, such as because it has been encrypted with the of corresponding pseudonym public key. The value transferred is also revealed so that it can be checked for consistency with the otherwise public or published or agreed computation. If the check fails, it is believed that the particular prover would be discredited, as mentioned, and the overall computation process instance terminated.

Referring next to FIG. 4D, transfer of instructions from the prover to the respective pseudonym holders is shown. The arrows, already introduced in FIG. 4B are used to show these transfers of information from the prove to the respective pseudonym owners.

Referring finally here to FIG. 4E, some few exemplary transfers between pseudonym holders of dynamic values during computation are shown. It will be appreciated that in general, as illustrated in the example described with reference to FIG. 2, some nodes receive more than one input for their operation. Similarly, some values are sent by one node, in general, to more than one node. And also indicated, by the dotted line arrow, some initial nodes can receive values from other nodes.

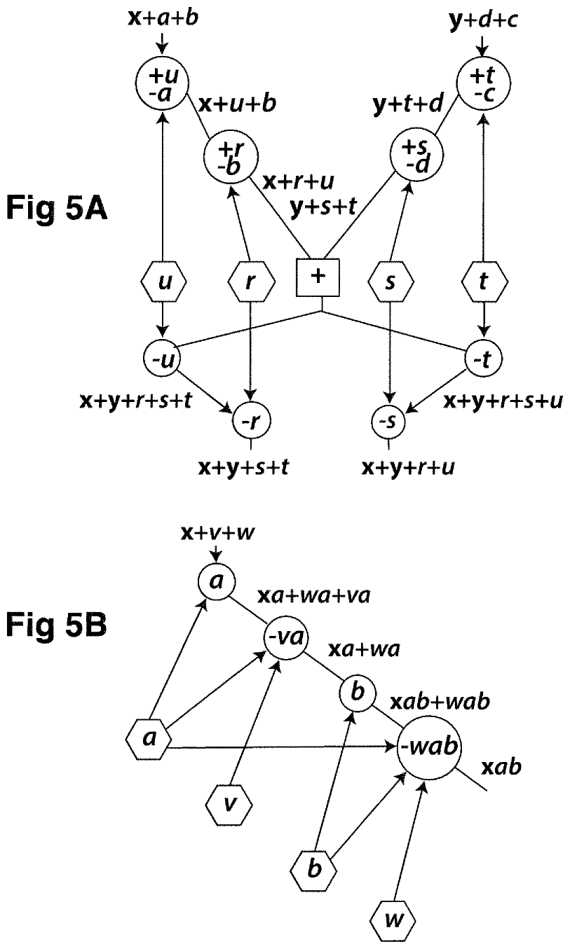

Turning to FIG. 5A-B, a detailed exemplary embodiment for a double-blinding multiparty computation in accordance with aspects of the teachings of the invention. FIG. 5A is an example addition of double-blinded values; FIG. 5B is an example conversion from additive blinding to multiplicative blinding in a double blinding system.

Single blinding may be referred to here as “single level” blinding. It will be appreciated that double-blinding can, it is believed, protect against collusion of any two nodes. It may be referred to here as “double level” blinding. Blinding of more than one level, here refers to double level, triple level, and so forth.

Referring now to FIG. 5A, two inputs x+a+b and y+d+c are shown and they are to be added; each is double blinded, x by a+b and y by d+c. In a first vertical level one blinding summand, a and c, is removed from each and one blinding summand, u and t, is added to each; in the second level, again one blinding summand, b and d, is removed from each and one blinding summand, r and s, is added to each. Thus, after the summation, the resulting sum has four blinding summands. These are removed in two layers: the upper layer removes the u from the left side and the t from the right side; the lower layer removes the r from the left and s from the right. So what is left is the sum, x+y, double-blinded: on the left, x+y+s+t, and on the right x+y+r+u.

It will be appreciated that in some cases nodes, such as a pair of nodes, can be what may here be called “isolated” from each other by the inclusion of intermediary nodes, and intermediary blinding that is later removed, that ensures that the two nodes of the pair have no value in common that they could use to reach out to each other.

Finally, referring now to FIG. 5B, an example conversion between additive and multiplicative blinding is shown. The direction shown starts with the double additively blinded value x+v+w and converts it to the double multiplicatively blinded value xab. The opposite direction, from multiplicative to additive, is readily understood by those of skill in the art, as can be interpreted as isomorphic or simply swapping notation for additive and multiplicative.

At the first vertical layer, a multiplicative factor is combined into the input, x+v+w, with the result being shown as xa+wa+va. Then the next level removes the va term. Next a factor of b is introduced, yielding xab+wab. Finally, the last term is removed, such as by adding its additive inverse, and the final multiplicatively double-blinded result is obtained, xab.

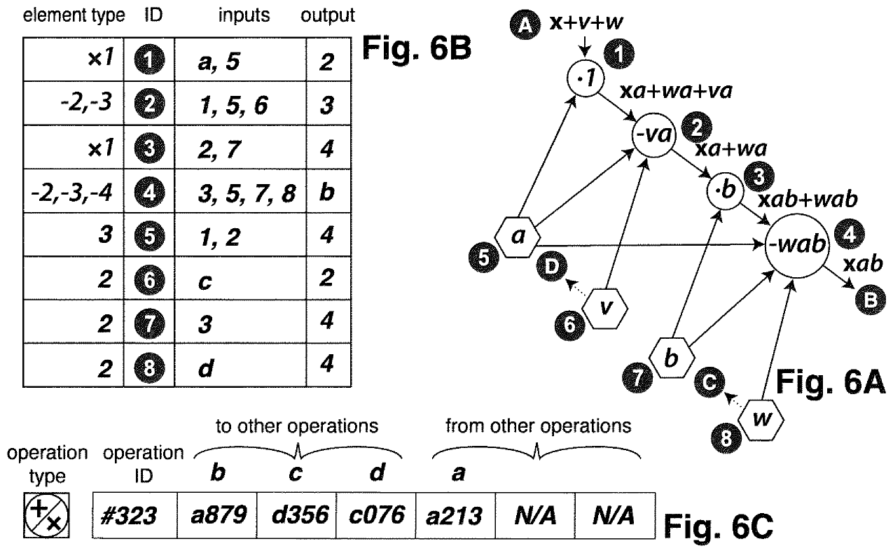

Turning now to FIG. 6A-C, an exemplary additive to multiplicative operation graph is further detailed for clarity, as will be appreciated, in accordance with aspects of the teachings of the invention. FIG. 6A is the graph already described with reference to FIG. 5B but with its inputs and outputs and internal nodes labeled; FIG. 6B is the full table of the graph of FIG. 6B; and FIG. 6C is a compact representation of the operation of FIGS. 6A and 6B.

Referring first to FIG. 6A, the input can be seen labeled by the “A” within a circle, also called here circle “A” for short. The first operation, a multiplication, takes this input and combines it with the input from hexagon labeled circle “5,” and so forth, to the output shown labeled as circle “B.”

Referring next to table 6B, the table is in four columns. Column 1 shows the elementary operation type. The first row, for instance, is a multiply with a single output, as will be understood. The second column shows for this elementary operation the ID of the circle notation that performs it, as circle “1.” Two inputs are shown, one is circle “A” and the other is from the hexagon labeled circle “5.” As another example, the fourth row corresponds to label circle “4” and forms the sum of three additive inverses. It has an additional input that is not subtracted. Its output is the output of the operation, labeled circle “B.”

Referring finally to FIG. 6C showing a compact tabular representation of the operation, where the overall conversion from additive to multiplicative is shown as what is called here the “operation type.” Next is what is called the “operation ID,” and it is shown as “#323.” After this, the output to other operation is shown, such as “a879,” which goes to circle “B” output of the conversion. The inputs are also shown, in this case circle “A,” which is given ID “#213.”

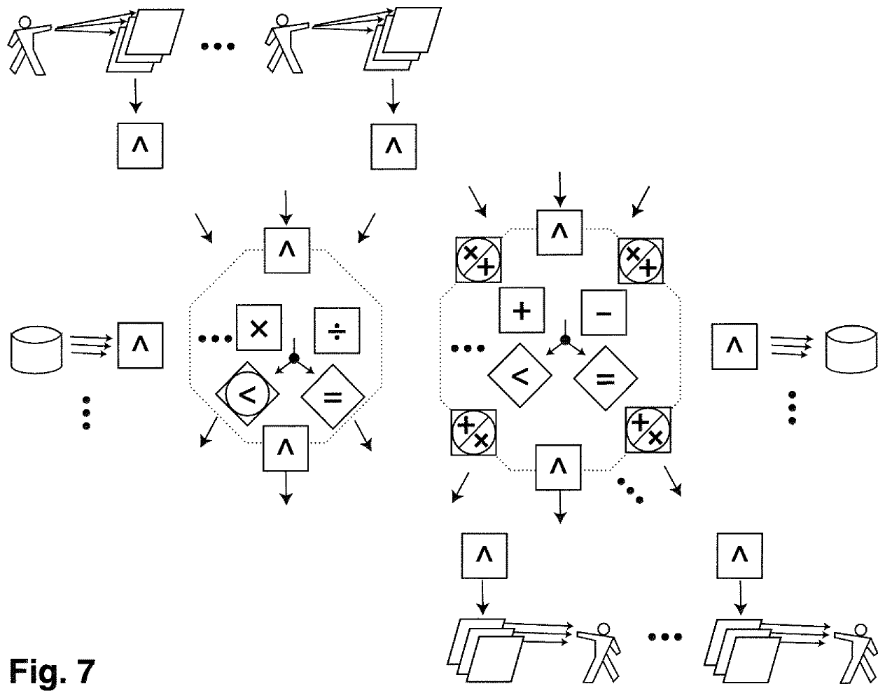

Turning next to FIG. 7, an exemplary overall combination block diagram and protocol overview is shown in accordance with aspects of the teachings of the invention. A plurality of input providers, shown as persons, and plural output recipients, shown as persons, are also depicted. Memory subsystems providing data and receiving data for storage are shown. The operations are shown in two groups, those that are additive and those that translate in from additive and back out.

The inputs are shown as two people separated by an ellipsis, to signify that one or more persons or other entities can provide inputs. Each person is shown providing multiple inputs, one to each of multiple trapezoids. In practice, by dividing the input into parts, such as the type of parts used by the operations, and providing the parts each to a different portion of the system, such as a different node or trapezoid, the inputs can be protected by being spread across nodes much as internal computation values. Similarly, the outputs are shown being provided to people or entities, and in parts that the recipient can combine, yielding similar advantages, as will be understood.

In some exemplary embodiments, it may be advantageous to protect input values in transit to the system and also similarly in some cases to protect output values on their way from the system to recipients. A way to provide such protection is through encryption, such as using keys known to the counterparties. One example type of encryption includes exponentiation and this is why the exponentiation operations are shown between the inputs and outputs and the main computation. As an example, a person may send in three values, each raised to a secret power, and when the values are successively raised to the multiplicative inverse of that power and multiplied together, the plaintext input may result; however, it was protected on the way in and is divided across multiple nodes.

Storage of data, whether reading or writing, is shown similarly on the left and right sides of the diagram, respectively, with a drum icon symbolizing storage media, as will be appreciated. The data can also be multiply exponentiated for storage and then reconstructed, as with inputs, by combining and decryption, as indicated by the multiple arrows and the exponentiation operation.

Higher-level operations are shown for clarity as arranged in two clusters, each cluster in a dotted octagon. The three-way arrow icons in the center of the octagons are intended to indicate various combinations and interconnections. The octagons can input and output exponentiated data, as is also shown.

The octagon on the left has, for example, multiplicative operations shown, such as multiplication and division. The comparison is shown with a circle to indicate that it is believed a more expensive test in this setting than, for instance, equality. The outputs of this octagon can be used as inputs of other such octagons, as will be understood.

The octagon on the right, however, uses additive operations internally. Thus, as will be understood, it is believed that inputs should be converted from multiplicative to additive blinding, as already explained with reference for instance to FIG. 2, on the way into this octagon; similarly, outputs are shown translated from additive to multiplicative blinding by the icons, such as that as was described with reference to FIG. 6.

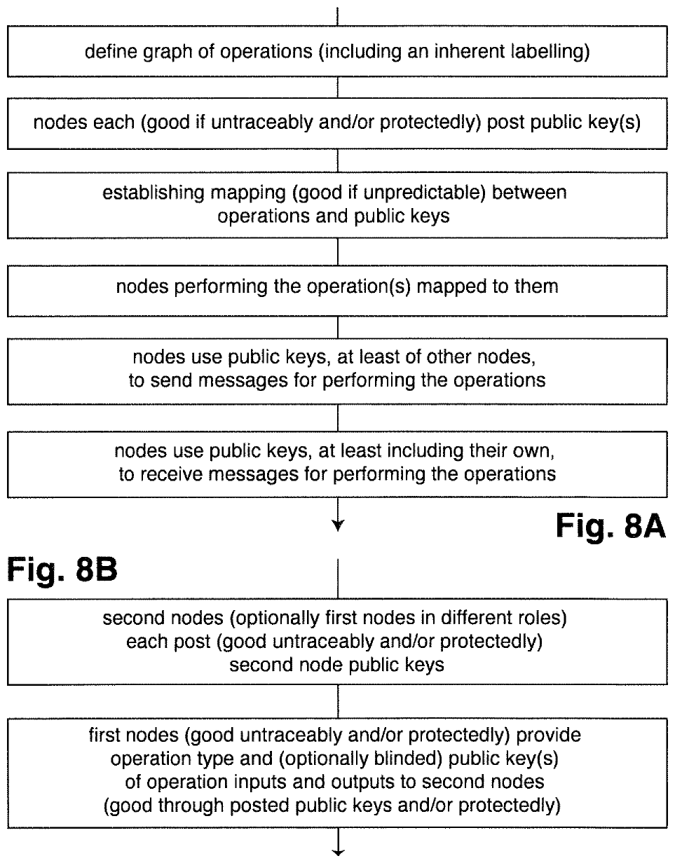

Turning to FIG. 8AB, presented is a detailed description of an exemplary overall flowchart in accordance with aspects of the teachings of the present invention. FIG. 8A is the assigning of computation parts to nodes the nodes communicating in conducting the computation while inhibiting other types of access to the nodes conducting the computation. FIG. 8B includes the options for changing encryption of messages between nodes and the introduction of nodes that hide which nodes perform operations.

Referring now to FIG. 8A, the system, in some examples, can be understood it is believed as including the following steps:

What can here be called “define graph of operations (including an inherent labelling)” is any way for a set of computational elements (in whatever non-limiting combination of arithmetic, symbolic, cryptographic, decision, control flow or other known aspects of computations) to be interconnected so as to form a definition or effective procedure for a desired computation and/or process, with whatever ongoing data storage, inputs, and outputs. Also, as will be understood, when encoding such a graph one or more orderings are typically in effect assigned to the nodes and edges, such as for instance by whatever algorithm for walking the graph.

What can here be called “nodes each (good if untraceably) post public key(s)” is any way for nodes to make public keys (for which they know all or part of the private keys) available at least to the other nodes. For instance, more than one node and/or other entity may be needed to decrypt a message sent encrypted with a private key, and/or more than one node and/or other entity may be needed to form a signature with a private key.

What can here be called “establishing mapping (good if unpredictable) between operations and public keys” is any way to at least have nodes know what operation(s) of the graph they are responsible for and be able to at least somehow communicate with the other nodes as per the definition of the operation(s) that they are responsible for.

What can here be called “nodes performing the operation(s) mapped to them” is any way for the nodes, whether separately and/or jointly, to compute the operations of the graph that have been mapped to them.

What can here be called “nodes use public keys, at least of other nodes, to send messages for performing the operations” is any way for the nodes to communicate information, such as using encryption with public and/or symmetric and/or other keys, at least facilitating the completion of their own operations and/or the operations of one or more other portions of the graph and/or assigned to other nodes.

What can here be called “nodes use public keys, at least including their own, to receive messages for performing the operations” is any way for the nodes to communicate information, such as using decryption with public and/or symmetric and/or other keys, at least facilitating the completion of their own operations and/or the operations of one or more other portions of the graph and/or assigned to other nodes.

The resulting property can here be called “the computation of the graph is performed without the particular nodes performing the particular functions being readily reachable by other than by the corresponding nodes of the graph,” which is any way to inhibit and/or impede and/or make detectable and/or make uncertain efforts by entities to try to and/or to reach out to and/or communicate with specific nodes of the graph.

Referring to FIG. 8B, additional portions of the system, in some examples, can be understood it is believed as including the following steps:

In addition, what can here be called “additional keys being included by nodes performing the mixing of messages sent to the nodes” is any way for one or more communication channels that can be used to reach nodes to include the incorporation of additional and/or extra encryption or public-key operations or the like. One exemplary advantage and/or aspect can be to create extra difficulty in reaching nodes performing certain functions, as the communication would have to pass through the particular channel in order to recover and/or reconstruct and/or arrive at the form of the message that is properly encrypted and/or decryptable by the recipient.

In addition, what can here be called “the mapping being known to the nodes on a roughly or approximately need to know basis” is any way to encrypt at least local and/or peephole and/or regional portions and/or subsets of what may here be called “interconnect points” between various operation sub-graphs so that the decryption is by the nodes that are mapped to those regions. As just one example, each node can use so-called “private information retrieval” to obtain the portion of the graph that has been assigned to it and then again use private information retrieval to find the key for the region and/or of the specific interconnect points.

In addition, what can here be called “first nodes (good untraceably and/or protectedly) provide operation type and (optionally blinded) public key(s) of operation inputs and outputs to second nodes (good through posted public keys and/or protectedly)” is any way to transfer the duty of performing the operations to entities that are not publicly visible as associated with specific operations.

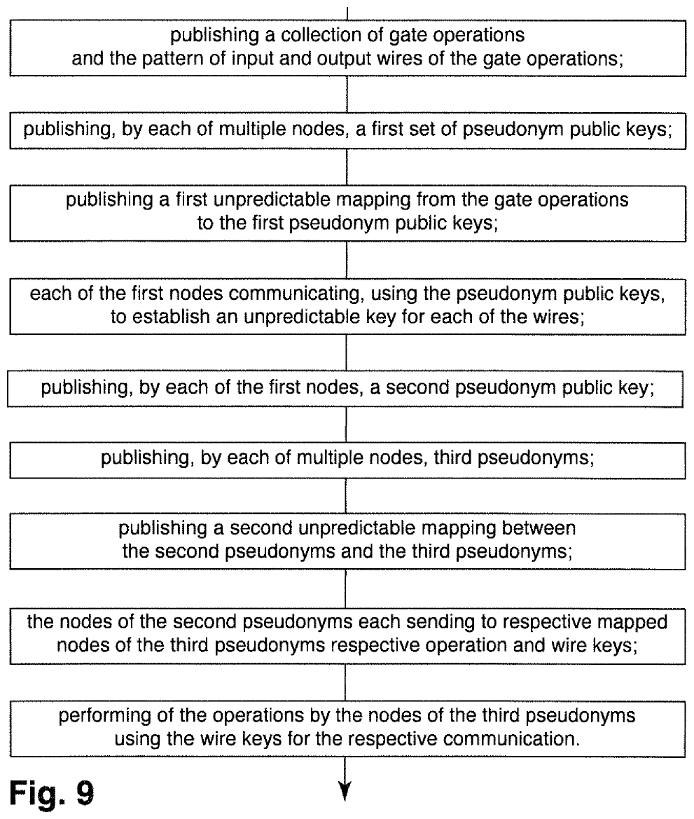

Turning to FIG. 9, a flowchart for an exemplary distributed computation system is shown, in accordance with aspects of the teachings of the invention. The system, in some examples, can be understood it is believed as including the following steps:

What can here be called “publishing a collection of gate operations and the pattern of input and output wires of the gate operations” is any way to lay out and/or determine and/or compile and/or create a graph with operations as nodes and interconnections for the inputs and outputs of those operations characterized by the edges.

What can here be called “publishing, by each of multiple nodes, a first set of pseudonym public keys” is any way to allow more than one node, typically, to obtain identities, such as public keys, that are not readily linked to the nodes by at least some parties.

What can here be called “publishing an unpredictable mapping from the gate operations to the first pseudonym public keys” is any way to associate and/or link each of multiple operations, at whatever level they are defined, to respective nodes based on first pseudonyms of the nodes. For instance, this can be by a mutually trusted random number source, such as a blockchain, and a pre-arranged algorithm for making the mapping. The mapping can, in some examples, be known to the nodes and few if any other entities, or for instance it can be public.

What can here be called “each of the first nodes communicating using the pseudonym public keys to establish an unpredictable key for each of the wires” is any way to for the first nodes to communicate selectively with other first nodes to create keys that are not public but that correspond, for instance, to each wire. One kind of example is where the nodes use the public keys already posted to encrypt additional keys and send those additional keys as messages and then some or all of the keys enter into the final wire key or key computation, as will be understood.

What can here be called “publishing, by each of the first node, a second pseudonym public key” is any way to allow more than one node, typically, to obtain identities, such as public keys, that are not readily linked to the nodes by at least some parties.

What can here be called “publishing, by each of multiple nodes, a third set of pseudonyms” is any way to allow more than one node, typically, to obtain identities, such as public keys, that are not readily linked to the nodes by at least some parties.

What can here be called “publishing an unpredictable mapping between the second set of pseudonyms and the third set of pseudonyms” is any way to associate and/or link each of multiple second pseudonyms third pseudonym and/or linking the respective nodes, as will be understood. For instance, this can be by a mutually trusted random number source, such as a blockchain, and a pre-arranged algorithm for making the mapping. The mapping can, in some examples, be known to the nodes and few if any other entities, or for instance it can be public.

What can here be called “the nodes of the second pseudonyms each sending to respective mapped nodes of the third pseudonyms respective operation and wire public keys” is any way for the second nodes to communicate to the third nodes and the third nodes to receive information related to the operations that the respective third nodes are to perform and the keys corresponding to the wires for those operations.

What can here be called “performing of the operations by the nodes of the third pseudonyms using the wire keys for the respective communication” is any way to actually compute the operations, taking inputs from the wires and expressing outputs to the wires, according to the graph, as will be understood.

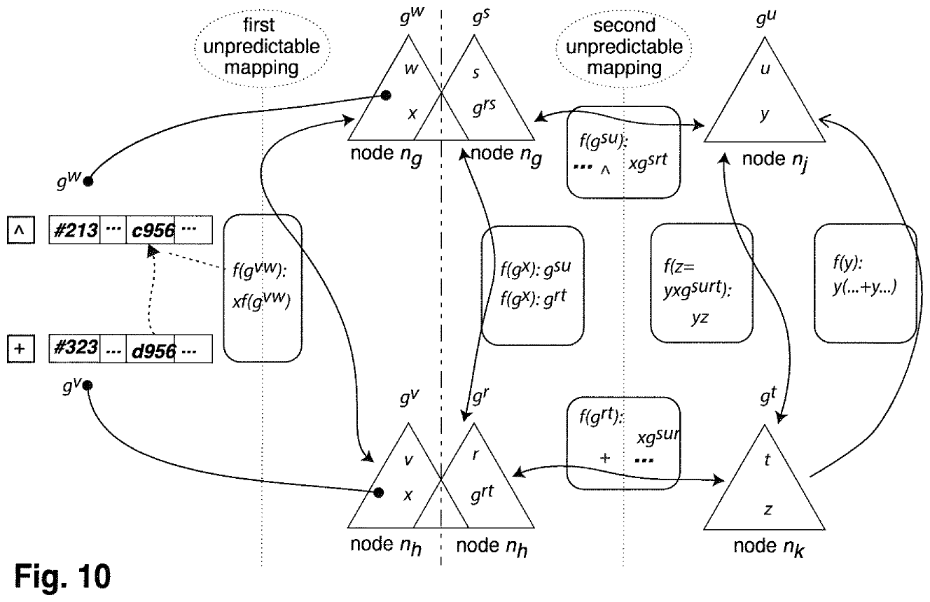

Turning finally now to FIG. 10, an exemplary distributed computation system is shown in combination block diagram and cryptographic protocol schematic, in accordance with aspects of the teachings of the invention. The vertical lines divide sets that are at least at some point and to some extent unlinkable; two example gate operations are included and a wire connecting output of one to input of the other; four nodes, shown as triangles, each communicate with each other at least including via untraceable sending.

Two gate operations such as have been described already are shown on the left: the upper is an exponentiation and the lower is addition; the identity of the upper is “#213” and that of the lower is “#323”; the wire connecting the two operations is shown, with other wires indicated by ellipsis, as will be understood, as “d956” and “c956,” where the common numerical portion is intended to indicate that they are the same wire, as also indicated by the dashed arrow, but the different letters to indicate the different input and output role of each.

First the gates are punished as shown. Next, each of the two leftmost nodes, n_{g} and nₕ, have published public keys, such as so-called “diffie-hellman” public keys. Then, the first unpredictable mapping, assigns in the example a gate to a node identified by public key, such as for instance best in a one-to-one or bijective mapping, though an injective mapping is believed also useable. Next, the nodes knowing that they have been mapped to the same wire of the gate, such as because of the matched input output numbers mentioned above, communicate. In some examples this can, it is believed be without a mix; however, they are shown using a mix for consistency and potential advantage.

The messages exchanged by the two nodes can be thought of as identified by the same value in an output batch of a mix publishing system, for clarity here. The header is thus shown as the image under the one-way function f of the diffie-hellman key that they can both form, g^{vw}; the payload x is thus then indicated for simplicity and clarity but without limitation in the example as being the product of the secret and the pre-image of the header under f, as will be understood. Accordingly, both upper and lower leftmost nodes now know their mutual secret key x.

Next, each of the leftmost nodes publish a new public key or second pseudonym, anonymously, g^{s} and g^{f} respectively, it is believed ideally unlinkably to at least their previous key g^{w} and g^{v}, respectively. Additionally, other or the same nodes under different pseudonyms, publish a third set of pseudonyms. These are shown as separate nodes nⱼ and nₖ on the right side of the diagram, with public key pseudonyms g^{u} and g^{y}, respectively. At this point a separate unpredictable mapping is made known, between the second pseudonyms and the third pseudonyms.

Now the second pseudonym owners can communicate, based on the wire key x, to arrive at public keys corresponding to the respective third nodes, g^{su} and g^{rt}. At this point, the second nodes can communicate with the mapped nodes of the third set, nⱼ and nₖ, respectively. These messages can use hashes of the corresponding public key pairs as headers. These payloads can include the shared key x combined with the respective public key of the recipient third node; this allows the third nodes to compute the common key, it is believed, unlinkable to the second nodes, for the wire: z=yx^{gsur}. The key y then is unlikable to the previous messages, was included as the payload exchanged, similar to the way x was a wire key. Then, finally, y can be used to send the value as shown through a mix from g^{t} to g^{u} during evaluation of the operation graph.

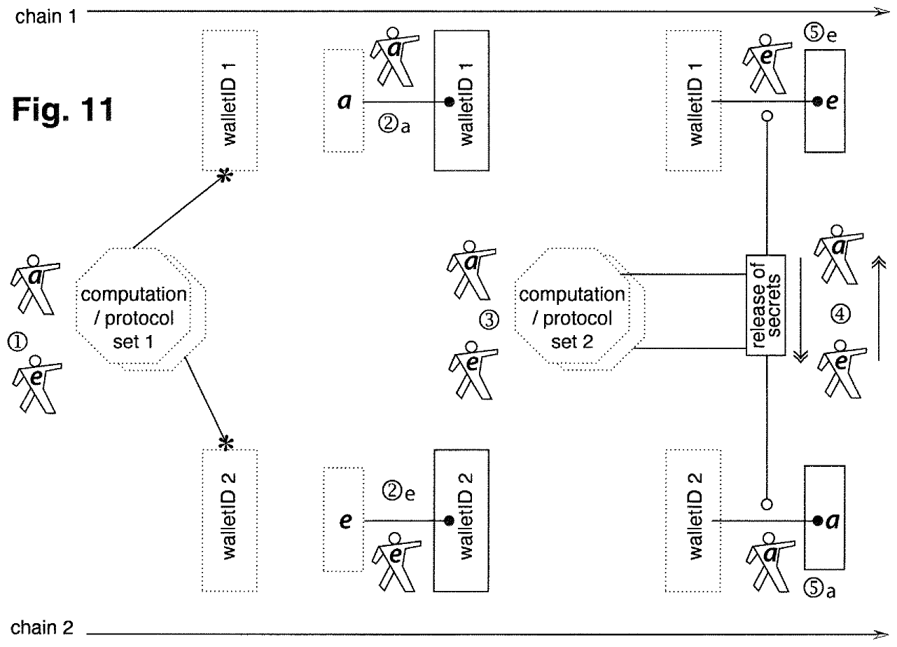

Turning to FIG. 11, an exemplary distributed atomic swap system is shown in combination block diagram and cryptographic protocol schematic, in accordance with aspects of the teachings of the invention. Two parties and two blockchains are shown and two sets of computations are used by the parties to move value on a first chain from a first party to a second party on the first chain and value on the second chain from the second party to the first party, in such a way that is believed to ensure that neither party can obtain the value from the other party unless both parties obtain the value from their counterparty.

Across the top a first blockchain with some example data stored in its ledger is shown changing over time from left to right; similarly, across the bottom a second blockchain with some example data stored in its ledger is shown changing over about the same timeline. There are potentially six so-called “walletIDs” shown: two are created by the protocol, walletID1 and walletID2; two are controlled unilaterally in some examples by party “a,” called here Alex for clarity, and are labeled as such; and two are controlled unilaterally in some examples by party “e,” called here Ellis for clarity, and are also labeled as such. The walletID's shown dotted line may contain no value, such as after being created as indicated by the asterisk line end, whereas those shown solid line are shown receiving value by the filled circle line end. A first and second set of computations and/or protocols is shown conducted between at least the parties shown, as indicated by the dotted octagon notation used elsewhere here as well. Also for clarity, as will be appreciated, what may be regarded as steps are numbered in circles, sometimes including a suffix of “a” or “e” to indicate when a step is performed by each of the two example parties, Alex and Ellis, at least somewhat separately.

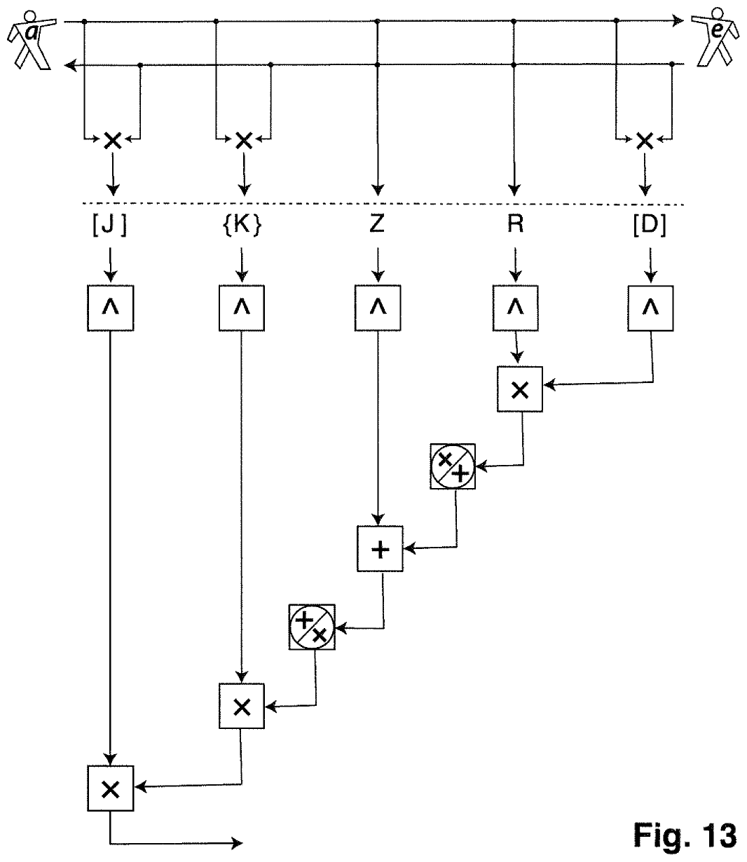

The first computation and/or protocol is shown as step one being performed by Alex and Ellis. It will be described in more detail, such as with reference to FIG. 13, but can be thought of as made of up two sub-parts, one that creates each of two separate public keys or “walletIDs” in blockchain, as is indicated by the asterisk line ends. The private keys of these two walletIDs are what may be called “shared” in the sense of secret-sharing protocols, or divided into parts, such that the parties, in this case Alex and Ellis are unable, without helping each other, to create signatures that would result in removing value from either walletID.

Next shown is that each of Alex and Ellis are involved somehow respectively in transferring value to the new walletIDs on their native blockchains. For instance, Alex is shown above the line that moves value from a walletID, or potentially another source, to walletID1 in step 2a; similarly, Ellis is shown below the line indicating moving of value from a walletID labeled “e” to walletID2 in step 2e.

A further step 3 is again a computation and/or protocol set 2 performed in the example by at least Alex and Ellis, as shown.

The result of this set of operations is input to what is shown as step 4, a “release of secrets” protocol, known in the art. Such protocols, at least in some examples, allow one party to gradually likely but verifiably make a secret easier to compute and/or increasingly likely to be revealed to at least another party. By conducting two instances of such a protocol, with the respective outputs of the second set of protocol computations, Alex and Ellis are able to in a parallel manner release signatures, indicated as hollow circle line ends, that transfer value from the respective wallets.

Accordingly, as will be appreciated and understood: the value from walletID1 on chain1 can be obtained by Ellis in step 5e in a wallet or other method/means shown as a rectangle with an “e” in it; and the value from walletID2 can be obtained by Alex in step 5a in a wallet or other method/means shown as a rectangle with an “a” in it.

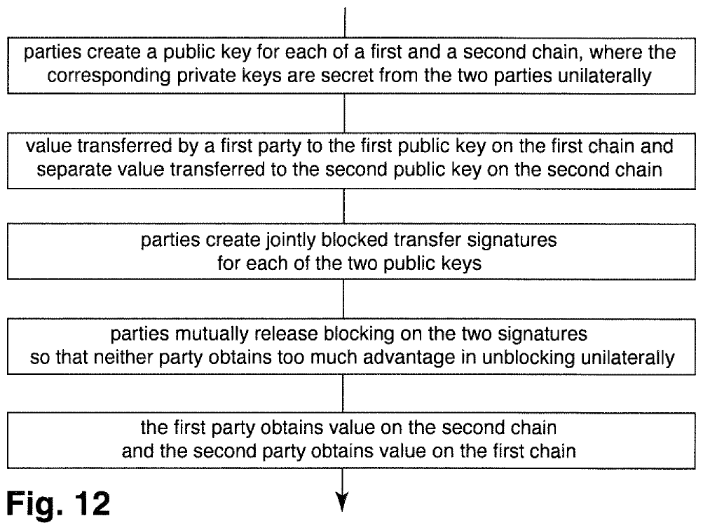

Turning to FIG. 12, an exemplary flowchart of a distributed atomic swap system is shown, in accordance with aspects of the teachings of the invention.

What may here be called “a cryptographic protocol system” is any means and/or method whereby one or more parties are able to use cryptography, in some cases in cooperation with other parties, to obtain desired properties with respect to information, such as secret keys, public keys, distributed ledgers and the like.

What may here be called “parties” are any entities, whether natural persons, devices believed under control of such persons, legal entities, technical processes that may be controlled by others or largely autonomous.

What may here be called “blockchains” are any and all protocols involving multiple parties that in some way control and/or protect the store of value in wallets.

What may here be called “the at least two parties create a public key for each of at least a respective first and a second chain, where the corresponding private keys are secret from the two parties unilaterally” is any way for at least two parties to cooperate to create places where and/or names under which value can be stored on a blockchain, but that neither party acting alone can take that value from that place without cooperation of the at least one other party.

What may here be called “transfer of value made to the first public key on the first chain and separate value transfer made to the second public key on the second chain” is value moved under the control of the jointly controlled accounts, by whatever party and whatever means. For instance, the two parties themselves could move the value from their existing accounts; but, in other examples, the sources can be accounts with various control and/or ownership arrangements.

What may here be called “the at least first and second parties create jointly blocked transfer signatures for at least each of the two public keys” is any cryptographic or other protocol or computation that makes the signatures in a protected but releasable state.

What may here be called “the at least first and second parties mutually release blocking on the at least two signatures so that neither party obtains substantial advantage in unblocking unilaterally” is any means and/or method whereby it is accomplished that the at least two parties each obtain access and/or control to the value transferred to their respective accounts or the like, but in a single indivisible action and/or gradually but increasingly surely or made easily reached and/or with increasing likelihood. A “substantial advantage” as used here can be any way that the party could get access to their value but still not have gone far enough with the unblocking that the other party is unable to obtain their value.

What may here be called “the at least first party obtains value on the second chain and the second party obtains value on the first chain” is the desired end result that after the release of the blocked transactions, the parties receive the swapped value; however, any variant of multiple parties and/or where the value is stored is anticipated.

Turning to FIG. 13, an exemplary computation for a distributed atomic swap system is shown in combination block diagram and cryptographic protocol schematic, in accordance with aspects of the teachings of the invention. The overall notation is related to that introduced, for instance, with reference to FIG. 2, FIG. 3 and FIG. 7; however, two parties are here shown providing input that is pre-combined, such as for clarity, efficiency and/or to illustrate an option, for a respective input of a series of inputs, some multiplicative and some additive.

The notation used is believed relatively standard and consistent with that used for instance in the Wikipedia entry for “Elliptic Curve Signatures”:

D (is the private key dₐ);

### R (is x₁ mod n);

### Z (is s);

K (is k⁻¹ mod n); and
J (is the blocking factor introduced here).

More specifically, there are two parties, Alex and Ellis, as already described with reference to FIG. 11, shown providing inputs across the top. Each of these inputs (apart from Z) is combined pairwise to produce the inputs shown below the dot dash boundary line. In the example, Alex and Ellis each encrypt each respective input for each node (of which there may be more than one, such as using the techniques described with reference to FIG. 5 not shown here for clarity) using a public key of the respective node. Since in the example show for clarity the encryption is by exponentiation using the “public key” of the recipient node, as will be understood, encrypted inputs can be combined in the clear. For instance, Alex and Ellis can, it is believed, multiply in the multiplicative group of the encryption with the nodes what is in effect their respective shares of the secret key D, shown in square brackets to indicate this case; each of Alex and Ellis would have to cooperate, it is believed, to recover the combined key, the sum in the exponent of their respective secret exponents. Similarly for J, which is also shown in square brackets to denote this.

The value K, although in some systems might ultimately be made public, it is believed best and in the example case shown here for clarity would be mutually random and can be kept confidential. To this end, it is shown as the product of two encryptions, so that as with D, it becomes what is believed a mutually random value for the two parties, Alexa and Ellis.

For the input Z, since it is typically the image under a believed one-way or hash function, each party would, it is believed ideally be able to check it and/or agree on it. Accordingly, Z is shown being sent in by both Alex and Ellis; however, to keep it confidential for various reasons, it can still be encrypted using a public key known to nodes for this purpose, shown as exponentiation.

Similarly, for R, since Alex and Ellis can use the public curve and the value Z that they agree on and the mutually random value K, it is believed that they can and would ideally compute and check the same value for R.

The value J, shown in square brackets as is the private key, would be a mutually random and believed ideally secret value to the parties; for instance, neither Alex nor Ellis would be able to learn J until, as in step 4 already described with reference to FIG. 11, the parties participate in a release of secrets protocol, as are known in the art as already mentioned and not shown here for clarity.

In order to learn the public key and thereby in some blockchain systems, the walletID, as already also described with reference to FIG. 11, the protocol described here with reference to FIG. 13 can conducted once in advance, with J set to the identity or left out, taking advantage of the well-known property that the public key can be computed from such a signature and a walletID then arrived at from the public key.

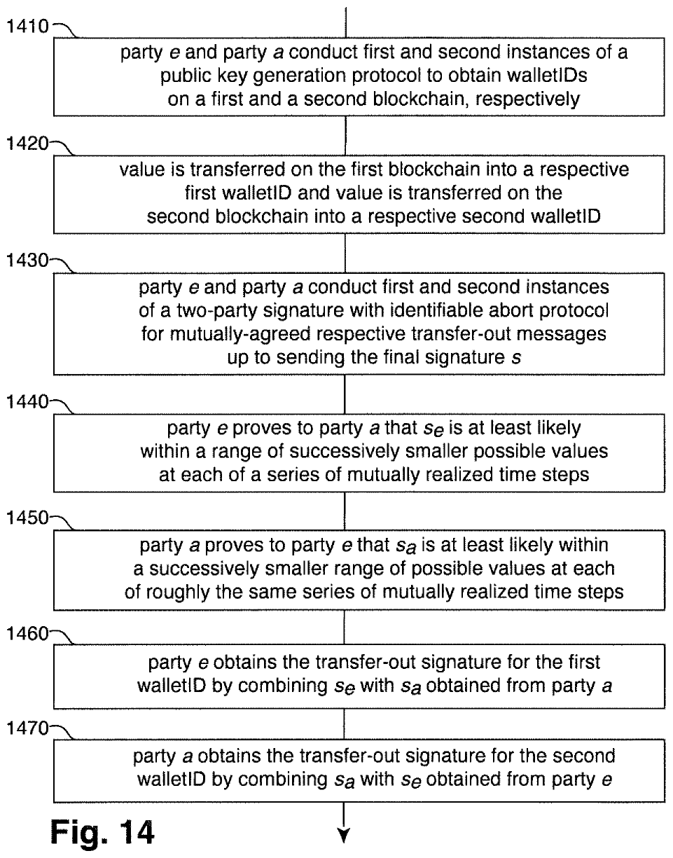

Turning to FIG. 14, an exemplary atomic swap cryptographic protocol is shown in combination flowchart and protocol schematic, in accordance with aspects of the teachings of the invention. In the first example the swap is described for ease in understanding and clarity between a first blockchain and second blockchain (anticipated, however, are more than two chains) by a first and a second party (anticipated, however, are more than two parties).

In block 1410, party e and party a conduct first and second instances of what may here be called a “public key generation protocol” that is said here to result in “walletIDs” on the first and second blockchains respectively. Any way for the parties to arrive at so-called WalletID's, well known in the blockchain art, so that the parties must work together (either in the pair or with whatever monotonic sharing function per chain, as will be understood is anticipated in more general settings) in order to move value from the walletID's.

One example protocol that can be used for this has been disclosed by Rosario Gennaro and Steven Goldfeder, in an article titled “One Round Threshold ECDSA with Identifiable Abort,” that appeared among other places for instance on the IACR ePrint server, as “eprint.iacr.org/2020/540.pdf.” This article is incorporated as if copied in its entirety in the present application. It may be referred to here as “Rosario et al 2020.”

In block 1420, it may here be said that “value is transferred on the first blockchain into a respective first walletID” and similarly value is transferred on the second blockchain into a respective second walletID. What is meant is any and all movement of value or other entities, without any limitation, on a blockchain, its shards or sidechains generally, without any limitation. The parties moving the value can in some examples be a and e, respectively; however, this value is anticipated to be possibly moved by whatever other entities or combinations of entities.

In block 1420, it may here be said that “party e and party a conduct first and second instances of a two-party signature with identifiable abort protocol for mutually-agreed respective transfer-out messages up to sending the final signature s.” This can be used to mean, as just one example, that a protocol such as Rosario et al 2020 is used to create what may here be called “precursors” or other values that almost move value from the walletIDs mentioned with reference to block 1420, but that are missing some aspect that is generally needed or very helpful at least on average or statistically or for whatever other limitation, does not move the value. What may here be called “mutually-agreed respective transfer-out signatures” is any and all signatures or other digital authentication of whatever form that can transfer the value from the walletID's to other types of ownership and/or control, such as for instance but without limitation to other walletID's and/or to so-called “burning” and/or to coins or other formats.

In box 1440, it may here be said that “party e proves to party a that sₑ is at least likely within a range of successively smaller possible values at each of a series of mutually realized time steps.” This can be used to mean the gradual and/or probabilistic transfer of a secret by party e to party a, according for instance to protocols such as those described in the following:

One example protocol that can be used for this has been disclosed by E. F. Brickell, D. Chaum, I. B. Damgard, & J. van de Graaf, titled “Gradual and verifiable release of a secret,” appeared in Advances in Cryptology CRYPTO′ 87, Springer-Verlag, pp. 156-166. This article is incorporated as if copied in its entirety in the present application. It may be referred to here as “Brickell et al 1987.” (A more fully provable version based on the same ideas, but stronger assumptions, has been disclosed by Damgard, and appeared in J. Cryptology 1995 8:201-222. This article too is incorporated as if copied in its entirety in the present application.)

Another approach, for instance, was disclosed by M. Rabin, “How to exchange secrets by oblivious transfer,” Tech. Memo TR-81, Harvard University, 1981. As just another example of the variety of approaches, without limitation, S. Goldwasser and L. Levin disclosed “Fair computation of general functions in presence of immoral majority,” in Proc. Crypto 90, Springer-Verlag, Berlin, 1991, pp. 77-93. These will here be referred to as “probabilistic” release.

In Rosario et al 2020, the final contribution to the signature released by party “i” is sᵢ. It will also be understood by those of skill in the art that this value appears in the exponent of the residue class denoted “R^{s(i)}” in Equation 1. Accordingly, it is believed here, that this in effect encryption of the signature component is known to the parties and believed to have been established by so-called “proofs” resulting from cryptographic protocols, as properly formed. Accordingly, it is believed that Brickell et all 1987 can be used directly to release and prove smaller and smaller intervals constraining sᵢ until sᵢ becomes feasibly to find exhaustively, as is the basic concept of Brickell et al 1987. As will also be readily understood by those of skill in the art if two (or more generally more) parties each in a simultaneous and/or interleaved manner or some other approximation, as will be understood, over time continue to reduce the range of possible values for the respective signature component sᵢ, this creates what is sometimes called a “fair exchange” of the secrets. It is believed that probabilistic release can be used instead and/or combined.

Referring to box 1450, it may here be said that “party a proves to party e that sₐ is at least likely within a successively smaller range of possible values at each of roughly the same series of mutually realized time steps” the meaning is similar to the symmetric case just described above.

Referring to box 1460, it may here be said that “party e obtains the transfer-out signature for the first walled by combining sₑ with sₐ obtained from party a.” This can mean any way to combine information already developed and/or obtained to recover the a. signature on the mutually agreed transfer of value, such as already described with reference to FIG. 11, FIG. 12 and/or FIG. 13, to a walletID on the same blockchain but now under the control of a party that was not in control of the value at the earlier stage when it was moved to the walletID partly controlled by the counterparty.

Referring to box 1470, it may here be said that “party a obtains the transfer-out signature for the second walletID by combining sₐ with sₑ obtained from party e.” This can have a symmetric meaning to that already described with reference to FIG. 1460, but with the parties interchanged, as will be understood.

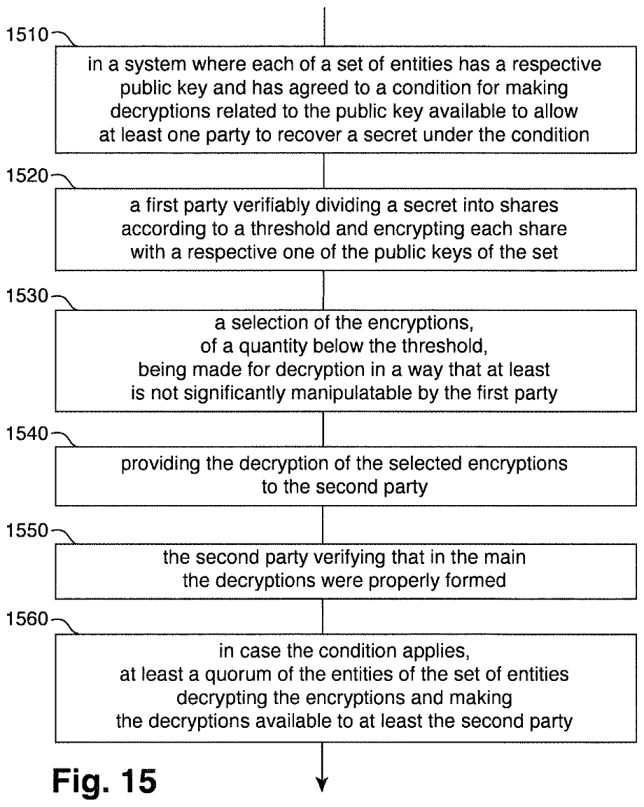

Turning now to FIG. 15, an exemplary recovery cryptographic protocol is shown in combination flowchart and protocol schematic, in accordance with aspects of the teachings of the invention. In the example the keys for unlocking value are divided among a set of entities so that in case the counterparty fails to complete the swap, a party whose value is locked can unlock it with cooperation of a subset of the entities.

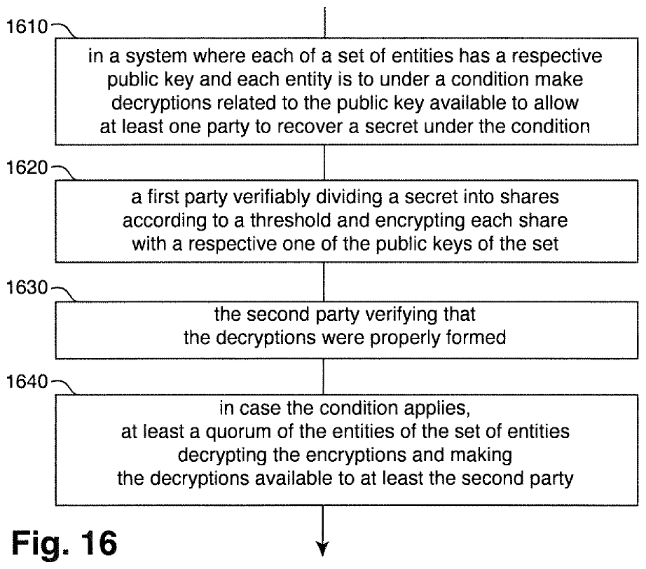

The present application is believed suitable for so-called “secret sharing” and/or so-called “verifiable secret sharing,” as will be understood by those of skill in the art. For clarity a non-verifiably example is presented with reference to this FIG. 15 and a verifiable example with reference to FIG. 16.

A. Beimel disclosed, in “Secret-sharing schemes: a survey,” that appeared in the International Conference on Coding and Cryptology, Springer, 2011, a survey of various secret sharing schemes. This article too is incorporated as if copied in its entirety in the present application.

Referring now to block 1510, a system can here be said to consist of “each of a set of entities has a respective public key and has agreed to conditions for making decryptions related to the public key available.” The purpose of the making the of decryptions available can be in some instances to be to “allow at least one party to check and/or recover a secret under the respective conditions.” In other instances, as described below, it the purpose can be for checking and in other instances for recovery, as will be described.

Referring to block 1520, it can here be said that “a first party divides a secret into shares according to a threshold and encrypting each share with a respective one of the public keys of the set.” The sharing can be verifiably or not verifiably, as mentioned, with verifiable to be described with reference to FIG. 16. The division of a secret into shares is well known in the cryptographic art, and any suitable way to accomplish this, whether with thresholds and/or other monotonic predicates is anticipated.

Referring to block 1530, it may here be said that “a selection of the encryptions, of a quantity below the threshold, being made for decryption in a way that at least is not significantly manipulatable by the first party,” which can be any way to choose which shares to decrypt that cannot readily be manipulated to cheat the party who is checking and/or the party issuing the shares, as will be understood. For instance, the number checked can be well below the threshold to arrive at the secret. Each share, however, can be formed and/or committed to in a way that can be verified separately, as will be understood.

Referring to block 1540, it may be said here that “providing the decryption of the selected encryptions to the second party” to indicate that the selected decryptions can be made available, in whatever way, such as publishing the information and/or sending it in encrypted form and/or over whatever channel.

Referring to block 1550, the second party may be said to “verify that in the main the decryptions were properly formed.” As mentioned above, since shares can be formed and/or committed to in a way that can be verified separately, the selected shares can be checked, as will be understood. Such verification can be accomplished in any way, such as for instance interactively or non-interactively.

Referring to block 1560, it may here be said that “in case the condition applies,” to refer to a situation where a party to a swap does not follow through and leaves the value of the other party trapped and/or blocked, as will be understood. In some examples this condition can be evident due, for instance to timing. In such examples it may be said there that “at least a quorum of the entities of the set of entities decrypting the encryptions and making the decryptions available to at least the second party,” to indicate that by whatever means enough of the entities that have not yet opened their encryptions do so and these decryptions are made available to the blocked party and the decrypted data is enough to unblock the swap, such as providing the private key of the walletID in a simple case or in other examples unlocking a pre-made signature that for example returns value to the party that supplied it.

Turning now to FIG. 16, an exemplary verifiable recovery cryptographic protocol is shown in combination flowchart and protocol schematic, in accordance with aspects of the teachings of the invention. In the example the keys for unlocking value are divided among a set of entities so that in case the counterparty fails to complete the swap, a party whose value is locked can unlock it with cooperation of a subset of the entities; however, in the present example a so-called “verifiable” secret sharing is used so that the shares are in effect checkable without being “opened” and this simplifies and increase the performance of the protocol.

As an example of a verifiable secret sharing, while many are known, a particularly important protocol was disclosed by P. Feldman in “A practical scheme for non-interactive verifiable secret sharing,” at the 28th Annual Symposium on Foundations of Computer Science, IEEE, 1987. This article too is incorporated as if copied in its entirety in the present application.

Referring to block 1610, it may here be said that “in a system where each of a set of entities has a respective public key and each entity is to under a condition make decryptions related to the public key available to allow at least one party to recover a secret under the condition” to mean any setting or the like where there are entities, of whatever type, that are believed likely to at least approximately make available to a party a secret under a condition. For instance, as already mentioned with reference to FIG. 15, a condition could be that a party to a swap has value that is locked up or otherwise inaccessible in the swap protocol because of failure to participate by the counterparty.

Referring to block 1620, it can here be said that “a first party verifiably dividing a secret into shares according to a threshold and encrypting each share with a respective one of the public keys of the set,” to mean any type of verifiable or publicly verifiable secret sharing system, as are known or may become known, used to for shares that can be verified at least by the counterparty as at least likely to mainly allow that the transaction to complete should enough of them be opened. In some examples, for instance, the checking is that the exponent is revealed that allows the signature with the walletID to move the value back to the walletID that the party supplied it from and/or to another walletID controlled by the party being blocked.

Referring to block 1630, it can here be said that “the second party verifies that the decryptions were properly formed,” to mean any cryptographic protocol steps and/or process that gives adequate probability and/or security against anticipate threats levels to ensure adequate that at least enough of the shares were at least mostly correctly formed so that they can be used if needed.

Referring to block 1640, it can here be said that “provisions in case the condition applies, at least a quorum of the entities of the set of entities decrypting the encryptions and making the decryptions available to at least the second party,” to mean any way whatsoever to allow adequate values to be obtained by the second party to unlock the blocked value. For instance, a quorum of entities can be according to any monotonic rule or even dynamic or adaptive condition, and such a quorum can, as will be understood, release enough information at least to the second party or other parties cooperating with that party to allow the second party or other cooperating parties to at least with some reasonable probability unlock or other free up the blocked value.

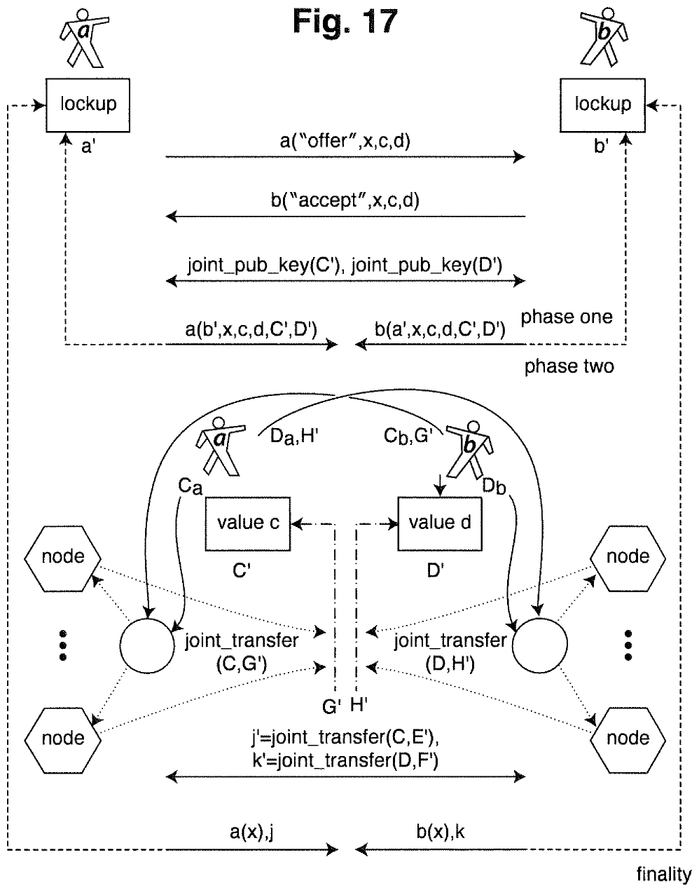

Turning now to FIG. 17, an exemplary digital outcry cryptographic protocol with refund is shown in combination cryptographic schematic and block diagram, in accordance with aspects of the teachings of the invention. The two example parties use infrastructure for locking up value and protocols for fallback and swapping.

Referring to the diagram, the two example parties to the eventual swap are shown as Alex and Bobbi, themselves labeled with the letters “a” and “b” respectively. The parties each lockup some value, what may be considered a security deposit or the like, shown associated with public keys a′ and b′, respectively. The corresponding private keys are shown without the apostrophe, a and b, respectively. The parties are shown for clarity both in phase one and in phase two, as will be appreciated.

Once at least the lockup of Alex is completed, Alex can then send the first protocol message shown in the now conventional notation as a closed form on an arrow. The message is shown signed by a, in a basic notation as will be understood. This message is anticipated that is some examples the message is in effect broadcast; the public keys associated with the message in the example are shown associated with the lockup. Four example elements are shown included in the content of the message signed: The message type indicator, shown as the literal string example “offer”; a transaction identifier x, which may be superfluous in some examples, as for instance various already-present quantities could serve this function; the definition of the value that Alex wants to swap, c, and the definition of the value, d, that Alex hopes to receive in return during the swap, where the value can for instance be defined as a specific quantity of a specific asset.

The offer is associated with a public key a′, because of the signature. This key allows the signature to be verified; it is also shown associated with a corresponding lockup, something that can checked, for instance by parties considering accepting the offer. It will be appreciated that different levels or types of lockups may be believed appropriate for different swap values.

After the offer, one or more “accept” messages may be received by Alex. At some point in the example, Alex receives an accept from Bobbi, shown as the second cryptographic protocol message step. This is left-point, from Bobbi to Alex, and essentially provides at least implicitly the public key of Bobbi, b′. This key allows the signature to be verified; it is also shown associated with a corresponding lockup, something that Alex can check in accepting the offer.

When Alex and Bobbi have in this way agreed at least in principle to do the swap, they are shown by the next message to cooperate in creating two public keys that will serve as account identifiers that they will have so-called “multi-sig” access to, requiring in some examples keys from both to transfer value from the account, as already explained with reference for instance to FIGS. 11, 12, 14 and 15. Two account identifier public keys, such as are well known in blockchain technology, are shown in the example, one for each of the values defined in the example of the original offer. One is shown as having public key C′ for the value defined as c; the other is shown as having public key D′ for the value defined as d. As will be understood from earlier described protocols, the parties can transfer value to these wallet ID's but to transfer it out, the two parties in the example would have to cooperate with their respective keys. These keys are shown later in the figure as for example denoted Cₐ and C_{b}, for the secrets that Alex and Bobbi have, respectively, for the store of value with public key C′.

The final message of what is called “phase one” is shown as two arrows meeting each other. This can for example be a gradual reveal of secrets, as already described with reference to Brickel et al and for instance to FIGS. 11, 12, 14 and 15. Each of the two parties, Alex and Bobbi, reveal to their respective counterparty, a signature confirming consummation of phase one. This signature, for clarity is shown including a number of elements that are believed to define phase one: the public key of the counterparty, the transaction identifier (if needed) x, the definitions of the things to be swapped, c and d, as well as the public keys, C′ and D′, under which the values will be held until released at finality, as will be explained.

The lockups are shown receiving notice of the transition to phase two, such as supplied them by the respective parties. (It is believed that the parties are incentivized to show these signatures, otherwise they may not be able to unlock the locked-up value; if the signature is shown too late, the lockup can be forfeited, as will be described. A timestamp may be included in the signatures, with one example use being allowing the timely reporting to be checked by the lockups.) The lockups can test the signature made by their respective “owner” and know that they should enter phase two; however, they also learn the public key of the respective counterparty, whose signature will allow phase two to be ended with finality, as will be described. Conflicting signatures by the owner of a lockup can cause it to, for example, not complete phase two in time and, as will be described, for instance, return value to the infrastructure provider or other parties.

When Alex and Bobbi enter phase two, having revealed the signatures to each other, they can start by setting up various fallbacks, such as in the present example, refund capabilities. These are believed to server as protection against a variety of undesirable scenarios or attacks, that may include abandonment of the transaction and/or extortion related to value held inaccessibly in it. In one example, a refund capability can refund the value contributed as c by Alex to Alex and/or the value contributed as d by Bobbi back to Bobbi. For clarity, this example will be described but without limitation.

An encrypted signature that allows the value to be returned from C′ to Alex at G′, where in the example Bobbi transferred it into C′ in the first place is used. Other examples are anticipated, such as to a separate location controlled by Alex and/or various other parties in various combinations and for various portions, as may be desired. Instead of the underlying signature being released, in this example it is secret shared, such as in so-called “verifiable secret sharing,” in a way that parties to the protocol can verify properties. In the example shown, what is shared is the signature that would transfer the value that is in C′ to G′. The parties that would get the shares are shown as “nodes.” In some examples, it is believed preferable to prepare what the nodes would receive, and allow Alex in the case of a refund to Alex, to verify that that the parties would receive enough to reconstruct the signature sufficient to refund Alex, and to provide those messages to Alex. Since the messages would be encrypted for the specific node public keys, in some examples, Alex would not be able to access the signature directly; however, if Bobbi were to default and not help finalize the overall transaction, then Alex would be able to send evidence of this to the nodes and if enough of them found it compelling, they could allow the refund. The choice of nodes can be a sample of all nodes; however, it is believed advantageous if the sample is made in a way that neither Alex nor Bobbi can manipulate; such mutual random protocols being know, such as those disclosed by the present applicant, in US 2003/0104859, “Random number generator security systems,” which is incorporated here by reference as if copied in its entirety.

The situation is believed the same, symmetrically, for Bobbi. Accordingly, Bobbi shares the D to H transfer encryption with nodes, potentially other randomly-chosen nodes. This provides the same sort of protection to Bobbi.

Once it is known that the refund capability for Alex is in place, Alex can transfer the value from, in the example for simplicity and clarity, G′ to C′. Similarly, once the refund capability for Bobbi is in place, Bobbi can transfer the value from, in the example for simplicity and clarity, H′ to D′. The dot-dash lines are intended to indicate the recommended temporal ordering of the transfer and the respective refund capabilities.

At this point the Alex and Bobbi can conduct protocols, already described here with reference to Figure for instance to FIGS. 11, 12, 14 and 15, to produce the transfer signatures for the values c and d: the separate secrets behind formation of C′ are used to make, for instance, the transfer signature from C′ to E′; similarly, the separate secrets behind formation of C′ are used to make, for instance, the transfer signature from C′ to E′. These two values that result are encryptions of the signatures, in some examples already described, and are shown as j′ and k′.

Marking the end of the second phase, a pair of values is shown being released by Alex to Bobbi and a related pair from Bobbi to Alex. Alex reveals both: a signature on x that indicates finalization for the lockup; and what is shown as j, that is the signature authorizing the transfer from c to E′. Similarly, Bobbi reveals both: again a signature on x to indicate finalization for the lockup; and what is shown as k, that is the signature authorizing the transfer from d to F′.

The signatures with a and b can be shown to the lockup infrastructure to establish that the transaction was finalized and the lockup can be released (though a portion may be held back for instance as fees), as indicated by the dashed lines. The release can also check, if desired in some cases, other aspects of the finalization, such as that the value and accounts defined at the end of phase one were actually used in achieving finality.

If a timeout on the finalization of phase two were to occur, only an exceptional case, and not shown for clarity, then various things can be allowed to happen. One might, for example, be that the lockup value is all or part reverted to the system or some other entities. Another example is that the nodes can refund one or both of the values they hold the signatures for.

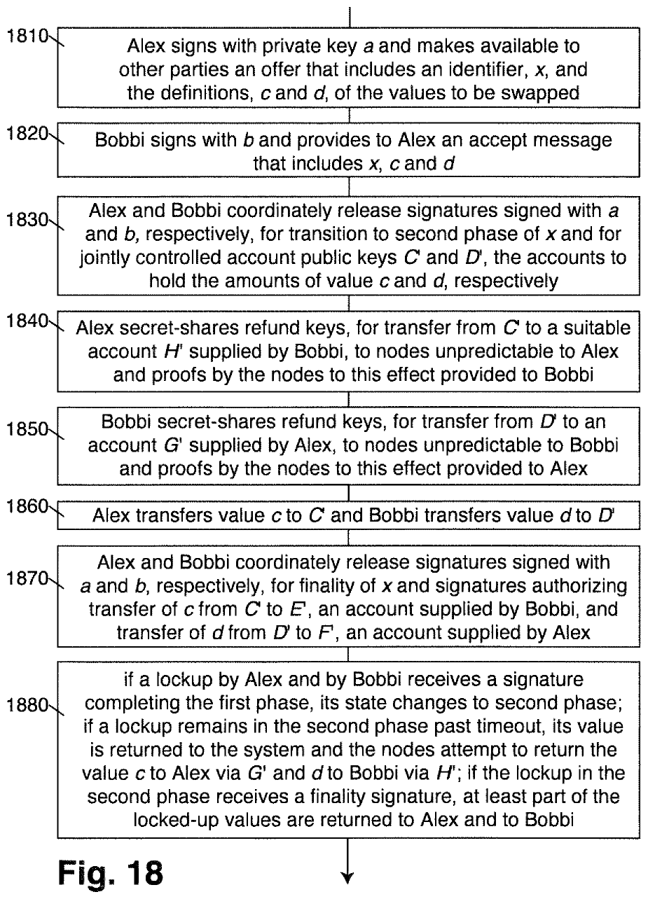

Turning now to FIG. 18, an exemplary digital outcry cryptographic protocol is shown in combination flowchart and protocol schematic, in accordance with aspects of the teachings of the invention.

Referring to box 1810, it may here be said that “Alex signs with private key a and makes available to other parties an offer that includes an identifier, x, and the definitions, c and d, of the values to be swapped” to mean any kind of digital authentication that Alex issues for the desired swap, such as including definitions of the items to be swapped and/or an identifier of the swap.

Referring to box 1820, it may here be said that “Bobbi signs with b and provides to Alex an accept message that includes x, c and d” to mean any sort of digital authentication that substantiates the intention of Bobbi to cooperate with Alex in the requested transaction.

Referring to box 1830, it may here be said that “Alex and Bobbi coordinately release signatures signed with a and b, respectively, for transition to second phase of x and for jointly controlled account public keys C′ and D′, the accounts to hold the amounts of value c and d, respectively” to mean any type of joint release of secrets or otherwise coordinated authentication that indicates that both Alex and Bobbi are agreeing at least provisionally to transfer value to or otherwise lock up value in a way that some sort of mutual cooperation and/or third party actions would be required to unlock and/or refund it.

Referring to box 1840, it may here be said that “Alex secret-shares refund keys, for transfer from C′ to a suitable account H′ supplied by Bobbi, to nodes unpredictable to Alex and proofs by the nodes to this effect provided to Bobbi” to mean any way to accomplish the division of secret values between a number of nodes such that at least Bobbi can have some confidence that those secrets will allow those nodes to refund Bobbi.

Referring to box 1850, it may here be said that “Bobbi secret-shares refund keys, for transfer from D′ to an account G′ supplied by Alex, to nodes unpredictable to Bobbi and proofs by the nodes to this effect provided to Alex” to mean any way to accomplish the division of secret values between a number of nodes such that at least Alex can have some confidence that those secrets will allow those nodes to refund Alex.

Referring to box 1860, it may here be said that “Alex transfers value c to C′ and Bobbi transfers value d to D′” to mean any suitable way for the values to be swapped are locked up in respective digital locations by the respective counterparties.

Referring to box 1870, it may here be said that “Alex and Bobbi coordinately release signatures signed with a and b, respectively, for finality of x and signatures authorizing transfer of c from C′ to E′, an account supplied by Bobbi, and transfer of d from D′ to F′, an account supplied by Alex” to mean that the parties release to each other, in a manner that neither should be able to unilaterally interrupt, authenticated orders to move the respective values to the agreed locations so that they are swapped.

Referring to box 1880, it may here be said that “if a lockup by Alex and by Bobbi receives a signature completing the first phase, its state changes to second phase” to mean any authentication from one party can cause the respective lockup to change state and to associated additional information such as counterparty authentication and/or transaction details.

It may here also be said that “if a lockup remains in the second phase past timeout, its value is returned to the system and the nodes attempt to return the value c to Alex via G′ and d to Bobbi via H′” can mean that nodes that have locked up value contingent on a timeout for its release can do so.

It may here also be said that “if the lockup in the second phase receives a finality signature, at least part of the locked-up values are returned to Alex and to Bobbi” to mean that the lockups can be released, all or part, responsive to authentication of the finalization of the swap.

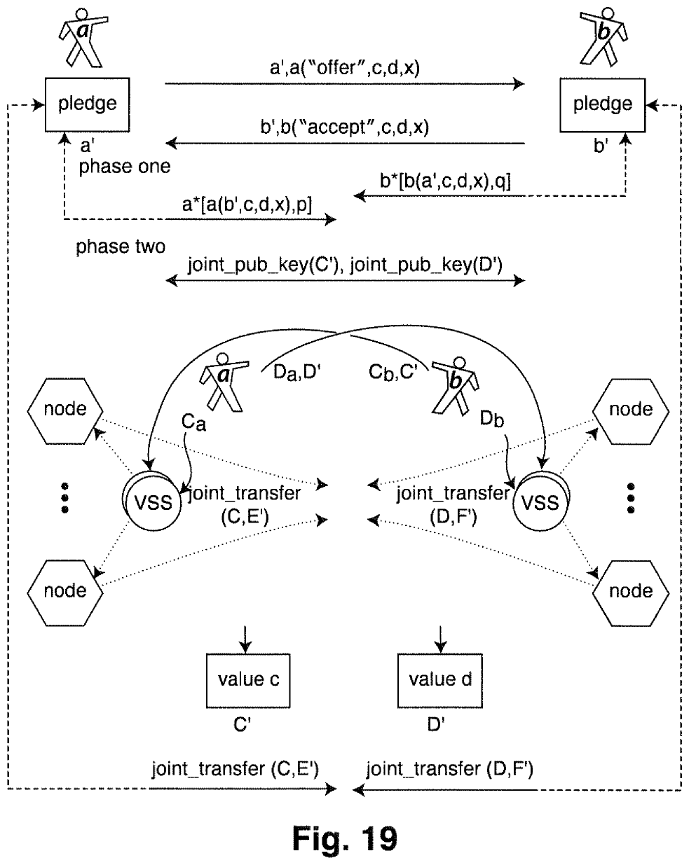

Turning now to FIG. 19, an exemplary digital outcry cryptographic protocol is shown in combination cryptographic schematic and block diagram, in accordance with aspects of the teachings of the invention. The two example parties use infrastructure for pledging value and then locking up value for swap and protocols for fallback and swap.

Referring to the illustration, the two example parties to the eventual swap are shown as Alex and Bobbi, themselves labeled with the letters “a” and “b” respectively. The parties each pledge some value, what may be considered a security deposit or the like, shown associated with public keys a′ and b′, respectively. The corresponding private keys are shown without the apostrophe, a and b, respectively. The parties are shown for clarity both in phase one and in phase two, as will be appreciated. The eventual value c and d is that to be swapped by being transferred from C′ and D′, respectively, to E′ and F′, respectively. As also in FIG. 17, the parties issue and offer and acceptance.

Here, the parties optionally, as illustrated and indicated by the star superscript on the private key used to make the signatures, use so-called “offline-cash” type signatures, as disclosed by the present applicant, in U.S. Pat. No. 4,987,593, titled “One-show blind signature systems” included here by reference as if copied herein its entirety.

In such signatures, often, certain parameters are filled by what is referred to as a “challenge,” such as a random number provided by the party being paid. Here these values can be determined at least in part by the parameters of the offer and acceptance, such as c, d, x, the time, and so forth. In some examples a so-called “hash function” or the like could be applied to all or some of the parameters before including them in the signature. The desired effect, as will be appreciated, is that if the same party makes more than one offer with the same pledge and/or makes more than one acceptance with the same pledge, such as within a certain time period when the signature is value, then this fact would be revealed irrefutably once the signatures are combined, as usual, but with these special type of signature additional information, such as the identity of the party obtaining the signatures and/or access to a penalty value and/or for instance revealing other information that the signing party might wish to keep confidential. These signatures and this use are believed to offer advantages, including that the spamming or otherwise making false offers or acceptances is discouraged and/or traceable to larger things, such as the set of pledges and/or the identity of the party behind the process.

When such confirming signatures are provided, the pledges can be interpreted in some examples as transitioning from phase one to phase two. They might not return to phase one without penalty, in some examples, unless the transaction identified as parameters to the signature is finalized.

At this point the principal lockup public keys, C′ and D′, are computed, such as has already been described with reference to FIG. 17, for instance using the functions shown as “joint_pub_key.”

Now the secret sharing is shown. It can for example be using a public secret sharing system, such as that disclosed by Schoenmakers, in “A simple publicly verifiable secret sharing scheme and its application to electronic voting,” that appeared in Advances in Cryptology—CRYPTO '99, Lecture Notes in Computer Science, Springer-Verlag, 1999, pp. 148-164. In such systems, the parties who receive the shares, here called nodes, need not be involved in the distribution of the secret shares; all the nodes have to do is provided public keys. The counterparty can verify that the secret share is well formed without contacting the parties, as will be understood. This is believed to offer the advantage of efficiency and the nodes need not be contacted unless they are actually being asked to reconstruct the secret.

In the scheme referenced, the secret is unpredictable to the party issuing the shares, the dealer, Alex or Bobbi in the present case. In one example, to make the shares yield an actual jointly created transfer signature, as suggested by Schoenmakers, the secret can be used in effect as a key the decrypts the transfer signature. To allow this to be verified, one example solution, as will readily be appreciated, is for the parties to simply create a number of instances of the value public keys and transfer signatures and then each party be allowed to request all but one such instance to be opened; the unopened one is that used. The opened instances can each be verified to ensure that the secret shared is a valid transfer, thereby giving confidence that the unopened instance is also valid. In other examples, as will be understood the shares could be from the underlying joint transfer protocol and/or they could with a suitable encryption algorithm be proved in zero knowledge and/or minimum disclosure to correspond.

At this point, the parties can transfer the principal value to be swapped to the respective stores of value, shown with public keys C′ and D′. In this example the values can be considered, it is believed, essentially “locked up” until released either by enough nodes or by the respective counterparty. In some examples, since on time-out the release may already be made by the nodes, as mentioned elsewhere here, Alex and Bobbi may simply release the data in a somewhat uncoordinated manner, such as one first or both at about the same time; however, in other examples, the mutual release of secrets, as mentioned elsewhere here, such as with reference to FIG. 17, can it is believed still advantageously be used so as to protect either party from being disadvantaged by the counterparty forcing them to work with the nodes to finalize the aspect of the transaction in their favor.

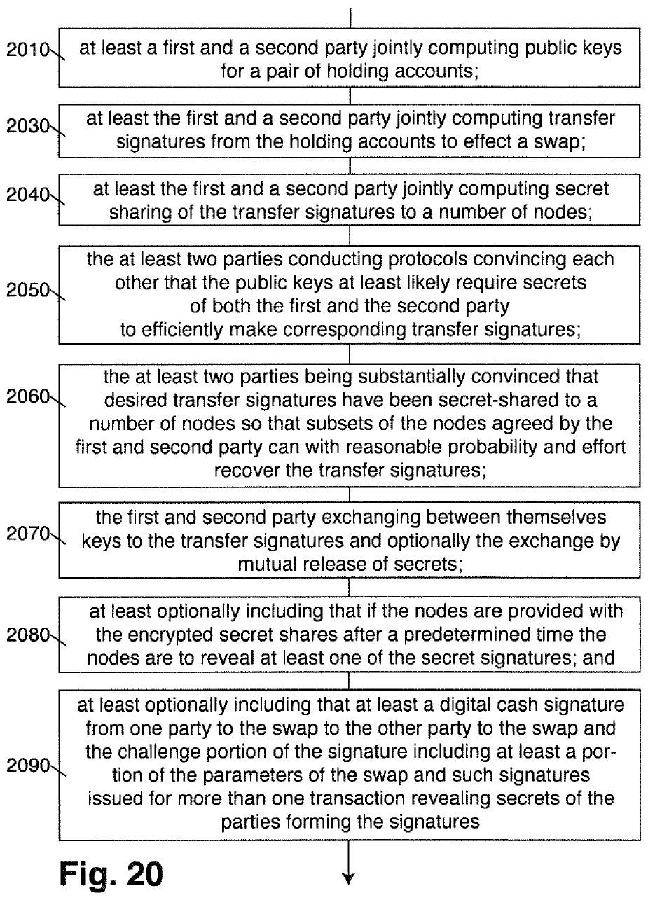

Turning now to FIG. 20, an exemplary digital outcry cryptographic protocol is shown in combination flowchart and protocol schematic, in accordance with aspects of the teachings of the invention.

Referring to box 2010, it may here be said that “at least a first and a second party jointly computing public keys for a pair of holding accounts” to mean any kind of cryptographic protocol by two or more parties that arrives at so-called “wallet ID” or other types of public keys or the like that identify and/or serve to secure digital assets or the like.

Referring to box 2030, it may here be said that “at least the first and a second party jointly computing transfer signatures from the holding accounts to effect a swap;” to mean any kind of cryptographic computation and/or protocol that is aimed at arriving at authenticators such as digital signatures that can serve to transfer value held in digital form.

Referring to box 2040, it may here be said that “at least the first and a second party jointly computing secret sharing of the transfer signatures to a number of nodes” to mean any kind of cryptographic computation and/or protocol that is aimed at arriving at digital information related to value transfer signatures to be potentially reconstructed by the nodes.

Referring to box 2050, it may here be said that “the at least two parties conducting protocols convincing each other that the public keys at least likely require secrets of both the first and the second party to efficiently make corresponding transfer signatures” to mean any kind of so-called minimum disclosure, zero-knowledge, and/or other proof technique that gives confidence, based on whatever assumptions, about the need for both parties, and/or the nodes as described later, to access make the signatures or other authorizations to move value from the custody of the keys.

Referring to box 2060, it may here be said that “the at least two parties being substantially convinced that desired transfer signatures have been secret-shared to a number of nodes so that subsets of the nodes agreed by the first and second party can with reasonable probability and effort recover the transfer signatures” to mean any kind of so-called secret sharing or other cryptographic scheme that is “verifiable” or otherwise imparts confidence that under certain assumptions and/or with certain probabilities that the various subsets, such as so-called monotonic subsets, of the nodes can recover the authentication to move the value.

Referring to box 2070, it may here be said that “the first and second party exchanging between themselves keys to the transfer signatures and optionally the exchange by mutual release of secrets” to mean any kind of process or system whereby the parties cause information to be obtained by the parties that can be used to transfer digitally represented value, whether that information is provided first in one direction and then in the other direction, interspersed in some manner, and/or by a mutual release of secrets protocol.

Referring to box 2080, it may here be said that “at least optionally including that if the nodes are provided with the encrypted secret shares after a predetermined time the nodes are to reveal at least one of the secret signatures” to mean any kind of incentive and/or authorization and/or programming that makes it at least likely that nodes will reveal the secrets that were shared to them, and/or use those secrets in a computation, for the purpose of allowing the transfers to be conducted, provided that sufficient time has passed and/or an event has occurred and/or it is determined in some other way that the moment is appropriate.

Referring to box 2090, it may here be said that “at least optionally including that at least a digital cash signature from one party to the swap to the other party to the swap and the challenge portion of the signature including at least a portion of the parameters of the swap and such signatures issued for more than one transaction revealing secrets of the parties forming the signatures” to mean any kind of one-show or off-line signature that changes what is revealed when it is shown with more than one set of parameters and the first and/or the second party at least making at least one such signature with parameters that relate to the offer and/or acceptance of those parties related to the swap.

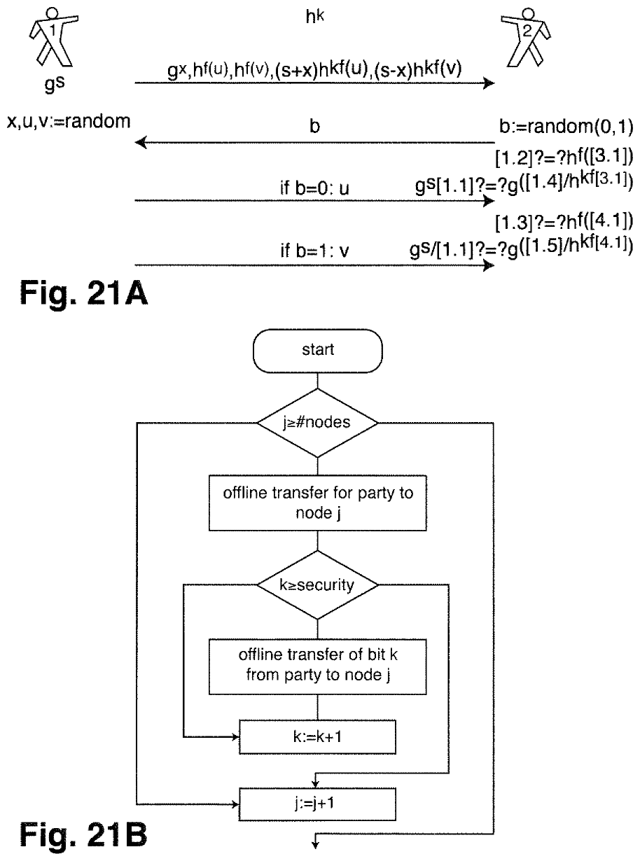

Turning now to FIG. 21AB, a detailed exemplary embodiment of a what may here be called a “verifiable offline key transfer” and a related distribution is shown in combination cryptographic schematic and block diagram, as well as flowchart, in accordance with aspects of the teaching of the invention. The notation of FIG. 21A is known in the art and introduced more specifically in various other patents of the present applicant and will be readily understood. All the elements are residue classes either in the group, such as a so-called Diffie-Hellman group, or in the group of the exponent, as will also readily be appreciated; the notation of FIG. 21B, which shows the distribution, is typical of flowcharts.

Referring now more specifically to FIG. 21A, initially, a single node is considered for clarity and concreteness and it has a single public key, denoted as h^{k}, which may be said to be the modular reduction of the generator h when k is applied in the exponent, as will be understood. Both parties know the public keys of the nodes (or pseudonymous public keys). The first party is shown having a sort of public key, g^{s}. (These can be in various protocols, such as those described elsewhere here, a value known to have an exponent, which is secret to some parties, but that is the value needed to for instance participate in computing a signature, such as in an elliptic curve system, to move value that is controlled by knowledge of typically a set of such secret exponents; an example is believed the s(i) of Gennaro et al included here with reference to FIG. 14.)

In a first message in the example, shown being sent by the first party to the second party, has five exemplary elements in the group shown: the first is the generator g to the first random power x; the second is a generator h to the power that is the image of the second random number u under a one-way function ƒ (for convenience and completeness the pre-images can be taken as group elements and images as elements in the exponent group); the third element is similarly the second generator to the power that is the image of the third random number v under the one-way function; the fourth can be considered an encryption of the sum of the secret values s and x, known in the example to the first party, where encryption is by multiplication in the group by a generator raised to a what may be considered, as will be appreciated, as like a Diffie-Hellman key distribution power, the product to the node private key k and the image of the second random element; similarly, and finally, the fifth can be considered an encryption of the difference of the secret values, s and x, as again known in the example to the first party, where encryption is again by multiplication in the group by a generator, shown as h as an example raised to a power, the product to the node private key k and the image of the third random element.

Next the second party provides a so-called “challenge” bit b that is until this point ideally unpredictable to the first party.

In the case the challenge bit is 0, the first party sends the first pre-image, u, that for the second element sent in the first message. The second party checks that the second element sent was formed properly from the generator h and the one-way function ƒ of u. The second party also checks that the product of g^{s}, which is known to the parties as mentioned, and the value that should be the g^{x}, sent as the first element of the first message, does in fact form the correct power of g. This power should be the payload that was encrypted in the fourth element sent in the first message. The decryption of this payload is accomplished by the second party dividing out the generator h to a power. This power is computed as the public key raised to the image power.

In the case the challenge bit is 1, the first party sends the second pre-image, v, that for the third element sent in the first message. The second party checks that this third element sent was formed as the image properly from the generator and the one-way function ƒ of v. The second party also checks that the quotient of g^{s} and the value that should be the g^{x} does in fact form the correct power of g. This power should be the payload that was encrypted in the fifth element sent in the first message. The decryption of this payload is accomplished by the second party dividing out the generator h to a power. This power is computed as the public key raised to the image power.

The recovery of s by the owner of public key h^{k}, who knows the private key k, is not shown for clarity but will readily be understood as the decryption, using this private key, of both s+x and s−x, thereby yielding s as the sum of the two decryptions in the group of the exponents.

Referring now specifically to FIG. 21B, a flowchart showing the application of the verifiable offline key transfer protocol, just described with reference to FIG. 21A, for providing the second party by the first party with significant confidence that a set of nodes can recover the transfer signature via s—in preparation for a possible case that the second party contacts the nodes and supplies them the data. It is believed, as will be appreciated, that not involving the nodes in the setup for this contingency is advantageous; however, the second party it is believed would advantageously have high confidence that things won't be locked up indefinitely, or only the first party can unlock them, even if the first party does not provide more information after this setup. In some examples with the secrets potentially distributable to the nodes here, if the nodes are supplied them, they can release the value back to the parties as refunds and/or to allow the nodes to finalize the transaction by moving the value to the appropriate locations when the parties do not do so for instance at least not in a timely manner.

The flowchart for simplicity and clarity shows how the protocol of FIG. 21A can be repeated a security parameter number of times for each of the #nodes instances of the outer loop. After starting, the conditional flowchart diamond tests whether j is great or equal #nodes and if so completes; otherwise the protocol of FIG. 21A is performed with reference to node j. For each node that it is performed for there are a number of iterations in an inner loop, depending on the so-called parameter “security.” When this number of iterations is, for instance about fifty to two hundred fifty, as will be understood in the art, the chance that there is not at least one properly formed value received by a node (assuming the second party performs properly), allowing the node access to the particular s in the protocol, is believed over the range of parameters varying roughly from potentially acceptably small, very small, to perhaps negligible.

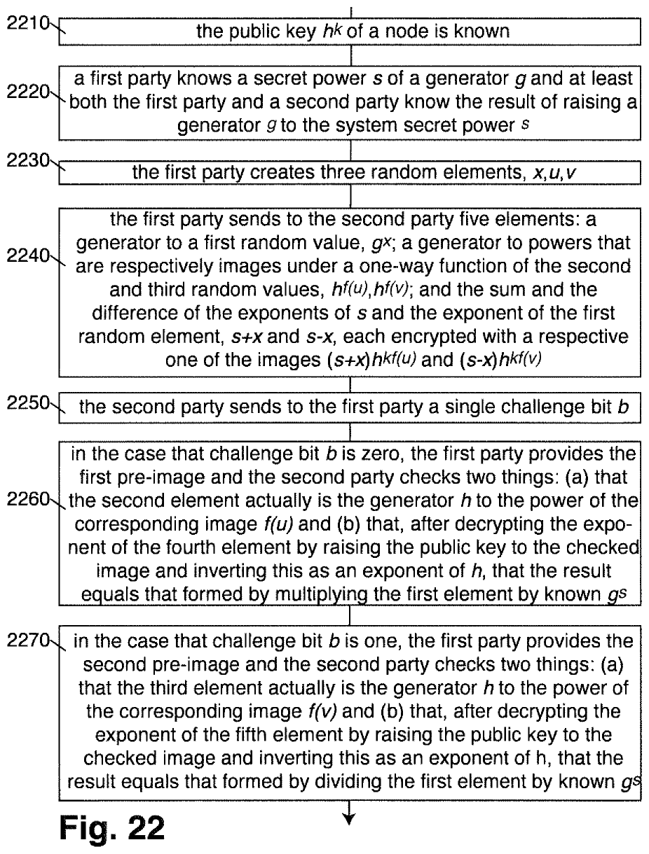

Turning now to FIG. 22, a detailed exemplary embodiment of a verifiable offline key transfer and distribution protocol is shown in combination flowchart and protocol schematic, in accordance with aspects of the teachings of the invention.

Referring to box 2210, it may here be said that “the public key h^{k} of a node is known” to mean the usual public key setup, though it is anticipated that these keys can be digital pseudonyms and that the parties owning them are not readily learned without at least contacting them via the pseudonyms.

Referring next to box 2220, it may here be said that “a first party knows a secret power s of a generator g and at least both the first party and a second party know the result of raising the generator g to the system secret power s” to mean any kind of protocol that has revealed and optionally proved properties of this residue class; for example, the protocol of Gennaro et al has powers of a generator believed known to and with certain properties proved to the parties but where the power exponents themselves are in fact the secrets that allow a particular signature to be computed.

Referring to box 2230, it may here be said that “the first party creates three random elements, x, u, v” to mean any kind of way to construct such elements that is at least believed difficult for the counterparty to predict, guess, and/or manipulate.

Referring to box 2240, it may here be said that “the first party sends to the second party five elements: a generator to a first random value, g^{x}; a generator to powers that are respectively images under a one-way function of the second and third random values, h^{f(u)},h^{f(v)}; and the sum and the difference of the exponents of s and the exponent of the first random element, s+x and s−x, each encrypted with a respective one of the images (s+x)h^{kf(u)} and (s−x)h^{kf(v)}” to mean any kind of

Referring to box 2250, it may here be said that “the second party sends to the first party a single challenge bit b” to mean any kind of challenge that comes from the second party and/or other parties or mechanisms at least believed by the second party as roughly or mainly or largely unpredictable and/or unimplementable by the first party.

Referring to box 2260, it may here be said that “in the case that challenge bit b is zero, the first party provides the first pre-image and the second party checks two things: (a) that the second element actually is the generator h to the power of the corresponding image ƒ(u) and (b) that, after decrypting the exponent of the fourth element by raising the public key to the checked image and inverting this as an exponent of h, that the result equals that formed by multiplying the first element by known g^{s}” to mean any kind of way for the parties to perform these operations, as also detailed with reference to FIG. 21.

Referring finally to box 2270, it may here be said that “in the case that challenge bit b is one, the first party provides the second pre-image and the second party checks two things: (a) that the third element actually is the generator h to the power of the corresponding image ƒ(v) and (b) that, after decrypting the exponent of the fifth element by raising the public key to the checked image and inverting this as an exponent of h, that the result equals that formed by dividing the first element by known g^{s}” to mean any kind of computational or protocol step or method or apparatus that can check these things that is trusted at least to some extent by the second party to report properly.

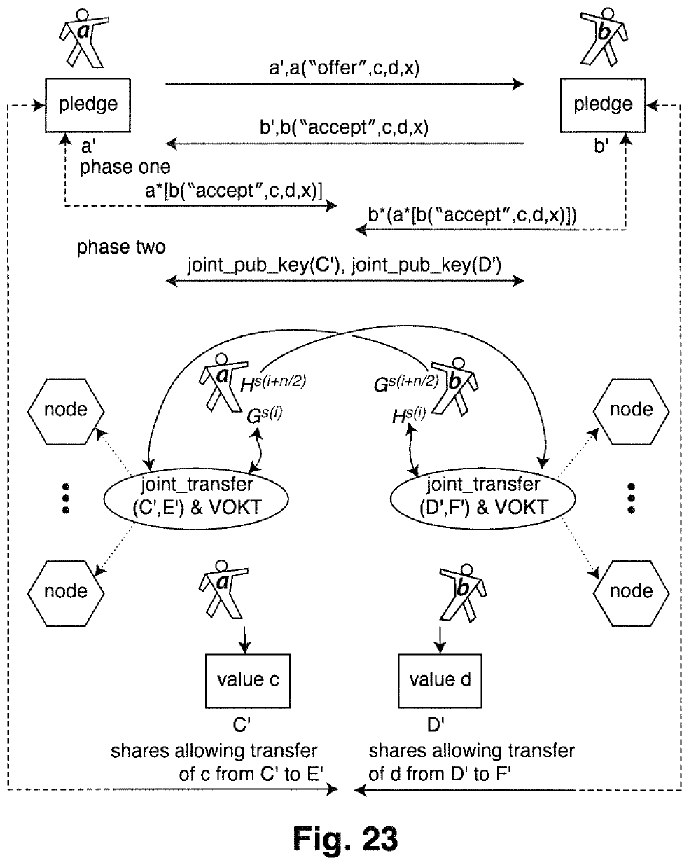

Turning now to FIG. 23, a detailed exemplary embodiment of a cryptographic protocol for value swap with verifiable offline key transfer is shown in combination cryptographic schematic and block diagram in accordance with aspects of the present invention.

Alex is shown in a protocol with Bobbi, as labeled across the top and again in the middle of the figure, similarly to earlier figures, as will be understood. Also similar is the initial offer and acceptance, each by an authenticated message sent by the respective parties. Also similar is that a value, but in this case called out as a “pledge,” is potentially held back until ideally the transaction contemplated is either cancelled or final.

The next two arrows from the parties are what can here be called “confirmations,” from the first and second party, respectively. It is believed that in at least some settings such confirmations responsive to at least some of the transaction particulars are advantageous, as for instance there may be more than two parties making offers and/or acceptances and each party may make more than one offer and/or acceptance and some messages may be delayed, corrupted, and/or received in whatever order and/or claimed to have been and/or screened and/or prioritized and/or rejected by the parties. The examples shown are intended to suggest that the payloads and/or other information authenticated in earlier messages and/or rounds is somehow related to that in these rounds, as indicated by the non-limiting example of composition of messages, as will be understood.

Once the confirmations are in place the “first phase” of the transaction, where the parties may not be held accountable to going forward is left and the pledges may be tied to consummation of the transaction, as indicated by the dashed lines. In some examples, for instance: the pledge by Alex can be considered forfeited once a signature by Alex on the third message is known; similarly, the pledge by Bobbi can be considered forfeited once a signature by Bobbi on the fourth message is known.

Next is shown the creation of two holding accounts, C′ and D′, to be transferred into by Alex and Bobbi, respectively; these are shown being transferred into near the bottom of the figure, once what can here be called “surety” described below is in place. Two instances of the Gennaro et al are an example way to accomplish this, where the signature generated is from C′ to E′ and from D′ to F′, respectively. This is believed able to allow the nodes to consummate the transaction in case one or both parties do not do so, at least in a timely manner. It will be appreciated, however, that were the signature generated is from C′ to G′ and from D′ to H′, as earlier described, the result would be a refund to the parties.

Once the holding accounts are known and jointly controlled, the joint transfer can be put into surety. This is shown as accomplished by joint computation of the transfer signatures for consummation but then some of these signatures can in some examples be what may be called here “verifiable offline key transferred” to the nodes.

The nodes should be given enough shares by Alex so that even a majority of them can cause the transaction to go through that Alex should send through according to the offer and acceptance once Bobbi has filled the holding account (but Bobbi will want to make sure not only that the nodes are so empowered but that the transaction only has Bobbi's account E′ as the beneficiary and no other signatures are issued for that holding account). For example, but without limitation, consider for clarity and concreteness an instance of a protocol like that of Gennaro et al where there are 2n shares, with a threshold set for instance at ¾ of the shares; only Alex and Bobbi conduct the protocols and Alex has n shares and Bobbi has n shares. Alex sends all n of Alex's shares by “verifiable offline key transferred” to the nodes (in other words proves to Alex what Alex could send to the nodes is correctly formed from Alex; Bobbi can do the same, or optionally can use a simpler transfer to the node public keys that is not verifiable by Alex. (For clarity, the shares from Bobbi are shown input to the VOKT along with those of Alex.)

If ¾ of the nodes are contacted by Bobbi or more generally by someone else at some point when Alex has not completed the protocol, for instance by the deadline date in the original signatures but not shown for clarity, the nodes should be able to compute the signature that moves the funds from the holding C′ to the place Bobbi wants them E′. Bobbi is pretty sure to certain because of the VOKT that Alex gave the nodes the shares Alex had to the nodes. If Bobbi also gives al the shares Bobbi has to the nodes, without Alex being able to learn them, such as by encrypting them using the nodes public keys, then each node has two shares. Then ¾ of the nodes can go ahead and compute the transfer signature if they all agree to do so. But if Bobbi were to give all Bobbi's shares to every node, then only half the nodes would be enough, which may be an acceptable approach for many applications.

Another approach, using a slight modification of Gnnaro, does not actually issue the shares to Bobbi that Bobbi is entitled to; Alex simply does not complete the final steps to allow Bobbi to get these shares. Then it is believed that the proportion of the whole number of shares (potentially issues) is also the proportion of the nodes that would be sufficient to allow the holding account to be transferred using the signature approved by Bobbi.

Similarly, the nodes should be given enough shares by Bobbi so that even a majority of them can cause the transaction to go through that Bobbi should send through according to the offer and acceptance once Alex has filled the holding account (but Alex will want to make sure that the transaction only has Alex's account F′ as the beneficiary). The situation of clearly symmetric and the same method and means and considerations apply.

At this point, what can here be called the “fallback provisions” having been put in place, with the nodes, Alex and Bobbi can move the value to the accounts C′ and D′ as they should, ideally in a timely manner.

Finally, Alex and Bobbi are able to consummate the swap and make it final by providing each other with the signatures. Alex provides Bobbi the shares, described already above that were sent verifiably offline to the nodes, that Alex has retained for this purpose that allow the construction of the signature that transfers the value in C′ to the place Bobbi wanted it sent, E′. Similarly, Bobbi provides Alex with the shares that allow Bobbi to transfer the value D′ to the place Alex wanted it sent, F′. It is believed that if a first party provides the shares but the second party does not, then the second party is disadvantaged because the nodes should be contacted in order to obtain the shares and transfer the value to the second party. Ideally, it is believed that such transfer of shares is most desirably done by mutual release of secrets, as described elsewhere here for such values as the shares having in effect public keys with the share itself as the secret power of the generator.

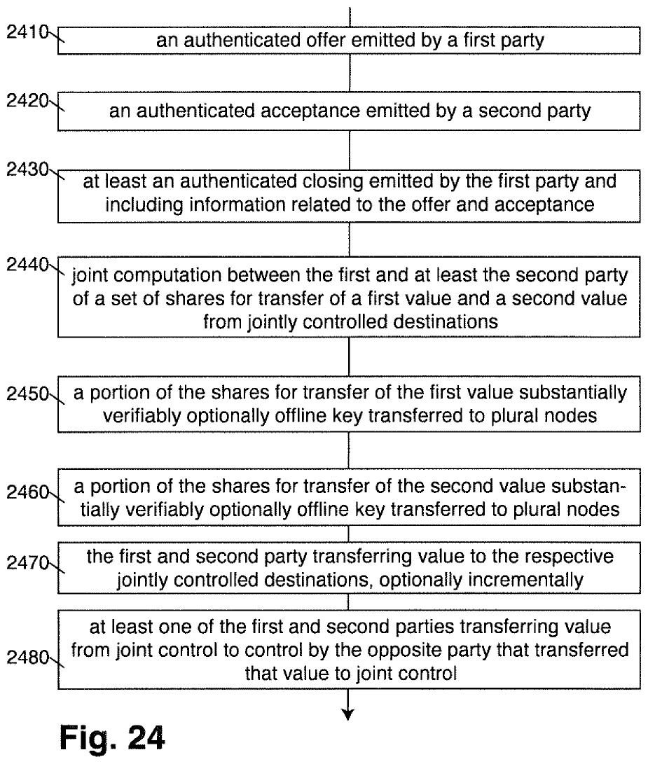

Turning now to FIG. 24, an exemplary cryptographic protocol for value swap is shown in combination flowchart and protocol schematic, in accordance with aspects of the teachings of the invention.

Referring to box 2410, it may here be said that “an authenticated offer emitted by a first party” to mean any kind of digital signature and/or one-show signature and/or other form of digitally authenticated information that includes and/or relates to what may be called an order and/or an offer or the like related to swapping and/or exchanging value.

Referring to box 2420, it may here be said that “an authenticated acceptance emitted by a second party” to mean any kind of digital signature and/or one-show signature and/or other form of digitally authenticated information that includes and/or relates to what may be called an acceptance of an offer and/or counter-offer related to such an offer or the like related to swapping and/or exchanging value.

Referring to box 2430, it may here be said that “at least an authenticated closing emitted by the first party and including information related to the offer and acceptance” to mean any kind of digitally authenticated information including signed or one-show signed that relates to a party emitting an offer or the like acknowledging or otherwise confirming that an acceptance is the one of possibly more than one acceptance that has been accepted by the offering party.

Referring to box 2440, it may here be said that “joint computation between the first and at least the second party of a set of shares for transfer of a first value and a second value from jointly controlled destinations” to mean any kind of exchange of messages and/or other cooperative computation that arrives at jointly controlled locations and/or keys and/or whatever custody technique.

Referring to box 2450, it may here be said that “a portion of the shares for transfer of the first value substantially verifiably optionally offline key transferred to plural nodes” to mean any kind of cryptographic informational protocol whereby plural nodes are empowered to jointly and/or in qualifying combinations transfer value and such empowerment is verifiable or otherwise determinable by a first party who would benefit from such transfer.

Referring to box 2460, it may here be said that “a portion of the shares for transfer of the second value substantially verifiably optionally offline key transferred to plural nodes” to mean any kind of cryptographic informational protocol whereby plural nodes are empowered to jointly and/or in qualifying combinations transfer value and such empowerment is verifiable or otherwise determinable by a second party who would benefit from such transfer.

Referring to box 2470, it may here be said that “the first and second party transferring value to the respective jointly controlled destinations, optionally incrementally” to mean any kind of method or system whereby the first and second parties are able to transfer value so that it comes under joint control and/or custody, in such a way that one or the other of the parties is mainly prevented or is unable to unilaterally transfer the value to their own benefit. It is anticipated that some parties may prefer to transfer the value incrementally (and or in parallel), such as while observing that the counterparty is reciprocating by also making such transfers, and the amounts may escalate as will be understood.

Referring to box 2480, it may here be said that “at least one of the first and second parties transferring value from joint control to control by the opposite party that transferred that value to joint control” to mean any kind of way that one or both of the parties has in effect transferred value from the joint control to their own beneficial control.

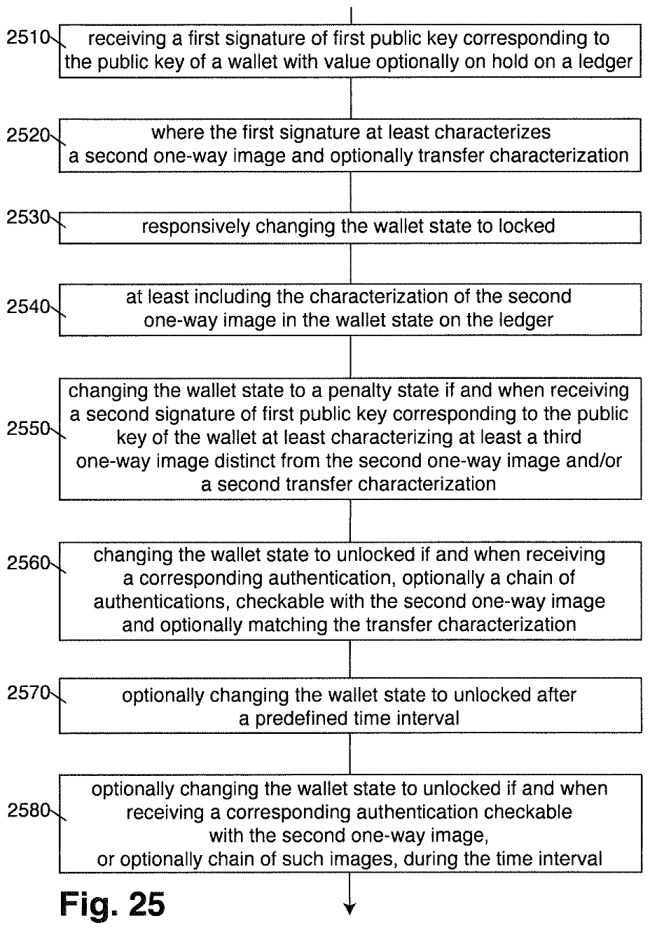

Turning now to FIG. 25, an exemplary anti-spoofing cryptographic protocol is shown in combination flowchart and protocol schematic, in accordance with the teachings of the invention.

Referring to block 2510, it may here be said that “receiving a first signature of first public key corresponding to the public key of a wallet with value optionally on hold on a ledger” to mean for example any blockchain and/or its block producers and/or validators and/or other nodes or the like receiving a signature or similar authentication corresponding to the public key or the like associated with a wallet or other store of value including a “coin” causing the ledger entry and/or other data associated with the value to record an indication of a state of that may here be called “hold.”

Referring to block 2520, it may here be said that “where the first signature at least characterizes a second one-way image and optionally transfer characterization” to mean for example any first signature authenticates a public identifier of a potentially at least separate digital authentication capability, such as a party that knows a signing key corresponding to a public key that is the one-way image and/or for example one or more pre-images and/or structures thereof. The optional transfer characterization can be information related to a trade or offered and/or accepted trade, swap or other transaction, such as but not limited to a hash and/or fingerprint and/or data and/or pointer to such data or information.

Referring to block 2530, it may here be said that “changing the wallet state to locked” to mean for example any indication and/or encoding related to the blockchain ledger entry that blocks and/or inhibits and/or otherwise interferes with the transfer of the value and/or a portion of the value from the wallet and/or coin; the indication believed ideally transparently visible to potential counterparties and/or included in an authenticated message to that effect.

Referring to block 2540, it may here be said that “at least including the characterization of the second one-way image in the wallet state on the ledger” to mean for example any way to record and/or link to a mainly public portion of information that can be used to authenticate what is believed in effect the second party being associated with the ledger entry.

Referring to block 2550, it may here be said that “changing the wallet state to a penalty state if and when receiving a second signature of first public key corresponding to the public key of the wallet at least characterizing at least a third one-way image distinct from the second one-way image and/or a second transfer characterization” to mean for example any time that a wallet is in a locked state or the like and a signature by the owner of the wallet arrives that establishes that the wallet has been offered by signature to at least more than one other counterparty, the wallet is marked or otherwise placed in a state that may here be referred to as “penalty,” such as what is sometimes referred to as burning the value and/or turning the value to a certain systemwide party and/or providing the value all or in part to one or more counterparties reporting the improper use of the wallet.

Referring to block 2560, it may here be said that “changing the wallet state to unlocked when receiving a corresponding authentication checkable with the second one-way image and optionally matching transfer characterization” to mean for example any way that the second party, that with the ability to make the second authentication, such as holding a pre-image for a hash function and/or a private key corresponding to a public key, to release the what is called “lock” on the value of the first party when the first party completes the transaction or otherwise satisfies the second party.

Referring to block 2570, it may here be said that “optionally changing the wallet state to unlocked after a predefined time interval” to mean for example any that whatever mark or indication that a wallet is blocked or otherwise inhibited can, by specific and/or general parameters and/or rules be changed after a pre-defined or variable—such as set when the lock was put in place—time, whether calendar time and/or blockchain block time and/or another type of monotonic advancing convention.

Referring to block 2580, it may here be said that “optionally changing the wallet state to unlocked if and when receiving a corresponding authentication checkable with the second one-way image, or chain of such images, during the time interval” to mean for example any changing of the indication of value state on the blockchain as mentioned responsive to authenticated information, such as from a corresponding counterparty as mentioned, to an unlocked state, as mentioned, being responsive and/or taking place according to a suitable type of authenticated message from the counterparty.

Not shown in the figure for clarity are three aspects: (a) the hold itself can be tied to an aspect of value to be traded; (b) the unlock can be tied to an aspect of the value to be traded; and a series of at least two authenticators chained with the later member of the series being shown to unlock and/or earlier members of the series creating a more locked state.

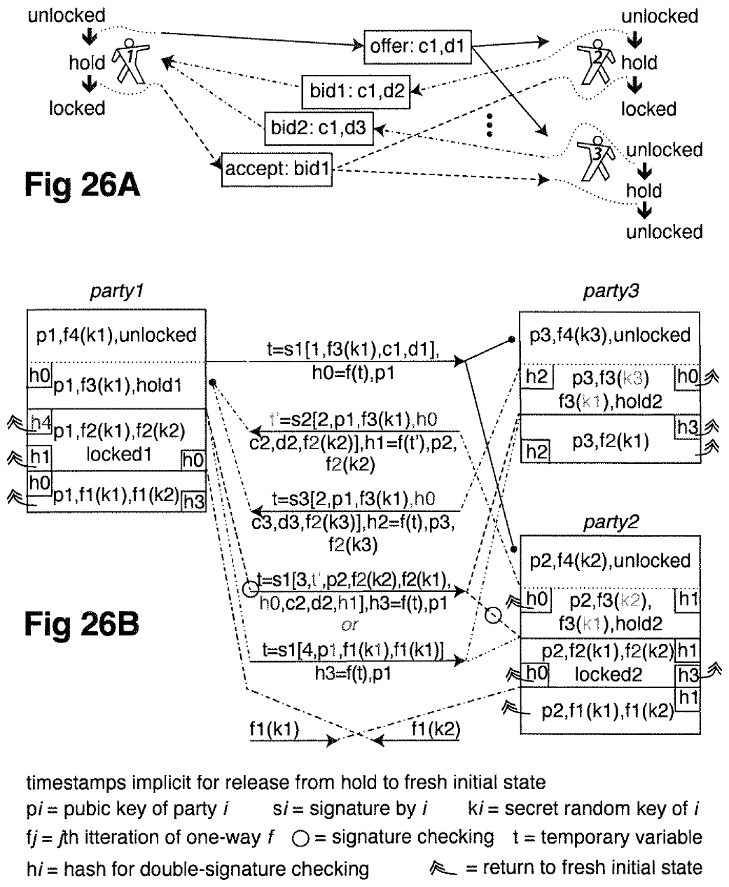

Turning now to FIG. 26AB, exemplary detailed cryptographic protocol, flowchart, block diagram and blockchain data diagrams for transaction negotiation are presented in accordance with aspects of the teachings of the invention. FIG. 26A shows three example parties exchanging messages to negotiate potential transactions and including value that can be considered “staked” related to those transactions; FIG. 26B shows the same transactions message detail and also including blockchain data state storage for each stake.

Referring first now more specifically to FIG. 26A, three parties are shown and numbered: 1, 2, and 3. Each party is shown with an accompanying stake state called here: “unlocked,” “hold,” and “locked,” as will be appreciated, to suggest that when unlocked the stake value can at least mainly be accessed for other purposes, but while on hold or locked, such access is at least inhibited. Furthermore, example transitions between the example states are shown with filled downward arrows connected to message endpoints by dotted lines, to indicate that the messages can trigger the transitions. However, it will be understood that in some cases the message sending by the recipient or sender shown, itself, may not trigger the transition; rather, the transition can be triggered in such examples by one or more parties or entities providing the messages to the appropriate blockchain or the like.

More particularly, first party one sends what may here be called an “offer” message to what can be called a “bulletin board” and/or considered a public place or other side of a mix network and/or other means of posting or making it available to other potential transaction parties. The offer contains, in the example, two example transaction parameters. For instance, they can be an amount of a first token, such as called “c,” and an amount of a second token, such as called “d.” The offer is shown being obtained and/or received by two example parties, two and three; however, the ellipsis indicates any number of such parties are anticipated.

The arrow does emanate from the first party and is connected by dotted line to the transition from unlocked to hold, as mentioned earlier. If, for instance, this message was signed by party one and such a signature were received by state means, such as a blockchain, then the state related to the stake of party one, as will be described further below, can be changed to hold, as also detailed further below. Since the arrows indicated do not terminate on the dotted lines of either party two or three, as mentioned, corresponding state transitions are not in this example indicated as occurring in this connection.

At this point, example responses from party two and party three are shown as arrows with dot dash lines. Party two supplies bid1 and party three bid2. Each bid, in the examples, includes a counteroffer related to the second parameter, d2 in the case of party two and d3 in the case of party three; these may, for instance, be different amounts of these commodities, currencies and/or for instance tokens that are proposed by the respective counter-parties as will be understood, and adjustment can for instance be made to the first parameter to indicate that there may be conventions related to this; however, and without loss of generality, the parameters may be those of the offer and/or both parameters may differ from those of the offer.

Having sent these bids, in the example protocol shown, the parties are subject to state transformation from unlocked to hold, as already mentioned, which can occur when the respective signatures by the parties are shown to the entity that maintains the state. It will be understood that in some examples, not shown for clarity, the state maintaining means can be consulted as part of obtaining the signatures; however, in the present embodiment it is believed that not requiring this allows fast transaction setup and/or negotiation, as will be appreciated.

Now party one in the example for clarity chooses to accept bid1, as indicated in the rectangle of the dashed-line messages. Both party two and party three are shown with access to this message. The consequences for the example state mechanism shown are that party one transitions to locked state, party two since bid1 was accepted also to locked state, whereas party three transitions from hold to unlocked, since the bid of party two not party three was accepted by party one. When these signatures or other authentication is provided, the state means can update, as already mentioned and will be understood.

Referring now to FIG. 26B, a conventional protocol diagram is shown in the center with respective state tables for each of the three parties already described with reference to FIG. 26A. Party one on the left and party three above party two on the right. The states are indicated symbolically and consistently with the protocol messages shown in the center. The states of a party are separated by horizontal lines and depict example values that would, for instance, be visible in a transparent blockchain ledger, as will be appreciated. Each collection of states is labeled by the respective party name in italics and enclosed in a dotted rectangle for clarity. (The optional state and message from party one is shown separately for clarity as will be understood and mentioned again below.)

The initial state of the three parties is similar. Each includes a public key, p1, p2 and p3, respectively. These might also be referred to as WalletID's in blockchain parlance. The corresponding private key information is known to the parties and ideally kept secret as it confers access to the value and the ability to make signatures that verify with the public keys, as will be understood. The private keys are shown when in use as private signing functions, s1, s2, s3, respectively checkable with the corresponding public keys, as will be understood.

Each initial state also contains, in the example, the image under a one-way function. As indicated, this is the fourth iteration of the function f applied to a secret of the respective party. Thus, for instance, accordingly f4(k1) is the result of applying the one-way function ƒ four times to the secret key k1. In some examples k1 is created randomly and/or unpredictably by party 1; in other examples, for instance, as may be known, k1 is itself the result of applying a one way function, such as the same function, in a whole what are sometimes called “ladder” or “chain” of such applications, with or without varying non-secret so-called “salt” parameters included. In some examples, as is believed known in the art, instead of creating a new walletID or state for the re-use of the keys and location, earlier values in the ladder can be switched to.

The initial state of the three parties is also shown, as the third component in the first rectangle before the first state transition, as mentioned, as being “unlocked.” This corresponds to the state already described with reference to FIG. 26A by the same name. When the state of a walletID is refreshed, the generic unlocked state is believed a good choice.

The first message shown as sent, from party one to the bulletin board and/or party two and party three, as indicated by solid line as in FIG. 26A, is shown as symbols around the first arrow in the middle, is shown as “t=s1[1,f3(k1),c1,d1], h0=f(t),p1.” The square brackets show the content signed with key s1, already mentioned, and that this is denoted also by the temporary variable t, which is then used to construct the hash of this signature under f and store it in variable h0, as will be understood. The message signed includes four example parameters for clarity: The first, 1, is the message type that is believed good practice to distinguish the various message types signed. The second parameter is the triple application off to k1, something that party one can compute and anyone is believed able to readily check against the already mentioned fourth iteration in the state. The last two components in the signature are example transaction parameters, d1 and c1; these can each include a type of commodity and/or currency and/or other type of value as well as the amount of such value. Finally, for clarity and completeness, the public key and/or a fingerprint of it, the so-called walletID already mentioned is concatenated and/or otherwise included.

The sending of this first message is shown as transitioning the first party to the second state; however, as will be understood, such transition is by supplying the signature to the ledger manager, for instance the consensus of the blockchain. When this signature is supplied, the ledger state can be as indicated in the example shown: “p1,f3(k1),hold1”. This hold1 state results from issuing the offer, as described with reference to FIG. 26A and as will be understood. Also shown is h0 in a rectangle. This is intended to indicate, as will be understood, that if a signature verifiable with p1 and message type 1 has a hash different from h0 (which is what was used to form/verify h0 such as when it was included on the ledger), then party one has issued conflicting offers and should in some examples be penalized, such as for instance by impugned reputation and/or forfeiture of all or part of the value staked.

The two recipient parties, among others as indicated by ellipsis in FIG. 26A, receive the message; however, it may not be entered directly on the blockchain as indicated by the solid disc endpoints on the lines not touching the state rectangles. Each of party one and party two in the example do, however, use this first message as a basis for their bids, shown as respective bid1 and bid2 in FIG. 26A. These two similar bid signatures do transition the states in a similar manner as will be described next.

Each bid signature, shown as a solid protocol message arrow delivered by dot dash lines, impinges on the state transition line, from the first to the second state, of the respective wallet. The first bid, from the second party, is shown as “t=s2[2,p1,f3(k1), c2,d2,f3(k2)],h1=f(t),p2” and the second bid, from the third party, as “t=s3[2,p1,f3(k1), c3,d3,f3(k3)],h2=f(t),p3”. Each bid is signed by the respective private key, s2 and s3. Each bid differs, in general, as indicated by c2 and d2 differing potentially from c1 and d2, as well as party three bid c3 and d3. The one-way ladders, as mentioned, are opened one level down, to three applications of f. The respective hashes, h1 and he2 are, shown formed from the signatures. Inside the signature the type, 2 in the example, is included as a prefix as are two identifiers (though many other examples can readily be devised) of the first party and the offer, in this case p1 and the third application f3(k1), both from the offer message just described. The public key of the signers are appended for clarity.

These bids are shown available to party one by the dot dash lines impinging on the second state of party one. Party one can choose to accept one of these bids by issuing the accept signature, as already explained with reference to FIG. 26A. This signature is shown as protocol message “t=s1[3,p2,f3(k2),f2(k1), c2,d2,h0],h3=f(t),p1”. It is transmitted with dashed lines. Again, the hash of the signature is h3, the message type is 3, the payload also contains in the example the public key and f3(k2) of the bid, as mentioned before as an example way of identifying the transaction. The public key could be a fingerprint. The f2(k1) is the hash for this second message sent by the first party. The exemplary transaction parameters related in this example to, but not in general equal to, those of the bid accepted, c2 and d2, are also shown. Furthermore, h0, the hash of the original offer is included for completeness and/or security reasons. The public key of the issuer, p1, is appended.

Each of party two and three illustrate an example way that this message is used to transition the state of a party.

Party three has issued a bid that was not accepted, so the state transition allowed, once the signature is shown to the ledger, is to unlocked3, to indicate that the hold was released because though a bid was accepted, this bid was not the one accepted. The hash of the acceptance h3 is included with the state, in case more than one acceptance is issued from the first state and then party three can show a different acceptance signature to the ledger maintainer, who then checks that the hash of the signature differs from h3, and can penalize party one. Party three is also shown in the example as storing h2 in the state; this allows party three's stake to be revoked and/reputation to be impugned if a second signature checkable by p3 but not matching h2 can be shown. The value h0 is also shown with double arrow symbolizing returning the state to unlocked if it turns out that the original offer signature was one of more than one such signature issued by p1.

Party two has issued a bid that was accepted, so the state transition allowed, once the signature is shown to the ledger, is from hold2 to locked2, to indicate that the hold related to a bid signature was changed to locked because the bid was accepted. The hash of the acceptance h3 is included with the state, in case more than one acceptance is issued from the first state and then party three can show a different acceptance signature to the ledger maintainer, who then checks that the hash of the signature differs from h3, and can penalize party one and release party two from the locked2 state, as indicated by the double arrow already introduced. Party three is also shown in the example as storing h1 in the state; this allows party two's stake to be revoked and/reputation to be impugned if a second signature checkable by p2 but not matching h1 can be shown to the ledger maintainer. The value h0 is also shown with double arrow symbolizing returning the state to unlocked (similar to how it could transition from hold in the previous state of party two) if it turns out that the original offer signature was one of more than one such signature issued by p1.

An example optional cancel by party one is shown for clarity as a separate dotted line rectangle. The state can be identified by public key, p1, for instance, and is indicated as hold3. The pre-image from the ladder related to k1 is shown as empty, so no applications of f (though this could be part of a larger ladder as mentioned already above; and also the type of hash function can differ over the ladder, an inventive aspect that will be understood). The corresponding message shown traveling via a double-dot dash line received by party two and party three, but believed best by all bidders at least, allows the bidders to unlock or unhold, as indicated by the double arrow. However, if the party issuing this, party one, has signed an acceptance, then as indicated the f1(k2) would be needed from party two in order to release the lock.

Now finally, as shown below by dot short-dash long-dash lines, party one and party two release f1(k1) and f1(k2), respectively, in a mutual reveal.

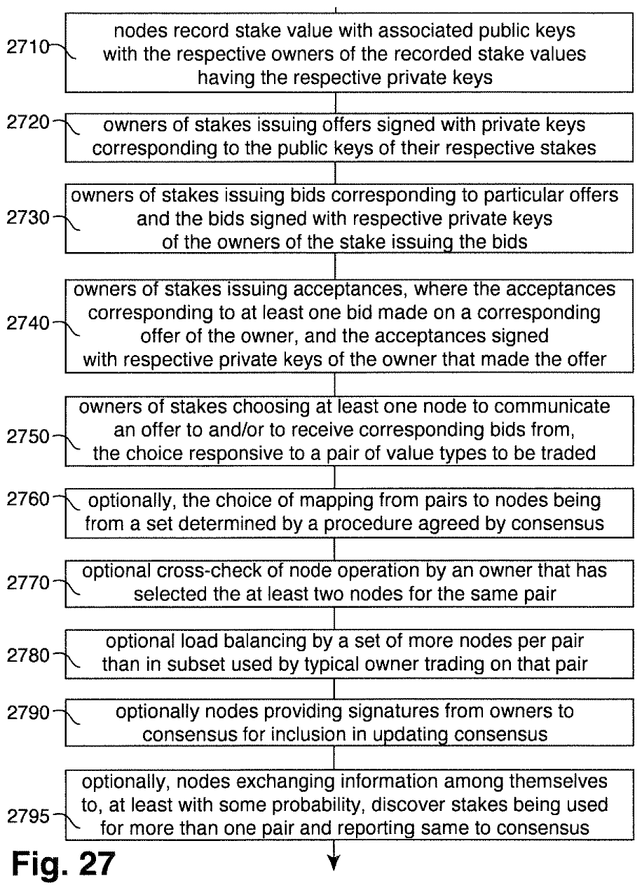

Turning now to FIG. 27, exemplary combination detailed flowchart and block diagram for transaction negotiation is presented in accordance with aspects of the teachings of the invention. The chart is believed self-explanatory, as will be appreciated, however the text will be included here to remove any doubt.

“nodes recording stake value with associated public keys, where the respective owners of the recorded stake values have respective private keys;

owners of stakes issuing offers signed with private keys corresponding to the public keys of their respective stakes;

owners of stakes issuing bids, where the bids correspond to particular of the offers, the bids signed with respective private keys of the owner of the stake issuing the bids;

owners of stakes issuing acceptances, where the acceptances corresponding to at least one bid made on a corresponding offer of the owner, signed with the acceptances signed with respective private keys of the offerer;

owners of stakes choosing at least one node to communicate an offer to and to receive corresponding bids from responsive to a pair of value types to be traded by the respective owners;

the choice of mapping from pairs to nodes being from a set determined by a procedure agreed by consensus;

optional cross-check by an owner of the operation between of least two nodes selected for a pair;

Optional load balancing by more nodes per pair than used by at least typical owner; Optionally nodes providing signatures from owners to the consensus for inclusion in updating the state; Optionally nodes exchanging information among themselves to at least statistically discover stakes being used for more than one pair and reporting same to the consensus;

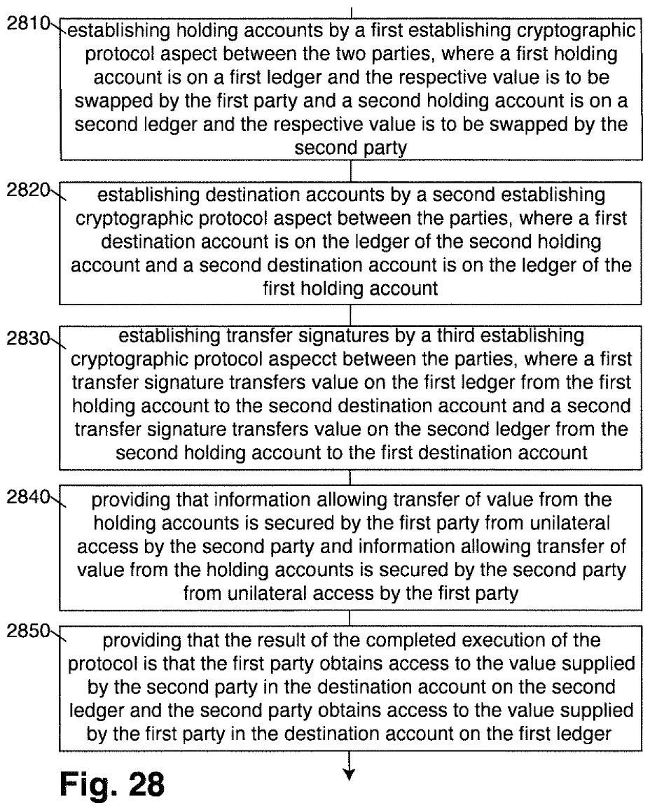

Turning now to FIG. 28, an exemplary cross-chain atomic swap cryptographic protocol is shown in combination flowchart and protocol schematic, in accordance with the teachings of the invention.

In box 2810, it may here be said that “establishing holding accounts by a first establishing cryptographic protocol aspect between the two parties, where a first holding account is on a first ledger and the respective value is to be swapped by the first party and a second holding account is on a second ledger and the respective value is to be swapped by the second party” to mean any way whatsoever to create accounts and/or walletID's and/or addresses on a blockchain that have a private key that is shared between more than one entity, so that cooperation between the entities is used to create the signatures that move value from the holding accounts.

In box 2820, it may here be said that “establishing destination accounts by a second establishing cryptographic protocol aspect between the parties, where a first destination account is on the ledger of the second holding account and a second destination account is on the ledger of the first holding account” to mean any way whatsoever to create accounts and/or walletID's and/or addresses on a blockchain for the swapped value to finally land in. While box 2820 indicates that the inventive swap system establishes the destination accounts using an aspect of the cryptographic protocol, the destination accounts can be input by the parties themselves if so desired. Alternatively, the destination accounts could preexist in a way that each party has at least some control over its destination account. Thus, the swap system includes destination accounts to allow the values of the parties to be swapped and the manner of existence or creation of the destination accounts can vary as detailed above.

In box 2830, it may here be said that “establishing transfer signatures by a third establishing cryptographic protocol aspect between the parties, where a first transfer signature transfers value on the first ledger from the first holding account to the second destination account and a second transfer signature transfers value on the second ledger from the second holding account to the first destination account” to mean any way whatsoever to create such signatures for transferring value on the respective chains where control of the signatures remains divided in a way that at least the two parties should cooperate in order move the value.

In box 2840, it may here be said that “providing that information allowing transfer of value from the holding accounts is secured by the first party from unilateral access by the second party and information allowing transfer of value from the holding accounts is secured by the second party from unilateral access by the first party” to mean any way whatsoever to secure the holding accounts so that at least cooperation between the two parties is what allows the value to be moved to the respective destination accounts.

In box 2850, it may here be said that “providing that the result of the completed execution of the protocol is that the first party obtains access to the value supplied by the second party in the destination account on the second ledger and the second party obtains access to the value supplied by the first party in the destination account on the first ledger” to mean any way whatsoever to ensure that the completion of the protocol results in the value being available to the respective parties on the respective ledgers, that is party two obtains it on the first ledger and party one obtains the value from party two on the second ledger.

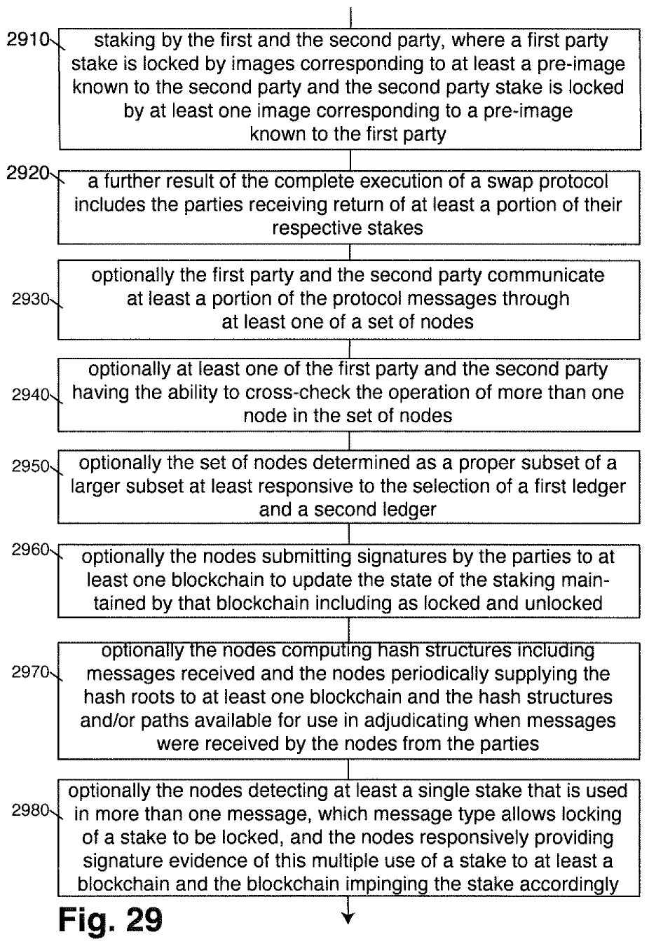

Turning now to FIG. 29, an exemplary staking for swapping cryptographic protocol is shown in combination flowchart and protocol schematic, in accordance with the teachings of the invention.

In box 2910, it may here be said that “staking by the first and the second party, where a first party stake is locked by images corresponding to at least a pre-image known to the second party and the second party stake is locked by at least one image corresponding to a pre-image known to that party” to mean any way whatsoever that the respective stakes are locked by keys or other cryptographic values not held by the respective parties, where the pre-image under whatever one-way function or the like is believed adequate to provide this means, since the image is easily computed from the pre-image by public function but finding a pre-image from an image is believed infeasible with modern cryptographic hash functions, for instance.

In box 2920 it may here be said that “a further result of the complete execution of a swap protocol includes the parties receiving return of at least a portion of their respective stakes” to mean whatever means by which the party whose stake was held during a transaction can obtain all of a part of it back, such as by being able to control it by the keys that formerly controlled it, once the transaction completes.

In box 2930, it may here be said that “optionally the first party and the second party communicate at least a portion of the protocol messages through at least one of a set of nodes” to mean whatever means by which the first and the second party communicate with each other include at least a portion of the communication at least in effect being known to if not being forwarded by at least one node.

In box 2940, it may here be said that “optionally at least one of the first party and the second party having the ability to cross-check the operation of more than one node in the set of nodes” to mean any way whatsoever for one or both of the parties to check that the nodes perform correctly or consistently by comparing the performance and/or data supplied by one or more of the nodes means.

In box 2950, it may here be said that “optionally the set of nodes determined as a proper subset of a larger set at least responsive to the selection of a first ledger and a second ledger” to mean any means whatsoever, such as special devices and/or algorithms and/or protocols that allow the particular nodes for a particular pair of chains to be determined, while it will be understood that a subset of that subset may be selected for use by the particular trading pair at least once they have found each other.

In box 2960, it may here be said that “optionally the nodes submitting signatures by the parties to at least one blockchain to update the state of the staking maintained by that blockchain including as locked and unlocked” to mean that the states related to staking maintained by a blockchain for the staking can be as limited as two states, locked and unlocked and that the states are changed by the blockchain responsive to signatures showing ownership of the particular accounts and/or walletID's and/or addresses on the blockchains, which are implemented by plural physical computer means under ideally separate control.

In box 2970, it may here be said that “optionally the nodes computing hash structures including messages received and the nodes periodically supplying the hash roots to at least one blockchain and the hash structures and/or paths available for use in adjudicating when messages were received by the nodes from the parties” to mean any type of so-called “Merkle tree” and/or time-stamping method or means whatsoever that allows the nodes to readily lock in the at least discrete blockchain time that a message was received the node, so that the such locked in time can be used for instance by third-parties that are to decide for instance, as will be appreciated, which of the two parties has stopped first, such as for the purpose of deciding which party shall at least have a stake what may here be called “impinged” to mean undesirably accessed and/or marked and/or burned.

In box 2980, it may here be said that “optionally the nodes detecting at least a single stake that is used in more than one message, which message type allows locking of a stake to be locked, and the nodes responsively providing signature evidence of this multiple use of a stake to at least a blockchain and the blockchain impinging the stake accordingly” to mean any means and/or method whatsoever to that allows nodes to detect the improper use of a stake for more than one transaction, as evidenced by signatures from the owner of the stake, to be provided by the nodes to a blockchain in order to in some way provide evidence allowing the blockchain to impinge on the stake. (It will be appreciated that nodes may be incentivized to perform such actions, and/or to make statistically significant test to discover such actions, such incentives including after the fact analysis and/or immediate reward.

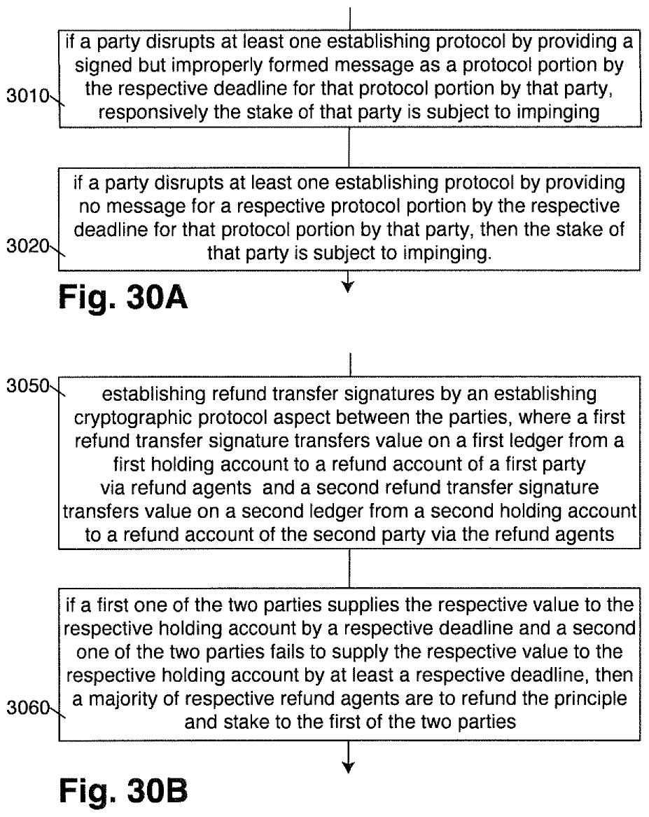

Turning now to FIG. 30A-B, exemplary anti-blocking cryptographic protocols are shown in combination flowchart and protocol schematic, in accordance with the teachings of the invention. FIG. 30A is the impinging on stake of the party missing deadlines for participating in the protocols properly; FIG. 30B is wallet ID's the returning of value to a party that funded a holding account when the counterparty did not fund the respective holding account.

Referring first here more specifically to FIG. 30A, in box 3010, it may here be said that “if a party disrupts at least one establishing protocol by providing a signed but improperly formed message as a protocol portion by the respective deadline for that protocol portion by that party, responsively the stake of that party is subject to impinging” to mean adjudication by independent adjudication parties and/or means is decided against one of the transacting parties if that party has signed a message and that message is not properly formed, as will be understood, meaning that it does not include a convincing proof as required, such as relative to data included in the message and/or data included in previous messages by the parties.

In box 3020, it may here be said that “if a party disrupts at least one establishing protocol by providing no message for a respective protocol portion by the respective deadline for that protocol portion by that party, then the stake of that party is subject to impinging” to mean that adjudication by independent adjudication parties and/or means is decided against one of the transacting parties if that party has not provided a message and that message by a deadline, as will be understood, meaning that the required message is absent; however, it will be appreciated that various measures, such as notification about the absence of the message may be provided and a limited extension of time automatically provided, are anticipated as provided in order to help the party get the message recorded. It will also be appreciated that the absence of a signed receipt, such as from a node to a party, can alert the party that message was not received; and, furthermore, when there are multiple nodes (such as being cross-checked as mentioned) when a node provides a message to multiple nodes presumably at least one of them would record it properly and also at least one of them would reach the party with a warning that a particular message was not received when expected.

Referring first here more specifically to FIG. 30B, in box 3050, it may here be said that “if establishing refund transfer signatures by an establishing cryptographic protocol aspect between the parties, where a first refund transfer signature transfers value on a first ledger from a first holding account to a refund account of a first party and a second refund transfer signature transfers value on a second ledger from a second holding account to a refund account of the second party” meaning any cryptographic means and/or method whereby the value can be returned to the party having moved it to the holding account in the event that the counterparty has not moved forward, as will be understood, including where the means is signature that allows the value to be moved on the blockchain from the holding account to an account different from the destination account and ideally one that the original party moved the value from to the holding account, as will be understood.

In box 3060, it may here be said that “if a first one of the two parties supplies the respective value to the respective holding account by a respective deadline and a second one of the two parties fails to supply the respective value to the respective holding account by at least a respective deadline, then a majority of respective refund agents are to refund the principal and stake to the first of the two parties” to mean that by whatever means and/or method a quorum or other agreement between entities of whatever type, called here “refund agents,” provides the information sufficient to allow the value to be returned to the party that did provide the value to the holding account in the case that the other party did not provide the value to the holding account, at least not be the deadline of whatever type.

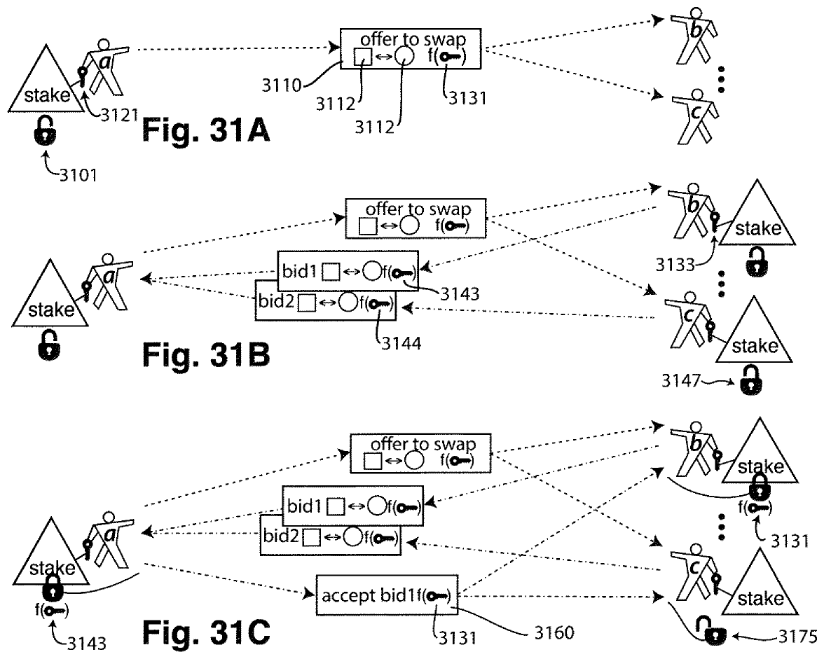

Turning now to FIG. 31A-C, exemplary detailed cryptographic protocol, flowchart, block diagram and blockchain data diagrams for transaction negotiation are presented in accordance with aspects of the teachings of the invention. FIG. 31A is the initial offer; FIG. 31B includes the bids by two example parties; and FIG. 31C shows the corresponding accept by the party making the initial offer of one of the bids.

Referring now to FIG. 31A more specifically. The first party called Alex is shown holding a key 3121 to a stake that is in the “soft locked” configuration 3101 and Alex emitting an offer 3110 to swap, as indicated by dashed lines. The offer indicates the two types of value to be swapped, symbolically for clarity, as a square 3112 and a circle 3113, as will be used in some other figures as will be appreciated. Also included is the image 3131 under a hash or other suitable one-way function of the particular key 3121 Alex is shown holding for clarity. Two example parties, of potentially more as indicated by the ellipsis, are called Bobbi and Charlie.

Referring next to FIG. 31B, both Bobbi and Charlie respond, as indicated by dot-dash lines, to Alex's offer 3110 by respective bids, called “bid1” and “bid2” for clarity. The key included with bid1 3143 is the hash of the key 3133 Bobbi holds; the key with bid2 3144 is the hash of the key 3147 Charlie holds. Upon emitting the bids, Bobbi and Charlie have respective stake shown as soft locked, for instance 3147.

Referring to FIG. 31C, Alex replies, shown as dot-dash-dash arrows, with an accept 3160 of bid1, which is provided to Bobbi and Charlie. Bobbi's stake as a result becomes locked with the hash of Alex's key 3131 from the offer and/or the accept; Alex's stake as a result becomes locked with the hash of Bobbi's key 3143 from the bid1. Charlie's stake is then in an unlocked configuration 3175.

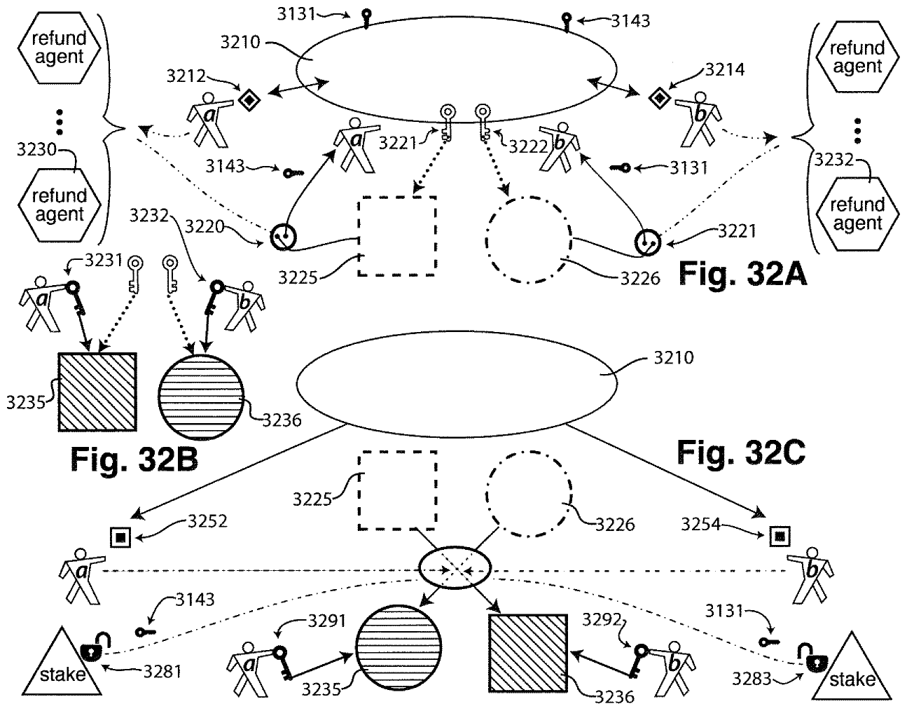

Turning now to FIG. 32A-C, exemplary detailed cryptographic protocol, flowchart, block diagram and blockchain data diagrams for transaction settlement are presented in accordance with aspects of the teachings of the invention. FIG. 32A is the initial offer; FIG. 32B includes the bids by two example parties; and FIG. 32C shows the corresponding accept by the party making the initial offer of one of the bids.

Referring first to FIG. 32A more specifically, a cryptographic protocol 3210 conducted between Alex and Bobbi is shown receiving a first 3131 and a second 3143 stake key, as already described with reference to FIG. 31. The cryptographic protocol is also shown issuing two so-called “walletID's” or addresses, one for each holding account of the swap 3225 and 3226, respectively, as will be understood; each holding account is controlled by cryptographic multi-sig between the parties, as indicated by the hollow keys, one key for the first value 3221 and a second key 3222 for the second value.

Additionally, protocol 3210 issues a proven commit 3212 to Alex and a proven commit 3214 to Bobbi. These convince each respective recipient, as also described elsewhere here, that the respective recovery nodes (also called here “refund agents”) control through a voting process the switches. In particular, Alex is convinced that he has received at least encrypted values 3212 that allow recovery nodes 3230 to decrypt and a majority or other predefined quorum of these nodes can control switch 3220 so that the value in holding address 3225 can be returned to Alex by release of a signature that the nodes 3230 can reconstruct. Similarly, Bobbi is convinced that she has received at least encrypted values 3214 that allow recovery nodes 3232 to decrypt and a majority or other predefined quorum of these nodes can control switch 3221 so that the value in holding address 3226 can be returned to Alex by release of a signature that the nodes 3232 can reconstruct.

Referring next to FIG. 32B more specifically, Alex funds, using existing key 3231 to existing value of Alex, the holding wallet 3235, as indicated by the diagonal hatching. Similarly, Bobbi funds, using existing key 3232 to existing value of Bobbi, the holding wallet 3236, as indicated by the horizontal hatching.

Referring next to FIG. 32C more specifically, information 3252 becomes available, as indicated by solid line arrow, to Alex and information 3254 becomes available to Bobbi, as a result of protocol 3210. This information allows Alex and Bobbi to be confident, such as by cryptographic proof or the like, that they can exchange that information with their respective counterparty to thereby allow the swap. When they do so, as indicated by the dash-dash-dot arrows, then the values funded as referenced in FIG. 32B, is transferred using transfer signatures on the respective ledgers, as follows: value 3235 is transferred to Bobbi and under key 3292; and value 3236 is transferred to Alex and under key 3291, such representing the destination accounts of the respective parties. Also, as a result ideally of the same reveal of secrets protocol, as described elsewhere here as well, the keys for unlocking the stakes are released as follows: Alex's stake is unlocked using the key 3143 from Bobbi; and Bobbi's stake is unlocked using the key 3131 from Alex.

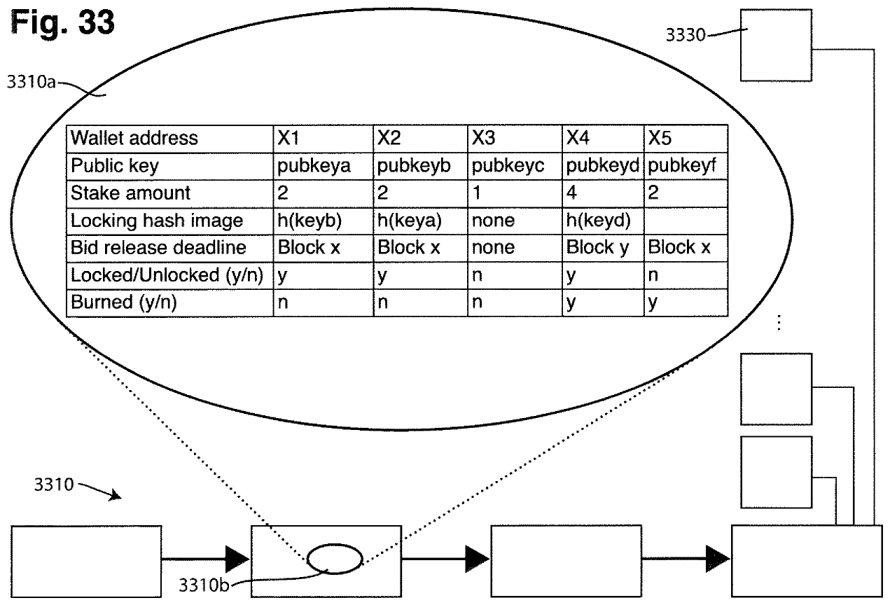

Turning now to FIG. 33, exemplary detailed cryptographic protocol, flowchart, block diagram and blockchain data diagrams for transaction data stored on chain are presented in accordance with aspects of the teachings of the invention.

The blockchain 3310 is shown as a series of blocks, as will be understood, with an example data portion 3310a shown as an enlarged portion 3310b of an example block, as a spreadsheet or the like, as will be understood. Additionally, matcher nodes 3330, are shown for additional clarity communicating with the blockchain, as described also elsewhere here.

Five example stakes are shown, each as a separate column. The rows are labeled: Wallet address, Public key, Stake amount, Locking hash image, Bid release deadline, Locked/Unlocked (y/n), and Burned (y/n).

The first row, called here “Wallet address,” is an ideally unique label or identifier or tag for the associated data, as will be understood.

The what can here be called “Public key,” field sometimes is the wallet address, or sometimes a hash of the public key is a wallet address; however, in any event typically a public key allows those with the ability to sign to effect “transactions” against the wallet data, within the rules enforced by the blockchain, as will be understood.

The what can here be called “Stake amount,” is intended to indicate that in some example systems there are more than one amount of stake that can be held at a wallet address; presumably, larger value swaps with larger expected relative price changes over the settlement interval would be more likely to favor larger stake amounts; a single stake amount is also anticipated in some examples.

The what can here be called “Locking hash image,” can as described elsewhere here be the image under a believed hard to invert function of a secret unlocking key known to a counterparty.

The what can here be called “Bid release deadline,” is a time such as related to UTC and/or expressed in terms of block sequence numbers, and/or some combination or other variation.

Two state bits are shown as examples: “Locked/Unlocked (y/n),” and “Burned (y/n).” The names are believed self-explanatory, at least for some examples. Locked is described elsewhere here; burned can be used to return value to the system and/or other entities, but typically removes it from control by the owner of the private key.

Referring to the first data column, the wallet address is shown as “X1” and the public key as “pubkeya.” The next column, with “X2” and “pubkeyb” is intended to suggest the case where Alex has made an offer and Bobbi has accepted it. The stake amount agree is two, which is in accordance with anticipated practice typically expected to be reciprocal, but need not be. Both are locked and of not burned. The transaction is still pending, as both wallets are locked.

Referring to the third data column, the case of Charlie as described elsewhere here is shown, where the wallet is not locked and not burned. Some other fields are not populated, thought there is stake value.

Referring to the fourth data column, the case of a user that was locked to do a transaction but then failed to meet the intermediate deadlines, such as by providing improper data as described elsewhere here, and the stake is burned.

Referring to the final column, in this example the stake was burned such as because an offer was not followed up within deadline by a corresponding accept or a release of the bidders, such as symbolized by the typical example of an invalid/empty state such as the offer wallet being the bidder.

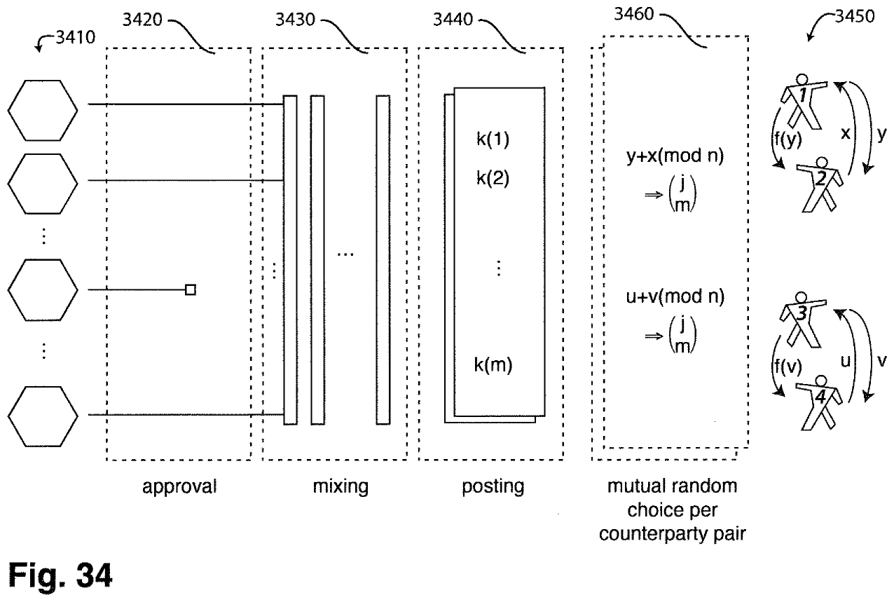

Turning now to FIG. 34, exemplary detailed cryptographic protocol, flowchart, block diagram and blockchain data diagrams for random selection of pseudonymous refund agents are presented in accordance with aspects of the teachings of the invention.

The left column 3410 is a set of candidate refund agents. They each submit to the approval process 3420, shown as the first dashed box. In the example one does not gain approval and does not pass through; this line ends in a small block. The approved agents each have a single input to the next dashed box, called here “mixing” 3430. This can be a cascade of mixes, such were introduced by the present applicant and are well known in the art; each vertical box can be a mix. The output 3440 of the mix comprises items that were input by the approved agents, one per such agent; these items are shown for clarity as public keys k( ), such as for instance secret powers of a fixed public generator in a discrete log system.

Next in temporal order, pairs 3450 of counterparties conduct cryptographic protocols to determine mutually random values. An example, though known in the prior art, is provided here for concreteness. Party1 first applies a one-way to y and provides the image to party2, who replies with a random value x and then party 1 provides the pre-image y.

Dashed box 3460 provides an example of how the values x and y are used to compute a random set of pseudonymous refund agents. The two values are added and the result reduced modulo the number subsets that can be selected between. Then the subset can be computed from the residue class determined, by well known algorithms. This is shown symbolically, though non-standardly for clarity, using j choose k notation, to indicate j items selected from the collection of m public keys.

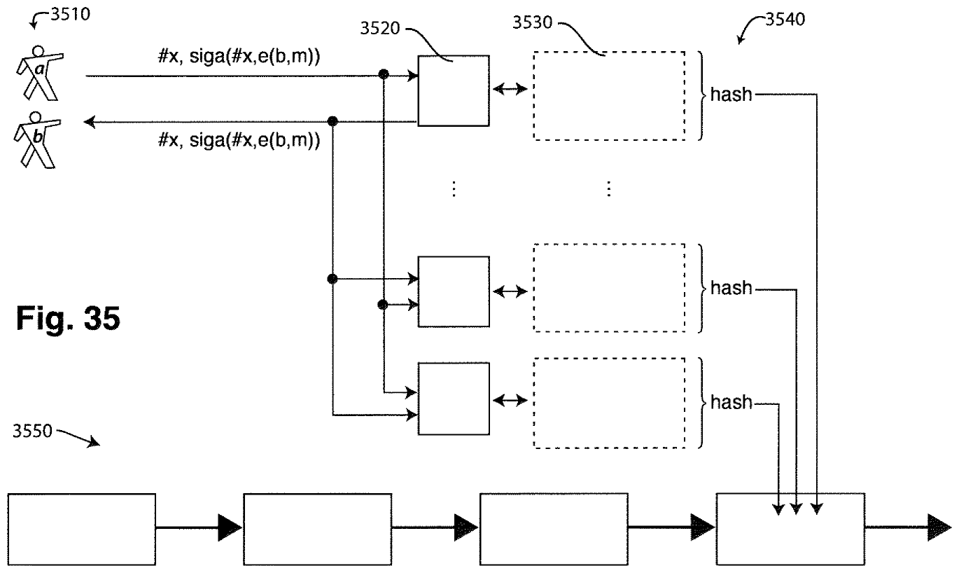

Turning now to FIG. 35, exemplary detailed cryptographic protocol, flowchart, block diagram and blockchain data diagrams for storing and validating and time stamping messages forwarded by matchers is presented in accordance with aspects of the teachings of the invention.

Parties 3510 Alex and Bobbi are shown communicating messages after they have locked on a swap. Each such message, in the example from Alex to Bobbi, has a kind of tag and/or identifier, for clarity, shown as #x, followed by a signature the respective party, such as indicated by the tag. The example signature is on, such as by signing a hash and/or including the data itself as input to the signature functions, as will be understood, the identifier for concreteness and an optional layer of encryption protecting the message payload m can be removed in case of dispute but provides privacy otherwise. The message should be, for instance, a set of parameters in a canonical order and/or a so-called “non-interactive” proof that the parameters are properly formed. Such proofs sometimes referred to in the art, as will be understood, as “identifiable abort.” It is believed that by signing all the messages and including the non-interactive proofs of well-formedness and/or non-abort, a party that stops performing the protocol in a way that would stop the honest counterparty from proceeding will be revealed irrefutably as such. Then the stake of that aborting party can be burned and/or shared with the victim party.

To achieve this, the messages have not only tags but corresponding deadlines, as will be understood. Moreover, the matcher nodes 3520 provide a posting 3530 of the messages. These postings are hashed 3540, such as in a tree structure, to provide a kind of time stamp that is shown being placed on the blockchain 3550, as shown and will be understood. Thus, the party that does not provide the correctly tagged and signed message by the deadline in the protocol is revealed publicly and the time stamping on the blockchain proves that the proper message precursor was in fact available in time.

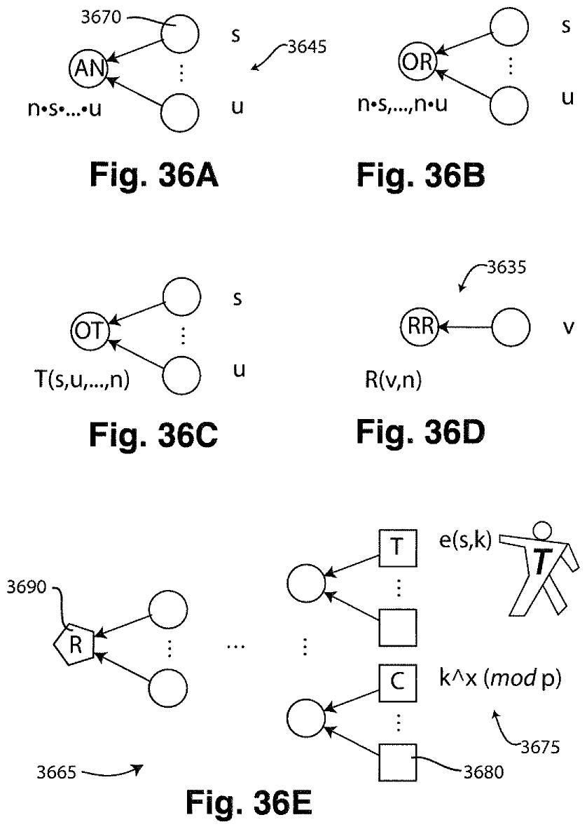

Turning to FIG. 36A-E, exemplary detailed cryptographic protocol, flowchart, block diagram and blockchain data diagrams for access tree structures are disclosed in accordance with aspects of the teachings of the invention. FIG. 36A is an “AND” node; FIG. 36B is an “OR” node; FIG. 36C is what can here be called here an “oblivious transfer” or “OT” node; FIG. 36D is what can here be called a “range reduction” or “RR” node; and FIG. 36E is an access tree from root to leaves.

Referring first particularly now to FIG. 36A, the “AND” node is shown abbreviated “AN” having two or more direct descendants (each of which may have any number of descendants as the root of a subtree, as will be understood generally here in this FIG. 36), as indicated by the ellipsis. An example direct descendant 3670 is shown for clarity. The value associated with the descendants are shown as s through u. As an example of how such a node can be formed, the product of the direct descendants is shown, such as in a group, so that in some examples nothing about the value n of the AND node is known until all the descendant values are combined with the group operation, shown as “·” in which case the value is fully revealed by forming the inverse and cancelling all factors but n.

Referring to FIG. 36B, an OR node is shown, much as with the AND node just described. A difference being that each and every of the direct descendants has a value suitable to achieve the value n of the OR node. For instance, but as just one example, a set of values can be publicly associated with the node that are each a combined using the group operation, in a suitable group, of a random value with the actual node value, shown as n·s.

Referring to FIG. 36C, an “oblivious transfer” or “OT” node for short is shown. The issuer of the access structure does not know some aspect of the OT node; however, the receiver of the access structure knows an aspect unknown to the issuer. For instance, the issuer can provide the receiver with a value that the issuer can prove cryptographically has a 50% probability of being the desired value w and a 50% probability of being zero, as is well known in the cryptographic art and literature. Thus, accordingly, the party providing the access structure is believed disadvantaged as it does not know whether or not the other party of the two has access to w. In some examples, w can be an AND node in a subtree where the other node is a restriction or particular party, as will be described with reference to FIG. 36D-E.

Referring now to FIG. 36D, a “range restriction” or “RR” node for short is shown. Such a node has in the example a single descendant, which has a value, such as n, at least sometimes unknown to the receiver of the access structure, such as n. Protocols to demonstrate, typically by the issuer to the receiver, that the secret value n has a more limited range or distribution of possible values than previously known to the receiver are known, such as those described here and referring to E. F. Brickell, D. Chaum, I. B. Damgard, & J. van de Graaf, titled “Gradual and verifiable release of a secret,” appeared in Advances in Cryptology CRYPTO '87, Springer-Verlag, pp. 156-166.

Referring finally on this sheet now to FIG. 36E, a whole example access tree structure 3656 is shown. The so-called “root” 3690, “R” for short, is shown as a pentagon with one or more direct descendants. Ellipsis indicates that there may be many nodes forming a directed graph of nearly whatever shape; however, the leaves are shown as squares, such as 3680.

A first type of leaf is can be regarded as an access rule in itself, shown as what may be called trustee party T, that has in the example for clarity received an encrypted value of key k, that is encrypted with encryption operator e, using key s; thus, the trustee would be contacted and provided s in order to allow it to provide the leaf value k.

A second type of leaf can here be called a “commitment,” “C” for short, is shown as an encryption of a value committed to using a public key encryption system 3675 such as discrete log modulo a prime, as will be understood: k\hat{ }x(mod p).

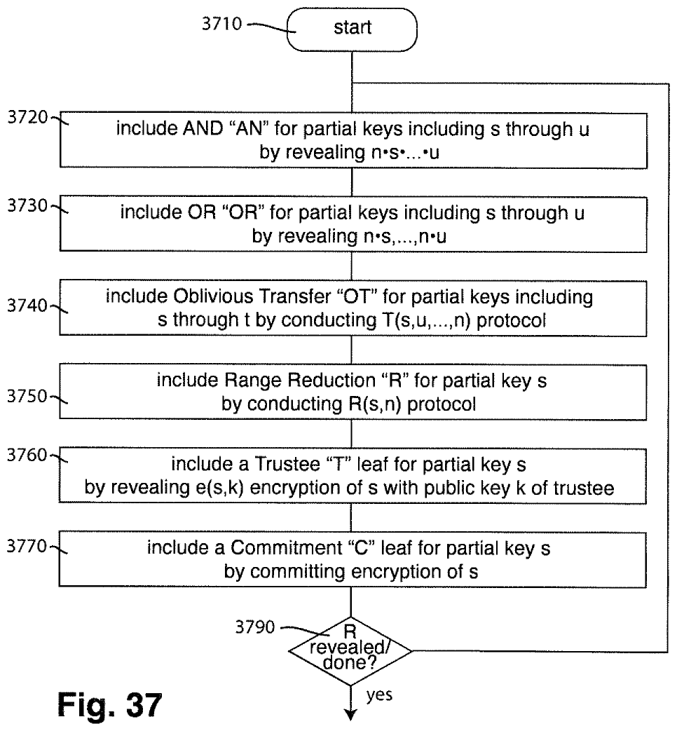

Turning to FIG. 37, exemplary detailed flowchart, cryptographic protocol, and block diagram for access tree structure traversal is provided in accordance with aspects of the teachings of the present invention. In some examples the process can be used to form an access tree; in other examples it can be used to attempt to compute the root value from leaves that have been issued.

Referring specifically first to start box 3710, the process is shown as a loop. In some example executions only those steps that can be executed are and the other steps skipped over for that pass through; however, skipped steps may be executed in subsequent passes.

Box 3720 shows the handling of an example AND node by either: determining n form the product of all the s through u, n·s· . . . ·u/s· . . . ·u, as explained already with reference to FIG. 36A; or by releasing the product n·s· . . . ·u in forming the tree.

Box 3730 shows the handling of an example OR node by either: determining n form any one of the sn through un, as explained already with reference to FIG. 36B; or by releasing the n·s, . . . , n·u in forming the tree.

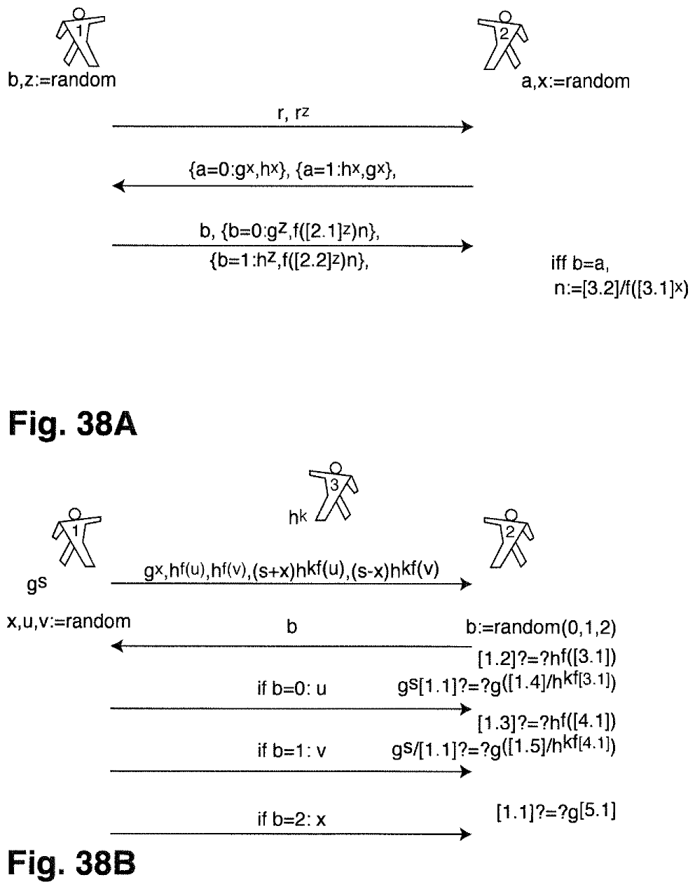

Box 3740 shows the handling of an example OT node by either: determining n form any one of the s through u node values that were revealed with some probability, as explained already with reference to FIG. 36C; or by the issuer performing the oblivious transfer protocol to the recipient for each of the s through u node values with corresponding probabilities, as already explained with reference to FIG. 36C and to be described with reference to FIG. 38A.

Box 3750 shows the handling of an example RR node by either: performing the protocol as, already described with reference to FIG. 36D; or by exhaustive search of the reduced key space that an execution of the protocol proves contains the key, also as already described with reference to FIG. 36D.

Box 3760 shows the handling of an example RR node by either: during issuing providing the trustee with an encrypted key e(s,k); or by contacting the trustee and requesting k, such as would typically include checking of some condition and/or making some public notice by the trustee, as will be understood.

Box 3770 shows the handling of an example C node by either: during issuing providing the commitment, and optionally cryptographically proving its correctness by the issuer to the recipient, as already described with reference to FIG. 36E; or by verifying the so-called “opening” of the commitment, as is well known in the art.

Box 3790 is a branch. If the root R has been computed, when the aim of the traversal repetitions is to find it, the branch follows the “yes” leg and completes the process; if the traversal instance is part of building a tree, then it completes only once the tree is completed.

Turning to FIG. 38A-B, exemplary detailed cryptographic protocol, flowchart, and block diagrams for protocol examples provided in accordance with aspects of the teachings of the invention. FIG. 38A is an oblivious transfer protocol for an OT node; FIG. 38B is proof of encrypted share protocol.

Referring first more specifically now to FIG. 38A, a first party is believed able to obliviously provide n to a second party, with probability 50%, but without the first party knowing whether the second party received n. The first party (on the left) is shown creating two values at random: a bit b and a residue z in the exponent group modulo a large prime p of a discrete log system, as will be understood; similarly, the second party also creates two random values from the same respective distributions, a and x.

In the first arrow, the first party sends r and r^{z} to the second party (all numbers except bits are modulo p, as will be understood).

Next, as indicated by the curly bracket notation, the second party sends one of two pairs. In case the random a=0, then the pair is g^{x}, h^{x}; however, in case the random a=1, then the order of the pair is reversed, h^{x}, g^{x}.

As the final of the three messages shown, the first party sends b and one of two message pairs: if b=0, then the pair g^{z},ƒ([2.1]^{z})n; however, if b=1, then the first party instead sends the pair h^{z}, ƒ([2.2]^{z})n.

Now the second party can compute n in the case that both a=b and otherwise the second party is believed unable to recover n from this protocol. This is the oblivious aspect. So, if and only if b is equal a, then the second party can raise the first component of the second message to the x power and obtain the pre-image for the one-way function ƒ, and then use that to get the image and then divide that out from the second component in order to recover n as shown.

Referring now more specifically to FIG. 38B, the explanation will be substantially similar to that already presented with reference to FIG. 21A, with the difference being the additional case, b=2, that allows g^{x} to be checked by the second party. Initially, a single node is considered for clarity and concreteness and it has a single public key, denoted as h^{k}, which may be said to be the modular reduction of the generator h when k is applied in the exponent, as will be understood. Both parties know the public keys of the nodes (or pseudonymous public keys). The first party is shown having a sort of public key, g^{s}. (These can be in various protocols, such as those described elsewhere here, a value known to have an exponent, which is secret to some parties, but that is the value needed to for instance participate in computing a signature, such as in an elliptic curve system, to move value that is controlled by knowledge of typically a set of such secret exponents; an example is believed the s(i) of Gennaro et al included here with reference to FIG. 14.)

In a first message in the example, shown being sent by the first party to the second party, has five exemplary elements in the group shown: the first is the generator g to the first random power x; the second is a generator h to the power that is the image of the second random number u under a one-way function ƒ (for convenience and completeness the pre-images can be taken as group elements and images as elements in the exponent group); the third element is similarly the second generator to the power that is the image of the third random number v under the one-way function; the fourth can be considered an encryption of the sum of the secret values s and x, known in the example to the first party, where encryption is by multiplication in the group by a generator raised to a what may be considered, as will be appreciated, as like a Diffie-Hellman key distribution power, the product to the node private key k and the image of the second random element; similarly, and finally, the fifth can be considered an encryption of the difference of the secret values, s and x, as again known in the example to the first party, where encryption is again by multiplication in the group by a generator, shown as h as an example raised to a power, the product to the node private key k and the image of the third random element.

Next the second party provides a so-called “challenge” bit b that is until this point ideally unpredictable to the first party.

In the case the challenge bit is 0, the first party sends the first pre-image, u, that for the second element sent in the first message. The second party checks that the second element sent was formed properly from the generator h and the one-way function ƒ of u. The second party also checks that the product of g^{s}, which is known to the parties as mentioned, and the value that should be the g^{x}, sent as the first element of the first message, does in fact form the correct power of g. This power should be the payload that was encrypted in the fourth element sent in the first message. The decryption of this payload is accomplished by the second party dividing out the generator h to a power. This power is computed as the public key raised to the image power.

In the case the challenge bit is 1, the first party sends the second pre-image, v, that for the third element sent in the first message. The second party checks that this third element sent was formed as the image properly from the generator and the one-way function ƒ of v. The second party also checks that the quotient of g^{s} and the value that should be the g^{x} does in fact form the correct power of g. This power should be the payload that was encrypted in the fifth element sent in the first message. The decryption of this payload is accomplished by the second party dividing out the generator h to a power. This power is computed as the public key raised to the image power.

The recovery of s by the owner of public key h^{k}, who knows the private key k, is not shown for clarity but will readily be understood as the decryption, using this private key, of both s+x and s−x, thereby yielding s as the sum of the two decryptions in the group of the exponents.

In the case the challenge bit is 2, the value of x is revealed by the first party allowing the correct form of the first component of the first message to be checked, as shown, by the second party. While this case may or may not be needed, it is believed that at least it can help with analysis and is safe to include.

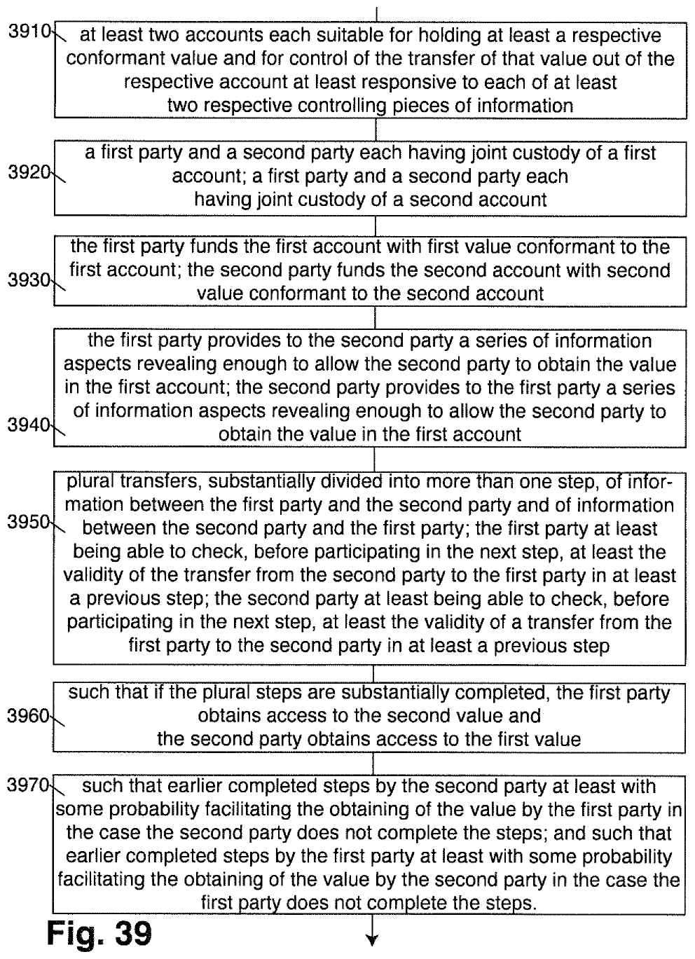

Turning to FIG. 39, exemplary detailed flowchart, cryptographic protocol, and block diagrams for overall swap systems and variations are illustrated in accordance with aspects of the teachings of the invention.

Referring first here more specifically to FIG. 39, in box 3910, it may here be said that “at least two accounts each suitable for holding at least a respective conformant value and for control of the transfer of that value out of the respective account at least responsive to each of at least two respective controlling pieces of information” to mean any means or method for maintaining accounts, such as on a distributed ledger or otherwise, whose value is controlled by the first and second parties, respectively.

Referring to box 3920, it may here be said that “a first party and a second party each having joint custody of a first account; a first party and a second party each having joint custody of a second account” to mean any means or method, such as cryptographic protocols where only through inputs of both parties are sufficient keys realized by the protocol and/or by smart-contract and/or logic built into a blockchain, and the configuration where both a first and second party information is needed to control each of the two accounts.

Referring to box 3930, it may here be said that “the first party funds the first account with first value conformant to the first account and the second party funds the second account with second value conformant to the second account” to mean that value is somehow transferred by whatever known means by the first party to the first account and by the second party to the second account.

Referring to box 3940, it may here be said that “the first party provides to the second party a series of information aspects revealing enough to allow the second party to obtain the value in the first account; the second party provides to the first party a series of information aspects revealing enough to allow the second party to obtain the value in the first account” to mean that information is passed between the parties in both directions and at multiple times such that after enough such transmissions the two parties each obtain enough information to gain enough control of the respective account, the first party of the second account and the second party of the first account.

Referring to box 3950, it may here be said that “plural transfers, substantially divided into more than one step, of information between the first party and the second party and of information between the second party and the first party; the first party at least being able to check, before participating in the next step, at least the validity of the transfer from the second party to the first party in at least a previous step; the second party at least being able to check, before participating in the next step, at least the validity of a transfer from the first party to the second party in at least a previous step” to mean that there are means and/or methods allowing the first and second party to each check that the transfers are properly formed and will ultimately lead to the control of the accounts.

Referring to box 3960, it may here be said that “such that if the plural steps are substantially completed, the first party obtains access to the second value and the second party obtains access to the first value” to mean that resulting from the transfers of box 3950 each of the two parties is able to obtain control of and/or access to the respective value in the two accounts.

Referring to box 3970, it may here be said that “such that earlier completed steps by the second party at least with some probability facilitating the obtaining of the value by the first party in the case the second party does not complete the steps; and such that earlier completed steps by the first party at least with some probability facilitating the obtaining of the value by the second party in the case the first party does not complete the steps” to mean that if a party does provide enough of the transfers but stops providing the transfers prematurely, then the other party has an ability to recover the value.

Turning to FIG. 36A-E, exemplary detailed cryptographic protocol, flowchart, block diagram and blockchain data diagrams for access tree structures are disclosed in accordance with aspects of the teachings of the invention. FIG. 36A is an “AND” node; FIG. 36B is an “OR” node; FIG. 36C is what can here be called here an “oblivious transfer” or “OT” node; FIG. 36D is what can here be called a “range reduction” or “RR” node; and FIG. 36E is an access tree from root to leaves.

Referring first particularly now to FIG. 36A, the “AND” node is shown abbreviated “AN” having two or more direct descendants (each of which may have any number of descendants as the root of a subtree, as will be understood generally here in this FIG. 36), as indicated by the ellipsis. An example direct descendant 3670 is shown for clarity. The value associated with the descendants are shown as s through u. As an example of how such a node can be formed, the product of the direct descendants is shown, such as in a group, so that in some examples nothing about the value n of the AND node is known until all the descendant values are combined with the group operation, shown as “·” in which case the value is fully revealed by forming the inverse and cancelling all factors but n.

Referring to FIG. 36B, an OR node is shown, much as with the AND node just described. A difference being that each and every of the direct descendants has a value suitable to achieve the value n of the OR node. For instance, but as just one example, a set of values can be publicly associated with the node that are each a combined using the group operation, in a suitable group, of a random value with the actual node value, shown as n·s.

Referring to FIG. 36C, an “oblivious transfer” or “OT” node for short is shown. The issuer of the access structure does not know some aspect of the OT node; however, the receiver of the access structure knows an aspect unknown to the issuer. For instance, the issuer can provide the receiver with a value that the issuer can prove cryptographically has a 50% probability of being the desired value w and a 50% probability of being zero, as is well known in the cryptographic art and literature. Thus, accordingly, the party providing the access structure is believed disadvantaged as it does not know whether or not the other party of the two has access to w. In some examples, w can be an AND node in a subtree where the other node is a restriction or particular party, as will be described with reference to FIG. 36D-E.

Referring now to FIG. 36D, a “range restriction” or “RR” node for short is shown. Such a node has in the example a single descendant, which has a value, such as n, at least sometimes unknown to the receiver of the access structure. Protocols to demonstrate, typically by the issuer to the receiver, that the secret value n has a more limited range or distribution of possible values than previously known to the receiver are known, such as those described here and referring to E. F. Brickell, D. Chaum, I. B. Damgard, & J. van de Graaf, titled “Gradual and verifiable release of a secret,” appeared in Advances in Cryptology CRYPTO '87, Springer-Verlag, pp. 156-166.

Referring finally on this sheet now to FIG. 36E, a whole example access tree structure 3665 is shown. The so-called “root” 3690, “R” for short, is shown as a pentagon with one or more direct descendants. Ellipsis indicate that there may be many nodes forming a directed graph of nearly whatever shape; however, the leaves are shown as squares, such as 3680.

A first type of leaf is can be regarded as an access rule in itself, shown as what may be called trustee party T, that has in the example for clarity received an encrypted value of key k, that is encrypted with encryption operator e, using key s; thus, the trustee would be contacted and provided s in order to allow it to provide the leaf value k.

A second type of leaf can here be called a “commitment,” “C” for short, is shown as an encryption of a value committed to using a public key encryption system 3675 such as discrete log modulo a prime, as will be understood: k\hat{ }x(mod p).

Turning to FIG. 37, exemplary detailed flowchart, cryptographic protocol, and block diagram for access tree structure traversal is provided in accordance with aspects of the teachings of the present invention. In some examples the process can be used to form an access tree; in other examples it can be used to attempt to compute the root value from leaves that have been issued.

Referring specifically first to start box 3710, the process is shown as a loop. In some example executions only those steps that can be executed are and the other steps skipped over for that pass through; however, skipped steps may be executed in subsequent passes.

Box 3720 shows the handling of an example AND node by either: determining n from the product of all the s through u, n·s· . . . ·u/s· . . . ·u, as explained already with reference to FIG. 36A; or by releasing the product n·s· . . . ·u in forming the tree.

Box 3730 shows the handling of an example OR node by either: determining n from any one of the sn through un, as explained already with reference to FIG. 36B; or by releasing the n·s, . . . , n·u in forming the tree.

Box 3740 shows the handling of an example OT node by either: determining n from any one of the s through u node values that were revealed with some probability, as explained already with reference to FIG. 36C; or by the issuer performing the oblivious transfer protocol to the recipient for each of the s through u node values with corresponding probabilities, as already explained with reference to FIG. 36C and to be described with reference to FIG. 38A.

Box 3750 shows the handling of an example RR node by either: performing the protocol as, already described with reference to FIG. 36D; or by exhaustive search of the reduced key space that an execution of the protocol proves contains the key, also as already described with reference to FIG. 36D.

Box 3760 shows the handling of an example RR node by either: during issuing providing the trustee with an encrypted key e(s,k); or by contacting the trustee and requesting k, such as would typically include checking of some condition and/or making some public notice by the trustee, as will be understood.

Box 3770 shows the handling of an example C node by either: during issuing providing the commitment, and optionally cryptographically proving its correctness by the issuer to the recipient, as already described with reference to FIG. 36E; or by verifying the so-called “opening” of the commitment, as is well known in the art.

Box 3790 is a branch. If the root R has been computed, when the aim of the traversal repetitions is to find it, the branch follows the “yes” leg and completes the process; if the traversal instance is part of building a tree, then it completes only once the tree is completed.

Turning to FIG. 38A-B, exemplary detailed cryptographic protocol, flowchart, and block diagrams for protocol examples provided in accordance with aspects of the teachings of the invention. FIG. 38A is an oblivious transfer protocol for an OT node; FIG. 38B is proof of encrypted share protocol.

Referring first more specifically now to FIG. 38A, a first party is believed able to obliviously provide n to a second party, with probability 50%, but without the first party knowing whether the second party received n. The first party (on the left) is shown creating two values at random: a bit b and a residue z in the exponent group modulo a large prime p of a discrete log system, as will be understood; similarly, the second party also creates two random values from the same respective distributions, a and x.

In the first arrow, the first party sends r and r^{z} to the second party (all numbers except bits are modulo p, as will be understood).

Next, as indicated by the curly bracket notation, the second party sends one of two pairs. In case the random a=0, then the pair is g^{x}, h^{x}; however, in case the random a=1, then the order of the pair is reversed, h^{x}, g^{x}.

As the final of the three messages shown, the first party sends b and one of two message pairs: if b=0, then the pair g^{z},ƒ([2.1]^{z})ₙ; however, if b=1, then the first party instead sends the pair h^{z}, ƒ([2.2]^{z})n.

Now the second party can compute n in the case that both a=b and otherwise the second party is believed unable to recover n from this protocol. This is the oblivious aspect. So, if and only if b is equal a, then the second party can raise the first component of the second message to the x power and obtain the pre-image for the one-way function ƒ, and then use that to get the image and then divide that out from the second component in order to recover n as shown.

Referring now more specifically to FIG. 38B, the explanation will be substantially similar to that already presented with reference to FIG. 21A, with the difference being the additional case, b=2, that allows g^{x} to be directly checked by the second party. Initially, a single node is considered for clarity and concreteness and it has a single public key, denoted as h^{k}, which may be said to be the modular reduction of the generator h when k is applied in the exponent, as will be understood. Both parties know the public keys of the nodes (or pseudonymous public keys). The first party is shown having a sort of public key, g^{s}. (These can be in various protocols, such as those described elsewhere here, a value known to have an exponent, which is secret to some parties, but that is the value needed to for instance participate in computing a signature, such as in an elliptic curve system, to move value that is controlled by knowledge of typically a set of such secret exponents; an example is believed the s(i) of Gennaro et al included here with reference to FIG. 14.)

In a first message in the example, shown being sent by the first party to the second party, has five exemplary elements in the group shown: the first is the generator g to the first random power x; the second is a generator h to the power that is the image of the second random number u under a one-way function ƒ (for convenience and completeness the pre-images can be taken as group elements and images as elements in the exponent group); the third element is similarly the second generator to the power that is the image of the third random number v under the one-way function; the fourth can be considered an encryption of the sum of the secret values s and x, known in the example to the first party, where encryption is by multiplication in the group by a generator raised to a what may be considered, as will be appreciated, as like a Diffie-Hellman key distribution power, the product to the node private key k and the image of the second random element; similarly, and finally, the fifth can be considered an encryption of the difference of the secret values, s and x, as again known in the example to the first party, where encryption is again by multiplication in the group by a generator, shown as h as an example raised to a power, the product to the node private key k and the image of the third random element.

Next the second party provides a so-called “challenge” bit b that is until this point ideally unpredictable to the first party.

In the case the challenge bit is 0, the first party sends the first pre-image, u, that for the second element sent in the first message. The second party checks that the second element sent was formed properly from the generator h and the one-way function ƒ of u. The second party also checks that the product of g^{s}, which is known to the parties as mentioned, and the value that should be the g^{x}, sent as the first element of the first message, does in fact form the correct power of g. This power should be the payload that was encrypted in the fourth element sent in the first message. The decryption of this payload is accomplished by the second party dividing out the generator h to a power. This power is computed as the public key raised to the image power.

In the case the challenge bit is 1, the first party sends the second pre-image, v, that for the third element sent in the first message. The second party checks that this third element sent was formed as the image properly from the generator and the one-way function ƒ of v. The second party also checks that the quotient of g^{s} and the value that should be the g^{x} does in fact form the correct power of g. This power should be the payload that was encrypted in the fifth element sent in the first message. The decryption of this payload is accomplished by the second party dividing out the generator h to a power. This power is computed as the public key raised to the image power.

The recovery of s by the owner of public key h^{k}, who knows the private key k, is not shown for clarity but will readily be understood as the decryption, using this private key, of both s+x and s−x, thereby yielding s as the sum of the two decryptions in the group of the exponents.

In the case the challenge bit is 2, the value of x is revealed by the first party allowing the correct form of the first component of the first message to be checked, as shown, by the second party. While this case may or may not be needed, it is believed that at least it can help with analysis and is safe to include.

Turning to FIG. 39, exemplary detailed flowchart, cryptographic protocol, and block diagrams for overall swap systems and variations are illustrated in accordance with aspects of the teachings of the invention.

Referring first here more specifically to FIG. 39, in box 3910, it may here be said that “at least two accounts each suitable for holding at least a respective conformant value and for control of the transfer of that value out of the respective account at least responsive to each of at least two respective controlling pieces of information” to mean any means or method for maintaining accounts, such as on a distributed ledger or otherwise, whose value is controlled by the first and second parties, respectively.

Referring to box 3920, it may here be said that “a first party and a second party each having joint custody of a first account; a first party and a second party each having joint custody of a second account” to mean any means or method, such as cryptographic protocols where only through inputs of both parties are sufficient keys realized by the protocol and/or by smart-contract and/or logic built into a blockchain, and the configuration where both a first and second party information is needed to control each of the two accounts.

Referring to box 3930, it may here be said that “the first party funds the first account with first value conformant to the first account and the second party funds the second account with second value conformant to the second account” to mean that value is somehow transferred by whatever known means by the first party to the first account and by the second party to the second account.

Referring to box 3940, it may here be said that “the first party provides to the second party a series of information aspects revealing enough to allow the second party to obtain the value in the first account; the second party provides to the first party a series of information aspects revealing enough to allow the second party to obtain the value in the first account” to mean that information is passed between the parties in both directions and at multiple times such that after enough such transmissions the two parties each obtain enough information to gain enough control of the respective account, the first party of the second account and the second party of the first account.

Referring to box 3950, it may here be said that “plural transfers, substantially divided into more than one step, of information between the first party and the second party and of information between the second party and the first party; the first party at least being able to check, before participating in the next step, at least the validity of the transfer from the second party to the first party in at least a previous step; the second party at least being able to check, before participating in the next step, at least the validity of a transfer from the first party to the second party in at least a previous step” to mean that there are means and/or methods allowing the first and second party to each check that the transfers are properly formed and will ultimately lead to the control of the accounts.

Referring to box 3960, it may here be said that “such that if the plural steps are substantially completed, the first party obtains access to the second value and the second party obtains access to the first value” to mean that resulting from the transfers of box 3950 each of the two parties is able to obtain control of and/or access to the respective value in the two accounts.

Referring to box 3970, it may here be said that “such that earlier completed steps by the second party at least with some probability facilitating the obtaining of the value by the first party in the case the second party does not complete the steps; and such that earlier completed steps by the first party at least with some probability facilitating the obtaining of the value by the second party in the case the first party does not complete the steps” to mean that if a party does provide enough of the transfers but stops providing the transfers prematurely, then the other party has an ability to recover the value.

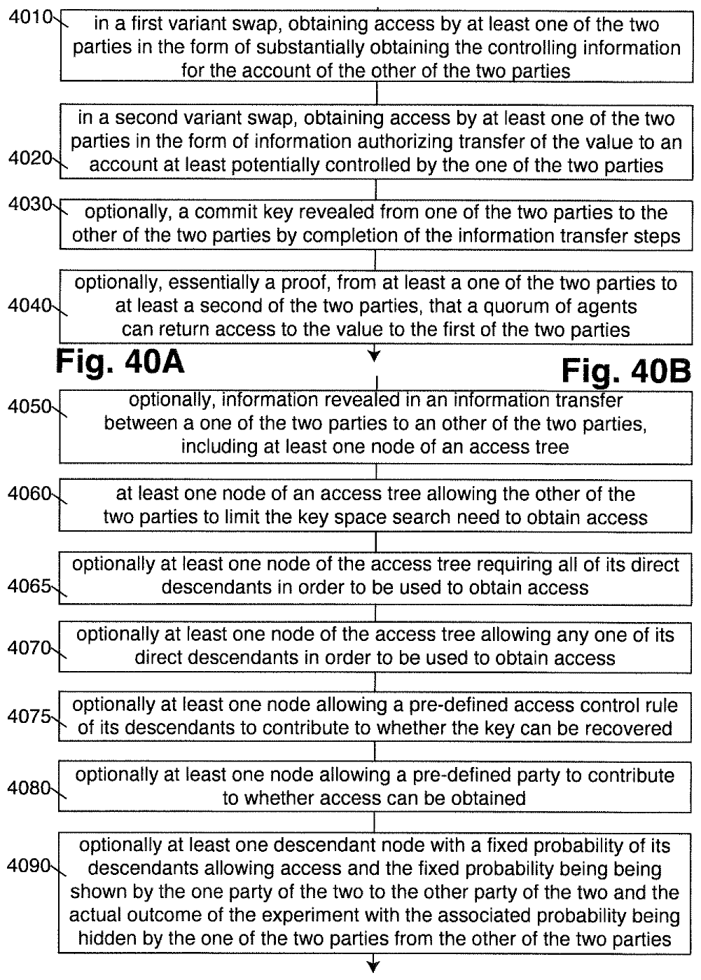

Turning now to FIGS. 40A-B, exemplary detailed flowchart, cryptographic protocol, and block diagrams for variations and enhancements of the overall swap are provided in accordance with aspects of the teachings of the invention. FIG. 40A is includes variants and also optional enhancements for commits and refunds; FIG. 40B includes an access tree steps and structure.

Referring first here more specifically to FIG. 40A, in box 4010, it may here be said that “in a first variant swap, obtaining access by at least one of the two parties in the form of substantially obtaining the controlling information for the account of the other of the two parties” to mean that in one variant of the swap described with reference to FIG. 39, the transfers from the first party to the second party, such as for example by including the portion of the information known to the first party for controlling the first account, give the second party sufficient information to control the first account, such as by combining with the information the second party has for joint control of the first account.

Referring to box 4020, it may here be said that “in a second variant swap, obtaining access by at least one of the two parties in the form of information authorizing transfer of the value to an account at least potentially controlled by the one of the two parties” to mean that in another variant of the swap described with reference to FIG. 39, the transfers from the first party to the second party are enough for an authorization to be released, such as a digital signature or other authenticated message, that instructs the account management system to transfer value from the first account to an account of the second party and/or an account controlled by the second party and/or an account otherwise selected or approved by the second party.

Referring to box 4030, it may here be said that “optionally, a commit key revealed from one of the two parties to the other of the two parties by completion of the information transfer steps” to mean that a key and/or other controlling authentication information is revealed, from one party to the other party, by the series of transmissions; in some examples, for instance, this can be the pre-image of an image under a cryptographic one-way function and/or a public key that has been associated with a “stake” or “deposit” or “security” account to at least temporarily lock it and then, when it is known and/or a suitable signature made with it is shown, the account can be unlocked.

Referring to box 4040, it may here be said that “optionally, essentially a proof, from at least a one of the two parties to at least a second of the two parties, that a quorum of agents can return access to the value to the first of the two parties” to mean that a party receives practically convincing evidence that the information they are provided, when provided to a corresponding set of refund agents, can allow the refund agents to refund the amount held in the corresponding joint custody account. As will be appreciated, this is believed to facilitate the transfer of value to the account by the party, as it provides a way to refund the amount in the case the other of the two parties does not complete the transfer process.

Referring next here more specifically to FIG. 40B, in box 4050, it may here be said that “optionally, information revealed in an information transfer between a one of the two parties to another of the two parties, including at least one node of an access tree” to mean that optionally, for instance, a root or other node of an access tree is provided by one party to the other party. Such a node allows access to the various descendants of that node in the tree according to the rule or procedure associated with each node in the path downward through the tree to the leaves, as will be understood.

Referring to box 4060, it may here be said that “at least one node of an access tree allowing the other of the two parties to limit the key space search need to obtain access” to mean any cryptographic protocol proof, such as a so-called zero knowledge and/or minimum disclosure, that convinces the receiving party that the key information lies in a particular limited range or has a probability distribution that is more restrictive than before such a proof. This, it will be understood, can in some examples it is believed allow the receiving party to mount an exhaustive search for the key.

Referring to box 4065, it may here be said that “optionally at least one node of the access tree requiring all of its direct descendants in order to be used to obtain access” to mean a sort of “and” node for which all the direct descendants combine, it is believed ideally in a group operation, to reconstruct the value for that node that it passes upwards in the tree or exposes as the root.

Referring to box 4070, it may here be said that “optionally at least one node of the access tree allowing any one of its direct descendants in order to be used to obtain access” to means a sort of “or” node for which any of the direct descendants can provide the value for that node that it then passes upwards in the tree or exposes as the root.

Referring to box 4075, it may here be said that “optionally at least one node allowing a pre-defined access control rule of its descendants to contribute to whether the key can be recovered” to mean, in some examples, a subtree rooted in the node that is made up of “and” and “or” nodes, to implement what is believed is whatever so-called “monotonic” function of the values of the leaves that may be desired, such structures being well known.

Referring to box 4080, it may here be said that “optionally at least one node allowing a pre-defined party to contribute to whether access can be obtained” to mean a node in an access tree that in some way indicates the party that can contribute the value needed for that node to provide access. In some examples the identity of the party can be obtained from the node definition; in other examples, as disclosed elsewhere here, the party may be identified only by pseudonym or otherwise unlinkably until a process is initiated to locate the party.

Referring to box 4090, it may here be said that “optionally at least one descendant node with a fixed probability of its descendants allowing access and the fixed probability being unlinkable shown by the one party of the two to the other party of the two and the actual outcome of the experiment with the associated probability being hidden by the one of the two parties from the other of the two parties” to mean that the one party of the two does not know whether the other party of the two obtains the key or other access-control value, but the other party of the two knows or is convinced (at least with some probability by cryptographic proof protocol or the like) that the first party of the two has actually made the value available with essentially that probability.

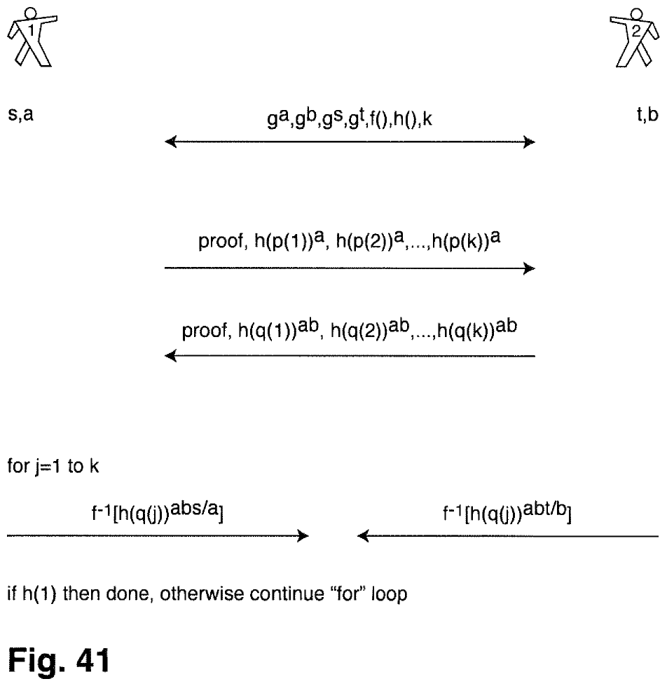

Turning to FIG. 41, an exemplary detailed cryptographic protocol, flowchart, and block diagrams for a probability-game release protocol is provided in accordance with aspects of the teachings of the invention. The first party is shown above the left side of the protocol and the second on the right; accordingly, as typical in the art, the arrows from the left show messages sent from the party first party to the second party and those to the right those sent by the second party to the first.

The notation used will be understood in the art as including residue classes in a cryptographically large group, ideally with high probability of random elements being generators, resulting in readily readable notation known in the art and as will be appreciated. The language of pseudocode is employed for clarity, as will also be appreciated.

The arrow with arrowheads on both ends is used here for clarity to collect together what are believed the main parameters and values that would be known to and agreed by the parties to the protocol, at least in some examples. In brief summary, as will be detailed below: each party has two secret exponents for two corresponding public keys and there are two agreed cryptographic functions and one main agreed parameter.

The public keys are shown for each party: the g^{a} for the first party and g^{b} for the second party may be more ephemeral than the g^{s} and g^{t}, the other two public keys for the two parties, respectively. In some examples, for concreteness and clarity but without limitation, as will be appreciated, these can be a public generator g raised to the secret exponent power modulo a cryptographically-suitable prime as are well known.

The function ƒ( ) shown is believed useful in causing delay in computing in that is difficult for a party to reduce to below some level. Cryptographic functions with similar purposes are known in the art, such as under the rubric of “delay functions” or “sequential work.” For example, the following work and its references are included here by reference as if copied in their entirety: Mohammad, Moran, and Vadhan, “Publicly Verifiable Proofs of Sequential Work,” 4th Conference on Innovations in Theoretical Computer Science, Berkeley, Calif., January 2012. For the present purposes, the delay is believed desirable to prevent a party from computing ƒ before submitting the corresponding image under ƒ inverse to the other party, at least within the agreed timing regime established for the protocol.

The function h( ), which can be taken to be a symmetric one-way function mapping group elements to group elements, for convenience here, is only an example way to produce a series of ideally at least likely generators of at least large subgroups with negligible probability of any multiplicative or other exploitable structure between the images of small integers. A distinguished image, such as h(1), may be defined to take any desirable value such as for compatibility with instances of other protocols, as will be appreciated for ultimate unlocking of value by the successful protocol completion case.

The values h(1)^{s} and h(1)^{t} are the secret values to be exchanged; before the protocol, h(1)^{s} may be known to party1 and h(1)^{t} to party2; however, after successful completion of the protocol, both parties will know h(1)^{s} and h(l)^{t}. Proof that these values can be used to recover other values committed to in various ways depending on the type of commitment, as known in the art, such as using the so-called Chaum-Pedersen proof of equivalent exponents.

The integer parameter k is used in the example as the agreed maximum number of instances that should occur in the simple example case where exactly one of the k instances is the what can here be called “matching value” guaranteed to yield the exchange of key values when it is selected by the iteration as will be described. Many other variations and examples are anticipated, such as where there is more than one possible matching value within the k instances and/or where the number of instances is changed during the iteration process and/or where the instances are accumulated. For clarity and concreteness, the example of a pre-defined k with single match, as will be appreciated, is described here.

The message is believed ideally in some examples proved, such as by an explicit proof sub-protocol indicated, to be of the form of the example shown on the remaining portion of the arrow from party1 to party2. The payload of that arrow uses a permutation p, which is a random permutation of the integers from one up to k, that is chosen by party1 as a random secret key. Each component of the vector of encryptions, performed in the example by exponentiation (modulo the agreed large prime as mentioned used throughout the example) with the secret key corresponding to the public key g^{a}, already described, is of an image under h, as already described, of the respective index integer. For example, the first payload element shown is the image of the integer p(1), which as will be understood can be any integer between one and k inclusive. The one-way function h is applied to what can here be called the “pre-image” p(1) to produce what can here be called the “image” h(p(1)); the resulting value is intended to be distinct and without known or exploitable structure relative to the other images as mentioned. Similarly, the second component has the image under h( ) with pre-image p(2), the additional k-3 values are indicated by the ellipsis, and the final value is indicated as having pre-image p(k).

Referring now to the third message, that shown sent from the part2 to party1, it is similarly made up of a proof about its own k elements or components of the k-tuple following the proof in the message. What is believed desirable to prove in this example is that each of these elements corresponds one-to-one with an element of the payload from party1 already described, and each component has been encrypted with the private key corresponding to the public key g^{b}. The re-arranged order in which these elements are included in the message is believed ideally similar to the first permutation, a secret permutation chosen roughly independently and uniformly at random, but in this case by and known to the second party. The function q(i) shows the integer input to the ith instance of h( ) in this message; it includes the mapping p(i) and is not known to the parties separately at this point but shown here for clarity. Consequently, as will be appreciated, which message component is the unique one in the example where q(i)=1, corresponding to h(1), the case that will be described below, is not known separately to the parties.

One example way, of which there are various known in the art, to accomplish the first proof and also even the second proof is by a so-called “cut and choose.” In a common and well-known type of approach, the first party commits to a table of values, each row of the table corresponding to one of the k-element vectors. The row number would parametrize the function h( ) and/or different encryption and/or blinding can be applied per row, as will be understood, to keep the rows essentially cryptographically independent. A simple example is where all but one row is opened by the first party to the second party for inspection by the second party and the unopened row is used further; this simple approach can also be applied by the second party in proving to the first party, as will be understood, when the second party generates a number of response vectors. It will be appreciated that the odds of successfully cheating with such a single-selected-row proof is about one in the number of rows and this can it is believed advantageously be adjusted to be comparable or less attractive to the odds of getting caught in a later stage that is believed in some examples to be about one in k. Accordingly, it is believed that a simple open-all-but-one style cut-and-choose can be used here, if desired.

A believed improved, though potentially what might be referred to as overkill, example version of the first proof is where the counterparty, or a beacon or the like, instead chooses half of the rows to be opened completely by the first party to the second party. After the selection the first party provides a partition of the components of all remaining row vectors according to, for instance, the first unopened row, where each partition is to contain the same pre-image under h( ). The second party can then multiply (or otherwise combine depending on an available structure of the cryptosystem) all the elements of each partition. In one example of a second proof, as will be understood, a table can be made from the result of the first proof and the first proof technique then applied to the resulting table after the second party permutes the position of the rows and also permutes within each row. With such proofs provision, as will readily be understood, would be made for the combined value of k(1) to recover the exchanged value key, such as for instance and updating of the access proof or values to include the new product of images.

The next section of the protocol is repeated potentially k times, and for each instance the value of j is increased by one, starting from 1 and ultimately reaching k in the example, as is indicated in pseudocode notation as was mentioned.

Two messages are shown with arrows pointing towards each other. This notation is intended to indicate that each of the two parties is to send a message at about the same time to the other party. The resolution and/or accuracy and/or precision and/or synchronization of the timing of these messages is ideally believed coordinated by protocols known in the art of realtime systems. An example would be to use real-time clocks that are themselves coordinated by known techniques. The function ƒ is selected, at least ideally, so that the amount of time believed at least needed to compute ƒ is roughly at least within the differences in time available to the parties when messages are exchanged within the limits imposed under the coordination regimes, as mentioned. It is believed that accordingly: when one party receives such a message, and the timing of the sending of the corresponding message by that one party is such that the other party is believed not to have had a chance to have computed ƒ before deciding the message that was received, the one party can accept the message.

The parties know j and they know the jth component of the third message (after the proof) and that is what the protocol example calls for use of as the basis for the transmissions in the jth iteration; which such component has q(j)=1 is believed to require cooperation of the parties to compute at this point. As indicated, the first party forms the message from the jth component of the third message k-tuple by including two powers and applying ƒ inverse to the result. The first power is the inverse of a in the exponent, to cancel the a that should be present. (The exponent a was already described when committed in the initial double-sided arrow and in forming the second message.) The second exponent is the secret power s, as committed to in the initial double-sided arrow already described. The inverse of the function ƒ, shown as ƒ⁻¹, is then applied, with scope as indicated by square brackets “[ ]”.

Similarly, as also indicated, the second party forms the message from the jth component of the third message by including the two corresponding secret powers and applying ƒ⁻¹ to the result. The first power is the inverse of b in the exponent, to remove the b, as already described with reference to the double-sided arrow and the third message. The second exponent is the secret power t, as already described as committed to in the initial double-sided arrow.

At this point in the loop iteration, each party can check, as indicated by the pseudocode shown “if k(1) then done,” whether or not this is the secret that they can use to complete the release or if it is one of the other k−1 that mean repeating. The way it is believed they can check is to remove their own exponent, a in the case of the party1 and b for party2, and then try the result to see if it opens the committed value already mentioned as known to each party. If the committed value is not opened, and parties have been conducting the protocol correctly, it is believed to mean that the h(1) is in another position in the third message's vector and the protocol should be repeated, as indicated by the pseudocode “otherwise continue ‘for’ loop.” A proof can be included with each message of an iteration, not shown for clarity, allowing the party to rule out the case that the counterparty has formed the message improperly. If a party does not send within the agreed timing regime and/or sends an improperly formed message, such as with no proof or an invalid proof, then the receiving party should stop the iteration process and, ideally, the offending party can be subject to penalty, such as fine and/or reputation harm.

In some examples, not shown for clarity, it may be desired for the protocol to be repeated less than k times and then re-run separately again, such as with a different h( ), in order keep the probability that q(j)=1 from growing too large. In other examples, as already mentioned, there may be more than one q(j)=1 in the vectors and this is believed to also limit the probability in almost all practical instances.

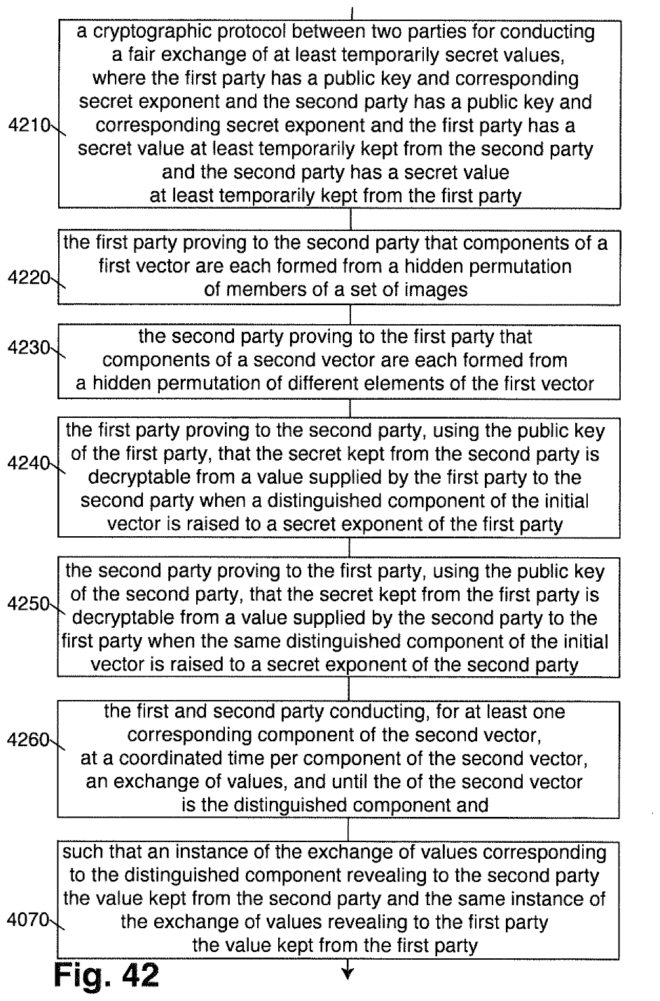

Turning to FIG. 42, exemplary detailed flowchart, cryptographic protocol, and block diagrams for overall fair swap is illustrated in accordance with aspects of the teachings of the invention.

Referring first here more specifically to FIG. 42, in box 4210, it may here be said that “a cryptographic protocol between two parties for conducting a fair exchange of at least temporarily secret values, where the first party has a public key and corresponding secret exponent and the second party has a public key and corresponding secret exponent and the first party has a secret value at least temporarily kept from the second party and the second party has a secret value at least temporarily kept from the first party” to mean any setup where each of the parties has at least a public key and a private key and each has a secret kept from the other party at least until some point in the protocol.

It will be understood, however, that the techniques shown here can extend to three or more parties.

Referring to box 4220, it may here be said that “the first party proving to the second party that components of a first vector are each formed from a hidden permutation of members of a set of images” to mean a cryptographic proof technique or the like whereby the first party can convince the second party, at least to a pre-arranged degree, that certain images are hidden in among a set of encrypted values, but which image is in which encrypted value remains a secret of the first party at least at this point in the protocol.

Referring to box 4230, it may here be said that “the second party proving to the first party that components of a second vector are each formed from a hidden permutation of different elements of the first vector” to mean any cryptographic proof technique used by the second party to adequately convince the first party that the second vector of encrypted values provided by the second party to the first party is of the correct or at least adequately the correct form.

Referring to box 4240, it may here be said that “the first party proving to the second party, using the public key of the first party, that the secret kept from the second party is decryptable from a value supplied by the first party to the second party when a distinguished component of the initial vector is raised to a secret exponent of the first party” to mean any suitable cryptographic proof that the vector is well formed at least in the sense that at least one of the elements when raised to a secret power corresponding to a public key of the second party will allow that first party to obtain the particular secret being kept by the first party from the second party usable to consummate the exchange of value.

The term “cryptographic proof” can be used h (anywhere here to include both what are sometimes referred to as interactive and/or non-interactive proofs, whether they are based in whole or in part on computational assumptions and/or are statistically convincing and whether and to whatever extent and under what assumptions they provide privacy of inputs.

Referring to box 4250, it may here be said that “the second party proving to the first party, using the public key of the second party, that the secret kept from the first party is decryptable from a value supplied by the second party to the first party when the same distinguished component of the initial vector is raised to a secret exponent of the second party” to mean any suitable cryptographic proof by the second party to the first party that the vector is well formed at least in the sense that at least one of the elements when raised to a secret power corresponding to a public key of the first party will allow that first party to obtain the particular secret being kept by the second party from the first party usable to consummate the exchange of value.

Referring to box 4260, it may here be said that “the first and second party conducting, for at least one corresponding component of the second vector, at a coordinated time per component of the second vector, an exchange of values, and until the of the second vector is the distinguished component” to mean any suitable loop or repeat protocol structure or step or system where each of the two parties provides information to the other of the two parties and where that information is related to a one of the elements of the third message vector selected mainly by or mutually randomly for the particular iteration.

Referring to box 4270, it may here be said that “such that an instance of the exchange of values corresponding to the distinguished component revealing to the second party the value kept from the second party and the same instance of the exchange of values revealing to the first party the value kept from the first party” to mean that when the instance of the iteration does correspond to at least a distinguished component the instance is believed to reveal to one party the information allowing access to the value to be exchanged, provided the information sent that one party were properly formed, and the information sent by the other of the two parties to the one of the two parties, provided it is correctly formed, allows access by the other of the two parties to the value exchanged.

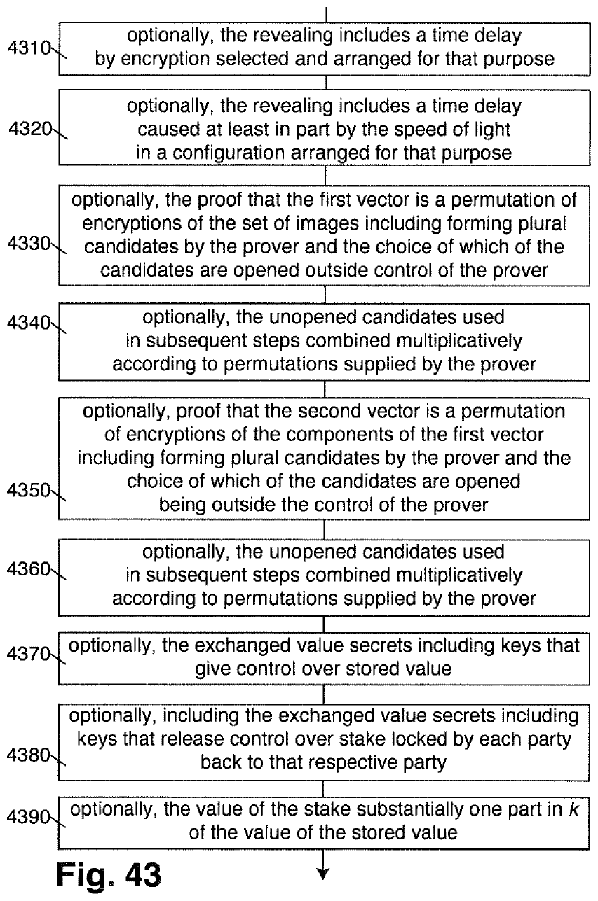

Turning to FIG. 43, exemplary detailed flowchart, cryptographic protocol, and block diagrams for overall fair swap is illustrated in accordance with aspects of the teachings of the invention.

Referring first here more specifically to FIG. 43, in box 4310, it may here be said that “optionally, the revealing includes a time delay by encryption arranged for that purpose” to mean that an amount of computation is believed built in to recovering the actual message content from the information exchanged that the amount of time to conduct that computation is arranged so that it is believed to take more time than would be needed to first conduct the computation, check the result, and then decide whether or not to send the information for that iteration to the counterparty so that it arrives in time according to the pre-arranged setup.

Referring to box 4320, it may here be said that “optionally, the revealing includes a time delay that is caused by the speed of light in a configuration arranged for that purpose” to mean that the physical distance and/or believed minimal communication path length between participants is such that the amount of time taken for information to travel between the participants is adequate to prevent one party from receiving information about a particular iteration and then providing the information for that same iteration to the other party in time according to the pre-arranged rules to be accepted by that other party as properly sent by the one party.

Combinations of communication delay and computational delay are also believed advantageously made.

Referring to box 4330, it may here be said that “optionally, the proof that the first vector is a permutation of encryptions of the set of images including forming plural candidates by the prover and the choice of which of the candidates are opened outside control of the prover”

Referring to box 4340, it may here be said that “optionally, the unopened candidates used in subsequent steps combined multiplicatively according to permutations supplied by the prover” to mean a proof technique that, as mentioned with reference to FIG. 42, includes combining elements from multiple vectors according to a partition schedule supplied by the counterparty once the particular vectors to be opened have been determined.

Referring to box 4350, it may here be said that “optionally, proof that the second vector is a permutation of encryptions of the components of the first vector including forming plural candidates by the prover and the choice of which of the candidates are opened being outside the control of the prover” to mean any cryptographic proof technique that opens many rows and the combines the remaining unopened rows as the output, where the combining is believed advantageously according to information not revealed to the counterparty until the selection of which rows have been opened.

Referring to box 4360, it may here be said that “optionally, the unopened candidates used in subsequent steps combined multiplicatively according to permutations supplied by the prover” to mean a proof technique that, as mentioned with reference to box 4340, includes combining elements from multiple vectors according to a partition schedule supplied by the counterparty once the particular vectors to be opened have been determined.

Referring to box 4370, it may here be said that “optionally, the exchanged value secrets including keys that give control over stored value” to mean that the information that each of the parties obtains when the iteration is of the distinguished component and the messages were properly formed then the parties each obtain keys or other information that gives them each access to the value that their respective counterparty has committed for the swap.

Referring to box 4380, it may here be said that “optionally, including the exchanged value secrets including keys that release control over stake locked by each party back to that respective party” to mean that in configurations anticipated elsewhere here where additional value, sometimes here called “stake,” is locked until a transaction is completed the exchanged value referred to here with reference to box 4370 and elsewhere is augmented to include information unlocking and/or otherwise allowing return of control of the stake to the party that controlled it before the protocol.

Referring to box 4390, it may here be said that “optionally, the value of the stake substantially one part in k of the value of the stored value” to mean coordination of two expected values so that at least a rational party will not be incentivized to cheat by improperly forming the communication of an iteration. On the one hand, if a party does improperly form the input, the other party is believed to be able to detect this and even to offer evidence of it in the form of a signature supplied by the party on the message; so, it is believed that the party forming the improper message will lose the stake almost certainly as a consequence of sending the message. On the other hand, if a party improperly forms a message, they may, if the distinguished element happens to have been chosen, be able to obtain the swap value from the counterparty while not giving access to the value they offered in swap. On the other hand, it may be difficult for the party to obtain this value back, even if it were not made available to the counterparty, but giving the benefit of the doubt, keeping the swap value with this probability. Accordingly, it is believed advantageous in some settings that, even with the benefit of the doubt, losing the stake costs more than would be made on average by cheating the particular iteration.

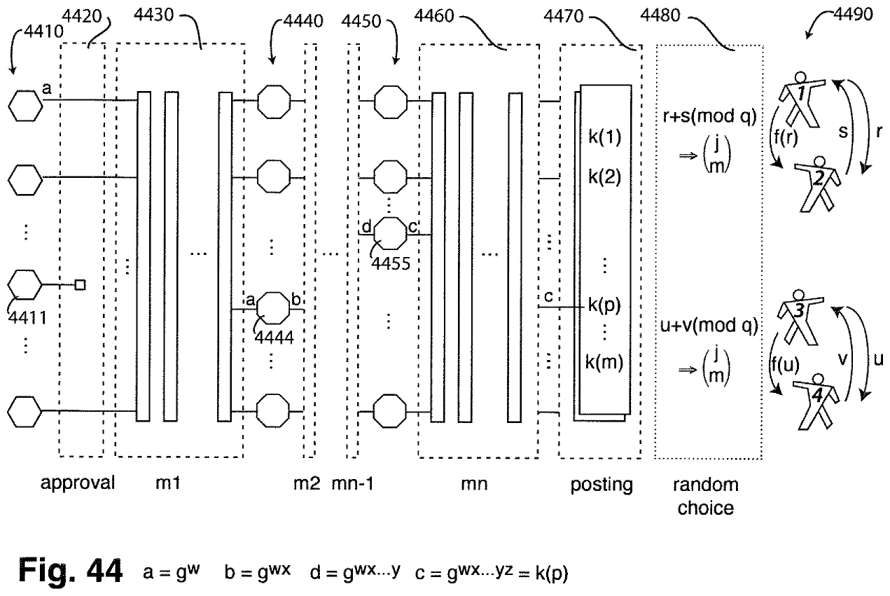

Turning now to FIG. 44, exemplary detailed cryptographic protocol, flowchart, block diagram and blockchain data diagrams for random selection of pseudonymous refund agents with intermediaries is presented in accordance with aspects of the teachings of the invention.

The left column 4410 is a set of candidate refund agents, each shown as a hexagon. They each submit to the approval process 4420, shown as the first dashed box vertical. In the example one candidate 4411 does not gain approval and does not pass through; this line ends in a small square. The approved agents each have a single input to the next dashed box, the first what is called here “mixing,” m1 4430. This can be a cascade of mixes, such were introduced by the present applicant and are well known in the art; each narrow vertical solid box can be operated as a so-called “mix node.” The output of this mix comprises items that were selected by approval 4420. These items are shown for clarity as lines that bring them each to a respective member of the first collection of intermediaries 4440, shown each as octagons though one or more in general may be the same entity. These intermediaries 4440 are shown between mixes m1 and m2. For clarity, m2 is shown as a dashed line only, without showing the example mix nodes as already shown and described with reference to mix 4430.

One example refund agent, the uppermost for clarity, is shown providing an input public key, denoted a. The value of this key is shown, in the formula key at the bottom of figure, as a=g^{w}. This can be taken to be, for instance, as will be understood, as a public key in a discrete log system where g is the generator and w is the exponent secret key. This value passes through the plural mix nodes, as indicated by the ellipsis, and emerges positioned for an intermediary 4444; which position has been obscured by the composition of the permutations of the mixes, as will be understood. The intermediary, which may cover one or more, up to all, such “messages” in the so-called “batch” of the mix 4430 output, receives the key from the first agent through the mix and transforms it into the value b, shown in the formula key as b=g^{wx}, by applying an exponent x that is secret to that intermediary 4444. This value is shown input then to mix m2.

The ellipsis between mix m2 and mix mn−1 can represent a series of intermediaries alternating with mixes, ultimately including n mixes. As will be understood, if there are no other intermediaries, the two mixes can be merged, but more generally there can be any number of mixes and intermediaries intermingled, where n−1 intermediaries would for instance make up an orderly alternating pattern.

The example value b passes through the plural mixes and intermediaries, as indicated by the ellipsis, and emerges in an example position 4455. The intermediary, which may again cover one or more, up to all, such “messages” in the so-called “batch” of the mix 4450, receives the public key d, d=g^{wxβ y} and transforms this message, by applying a secret exponent z, into the value c, shown in the formal key as c=g^{wx . . . yz}. This value is then shown emerging from mix mn 4460 at a randomized location and entering posting 4470 as k(p).

Next in temporal order, pairs 4490 of counterparties conduct cryptographic protocols to determine mutually random values. An example, similar to what has already been described with reference to FIG. 34, believed known in the prior art, is provided here for concreteness: party1 first applies a one-way function to r and provides the image under that function to party2, who replies with a random value s and then party1 provides the pre-image r; similarly, Party3 first applies a one-way to u and provides the resulting image to party4, who replies with a random value v and then party3 provides the pre-image u.

Dashed box posting 4470 indicates the results of the mixing being made available for use by counterparties and the like as k(i), i between 1 and m inclusive. The multiple planes are intended to indicate that multiple instances of the preceding can be used to compute multiple complete sets of refund agent 4410 pseudonyms; or, alternatively, larger collections that have higher multiplicities of agents can be used knowing that there may be some duplication, which will depend statistically on the actual sizes of subsets drawn, as will be understood.

Dashed box 4480 provides an example of how the values r and s are used to compute a random set of pseudonymous refund agents, similar to what has already been described with reference to FIG. 34. The two values are added and the result reduced modulo the number subsets that can be selected between. Then the subset can be computed from the residue class determined, by well known algorithms. This is shown symbolically, though non-standardly for clarity, using j choose k notation, to indicate j items selected from the collection of m public keys.

When a refund agent is to be contacted by a counterparty the value of the index i may it is believed here be assumed for clarity to already be known to the counterparty. One example general way to connect would be for the counterparty to publish i and mix mn 4460 would be run backwards by its nodes to recover the particular intermediary, who would remove the exponent, and the process would be repeated alliteratively back through all the intermediaries. In cases where there is only one exponent introduced by all the intermediaries that are between two mixes (such as when they are the same party as mentioned as an example earlier), then tracing back through mixes is believed avoided; in cases where there are a small number of intermediary parties and accordingly a small number of keys injected between mixes, a combinatorial exhaustive search through them could be conducted, giving a robustness advantage: many k(i) messages would still be useful even if one or a few intermediaries were not cooperating.

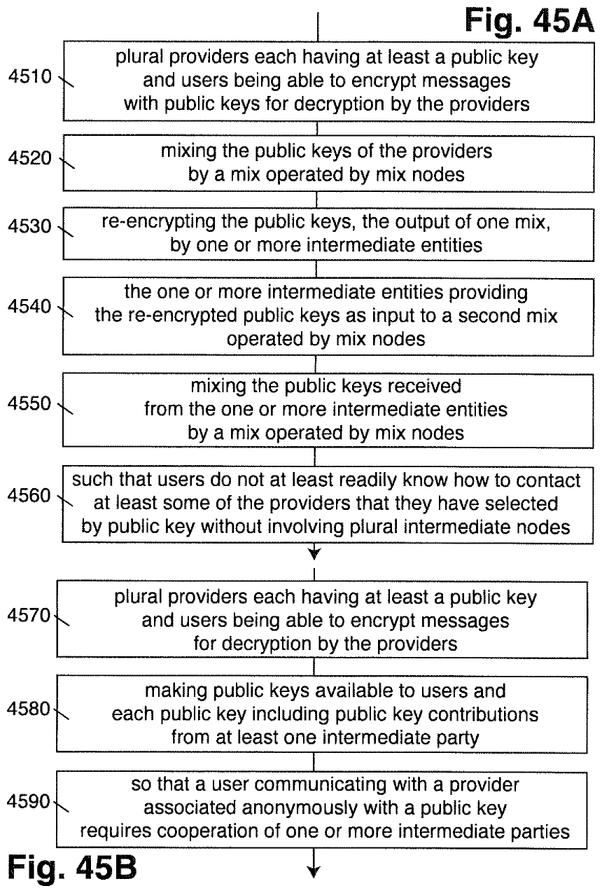

Turning to FIGS. 45A-45B, exemplary detailed flowchart, cryptographic protocol, and block diagrams for provider anonymity with intermediary systems and variations are illustrated in accordance with aspects of the teachings of the invention. FIG. 45A is one example description of insertion of intermediaries between providers and users; and FIG. 45B is a second example description of insertion of intermediaries between providers and users.

Referring first here more specifically to FIG. 45A, in box 4510, it may here be said that “plural providers each having at least a public key and users being able to encrypt messages for decryption by the providers” to mean any way to allow users to obtain public keys that can be used to encrypt data that can then be decrypted ultimately by an anonymous one of the providers, with cooperation of at least one intermediary party.

Referring to box 4520, it may here be said that “mixing the public keys of the providers by a mix operated by mix nodes” any way to hide the mapping between items in an input batch and an output batch, by permuting the items randomly and changing the encryption so that the change in order is not visible.

Referring to box 4530, it may here be said that “re-encrypting the public keys, the output of one mix, by one or more intermediate entities” to mean any way to modify the public key received originally from a provider entity so that it is no longer recognizable by the provider entity and the decryption of values encrypted with it is no longer readily performed by the provider entity.

Referring to box 4540, it may here be said that “the one or more intermediate entities providing the re-encrypted public keys as input to a second mix operated by mix nodes” to mean encryption of public keys so that keys of the party doing the encryption would apparently be needed to decrypt items that are later encrypted by the re-encrypted public keys.

Referring to box 4550, it may here be said that “mixing the public keys received from the one or more intermediate entities by a mix operated by mix nodes” to mean any way to hide any aspect of the correspondence between items in an input batch and the items in a respective output batch, by permuting the items ideally randomly independently and uniformly and changing the encryption so that the change in order is not visible, also as already described with reference to box 4520.

Referring to box 4560, it may here be said that “such that users do not at least readily know how to contact at least some of the providers that they have selected by public key without involving plural intermediate nodes” to mean any means or method whatsoever that inhibits and/or retards and/or delays and/or thwarts efforts of user to reach providers from the public keys without contacting at least a portion of the intermediary parties.

Referring now here more specifically to FIG. 45B and box 4570, it may here be said that “plural providers each having at least a public key and users being able to encrypt messages for decryption by the providers” to mean public keys that can be used to encrypt messages and where decryption of the messages requires cooperation of at least one such provider.

Referring to box 4580, it may here be said that “making public keys available to users each public key including public key contributions from at least one intermediate party” to mean that the public keys exposed to users include contribution from both at least one provider and at least one intermediary.

Referring to box 4590, it may here be said that “so that a user communicating with a provider associated anonymously with a public key requires cooperation of one or more intermediate parties” to mean that pub keys exposed to users include contributions from not only corresponding providers but also one or more intermediaries and that decryption requires cooperation of the corresponding provider and intermediary and/or that recognition of the public key by the provider at least in practice requires cooperation of the corresponding intermediary or intermediaries.

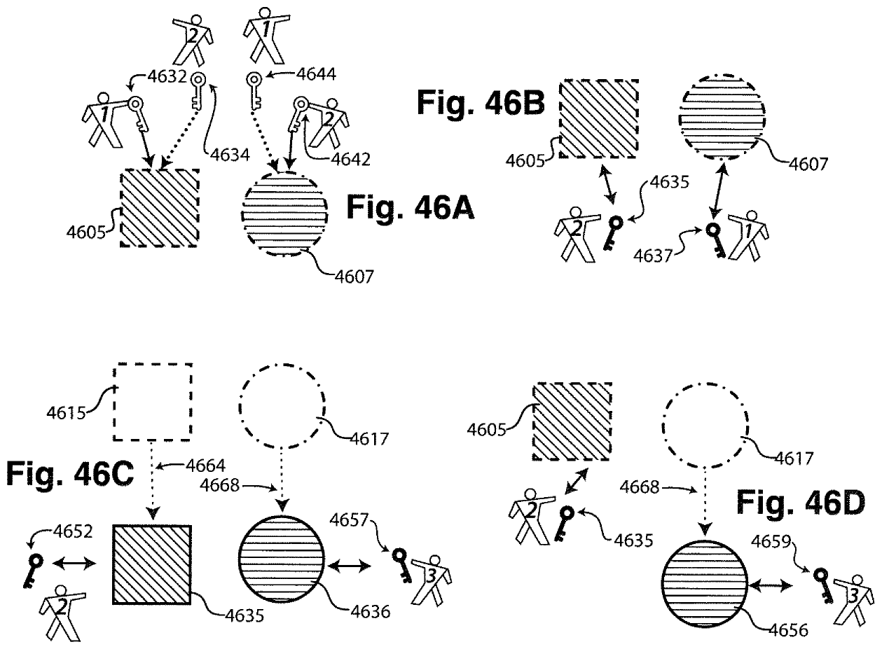

Turning to FIGS. 46A-46D, exemplary detailed cryptographic protocol, block diagram and ledger data diagrams for value swap and payment are presented in accordance with aspects of the teachings of the invention. FIG. 46A is the funding of two respective holding accounts; FIG. 46B is a swap by releasing control of the respective holding accounts; FIG. 46C is a swap releasing respective signatures for value transfer or a payment release one of the signatures to a payee; and 46D is a swap releasing one signature for value transfer and the other to holding account or a payment release one of the signatures to a payee and the other to a holding account.

Referring more specifically now to FIG. 46A, the funding of two respective holding accounts is shown. The first holding account 4605 is shown with joint custody between party1 using joint partial key 4632 and party2 using joint partial key 4634. Both partial keys are believed needed to move value from the account 4605, however, party1 is assumed here to have moved the value shown by the diagonal hatch into the custody account 4605, which account is shown with dashed lines.

The second holding account 4607 is shown with joint custody between party1 using joint partial key 4644 and party2 using joint partial key 4642. Both partial keys are believed needed to move value from the account 4607, however, party 2 is assumed here to have moved the value shown by the horizontal hatch into the custody account 4607, which account is shown with dot-dash lines.

Referring now to FIG. 46B, the holding accounts just described, 4605 and 4607, are shown having been used to affect a swap. The party2 now has a key 4635 that controls the ability to move value from the first holding account 4605, for example obtained by a mutual release protocol such as those described elsewhere here, for instance a mutual release protocol that fairly exchanges values committed to by the respective parties, as will be understood. Similarly, party1 now has a key 4637 that controls the ability to move value from the second holding account 4607, also for instance obtained by a mutual release protocol that fairly exchanges values committed to by the respective parties, as will be understood.

Referring next to FIG. 46C, a swap releasing respective signatures for value transfer or a payment release one of the signatures to a payee is shown. The first holding account 4615 and the second holding account 4617 are shown with value having been removed by first signature 4664 and second signature 4668. Accordingly, the value is shown in solid-line accounts, to distinguish from holding accounts, being accounts of the recipients of the value: party2 received the value in 4635 and has (in the example shown unilateral) control over moving all or part of it using signing key 4652, as will be understood; party3 received the value in 4636 and has (in the example shown unilateral) control over moving all or part of its using signing key 4657, as will be understood.

It will be understood that party3 can in some examples be simply another name for party1, which is believed would be consistent with a swap between party1 and party2, as described in detail variously elsewhere here. However, it will be appreciated that party3 can also be a true third party, distinct from party1 and party2. In some examples, advantageously, party three can be the payee and/or owner of the destination account of a payment made to party3 by party1. The type of value, or the choice of ledger, can be that selected and/or requested and/or determined by party3; however, the type of value, or the choice of ledger, available to party1 may differ. Accordingly, the swap with party2 allows party1 to translate and/or trade and/or swap the value type held into the value type for party3.

Referring finally here to FIG. 46D, a swap releasing one signature for value transfer and the other to a holding account or a payment release one of the signatures to a payee and the other to a holding account is shown. It will be appreciated that one portion of the transfer is by providing access directly to a holding account, which it is believed might not be as desirable for a third party, since checking that the former counterparties might not be able to have some ongoing access to the account is believed at least cumbersome and/or difficult and/or infeasible in some examples. Accordingly, the second portion of the transfer, that using the signature 4668 to move the value to account 4656 shown as for example exclusively controlled by party3 may be more practical and/or desirable.

For completeness, as will be appreciated, party2 receives value by obtaining control over holding 4605 shown dashed by key 4535; while party3, that may be the second party to a swap or the third party receiving payment, has control over account 4656 shown solid-line by key 4659, which obtained value from holding 4617, shown dot-dash, by signature 4668.

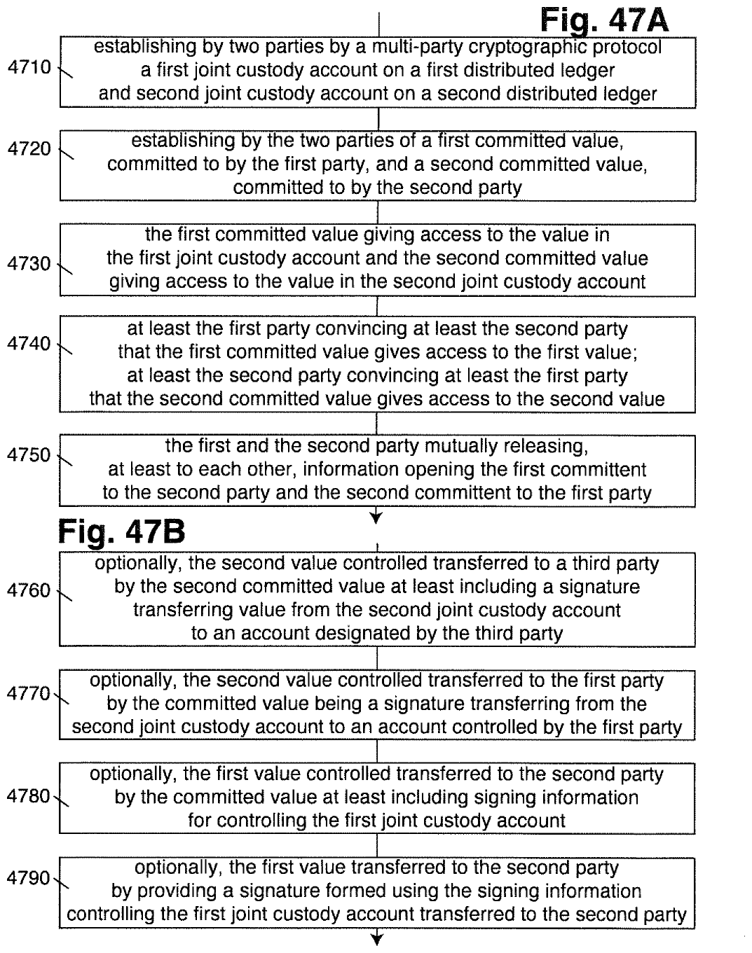

Turning now to FIGS. 47A and 47B, exemplary detailed flowchart, cryptographic protocol, and block diagrams for swap and/or payment are illustrated in accordance with aspects of the teachings of the invention. FIG. 47A is a swap between two parties; and FIG. 47B includes options and swaps between parties as well as for payments to third parties.

Referring first here more specifically to FIG. 47A, and in particular to box 4710, it may here be said that “establishing by two parties by a multi-party cryptographic protocol a first joint custody account on a first distributed ledger and a second joint custody account on a second distributed ledger” to mean any way whatsoever for two parties or groups or the like to use cryptographic techniques in combination with communication or related information to develop two walletID's or other types of accounts on blockchain ledgers or the like, where the accounts are what may here be called “joint custody” to mean that keying information generally from at least the two parties and/or controlled by the two parties can generally be required in order to move value from one or the other or both accounts.

Referring to box 4720, it may here be said that “establishing by the two parties of a first committed value, committed to by the first party, and a second committed value, committed to by the second party” to mean any cryptographic or other way for the parties two agree on information that in effect what may be said to “lock in” or commit to the parties some information.

Referring to box 4730, it may here be said that “the first committed value giving access to the value in the first joint custody account and the second committed value giving access to the value in the second joint custody account” to mean that in some way, such as by cryptographic signing keys and/or digital credentials and/or third party cooperation, the values committed to, respectively, give access to the joint custody accounts.

Referring to box 4740, it may here be said that “at least the first party convincing at least the second party that the first committed value gives access to the first value; at least the second party convincing at least the first party that the second committed value gives access to the second value” to mean that in some way, such as by a so-called zero-knowledge and/or minimum disclosure or other so-called cryptographic “proof,” whether interactive or non-interactive, that the values committed to would give access to the respective accounts.

Referring to box 4750, it may here be said that “the first and the second party mutually releasing, at least to each other, information opening the first commitment to the second party and the second commitment to the first party” to mean any way whatsoever that allows the parties to, with protection of whatever kind against one party releasing while the other party does not, mutually release the values committed to in effect to each other and/or otherwise so that the effect of such release is achieved.

Referring next to FIG. 47B, and more specifically to box 4760, it may here be said that “optionally, the second value controlled transferred to a third party by the second committed value at least including a signature transferring value from the second joint custody account to an account designated by the third party” to mean any way whatsoever that the signature transferring value to what may be called here “party3” or the “third party” is in effect a payment or other kind of value transfer to a party that was, at least optionally, not one of the two parties to the underlying swap or exchange, as will be understood.

Referring to box 4770, it may here be said that “optionally, the second value controlled transferred to the first party by the committed value being a signature transferring from the second joint custody account to an account controlled by the first party” to mean that in some examples the beneficiary of the transfer is the first party, at least generally the party or group of parties or interests or the like that participated in transferring the value to the second party through the holding account arrangement, as will be understood. Accordingly, this case differs from that described with reference to box 4760 in that the third party is one of the original parties.

Referring to box 4780, it may here be said that “optionally, the first value controlled transferred to the second party by the committed value at least including signing information for controlling the first joint custody account” to mean any means or method for transferring information related to the first joint custody account including by the first party to the second party where the information is related to the committed information and where the information in effect gives control of transfers out of the first custody account to the second party.

Referring to box 4790, it may here be said that “optionally, the first value transferred to the second party by providing a signature formed using the signing information controlling the first joint custody account transferred to the second party” to mean any way to provide a signature or the like related to the first custody account that in effect by whatever means or method causes and/or allows value to be transferred from the first custody account to an account controlled by and/or associated with the second party or related parties.

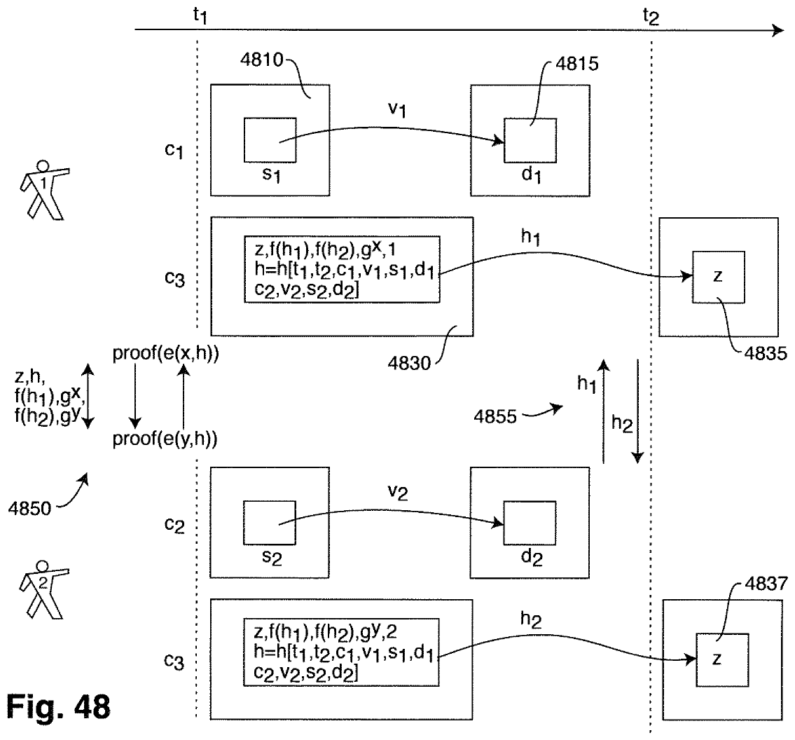

Turning to FIG. 48, exemplary detailed cryptographic protocol, block diagram and ledger data diagrams for value swap and payment are presented in accordance with aspects of the teachings of the invention. The timeline is shown across the top with times t₁ and t₂ indicated, such as block heights and/or real times, and also by descending dashed lines for clarity, as will be appreciated. The first party, party1, is shown controlling wallets on two blockchains, c₁ and c₃; similarly, party2 is controlling wallets on the chains to its right, c₂ and c₃; where c₃ is the same blockchain used by both party1 and party2. For instance, shown is block 4810 on chain c₁ including wallet s₁ after t₁ and before t₂. In a believed advantageous exemplary use, party1 that can be called “payer” is to pay a party5 that can be called “payee,” not shown for clarity, by transferring an amount v₂ on c₂ to d₂.

The block 4830 of blockchain c₃ is shown containing the following exemplary values: the what may be called “stake” z for the transaction; the images under one-way ƒ of h₁ and h₂, used for unlocking the value z on settlement; a public key, formed for instance as the secret key power x of the generator g in the Diffie-Hellman discrete log group, as will be understood; the integer one, used as a tag to indicate that this is the first of the two related wallets on c₃ so its parameters are the first set in the list to be described; and the image under hash function h( ) of the parameters, defined by the equal sign and shown for clarity as h.

The exemplary parameters include: the first and second times, t₁ and t₂, respectively; indication of first blockchain c₁; the value v₁ to be moved on the first blockchain; the source address s₁ on the first blockchain; the destination address d₁ on the first blockchain; indication of second blockchain c₂; the value v₂ to be moved on the second blockchain; the source address s₃ on the second blockchain; and the destination address d₂ on the second blockchain.

The messages sent between party1 and party2 are shown in two collections, those 4850 sent before time t₁ and those sent after the transaction closes 4855. The first collection includes agreements on values including the parameters and two cryptographic proofs. The parameters agreed shown are: the backing amount z, the hash of the parameters, h, as defined in 4830, the two one-way function images used for locking, ƒ(h₁) and I(h₂) as well as the public keys, g^{x} and g^{y} as shown in the respective blocks of c₃.

The first proof, from party1, shown provided downward in the plane of the figure, to party2, is that a value provided is the encryption under e of the secret exponent x of party1 along with the parameters h. In some examples this can be using the techniques introduced with reference to FIG. 38B; this is believed to allow the “refund agent” or the like to decrypt with e, if time t₂ has already passed and the value v₁ not arrived at d₁, to access x and use it to move the value z to the possession of party2 and/or optionally to d₂. Similarly, the second proof, from party2, shown provided upwards, to party1, is that a value provided is the encryption under e of the secret exponent y of party2 along with the parameters h. Again, this is believed to allow the “refund agent” or the like receiving the message from party1 to, if time t₂ has already passed and the value v₂ not arrived at d₂, to access y and move the value z to the possession of party1 and/or value v₂ to d₂.

The messages show on the right, are what would be sent in it is believed the vast preponderance of cases, once both party1 and party2 see that the values v₁ and v₂ have arrived at their respective destinations d₁ and d₂. These pre-images, as will be understood, allow ready release of the lockup of the two wallets on chain c₃ and result, in some examples for clarity, in wallets 4835 and 4837 with just the value z unlocked on c₃ and free to be used separately by party1 and party2, respectively.

In some examples this release will not be allowed by c₃ until time t₂ has passed, at least not for party2 if party1 has a corresponding wallet on c₃; this is believed to advantageously allow the payee to supply the respective encryption proved to the respective party3 and/or party4 who should then by whatever means cause all or part of the value v to be converted from c₃ so that it can appear as v₂ on and be transferred on blockchain c₂ to d₂. In such advantageous uses, the payer can supply a version of the respective proof or proofs to the payee along with a proof by c₁ or c₂ that v is locked in a wallet referenced by the parameters in the hash related to the particular proof.

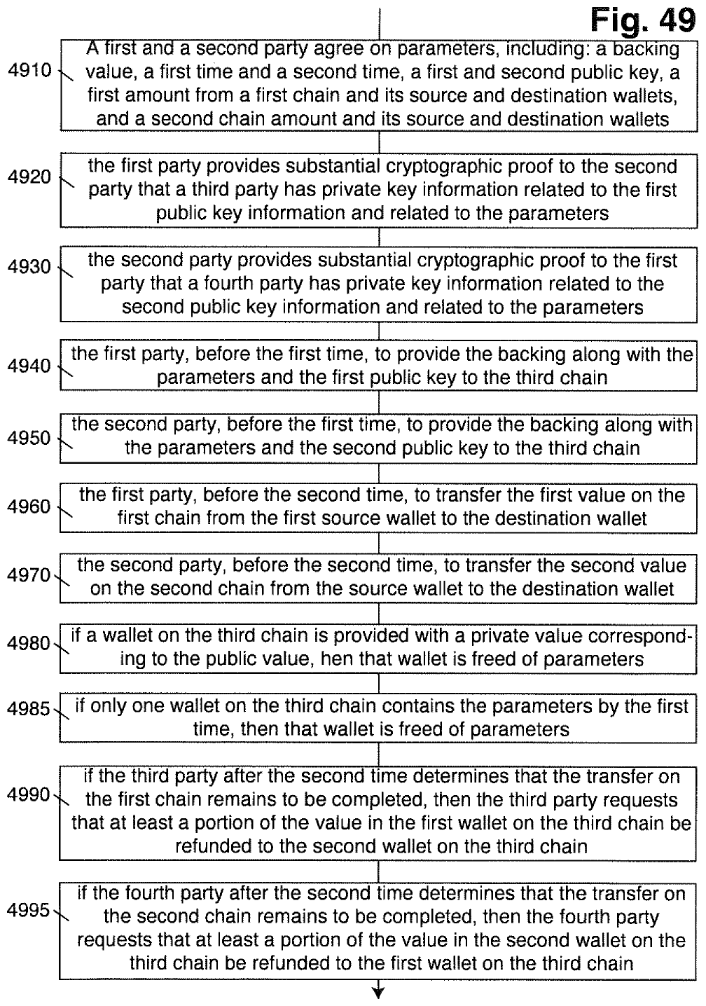

Turning to FIG. 49, exemplary detailed flowchart, cryptographic protocol, and block diagrams for provider anonymity with intermediary systems and variations are illustrated in accordance with aspects of the teachings of the invention.

Referring first here more specifically to box 4910, it may here be said that “a first and a second party agree on parameters, including: a backing value, a first time and a second time, a first and second public key, a first amount from a first ledger and its source and destination wallets, and a second ledger amount and its source and destination wallets” to mean that the parties agree on a set of values as indicated and described also with reference to the exemplary embodiment of FIG. 49.

Referring to box 4920, it may here be said that “the first party provides substantial cryptographic proof to the second party that a third party has private key information related to the first public key information and related to the parameters” to mean any kind of zero knowledge and/or minimum disclosure and/or other technique for giving from one party to another party any statistical and/or cryptographic confidence, and to whatever extent that confidence is agreed low or high, conviction and/or certainty about a fact, such as whether a particular public key can be used to decrypt a message and that the result of such decryption will be a value or values that are committed to and/or known to the parties, such as a private key and a hash of parameters.

Referring to box 4930, it may here be said that “the second party provides substantial cryptographic proof to the first party that a fourth party has private key information related to the second public key information and related to the parameters” to mean again, for instance, that a particular public key, such as of a fourth party and as described further for instance with reference to FIG. 44, can be used to decrypt a message and that the result of such decryption will be a value or values that are committed to and/or known to the parties, such as a private key and a hash of parameters.

Referring to box 4940, it may here be said that “the first party, before the first time, to provide the backing along with the parameters and the first public key to the third ledger” to mean that the first party in effect locks up some sort of agreed value on a blockchain ledger in such a way that it can primarily be unlocked only once the second party agrees, such as by providing a pre-image or other value that can be checked by that blockchain ledger as having come from that second party (or the fourth party(s) agree by providing something that could have mainly only come from that fourth party, such as a signature using a private key committed to by the first party).

Referring to box 4950, it may here be said that “the second party, before the first time, to provide the backing along with the parameters and the second public key to the third ledger” to mean that the second party in effect locks up some sort of agreed value on a blockchain ledger in such a way that it can primarily be unlocked only once the first party agrees, such as by providing a pre-image or other value that can be checked by that blockchain ledger as having come from that second party (or the fourth party(s) agree by providing something that could have mainly only come from that fourth party, such as a signature using a private key committed to by the second party).

Referring to box 4960, it may here be said that “the first party, before the second time, to transfer the first value on the first ledger from the first source wallet to the destination wallet” to mean any way that the first party can affect the first ledger to move the value between the accounts in a way that conforms to the parameters.

Referring to box 4970, it may here be said that “the second party, before the second time, to transfer the second value on the second ledger from the source wallet to the destination wallet” to mean any way that the second party performs or other ensures the occurrence of that conforms to the transfer described and/or indicated in the parameters.

Referring to box 4980, it may here be said that “if a wallet on the third ledger is provided with a private value corresponding to the public value, then that wallet is freed of parameters” to mean that a wallet on the third ledger in effect unlocks or otherwise allows the use of the value once it has received the private value; some examples include pre-images to images that are believed one-way functions; other examples include signatures or the like that evidence possession of and/or access to certain values. In some inventive aspects public information related to unlocking one wallet on the third ledger at least in some scenarios, such as the mutual unlocking in the expected case, is replicated on both ledgers so that if one is unlocked by this means the other is as well by the rule, for instance, that both pre-images must be shown to unlock either one.

Referring to box 4985, it may here be said that “optionally, if only one wallet on the third ledger contains the parameters by the first time, then that wallet is freed of parameters” to mean that a refund and/or other agent unlocks a wallet on the third ledger in case only the first wallet is funded.

Referring to box 4990, it may here be said that “if the third party after the second time determines that the transfer on the first ledger remains to be completed, then the third party requests that at least a portion of the value in the first wallet on the third ledger be refunded to the second wallet on the third ledger” to mean that the third party who obtains the private key information, such y, is to use it to sign a request to move the locked value and/or a portion of it, from the account of the party that did not complete the transaction, when that party is the second party, according to the parameters.

Referring to box 4920, it may here be said that “if the fourth party after the second time determines that the transfer on the second ledger remains to be completed, then the fourth party requests that at least a portion of the value in the second wallet on the third ledger be refunded to the first wallet on the third ledger” to mean that the third party who obtains the private key information, such x, is to use it to sign a request to move the locked value and/or a portion of it, from the account of the party that did not complete the transaction, when that party is the first party, according to the parameters.

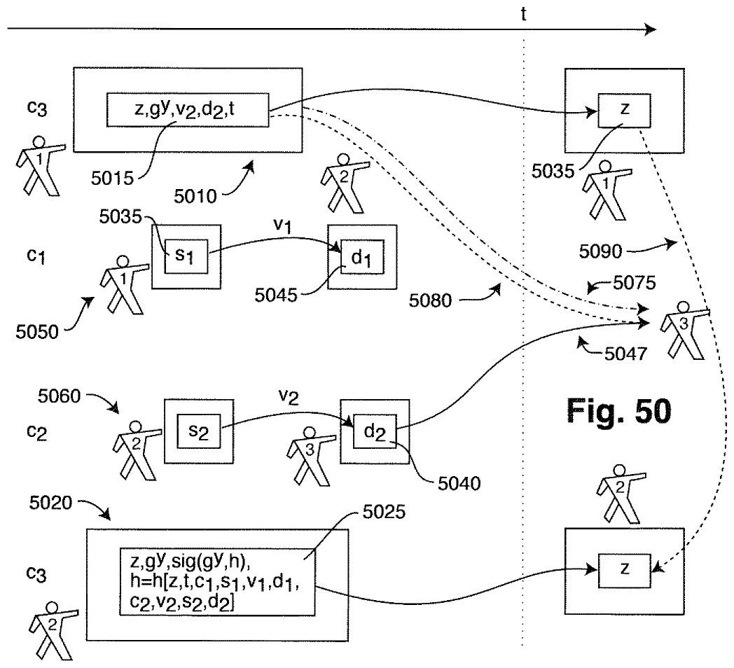

Turning now to FIG. 50, an exemplary detailed combination cryptographic protocol diagram, block diagram, flowchart and blockchain diagram for an immediate value transfer system with translation and variations will now be described in detail and in accordance with aspects of the teachings of the invention. A timeline is shown across the top; the three ledgers are shown with various wallet states horizontally, with the third ledger shown in portions on two rows; and counterparties are shown pictorially and distinguished by numbers.

Referring more specifically now to the drawing, time t is positioned at a point horizontally across the top, as indicated by the dotted vertical line. The three ledgers are labeled c3, c1 and c2, respectively, where example blocks 5010 and 5020 of c3 appear on different rows for clarity. The first ledger, c1, is intended to be where the first party 5050, party1, places the value v1 5035 that party is to move to a wallet 5045 of the second party. (It will be appreciated that the same party is shown multiple times for clarity at different temporal positions.) The second ledger, c2, is where the second party 5060, party2, is to move value v2 from a wallet of party2 to 5040 the wallet of party three, party3, that is to be in effect the recipient of the payment. It is expected that c1 and c2 are in general different, such as various currencies or “tokenized assets,” and so party1 is in effect paying party3 in a medium that party2 uses but is exchanging for the medium of c1 used to make the transfer to party2 by party1.

The third ledger, c3, is where party2 and party3 commit value v and to the parameters of the payment from party1 to party3 generally. More specifically, in the example, first party1 commits value z and reveals a public key g^{y} for which it has typically exclusive access to the secret signing key y, such as in a discrete log system as are well known. It is this public key that then, in the example, signs the block 5025 committed by party2, thereby tying the two wallets together. The tying together could also be achieved it is believed if the first wallet is formed after the first party knows the second c3 wallet information; however, in the example, the advantage of the arrangement shown is believed to be that party1 is able to get the commitment on the ledger and available for checking by party3 before the particular party2 has been found, identified and/or locked in. In other examples, as will readily be understood, party1 and party2 can agree before the posting to coordinate the transactions without the signature being in the second block, but for instance with an unsigned pointer in the first block to the second block.

To the right of the dotted vertical line party1 and party2 are shown receiving control back of their respective values v after the expected case confirmation of the entire transaction. Party3 is also shown there receiving the value d2 on the ledger, in the expected case, but in some cases may receive v or a portion of it instead as will be described.

The first ledger, as mentioned, is where party1 is to transfer from wallet 5035 containing s1 the value v1 to the wallet 5045 of party2 so that it contains d2. Similarly, party2 5060 is associated with wallet s2 and transfers the value v2 to wallet d2 5040 associated with party three, as indicated 5047. Accordingly, as will be appreciated, in this case party three receives the translated value v2 that party1 is paying to party3 on the ledger of and into the wallet of party3. The lower dashed arrow 5095 to party three on the right of the dotted line indicates that in other scenarios it may occur that party3 is to be compensated on c3, as will be explained.

The third ledger c3 is shown with three example kinds of wallet state. On the right, the wallets of party1 and party2 are shown with the original backing value v in them and without additional data, to indicate that each party can at this point access the value in their respective wallet; the value is no longer what may be called “locked up” or “backing” the transaction to party3. The first state of the wallet 5015 of party1 on c3 in block 5010 is shown with five example values: z, g^{y}, v2, d2, t. As mentioned, z is the backing value that is believed ideally in excess of the anticipated value of d₂ by some margin to allow for various contingencies, as will be described. The wallet contains the public key g^{y} as mentioned that allows signatures to be made by party1 and checked by anyone with access to c3. The actual value that party1 wishes to pay party3 is shown as v2. The wallet 5040 into which the value is to be paid to party3 is d2. The deadline time for the transaction, t, shown explicitly here can in some examples it is believed be implicit, such as a function of the so-called “block height” or realtime creation of the block 5010.

The second example wallet state 5025 for the third ledger in the second example block 5020 on c3 is show as including four values: z, g^{y}, sig(g^{y}, h), h. The backing value z has already been described and is shown also stored here as a value in this wallet of party2. The public key has already been described and its representation is simply copied here as will be understood; however, in some examples so-called key fingerprints could it is believed be used instead. What can be a so-called “public key digital signature” formed using the secret signing key y, as already mentioned, would typically be available to party1 and is shown on the value of h; this links the two wallets 5015 and 5025 and it may also be said in effect to authenticate the second wallet as being agreed upon by the owner of the first wallet 5015. The value h is a hash image under a function with the same name, h, or other cryptographic operation or even the identity function binding a set of parameters for the transactions, as will be understood. An example of the set of parameters is listed: h=h[z,t,c1,s1,v1,d1, c2,v2,s2,d2]. The first two, z and t, have already been described. The next four parameters are for the first ledger, c1, where value v1 is to be transferred by party1 from source walled s1 to destination wallet d1. Similarly, the last four parameters are for the second ledger, c2, where value v2 is to be transferred by party2 from source walled s2 to destination wallet d2 5040.

In exceptional cases, two additional flows of value are shown dashed line. In the first example case, value v or a portion thereof is taken dashed-line 5080 from party1 and provided to party3. In the second example case value v or a portion thereof is taken dashed line 5090 from party2 on ledger c3 to party1 on ledger3.

In operation, bringing together here temporal aspects as may have already been described for clarity as will be appreciated, first party1 commits to pay party3 by posting on c3 as shown. Then, optionally, party3 obtains from ledger c3 authenticated information, shown as dot-dash line 5075, related to the wallet 5015 of party1 that includes the amount v2, destination account d2, and optionally time t. This is believed to be in some examples an adequate “proof of payment” or at least a near equivalent that party3 can use in interacting with party1, as will be understood. In parallel, in advance, afterwards, and/or potentially never, party two is shown forming block 5020 on c3 that can be interpreted as accepting party1's proposition of party2 transferring v2 to d2 in exchange for v1 being provided by party1 to d1. At this point party2 has committed value z to the transaction and it is believed only receives it back after completing its part of the transaction; if it fails to complete its part, all or part of this value is sent 5090 back to party1, as will be described. The two wallets 5015 and 5025 of c3 shown are linked by g^{y}, and also by the signature, with that of party1 being the initiator because it has formed the signature and thereby agreed in effect to the second wallet 5025 as being tied to the first 5015. This signature also allows party1 to check and then binds party1 to the parameters of h, as already described. Pary1 and party2 can, in some examples, have found each other willing to make this arrangement through a bulletin-board matcher-node arrangement, as has already be described earlier.

If all goes according to the expected case, party1 moves v1 to d1 and party2 moves v2 to d2 and party3 learns 5075 that the value is present and the whole transaction completes at least for instance because by time t both c3 wallets 5015 and 5025 are unlocked, as shown right of the vertical dotted line as described. If, however, in one example, party3 finds it has not received value v2 in d2 by time t, then what may here also be called an “adjudicator” or multiple such parties, can be contacted by party3 to resolve the matter; similarly, if party2 finds that it has not received value v1 in wallet d1, presumably a default by party1, then party2 may contact one or more adjudicators. When adjudicators find in favor of the party that called them, then value can be moved on c3 in favor of the calling party (note that party3 is not shown having a wallet on c3 though it can have such a wallet and/or another party may translate the value to a wallet that it does have, as will be understood).

An adjudicator can be determined for this transaction in a predefined manner, as will be appreciated, such as by an indication being included in the wallet 5015 or by choice of one of the parties; however, the choice is believed more resistant to manipulation if the adjudicator is selected in a manner at least partly outside the control of the parties to the transaction. For instance, if the anonymous refund agent protocols already described are used, then the adjudicator can be a pseudonym entry in the final output batch that is a function of the ledger hash or random at a predefined time, such as at the block height of the initiating block 5010 as just one example. In some examples multiple or subsequent pseudonyms can be selected in a similar manner, such as in case of non-response and/or for corroboration and/or for redundancy.

It is believed that adjudicators can determine which of the two cases pertain by determining whether by time t the appropriate value was in fact in d1 or d2. If it was in both, then the transaction is believed to completed normally, as has already been described. But if it is in not in d2, then the decision should it is believed be in favor of party3 over party1 as indicated by arrow 5080. If value is in d2 but not in d1, then a decision should it is believed be in favor of party2 over party3 as indicated by arrow 5090, which can also be understood as emanating from wallet 5015 as with arrow 5080.

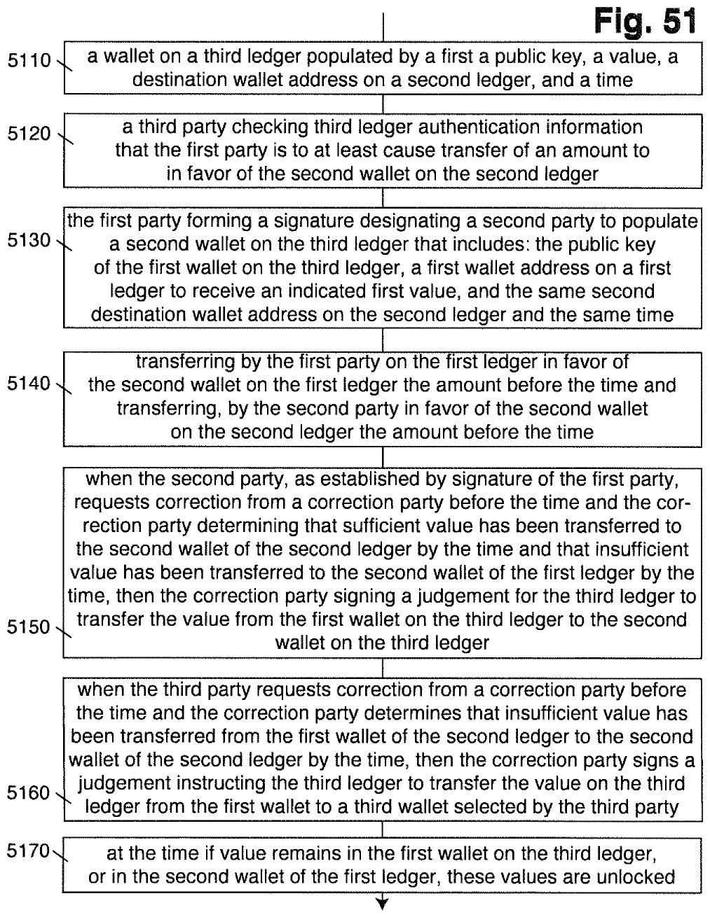

Turning to FIG. 51, exemplary detailed flowchart, cryptographic protocol, and block diagrams for an immediate value transfer system with translation and variations are illustrated in accordance with aspects of the teachings of the invention.

Referring first here more specifically to box 5110, it may here be said that “a wallet on a third ledger populated by a first a public key, a value, a destination wallet address on a second ledger, and a time” to mean that a blockchain and/or other ledger type includes a so-called “wallet” information portion that encodes values including a public key, backing value amount, a destination wallet address optionally on a second ledger and optionally a time however encoded, whether implicitly or explicitly.

Referring to box 5120, it may here be said that “a third party checking third ledger authentication information that the first party is to at least cause transfer of an amount in favor of the second wallet on the second ledger” to mean any verification by a third party and/or another related party that informs the third party that the backing value is in effect locked or held or escrowed on the third ledger in favor of the second wallet.

Referring to box 5130, it may here be said that “the first party forming a signature designating a second party to populate a second wallet on the third ledger that includes: the public key of the first wallet on the third ledger, a first wallet address on a first ledger to receive an indicated first value, and the same second destination wallet address on the second ledger and the same time” to mean that optionally, in case the second wallet on the third chain is not yet present, that the first party forms a public key signature and/or other suitable digital authentication to indicate that the first party is in accord with or otherwise supports the second wallet information on the third ledger.

Referring to box 5140, it may here be said that “transferring by the first party on the first ledger in favor of the second wallet on the first ledger the amount before the time and transferring by the second party in favor of the second wallet on the second ledger the amount before the time” to mean any means or method whereby transferring of value in effect caused by the first party in favor of the second party on the first ledger and any means or method whereby transferring of value in effect caused by the second party in favor of the second wallet on the second ledger.

Referring to box 5150, it may here be said that “when the second party, as established by signature of the first party, requests adjudication from an adjudication party before the time and the requested party determines that sufficient value has been transferred to the second wallet of the second ledger by the time and that insufficient value has been transferred to the second wallet of the first ledger by the time, then the adjudication party deciding that the third ledger is to transfer the value from the first wallet on the third ledger to the second wallet on the third ledger” to mean that however suitable adjudication party or parties are selected and accredited and authenticated, when requested by the second party and if it is determined that the first party did not transfer to the second party, but the second party did transfer to the second address, then value from the first party should be transferred in favor of the second party.

Referring to box 5160, it may here be said that when the third party requests adjudication from a party before the time and the requested party determines that insufficient value has been transferred from the first wallet of the second ledger to the second wallet of the second ledger by the time, then the adjudication party decides that the third ledger should transfer the value on the third ledger from the first wallet to a third wallet selected by the third party” to mean that however suitable adjudication party or parties are selected and accredited and authenticated, when a decision is rendered that the second wallet on the second ledger has not been properly funded by the established time, then the adjudication decision is that value should be transferred from the first party to the third party.

Referring to box 5170, it may here be said that at the time if value remains in the first wallet on the third ledger, or in the second wallet of the first ledger, these values are unlocked” to mean that absent adjudication moving these backing values they remain on the third ledger and at least after the time are unlocked and able to be used for whatever purposes such unlocked values are usable.

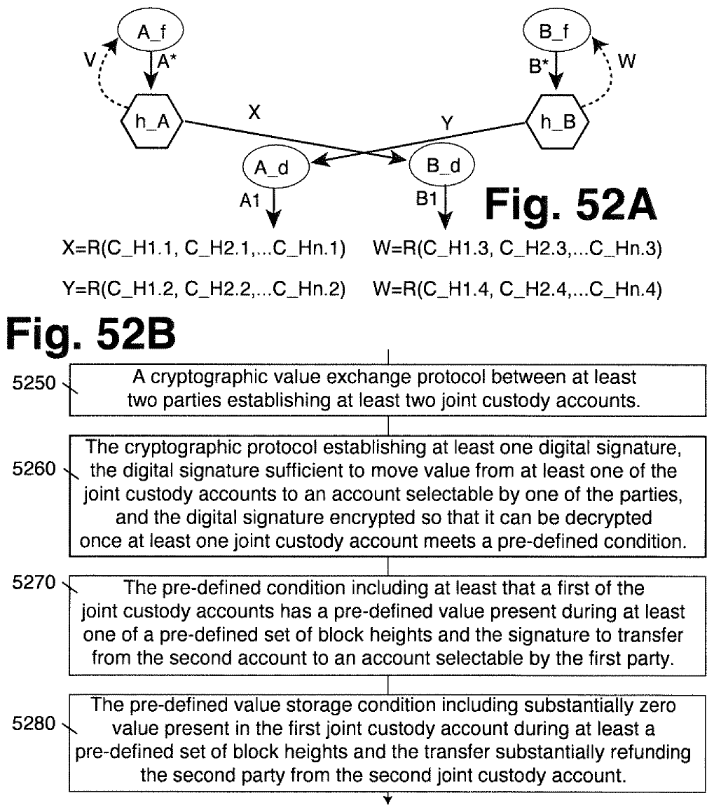

Turning now to FIGS. 52A and 52B, a combination cryptographic protocol diagram, block diagram, and flow chart for a cryptographic pre-defined value exchange protocol in accordance with aspects of the present invention. FIG. 52A shows the overall cryptographic protocols and exemplary formulas; FIG. 52B is a flowchart for aspects of the operation of FIG. 52A.

Referring more specifically now to FIG. 52A, the notation is first described.

Generally, the diagram is arranged temporally from top to bottom, with the first and second party shown labeled “A” and “B,” respectively. While the principal parties A and B can each be comprised of multiple entities in some examples, for clarity in presentation such possibilities are rarely mentioned. Elsewhere here the protections against at least one of the parties being able to easily and/or covertly contact and communicate with the refund agents has been addressed, since this can in some examples facilitate various types of abuses, such as have been mentioned and as will be understood. For instance, but without limitation, a quorum of refund agents, optionally and adaptively along with one or more parties, can be able to allow refund. In some examples, for instance, but without limitation, conditions can be based on information outside the cryptographic protocols, such as prices and/or market events, and are believed advantageous, without limitation, for such uses as various forward and/or futures contracts or the like.

The various shapes and various lines are included for clarity in exposition and suggest particular functions and/or uses, but without limitation. The ovals are intended for clarity to suggest accounts with the party controlling the respective account shown within the oval. Similarly, the hexagons are intended for clarity to suggest joint custody accounts created by the cryptographic protocol between the parties. There are various types of lines shown. The solid lines with arrowheads represent potential transfers of value on the respective ledgers from the one account at the tail to the other at the arrowhead end. The dashed lines, with arrowhead, are also for transfer of value, typically to suggest such transfers related to refund.

Labels accompany various lines to indicate for clarity the types of parties and/or conditions related to more than one party that allow in some examples the value transfer corresponding to the line. For instance, a party name, such as A or B, indicates that party can have information that allows it to, at least relatively easily, convince the corresponding ledger to move the corresponding value; in other cases, such as with X or Y, the parties can gain access to the signatures and cause the value to move as shown by the directed edge.

Referring more specifically to the figure now, each party is shown freely able to fund a respective holding account: A can use A* to fund h_A and B can use B* to fund h_B. The remaining four transfers, including transferring from h_A to B_d, h_B to A_d, h_A to A_ƒ, and h_B to B_ƒ, as shown, are each enabled by the cryptographic operation recovering the respective signatures, using the operation R, shown as X, Y, V, and W, respectively. The example cryptographic operation shown, without loss of generality, are the dividing of the respective signature reconstruction among “n” entities, shown as Hq.i, where q varies for the choice of X, Y, V, and W, and i varies for the multiplicity of the number of entities the respective division is among. Thus, R(C_H1.1, C_H2.1, . . . C_Hn.1) recovers the signature X from the quorum of the “H” parties, H1 through Hn, where these parties are, in some examples, instances of the party holding the public key H^{k} as already described with reference for instance to FIG. 21A.

Referring now more specifically to FIG. 52B, and more specifically to 2. 1, . . . box 5250, it may here be said that “a cryptographic value exchange protocol between at least two parties establishing at least two joint custody accounts” to mean whatever system and/or technique for at least two parties to exchange value, such as on ledgers and/or blockchains, where the one party starts with one value and the other party with the other value and at the end of the successful exchange control of the values is substantially interchanged between the parties.

Referring to box 5260, it may here be said that “the cryptographic protocol establishing at least one digital signature, the digital signature sufficient to move value from at least one of the joint custody accounts to an account selectable by one of the parties, and the digital signature encrypted so that it can be decrypted once at least one joint custody account meets a pre-defined condition” to mean that cryptographically at least one digital signature or other authentication technique is realized, in some form of protected state, that allows transfer or moving of all or part of the value out from at least one of the joint custody accounts to an account that can be chosen in advance and/or the choice modified by one of the parties, and only once a pre-defined condition on the value stored in at least one of the joint custody accounts is satisfied is the signature or the like in effect released so that it can be used to effect the transfer out from the joint custody account; examples include consensus of a set of nodes operating the blockchain on which the ledger is maintained, consensus of a potentially partly or fully different set of nodes, and/or a cryptographic proof.

Referring to box 5270, it may here be said that “the pre-defined condition including at least that a first of the joint custody accounts has a pre-defined value present during at least one of a pre-defined set of block heights and the signature to transfer substantially that value from the second joint custody account” to mean that the condition determines that of the accounts has sufficient value in it at least at some time or during some time interval, where the time interval can be in some examples, but is not limited to, the discrete times sometimes referred to as “block heights” to suggest the number of blocks in a blockchain since its genesis event, for instance, and in other examples can relate to calendar and/or clock time, as will be understood, and in other examples to time defined by events in asynchronous systems and/or their state.

Referring finally to box 5280, it may here be said that “the pre-defined value storage condition including substantially zero value present in the first joint custody account during at least a pre-defined set of block heights and the transfer substantially refunding the second party from the second joint custody account” to mean that, independent of whatever may relate to box 5270, and by whatever type of means or method including those mentioned with reference to box 5270, the value is absent the joint custody account sufficiently however defined so that the signature is released to allow the transfer from the other of the two accounts back in effect to the party that funded that account.

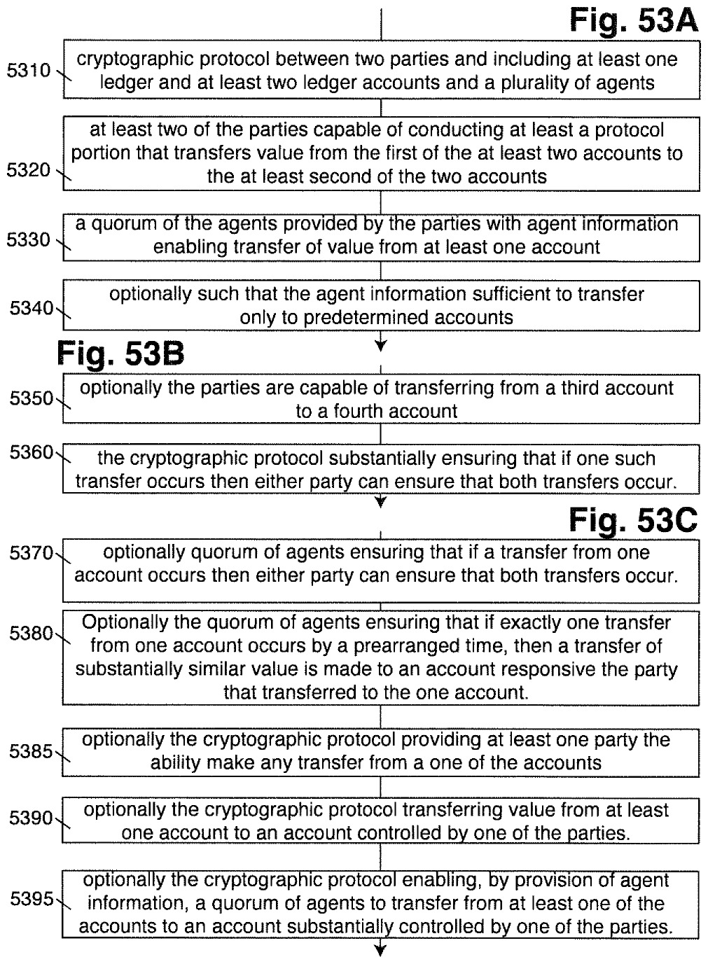

Turning now to FIGS. 53A-53B, exemplary detailed flowchart, cryptographic protocol, and block diagrams for swap and/or payment are illustrated in accordance with aspects of the teachings of the invention. FIG. 53A is a transfer from one account to another account; FIG. 53B is transferring from at least a second account to a third account; and FIG. 53C is verifiable fair exchange with pre-arranged and delegated and escrowed transfers.

Referring first here more specifically to FIG. 53A, and in particular to box 5310, it may here be said that “cryptographic protocol between two parties and including at least one ledger and at least two ledger accounts and a plurality of agents” to mean that there are at least two parties using a cryptographic protocol along with plural agents and at least some form of ledger such as a blockchain.

Referring particularly to box 5320, it may here be said that “at least two of the parties capable of conducting at least a protocol portion that transfers value from the first of the at least two accounts to the at least second of the two accounts” to mean that at least two of the parties are enabled by a cryptographic protocol to cause a transfer from one account to a second account, in whatsoever manner.

Referring particularly to box 5330, it may here be said that “a quorum of the agents provided by the parties with agent information enabling transfer of value from at least one account” to mean that the cryptographic protocol allows the parties to use the agent information, that is any suitable information responsive to plural agents, to empower whatever quora of the agents defined and/or modified, to transfer.

Referring particularly to box 5340, it may here be said that “optionally such that the agent information sufficient to transfer only to predetermined accounts” to mean that the quora of agents are able to transfer to predefined or otherwise limited or fixed by the parties and the cryptographic protocols.

Referring first here more specifically to FIG. 53B, and in particular to box 5350, it may here be said that “optionally the parties are capable of transferring from a second account to a third account” to mean that the parties can hand over from one of the parties to another party, possibly an unrelated party, the value in one of the accounts.

Referring particularly to box 5360, it may here be said that “the cryptographic protocol substantially ensuring that if one such transfer occurs then either party can ensure that both transfers occur” to mean that the protocol allows the parties to verify, at least to a degree of certainty and/or at least based on cryptographic assumptions, as will be understood by those of skill in the art, that the transfers are in effect linked in a manner that provides for one to complete if the other completes.

Referring first here more specifically to FIG. 53C, and in particular to box 5370, it may here be said that “optionally quorum of agents ensuring that if a transfer from one account occurs then either party can ensure that both transfers occur” to mean that a quorum of agents can be allowed by the protocol to provide either leg of the swap or exchange if the other leg has occurred.

Referring particularly to box 5380, it may here be said that “optionally the quorum of agents ensuring that if exactly one transfer from one account occurs by a prearranged time, then a transfer of substantially similar value is made to an account responsive the party that transferred to the one account” to mean that a first predefined account have a transfer made to it allows the cryptographic protocol to make a predefined corresponding transfer.

Referring particularly to box 5385, it may here be said that “optionally the cryptographic protocol providing at least one party the ability to make any transfer from a one of the accounts” to mean that the cryptographic protocol can, at a certain stage and/or under certain conditions and/or when in a certain state, allow a party to be provided enough additional information for that party to in effect at least make a transfer from that particular account. More generally, the party can in effect “control” that account from that point.

Referring particularly to box 5390, it may here be said that “optionally the cryptographic protocol transferring value from at least one account to an account controlled by one of the parties” to mean that the cryptographic protocol can allow a transfer to an account that is under control of one party, for instance once of the parties to the protocol.

Referring particularly to box 5395, it may here be said that “optionally the cryptographic protocol enabling, by provision of agent information, a quorum of agents to transfer from at least one of the accounts to an account substantially controlled by one of the parties” to mean that agent subsets satisfying a quorum rule can be sufficient to cause a transfer accounts of the parties to an account controlled fully by one of the parties.

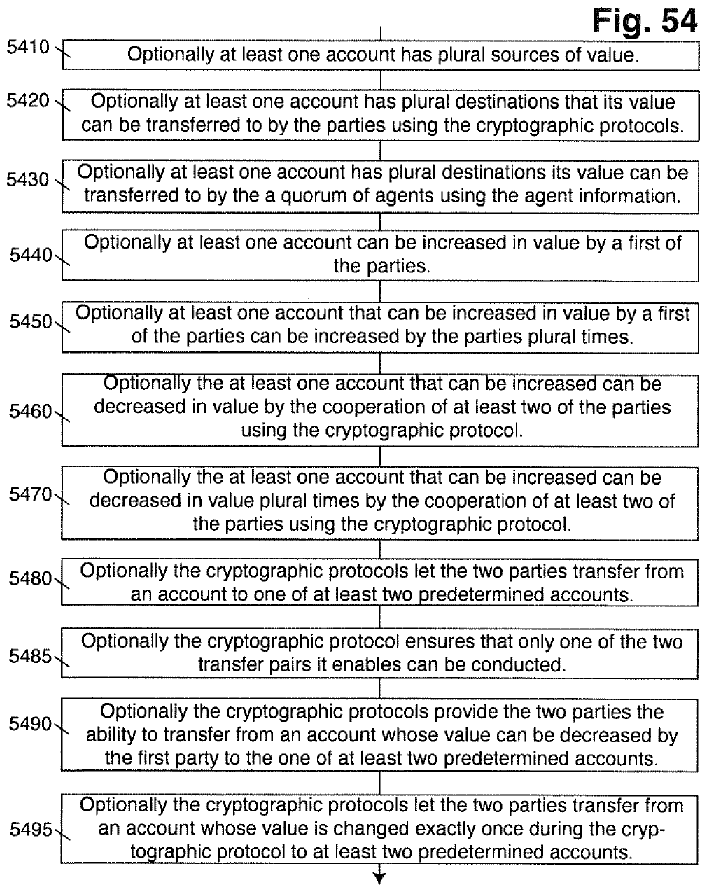

Turning now to FIG. 54, exemplary detailed flowchart, cryptographic protocol, and block diagrams for margin accounts and futures and options illustrated in accordance with aspects of the teachings of the invention.

Referring particularly to box 5410, it may here be said that “optionally at least one account has plural sources of value” to mean that in some examples at least one of the accounts can be the destination account in more than one transfer that involves more than one distinct source accounts.

Referring particularly to box 5420, it may here be said that “optionally at least one account has plural destinations that its value can be transferred to by the parties using the cryptographic protocols” to mean that the cryptographic protocol allows at least a one of the accounts to be the source account in more than one transfer and that at least two of these transfers have distinct destination accounts.

Referring particularly to box 5430, it may here be said that “optionally at least one account has plural destinations its value can be transferred to by a quorum of agents using the agent information” to mean that the cryptographic protocol can allow agents to make more than one at least alternative transfer with one of the accounts serving as source account and the at least more than one accounts serving as destination accounts.

Referring particularly to box 5440, it may here be said that “optionally at least one account can be increased in value by a first of the parties” to mean that an account, such as what is sometimes called a “margin” account, can have more than one what is sometimes referred to as a “call” that requires additional transfer to it as a destination.

Referring particularly to box 5450, it may here be said that “optionally at least one account that can be increased in value by a first of the parties can be increased by the parties plural times” to mean that more than one call can require more than one increase by transfer to an account.

Referring particularly to box 5460, it may here be said that “optionally the at least one account that can be increased can be decreased in value by the cooperation of at least two of the parties using the cryptographic protocol” to mean that the account that can be the destination of more than one transfer can also be the source of at least one transfer, allowed the parties by the protocol, when at least two of the parties or a quorum of the parties as will be understood applies more generally elsewhere here but has been omitted from explicit reference for clarity, back to the account from which at least some of the plural transfers were sourced from.

Referring particularly to box 5470, it may here be said that “optionally the at least one account that can be increased can be decreased in value plural times by the cooperation of at least two of the parties using the cryptographic protocol” to mean that the transfers described with reference to box 5460 can be multiple.

Referring particularly to box 5480, it may here be said that “optionally the cryptographic protocols let the two parties transfer from an account to one of at least two predetermined accounts” to mean that the cryptographic protocols provide for “or” functionality in the sense that there can be two or more possible destinations for transfers with a particular account as source and the protocols can provide for control that choice.

Referring particularly to box 5485, it may here be said that “optionally the cryptographic protocol ensures that only one of the two transfer pairs it enables can be conducted” to mean that, with reference to box 5484, that the transfers allowed by the protocol can, in some examples, be made to conform to an example rule providing for mutual exclusion; however, other restrictions and/or limitation, such as with respect to amount, timing, multiplicity of occurrences and/or multiplicity of destinations are anticipated.

Referring particularly to box 5490, it may here be said that “optionally the cryptographic protocols provide the two parties the ability to transfer from an account whose value can be decreased by the first party to the one of at least two predetermined accounts” to mean that it is anticipated that the examples referred to in the description of boxes 5485 and 5460 and 5470.

Referring particularly to box 5495, it may here be said that “optionally the cryptographic protocols let the two parties transfer from an account whose value is changed exactly once during the cryptographic protocol to at least two predetermined accounts” to mean that an account that is the destination in an example such as that already described with reference to box 5485 can be allowed by the protocol to be transferred to two or more different accounts.

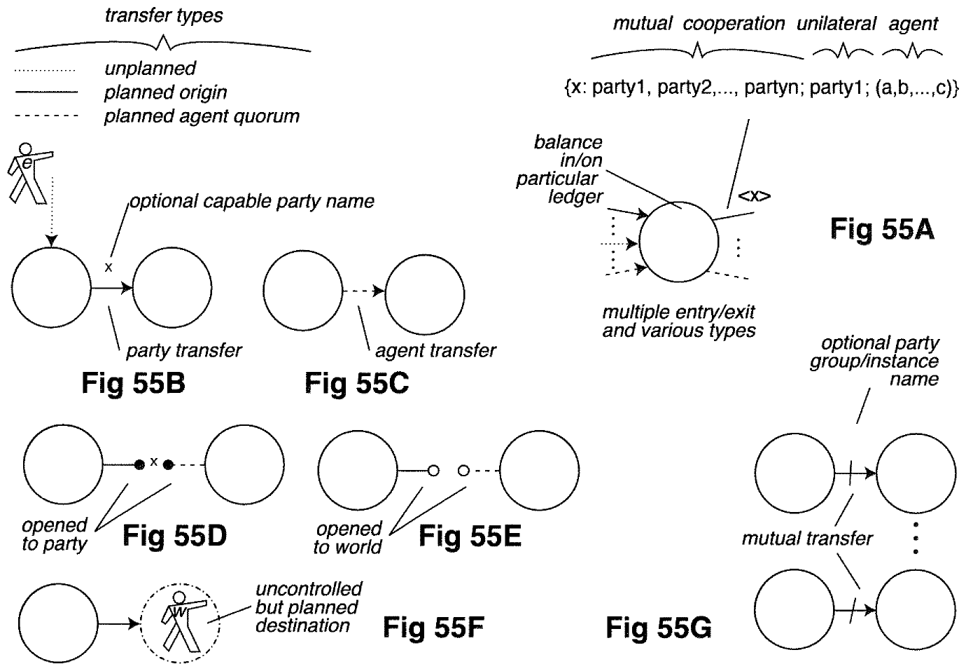

FIGS. 55A-55G are combination cryptographic protocol diagrams and notational exemplary elements in accordance with aspects of teachings of the invention. FIG. 55A is ledger account with multiple input and output transfers and curly-bracket notation introduced; FIG. 55B is a party funded account transferred to a planned account by parties; FIG. 55C is an account transferred to a planned account by agents; FIG. 55D shows account openings to a party by parties and by agents; FIG. 55E shows account openings to everyone by parties and by agents; FIG. 55F is the transfer to a party both by an agent and by parties; and FIG. 55G is multiple coordinated transfers.

A general key to transfer line type conventions at least for purposes of FIGS. 55A-57D is provided for clarity as will be appreciated, as follows: When the origin of the transfer is not locked in, so could come from many possible accounts on the ledger, for instance, then the transfer can here be called “unplanned” and shown in some diagrams as dotted line with arrowhead entering a ledger account circle. When the ledger account from which the value is to be transferred from is known in advance and can be built into the underlying cryptographic protocols, then the line in some examples can be shown as solid with an arrowhead and be called here a “planned origin” transfer. When, in other example cases, the transfer is made by what can be called a “quorum of agents” a single dashed line can be used. These notations are illustrated further in FIG. 55A and FIG. 55B and FIG. 55C.

Referring more specifically now to FIG. 55A, a ledger account with multiple input and output transfers and curly-bracket notation introduced, is shown. The what can here be called an “account” is symbolized as a circle. The input and output transfers and their possible multiplicity are shown, as already described. The curly bracket “{ }” notation shown can be defined as follows: there is an optional name field as a first item within the brackets, in the example “x” that can be shown in pointy brackets “< >” elsewhere in the diagrams for clarity. Next there are one or more what can be called “rule” fields, separated by semicolon. Each rule indicates either which parties have sufficient information, for instance, or which subsets of the parties should, for instance, cooperate in order to conduct the transfer. To indicate that information from more than one party may be needed, the vertical bar “|” may be used to separate the party names; when cooperation through the protocol, the comma “,” may be used as a separator; such as in the example, “party1,” and so forth. In some examples, not indicated for clarity, a majority or other quorum rule is implicitly and/or anticipated. In other examples, a quorum can be shown using the quorum notation “(a, b, . . . , c),” where the parenthesis “0” indicate that a quorum of the agents named are necessary and sufficient. In some examples a single party can be sufficient to cause the transfer, in which case the rule is just that party name, which can be referred to here as a “unilateral” transfer.

Referring more specifically now to FIG. 55B, a party funded account transferred to a planned account by parties is shown. The solid arrow indicates the transfer. The optional party capable of making the transfer is shown; however this can be considered shorthand for convenience for the curly brace notation with that singleton party at least included (in some examples there may be implicit agent quora, as will be understood, to allow the transaction to complete and/or to reverse it if it has not met criteria to complete).

Referring more specifically to FIG. 55C is an account transferred to a planned account by agents is shown, which is similar to that already described with reference to FIG. 55B, but the transfer is affected by a quorum of agents, such as may be denoted “(a, b, . . . , c).”

Referring more specifically to FIG. 55D, an account opening to a party by parties and by agents are shown. The solid small circle can be used here to indicate the case, already defined earlier, where information sufficient to readily compute signatures allowing transfers out of an account is provided to a party by the cryptographic protocols and/or by a quorum of agents, Oslo shown.

Referring more specifically to FIG. 55E, it shows account openings to everyone by parties and by agents. Much as FIG. 55D allowed a party to gain access to a key that lets signatures be made to move value from a specific account, here that information is in effect made widely available or public. The objective of this can be, it is believed, the advantageous making completely unfit for transfer to of an account that is to be left out of subsequent protocol parts.

Referring more specifically to FIG. 55F transfer to a pre-determined account controlled by a party is indicated. Unlike FIG. 55B or FIG. 55C, already described, the particular destination account illustrated here with the “dash-dot” line is to include the case where the party, in the example “w,” is able to control the account receiving the value at the time of value receipt.

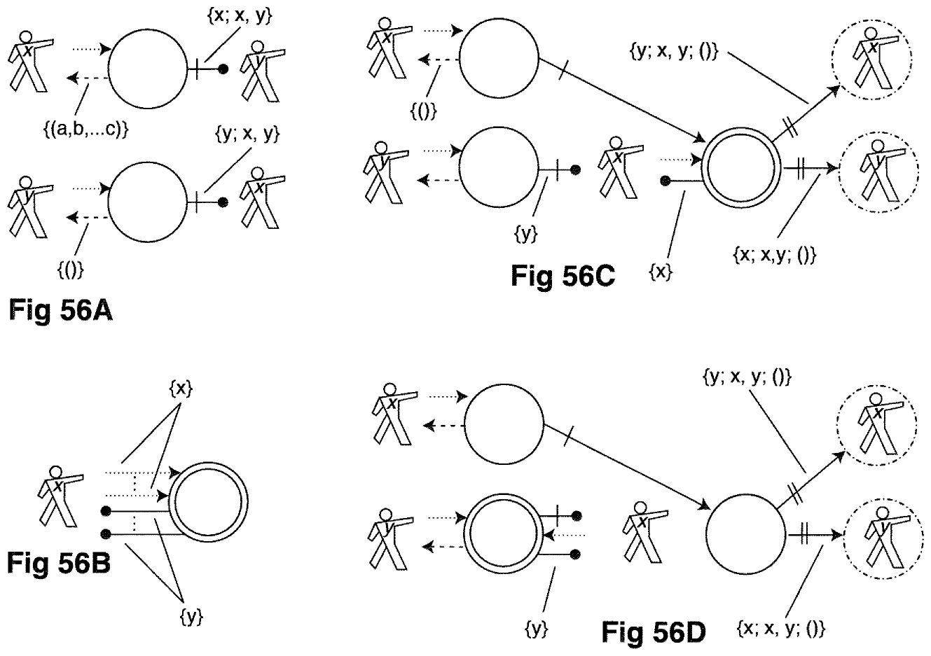

Referring more specifically to FIG. 55G, multiple coordinated transfers are shown. The small line crossing each of the two transfer arrows is intended to indicate that these transfers are to be made “all/nothing,” that is either all are transferred in time or none should be. The cryptographic protocols described elsewhere here include this aspect, sometimes for instance under the rubric of “fair exchange.” In other examples, there can be more than one set of “all/nothing” transactions, such as shown by some arrows crossed once and other crossed twice, for instance in FIG. 56D to be described. In order to maintain consistency of transfers, and to adhere to believed desirable aspects of rules governing transfers, overlapping quora of agents for sets, can provide what can here be called “consensus” on the set of transfers that are made, whether by the agents and/or including by the parties.

Turning now to FIGS. 56A-56D, shown are signatures cryptographic diagrammatic and notational example combinations of some exemplary elements in accordance with aspects of the invention. FIG. 56A is a mutual transfer between two parties; FIG. 56B is an account that can both be added to by one party and that can be refunded by mutual agreement of a second party; FIG. 56C is one party providing value to a second party, secured by value from the first party that the first party can increase and cooperation of both parties can decrease; and FIG. 56D is one party providing value to a second party, secured by value from the first party that the second party can increase and cooperation of both parties can decrease.

Referring more specifically now to FIG. 56A, a mutual transfer between two parties, x and y, is shown. This case is described elsewhere here but included here again for clarity in description of the notational aspects. As will be apparent, x funds the upper account circle and y funds the lower, using the dotted lines to indicate that where the value came from is not considered to be an account controlled by this cryptographic protocol instance. The two solid arrow outputs, to the two respective participants, swapped in terms of who funded which account, are both shown with a single cross, to indicate an all/nothing transfer, as already described.

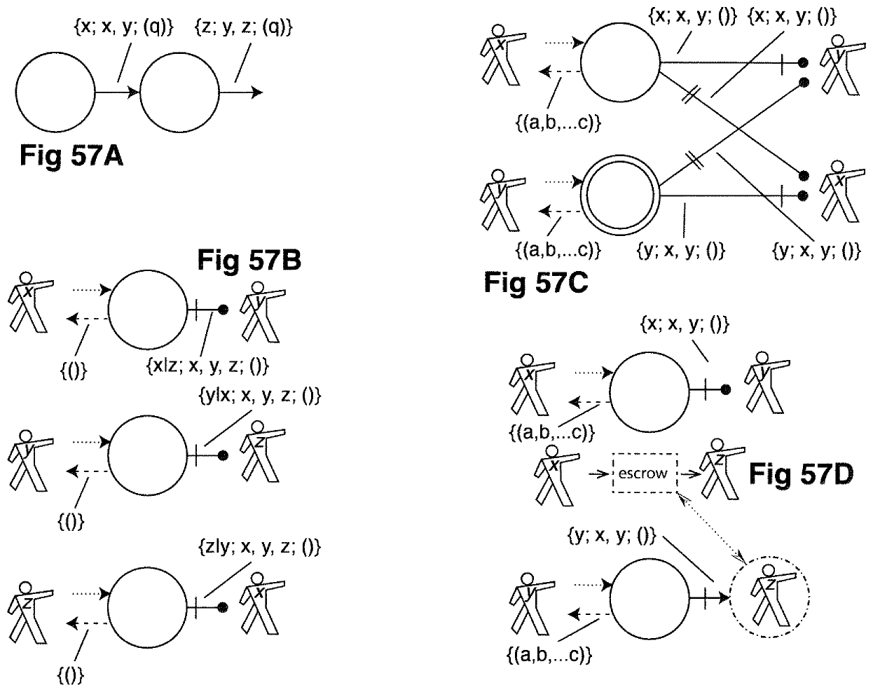

It will also be apparent that x has the ability to transfer the value to y, since the two of them have conducted the cryptographic protocol that was capable of generating that same signature instance. (It will be appreciated that in examples where multiple instances of cryptographic protocols are conducted, involving different accounts and participants, participation in an earlier instance may not lead to an ability of the participants to in effect collude to override the protocol.) Similarly, y has the ability to make the transfer to x, as also indicated. With more than two participants, such as will be described with reference to FIG. 57B, information known to multiple participants may be needed and shown, for instance, using vertical bar notation as already mentioned.

In another aspect, the agents are illustrated here in the curly bracket notation. For instance, the transfer back to x shows that there is an implicit agent ability to conduct the transfer, only to the predefined account of x as will be appreciated, and the particular set of agents is called out as “a” and “b” and so on all the way up to “c” in the example. In another illustrative example for completeness, the agent list can be acknowledged but not further detailed such as can be shown by “{( )}” for simplicity and is often omitted for clarity as elsewhere and as will be appreciated.

Referring more specifically to FIG. 56B, an account that can both be added to by one party and that can be refunded by mutual agreement of a second party is shown, using a double circle notation in which a second somewhat smaller circle appears placed concentric within the account circle. All the transfers in are shown with curly brace notation as being capable of being made by x; all the transfers out, are shown for clarity controlled by y in the curly brace notation, to an account controlled by x, as mentioned. However, other kinds of transfers out are anticipated. The multiplicity is shown with vertical ellipsis, to indicate that zero, one, two or more such transfers of each type are anticipated.

Referring more specifically to FIG. 56C, a second party providing value to a first party, secured by value from the first party that the first party can increase and cooperation of both parties can decrease, is shown. The leftmost two accounts are similar to those described elsewhere here, with funding by respective parties and the “refund” agents option of they are not both funded, indicated as “{( )}” but for clarity optionally as mentioned. The cryptographic protocols shown include two all/nothing transfer sets, as already described, each respectively indicated by the same number of cross line segments. The first set provides to x the value input by y; and the first set also provides the value input by x to the concentric circle account that x can increase and the cooperation of x and y in the protocol can decrease back to x, all as already described. By a time agreed at least by the parties such as including predefined or from time to time adjusted, for instance, the second set of transfers is to be accomplished; however, only one of the two transfers, according to the rule enforced by the cryptographic protocol, as mentioned and will be understood. The choice of which destination is by mutual agreement; however, in some optional variants and included in the example shown, agents can be provided agent information as will be understood as sufficient for them to make the transfer should the parties not agree. The recipients of the second set are shown, in the example for clarity, as prearranged accounts controlled by the respective parties; however, control over the concentric account could also be transferred, such as would be shown using the solid small circle and as described earlier with reference to FIG. 55B.

Referring more specifically to FIG. 56D, for completeness a second party providing value to a first party, secured by value from the first party, where the second party can increase the value provided and the first party can decrease the value provided, and cooperation of both parties can determine if the securing value is returned to the first party or provided to the second party. A main difference between this example and that just described with reference to FIG. 56C is believed to be that the value x obtains from y can be adjusted upwards by y and downwards by x; once the whole thing closes, one of the parties is to get the securing value as before. Accordingly, the concentric circle account is between y and x this time, as shown. It is anticipated that the techniques of this figure and the previous one can be combined to allow adjusting of the amount from x and/or the amount from y. Again, in case the parties cannot agree on the disposition of the amount from x, predefined agent information can allow the agents to make the decision with consensus, as already mentioned.

Turning now to FIGS. 57A-57C further cryptographic diagrammatic and notational example combinations of exemplary elements in accordance with aspects of the invention are shown and described. FIG. 57A is one party handing over its role to a third party while maintaining a second party; FIG. 57B is a mutual rotation transfer between three parties; FIG. 57C is a mutual transfer or non-transfer decided at a later time; and FIG. 57D is one party escrowing a second amount for a third party and offering a second party a first amount to transfer a related amount to a third party that will unlock the escrow.

Referring more specifically to FIG. 57A, shown is one party, x, handing over its role with respect to an account to a third party z, while maintaining a second party y as the other party in the joint control of the account handed over. The curly brace notation shows what may here be called the “handover”: in the first expression x can unilaterally transfer from the account but x and y are able to move the value in a coordinated manner through a cryptographic protocol along with other transfers with the same number of crosses, as already explained elsewhere here. Also shown are the agents, q, that may have an additional ability to make the transfer in general.

To start the handover, z and y create a joint custody account with the same rules (typically in the example for clarity) as the original account on the left. After the handover z has the information needed to make the transfer (as an example result of the cryptographic protocol setting up the new account for clarity), while the coordinated transfer out of the account on the right is now involving z and y. Similarly, the quorum of agents remains unchanged, for clarity in the example. Since x cannot move the value out of the first account, but has information when combined with y to do so, x and y can create the join transfer ability to move the value from the left account to the right account; once the transfer is made, z now has in effect received the handover from x of the role x had with respect to this account and coordinated other transfers. When this is done for all accounts that may be coordinated in a combined use (and the new accounts for z are set up with the same coordination), in effect x hands over its role to y; whatever x could do now y can do it and whatever x could do, x cannot do it any longer with respect to the overall use.

Referring more specifically to FIG. 57B, a mutual transfer that is a rotation between accounts of three parties is shown. All three transfers are coordinated, as indicted by the cross line on the transfer lines; the cryptographic protocol ensures that they should all be conducted or none conducted, not substantially unlike a two-way swap. (The fair exchange protocols it is believed both known and introduced here can be used by three or even more parties as will readily be appreciated by those of skill in the art.) Unless all three are conducted, the refunds to the respective parties are shown by the agents indicated in the curly braces, much as with any other number of parties to the swap.

The first party x transfers the value in the upper account circle to the second party y, as indicated. The second party y transfers the value in the middle account to z. And z transfers the lower account to x. The vertical bar notation is used to show that even one of the parties should not have enough information to make a transfer that benefits themselves; the two parties other than the beneficiary have, between them, information that is sufficient to make the transfer. Thus: “x|z” is shown needed for the transfer to y; “y|x” is shown needed for the transfer to z; and “z|y” is shown needed for the transfer to x.

Referring more specifically to FIG. 57C, a future time selection between a mutual transfer or non-transfer is shown. The funding of the two accounts on the left is as in other examples already described, as will be appreciated, so both can be assumed funded, otherwise one or the other will be refunded and the rest of the transaction will not complete as indicated. There are two types of transfers shown, the one-cross and the two-cross. Each type is conducted as may here be called “atomically” or by “consensus” or all/nothing, as has been mentioned. So, either: x gets from the upper and y gets from the lower account; or, alternatively, y gets from the lower account and x gets from the upper; but not both. The parties decide which way to go; however, if they cannot agree, then agents can break the stalemate, as indicated on the various transfer curly braces. In some examples agents may only be provided for one set of transfers; in still other examples, one or the other party may be required to cooperate with certain again combinations.

Referring finally more specifically to FIG. 57D, shown is a first party escrowing a second amount for a third party and offering a second party a first amount on a first ledger to transfer a related amount to a third party on a second ledger, where the transfer on the second ledger to the third party is to unlock the escrow for return to, or re-use by, the first party. The first party funds the upper account and the second party funds the lower account, as already explained for other example cryptographic protocols, so if both are not funded, then the one that is funded can be returned by an agent quorum as shown. The first party has also, in some examples, funded or otherwise made available an escrow or security deposit or guarantor of a more conventional nature that the third party can simply claim if the agreed amount is not made available to z, with a linked transfer shown as the one-cross coordinated transfers, by a time that is predefined or otherwise agreed and/or adjusted by the x and z.

It will be understood and appreciated that the use of a “more conventional” means of guarantee may provide a faster availability of funds that may be required and/or yield more attractive terms from z; however, a similar deposit account by x on the ledger used by y and z as shown could also serve a similar purpose. It is anticipated that ensuring only a relatively rigorous and/or onerous agent process to return the value to x and a simple x can transfer to z (or a set of predefined z's) may be an alternate embodiment that is advantageous in some settings.

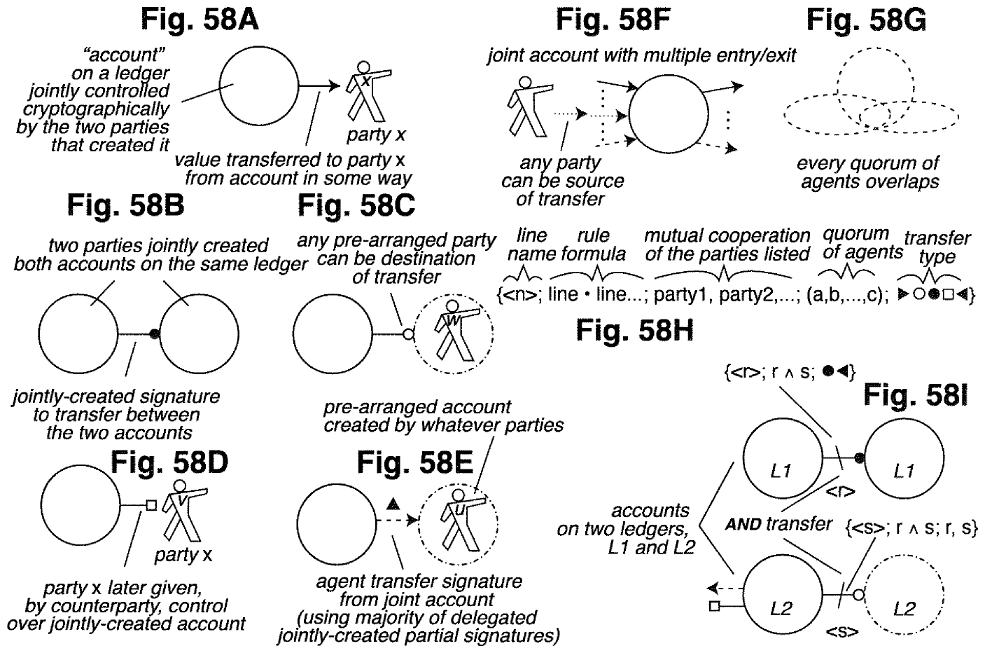

FIGS. 58A-58I are further combination cryptographic protocol diagrams and notational exemplary elements in accordance with aspects of teachings of the invention.

FIG. 58A is a generic transfer from a ledger account to the benefit of a party; FIG. 58B is transfer between two joint accounts; FIG. 58C is transfer of value from a joint account to account of a party; FIG. 58D is transfer of control from a joint account to a party; FIG. 58E is transfer by agents from a joint account to the benefit of a party; FIG. 58F is an example of multiple transfers in and out; FIG. 58G is shows overlap between agent quora; FIG. 58H is a notation for describing transfers between accounts; and FIG. 58I is an exemplary two-ledger coordinated AND.

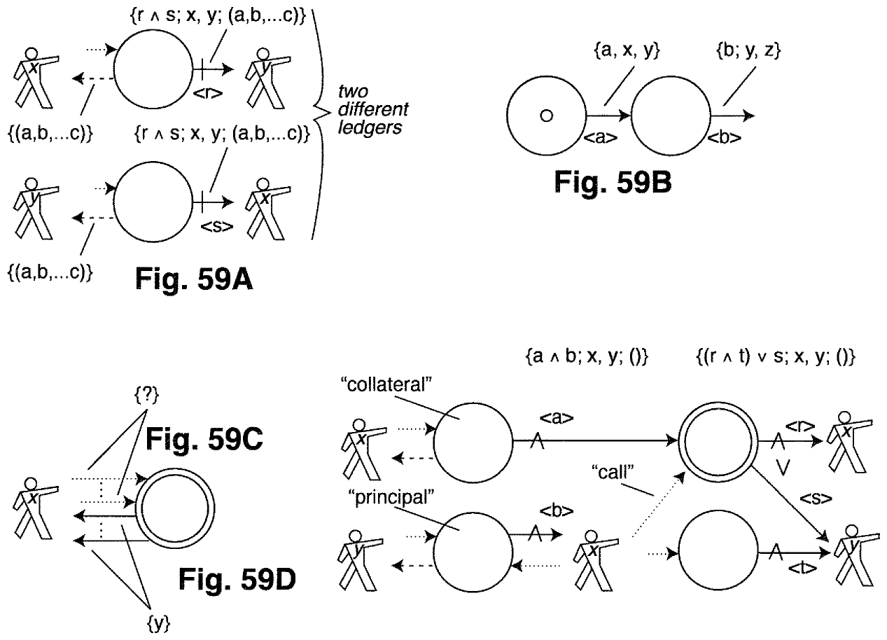

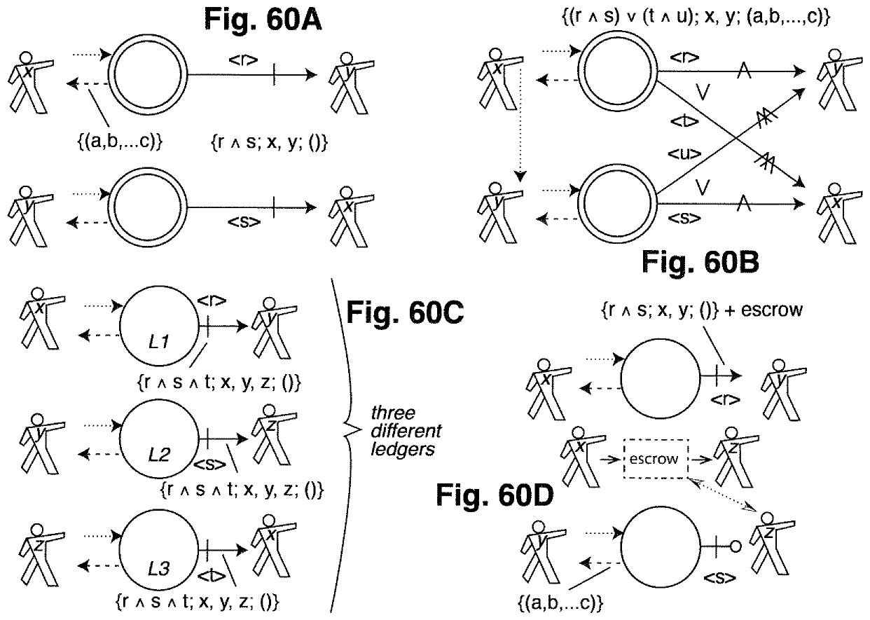

Referring now more specifically to FIG. 58A, a generic transfer from a ledger account to the benefit of a party is shown. The circle is a notation that can here be used to indicate an account on a ledger whose authentication information has been formed at least in part by cooperation of parties in conducting a cryptographic protocol, giving the parties at least joint control over the account. The beneficiary of the transfer is shown as party x in the example for clarity. Various example ways to conduct such a “generic” transfer to be described with reference to FIGS. 58B-E; however, the generic transfer, particularly at least with reference to the present Figure, and FIGS. 59 and 60 to be described, can indicate these and other specific transfer types as may be appropriate and will be understood.

Referring more specifically to FIG. 58B, transfer between two joint accounts is shown as example of the generic transfer already described. The solid-circle end of the line is intended as a notation to indicate that both accounts, the source and the destination, were jointly created by cryptographic protocols between parties and the transfer was by the release of a jointly created authenticator for moving the value from the account on the left to the account on the right.

Referring more specifically to FIG. 58C, shown is transfer of value from a joint account to account of a party. The hollow-circle line end out is intended to indicate that the account transferred to is pre-arranged. In general, such an account can be created by means other than joint custody; it can also be created by joint custody or otherwise that is at least to some extent independent of or irrelevant to the particular description of the source account.

Referring more specifically to FIG. 58D, transfer of control from a joint account to a party is shown. The box-end arrow notation can be used to symbolize the transfer of at least some information that the first party had related to control over the account to party v. This is believed to allow v to transfer value from the account and even to take overuse of the account more generally. The counterparty it is believed would after the transfer have not access to control over the account without cooperation of the party v. One example advantage of the approach is believed that the number of on-chain transfers can be reduced.

In another exemplary use of this type of transfer, where a first party may wish to refund and/or be entitled to refund, but the second party can allow the refund by providing information, as shown by the hollow box line, instead of waiting for the first party to contact the refund agents as provided by the dashed line arrow. It is believed that such “voluntary counterparty refund” can be advantageous, saving fees and/or time, and accordingly incentives can be provided to the counterparty to allow this instead of having the refund agents contacted. If, for example, a certain fee would in effect be paid by the counterparty in case the refund is by agents, the fee to be paid by the counterparty would it is believed ideally be lower in case the counterparty allows the refund through voluntary counterparty refund.

Referring more specifically to FIG. 58E, a transfer by what can be called here “agents,” or sometimes more specifically “refund agents,” as already described elsewhere here, from a joint account to the benefit of a party is shown. Party u as the recipient of the dashed arrow is intended to indicate that the account symbolized was not, or likely not, or not necessarily, created by the cryptographic protocol that created the authenticator for the account on the left. The dashed arrow is intended to indicate that a quorum of agents have provided the parts of or acted to reconstruct the signature or other authentication that moves the value from the account to the benefit of the party u.

In some examples it is believed at least potentially advantageous for the refund agent to have what may here be called a “third-party-checkable proof” that ensures that the refund should be made; however, the absence of such a proof in some examples may not mean that a refund should not be made. As an example, a so-called zero-knowledge and/or minimum-disclosure and/or snark proof, as are well known in the art, that a particular first account did have the particular value in it and a particular second account did not have value in it, and where the proof relates to particular so-called “block heights” or times in the discrete time of the ledgers and/or realtime. Such a what can here be called a “proof of refundability” is shown as “p” in the figure for clarity, but is implicit as an option in all instances of refund herein. In some examples the proof of refundability can be provided by the party who would benefit from the refund, by third parties with or without incentives, by the ledger(s) themselves, and/or by the refund agents separately or cooperatively. A proof of refundability can it is believed aid the refund agents in their reputation in speeding their decisions; discounts or other incentives can it is believed be offered by the agents in case they have suitable proof.

Referring more specifically to FIG. 58F, shown is an example of multiple transfers in and out of an account as well as general input to the account. The dotted arrow in in intended to indicate that any entity that knows the account identifier can, as is believed typical of ledger system, transfer in to the that account; what entity transfers in might not even be known, let alone pre-arranged. Other input types shown are the generic inputs already described with reference to FIG. 58A and the agent transfer as already described with reference to FIG. 58E. Any number of transfers in and/or out are anticipated. Two already described example types of transfers out are shown, one the generic and the other the agent.

Referring more specifically to FIG. 58G, overlap between agent quora is shown diagrammatically by overlapping ovals for clarity as will be appreciated. Such overlap is believed useful to be ensured so as to provide consistent actions by trustees when many different quora can be used in different portions of a related collection of transfers and/or parties.

Referring more specifically to FIG. 58H, an exemplary notation for describing cryptographic protocols related to transfers between ledger accounts, as will be appreciated, is shown in a generic and/or definitional example form. Four example what may here be called “fields” are shown, each separated by semicolons “;”. Each field can be optional in some examples and each field can have at least one default value and each field can appear in whatever order. The fields are grouped between delimiting curly braces “{ }” in some cases for clarity.

The first field shown is shown in what may be called a “schematic” for, that is the content items are described rather than shown. It includes what may here be called two G, overlap “line” identifiers separated by “operators.” When instantiated, the line identifiers can be symbols that if shown in the diagrams can be set off in pointy brackets “<r>”; in other examples the symbolic notation can be placed near the relevant diagrams and/or stand alone. Example operators are the logical connectives from first-order predicate calculus: “∧” for AND; “∨” for OR, as will be understood. Parenthesis can be used to show order of precedence and/or operation, as will be understood.

The second field shown is also in schematic and it shows a list of parties to the cryptographic protocol. Two are shown as a comma separated list, but the ellipsis indicates potentially more.

The second field shown is also in schematic and it shows a list of parties to the cryptographic protocol, typically identified by single-letter variable style names for clarity. Two are shown as a comma separated list, but the ellipsis indicates potentially more.

The third field shown is an example of a list of agents. Three are shown explicitly as “a,” “b” and after the ellipsis “c”; however any number can appear as will be understood. Moreover, a so-called “monotonic” formula can also indicate the combinations of the agents that are necessary and sufficient, a generalization that is anticipated and will be understood can be applied to any of the agent protocols of the present application. The agent list is set off in parenthesis. The agents can be shown explicitly or implicitly. A majority or other quorum is often implied, as already mentioned with reference to FIG. 58G for instance.

The fourth field shown is an example of transfer type symbols. The following examples are illustrated: “□□□□□” The solid triangles are ordinary arrowheads, the first shown, forward facing, is a transfer by the parties and is the default; the last shown, left-pointing, represents an agent transfer, typically a kind of refund or reversal more generally. The second and third are circles, as already described earlier with reference to FIG. 58B and FIG. 58C, these are believed sub-cases or variants of the solid forward arrow: in the one case the transfer is to a beneficiary that is not controlled by the cryptographic protocol, while in the other case it was created by and would at least initially be controlled by the protocol. The hollow square indicates that an account formerly controlled by the cryptographic protocol can be transferred by releasing control to a party, as already explained with reference to FIG. 58D.

Referring more specifically to FIG. 58I is an exemplary two-ledger coordinated AND introductory of the symbolic and diagrammatic, for clarity as will be appreciated. The common rule portion is shown as “{r∧s; r, s}” and two different ledgers are shown. The arrows are labeled “<r>” and “<s>”, respectively. The two transfers are each for a separate respective ledger and between two accounts, one pair created by the cryptographic protocol and one pair mixed with cryptographically created source but destination shown as not necessarily controlled by the same parties. The accounts are labeled in this introductory diagram by ledgers via labels L1 and L2; however, such labelling is omitted elsewhere for clarity as will be appreciated.

Also shown in the example is that the different legs need not have exactly the same formulas, even though they have common portions. In this case the upper transfer is of the type already described with reference to FIG. 5B, while the lower illustrates that described with reference to FIG. 58C. The upper leg, <r>, is shown as of what is called “transfer type” in the symbolic notation as being between two accounts created by essentially the same protocol, indicated by “□”, but also as what may be called “transferring backwards” under control of refund agents, as indicated by “□”. More generally, in a transaction or other system, by using the refund agent transferring back to the original parties, as shown in FIG. 58E, and transfer back for those legs between protocol-defined accounts, it is believed that this illustrates how substantial reversibility can be provided in case one or more parties stop moving forward with the process.

Turning now to FIGS. 59A-59D further cryptographic diagrammatic and notational example combinations of exemplary elements in accordance with aspects of the invention are shown and described. FIG. 59A is an exemplary arrangement related to a basic swap; FIG. 59B is an exemplary arrangement related to a handover between parties; FIG. 59C is an account that can at least be increased from time to time by one party; FIG. 59D is an exemplary collateralized loan or repo.

Referring more specifically first now to FIG. 59A, an exemplary arrangement related to a basic swap is first shown and described to illustrate the notation and for clarity in exposition, as will be appreciated. Two accounts are indicated as circles; two arrows out from the respective accounts are labeled r and s; refund dashed arrows point back to the parties x and y. The formula, shown for clarity labeling both lines, is: {r∧s; x, y; (a, b, . . . c)}. The lines have a single crossing short segment to indicate that they are coordinated, which is also indicated by the conjunction in the formula.

As already described elsewhere here, but for clarity and definiteness mentioned again here, both x and y are to fund the respective accounts, as indicated by the dotted line. If one is funded but the other is not in time or otherwise according to whatever agreed rule, not shown for clarity, a majority of the refund agents, shown as (a, b, . . . , c), as already described, are to provide the partial keys so that the refund transfer can occur. For the parties x and y to make the transfer (whether to another account and/or by transfer of control, as explained elsewhere here) they are both to agree in a fair exchange, as also described elsewhere here.

Referring more specifically next to FIG. 59B, an exemplary arrangement related to a handover between parties is described. With the cooperation of all three parties x, y and z, party x hands over to party z. The smaller concentric circle in the first account shown indicates that handover is anticipated. Two parties, x and y are shown controlling the transfer to the second account, while a second transfer is shown, from the second account, controlled by y and z. First party y and z can, in one example, create the second account through a cooperating cryptographic protocol, then party x and y can transfer to the second account. Thus, it is believed, by cooperation of y and z, x is able to transfer his/her/its position to z, such as for instance is well known in selling a position in a futures contract. Implicit in accounts circles shown elsewhere here is the small inner concentric circle to denote that handover is anticipated with cooperation of the parties.

Referring more specifically to FIG. 59C, an account that can at least be increased from time to time by one party is shown. The dotted arrows from x to the account show that at least x and in the example, it is anticipated that any party can move value in from time to time, as suggested by the ellipsis and the “T” in the curly braces as a party. Similarly, the arrows, such as by the option described with reference to FIG. 58C, below show an optional capability for y to refund to x, even from time to time as indicated by the ellipsis and y in the curly braces.

Referring more specifically to FIG. 59D, an exemplary collateralized loan or repo is shown. The term collateral is called out for clarity but without limitation in the upper circle; similarly, the term principal is called out for clarity but without limitation in the lower circle. The former is contributed by x, the “borrower” in loan terminology, and the later by y, the “lender” again in loan terminology. The leftmost two circles just mentioned and the arrows in and out of them, are believed essentially similar to those already described here with reference to swaps, such as described with reference to FIG. 59A. The “cross” of the outgoing arrows is shown here as an AND symbol, as already mentioned with reference to FIG. 58H, for clarity to distinguish from the disjunctive in the remaining portion of the present figure. The symbolic notation applies to both arrows out, <a> and <b>, and indicates that both should occur or none; the parties controlling the cryptographic protocol are x and y; there are no refund agents shown explicitly. If, however, a back-pointing hollow arrow, “□”, described with reference to FIG. 58H, were included, then the possibility to reverse the particular what may here be called “leg” of the transaction, such as in the case that the counterparty were to stop moving forward according to agreed schedule.

In some example applications there may be provisions for “calls” on the borrower to increase the collateral, depending on a variety of trigger conditions, such as so-called “mark-to-market,” as will be understood. A dotted arrow is shown for this. The concentric circle of the collateral account also indicates this capability as well as multiplicities and even, as already mentioned but not shown for clarity, the ability for the borrower to remove value from the collateral account, such as typically with agreement of the lender.

The final temporal phase includes the outflow from the two accounts on the left (apart from any reversal mentioned earlier). Two what may here be called “scenarios” as will be understood are indicated disjunctively: (a) collateral back to borrower and principal back to lender; or collateral to lender. The notation shows these as “(r∧t)∨s” to indicate that either both are returned or the transfer indicated by arrow s made.

Turning now to FIG. 60A-C, yet further cryptographic diagrammatic and notational example combinations of exemplary elements in accordance with aspects of the invention are shown and described.

FIG. 60A is an exemplary arrangement related to futures contract; FIG. 60B is an exemplary arrangement related to options contract; FIG. 60C is an exemplary three-way swap; FIG. 60D an exemplary arrangement related to cross-currency payments.

Referring now first more specifically to FIG. 60A, an exemplary arrangement related to futures contracts is shown. The arrangement and operation is similar to that already described with reference to FIG. 59A. An example difference is that both accounts are shown, using the double-concentric circle notation, as call accounts as already described with reference to FIG. 59C; however the additional arrows in and out on the left are not shown for clarity. An example use can be as follows: at each of plural pre-arranged times a so-called “marked to market” occurs and one of x or y can be required to increase the balance in the respective account; at a predetermined time the values are in effect swapped to the counterparties.

The accounts can additionally include a small hollow-circle, as already described with reference to FIG. 59B as optionally included without being shown explicitly for clarity, allow a party (with cooperation of the other party, which cooperation can it is believed at least be committed to if not provided at least partly in advance) to hand-over an account to a third party.

In some example applications, a balance is required of both parties sometimes referred to as a “minimum margin.” The differences in the mark to market from one period to the next are believed typically reflected in margin calls requiring one or the other party to increase the value in the account. If the minimum margin amounts are both additionally included in the respective accounts, and the accounts are swapped at the predetermined expiration of the contract, it is believed that each party will receive at least the minimum margin plus whatever compensation for the marked to market, the net cumulative marked to market.

Referring next more specifically to FIG. 60B, an exemplary arrangement related to options contracts is shown. A first difference between the configuration already described with reference to FIG. 60A is the optional compensation from one party, x in the example, to the other party y, for entering into the contract. A second difference is the presence of the disjunctive option for the transfers to go to the opposite parties. The lines are marked, for clarity, using the predicate calculus operators as already introduced with reference to FIG. 57H: the swap-like transfers are shown with the single carrot and what can here be called “straight through” transfers, x to x and y to y, with double carrots. The pair of alternative transfers emanating from a circle are shown with an inverted carrot or disjunction symbol.

In operation, similar to that already described with reference to FIG. 60A, the parties fund. There may also be calls to increase their balances and/or they may take some profits (not shown for clarity), such as related to marked to market. At a predetermined time, such as can be called “expiration” of the option, either the parties provide the balances to the counterparties (swap) or they provide them to themselves, straight through.

Referring now more specifically to FIG. 60C, an exemplary three-way swap is shown. The transfer of value is what can here be called “round robin,” x to y and y to z and z to x. The transfers are similar to those already described with reference to FIG. 59B, apart from the round-robin nature. It is believed that one exemplary way to arrange the control over the transfers is a pair of parties, what can here be called the “source” and “destination” parties; a believed an alternate example, shown here, has the non-source and non-destination party sharing control with the source party in each case, indicated symbolically as r∧s∧t; x, y, z.

Referring finally more specifically now to FIG. 60D, an exemplary arrangement related to cross-currency payments is shown. The transfers are similar to those already described with reference to FIG. 59B, apart from the destination of the second transfer, which in this example is changed from party x to party z. Initially, party x and z agree to what may be called an “escrow” amount that is administered by a mechanism at least acceptably trusted by party z to provide the value, or a somewhat larger value that may be called a “reverse haircut,” to allow the transaction to be considered to be guaranteed to settle at an agreed future time. For instance, there can be a handing over of physical goods or services or information and/or change of ownership. At least before or roughly at the agreed time the transfer to z from y should be accomplished, in which case the escrow value is not to be transferred and the whole agreement considered fully consummated.

The bottom and top lighted compass arrow line, “ [symbol] ” and “ [symbol] ” arrowheads, is intended to indicate that there is agreement on the identification and/or informational reference linking the escrow instance to the transfer to z; this information can, for example, be in the form of a number that identifies the escrow account specifics and/or its parameters or, for instance, is associated with a particular account controlled by z or benefitting z, as will be understood. The information coordinating the existence of the escrow, the release of the escrow, or the transfer of the escrow amount to z, can be referred to here as “escrow identification” and/or “escrow linking” information.

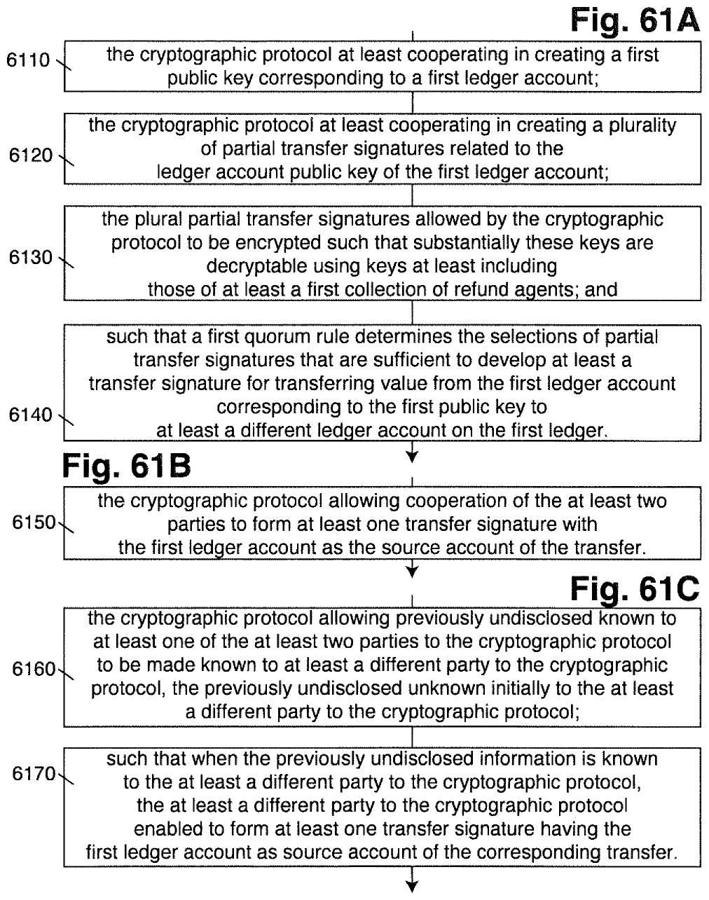

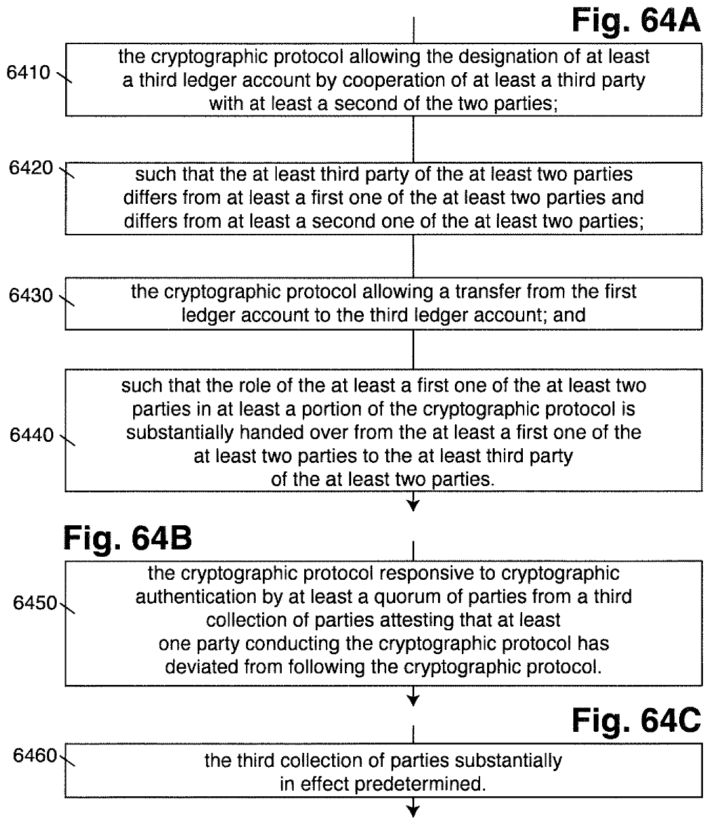

Turning now to FIGS. 61A-61C, a combination flow-chart and block diagram for exemplary refund agent and transfer signature aspects of the cryptographic protocols in accordance with aspects of the present invention will be described. FIG. 61A is a flowchart for allowing the creation and provision of partial keys; FIG. 61B shows allowing the creation of a transfer signature; and FIG. 64C is a flowchart for allowing transfer of previously undisclosed information.

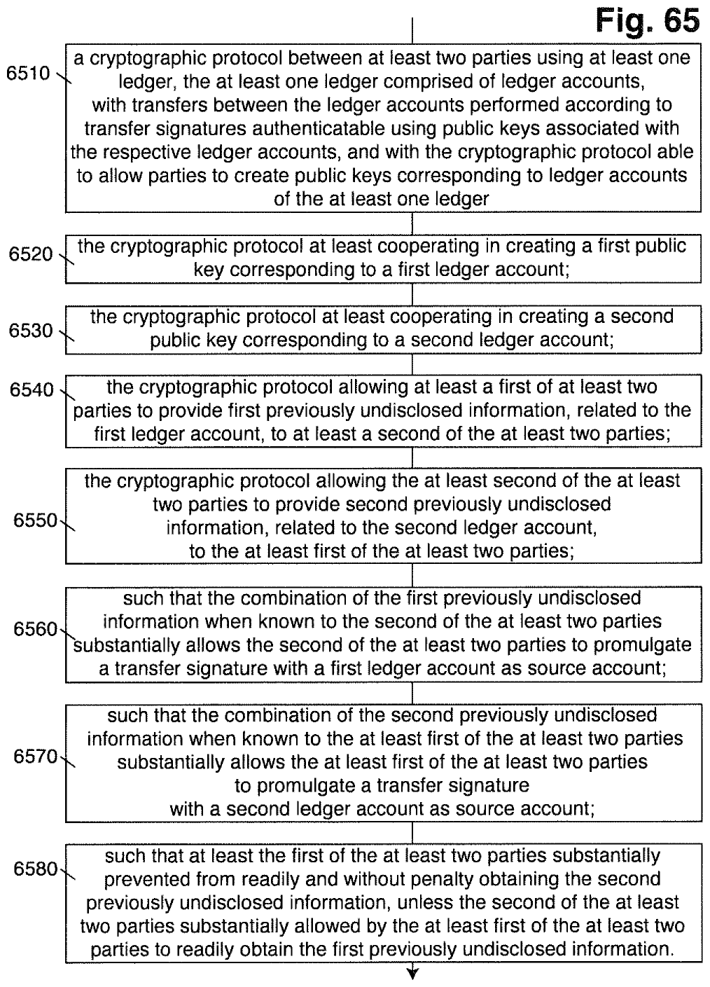

Referring now more particularly to FIG. 61A, and more specifically to box 6410, it may here be said that “the cryptographic protocol at least cooperating in creating a first public key corresponding to a first ledger account” to mean that at least a first of the at least two parties and at least a second of the at least two parties conducting a cryptographic protocol that allows them to create what can be called a public key, or other authentication enabling information as mentioned with reference to FIG. 65, box 6810, for a first ledger account. As will be understood, the corresponding what may be called private key information related to the public key can be kept secret by the cryptographic protocol from the at least two parties at least acting unilaterally, at least for some time, giving the cryptographic protocol in effect some control over when and how the private key information can and/or will be used.

Referring now more particularly to box 6420, it may be said that “the cryptographic protocol at least cooperating in creating a plurality of partial transfer signatures related to the ledger account public key of the first ledger account” to mean that the cryptographic protocol uses the secrets that it has developed in creating the public key, already mentioned with reference to box 6410, to create secret-shares of a transfer signature for at least a transfer with the first account on the first ledger as the source account.

Referring now more particularly to box 6430, it may be said that “the plural partial transfer signatures allowed by the cryptographic protocol to be encrypted such that substantially these keys are decryptable using keys at least including those of at least a first collection of refund agents” to mean that the secret shares, already mentioned with reference to box 6420, are encrypted by cryptographic protocols for refund agents, such as for instance using public keys at least corresponding to refund agents (whether or not which particular refund agent associated with which specific public key is known to the parties performing the protocol or the agents; in effect the agents are anticipated to be anonymous but with corresponding public key; the keys can, it is anticipated, also be mapped by additional parties to arrive at the form used by the protocol).

Referring now more particularly to box 6440, it may be said that “such that a first quorum rule determines the selections of partial transfer signatures that are sufficient to develop at least a transfer signature for transferring value from the first ledger account corresponding to the first public key to at least a different ledger account on the first ledger” to mean the partial transfer keys were formed, such as described with reference to FIG. 6430, so that the subsets sufficient to reconstruct the transfer signature are defined by what is called here a quorum rule.

Referring now more particularly to FIG. 61B, and more specifically to box 6450, it may here be said that “the cryptographic protocol allowing cooperation of the at least two parties to form at least one transfer signature with the first ledger account as the source account of the transfer” to mean that a transfer signature is allowed to be formed by cooperation of the parties with the cryptographic protocol such that at least neither party alone obtains the transfer signature. The parties can, however, agree on the transfer signature parameters, including the destination account, as part of cooperating with the cryptographic protocol.

Referring now more particularly to FIG. 61C, and more specifically to box 6460, it may be said that “the cryptographic protocol allowing previously undisclosed information known to at least one of the at least two parties to the cryptographic protocol to be made known to at least a different party to the cryptographic protocol, this previously undisclosed information unknown initially to the at least a different party to the cryptographic protocol” to mean that secret information developed by cooperation of the parties and the cryptographic protocol, such as has been mentioned with reference to FIG. 61A, can be made available to one of the parties by cooperation of other parties, such as the counterparty in case of two parties to the cryptographic protocol. This will then allow, it is believed, the party to whom the previously undisclosed information is made know to combine this with information known to that party and obtain the transfer signature and to provide that to the ledger to in effect cause the transfer from the first account to a destination account determined by the transfer signature.

Referring now more particularly to box 6470, it may be said that “such that when the previously undisclosed information is known to the at least a different party to the cryptographic protocol, the at least a different party to the cryptographic protocol enabled to form at least one transfer signature having the first ledger account as source account of the corresponding transfer” to mean that enough information is obtained so that when combined with the information known to that party, the party is believed able to create at least a transfer signature with the first account as source account of the transfer and with destination account and/or accounts chosen by that party.

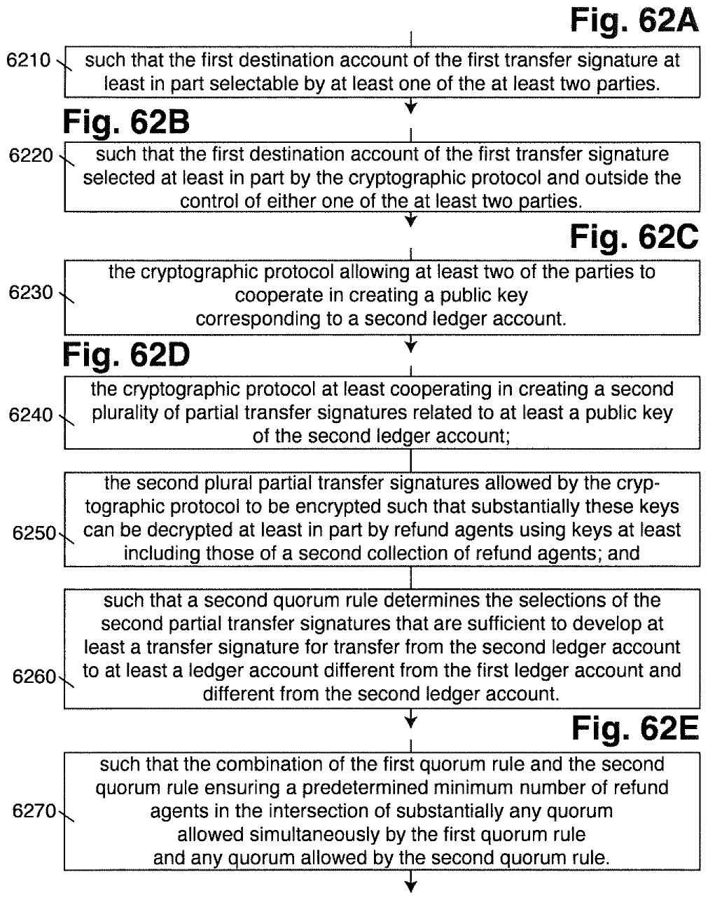

Turning now to FIGS. 62A-62E, a combination flow-chart and block diagram for exemplary aspects of forming of signatures, accounts, partial keys and quora of the cryptographic protocols in accordance with aspects of the present invention will be described. FIG. 62A is a flowchart for allowing the selection of transfer signatures; FIG. 62B shows allowing the uncontrolled creation of a destination account; FIG. 62C is a flowchart for allowing the creation of a second ledger account; FIG. 62D is a flowchart for allowing the creation and provision of a second set of partial keys; and FIG. 62E shows a flowchart for allowing overlap in refund agent quora.

Referring now more particularly to FIG. 62A, and more specifically to box 6510, it may here be said that “such that the first destination account of the first transfer signature at least in part selectable by at least one of the at least two parties” to mean that the account to which value is to be transferred is at least not out of the control of the at least two parties, such as if it were determined as will be described further with reference to box 6520; however, the selection may not be completely unconstrained, for a variety of potential reasons, such as for instance that certain ranges of public keys are excluded because they are already in use and/or they are reserved for certain purposes, one or more of the at least two parties may impose restrictions on destination accounts and/or their public keys, and so forth.

Referring now more particularly to FIG. 62B, and more particularly to box 6520, it may be said that “such that the first destination account of the first transfer signature selected at least in part by the cryptographic protocol and outside the control of either one of the at least two parties” to mean that the destination account of the first transfer signature is not, for instance, freely controllable by one or more of the parties so that they can select its value. Rather, the destination account is at least in part determined by the cryptographic protocol to be outside the control of either party separately. In some examples, when a value is determined by a cryptographic protocol, as will be appreciated, it can in effect be the output of a mainly irreversible process, such as a so-called one-way function, so that no party can choose the result (parties may repeat all or part of the protocol to “mine” for a particular value, but this is not a practical way to reach a single desired value that has been selected in advance, as the typical number of random candidates before the desired value is believed infeasibly large for useful cases). (It is anticipated that some other example cases where a value is determined by a cryptographic protocol should be taken to fall within the specification of FIG. 62A where a public key or the like can be arranged to take on a desired value by cooperation of the parties, such as for instance when the result is a public group operation applied to two inputs, one from each respective party and/or by agreement of the parties.)

Referring now more particularly to FIG. 62C, and more specifically to box 6530, it may here be said that “the cryptographic protocol allowing at least two of the parties to cooperate in creating a public key corresponding to a second ledger account” to mean that the at least two parties are allowed to determine a public key or the like to be associated with a second ledger account. It is anticipated that the second ledger account can be on the first ledger and/or on a second ledger different from the first ledger. In some examples that second account can for instance be created in a manner similar to that already described with reference to FIG. 62A; in some other non-limiting examples that second account can for instance be created in a manner similar to that already described with reference to FIG. 62B.

Referring now more particularly to FIG. 62D, and more specifically to box 6540, it may here be said that “the cryptographic protocol at least cooperating in creating a second plurality of partial transfer signatures related to at least a public key of the second ledger account” to mean, similar to that already described with reference to FIGS. 61A-C, box 6420, here for a second set of partial transfer signatures, as will be understood.

Referring now more particularly to box 6550, it may be said that “the second plural partial transfer signatures allowed by the cryptographic protocol to be encrypted such that substantially these keys can be decrypted at least in part by refund agents using keys at least including those of a second collection of refund agents” to mean, similar to that already described with reference to FIGS. 61A-C, box 6430, here for a second set of partial transfer signatures, as will be understood.

Referring now more particularly to box 6560, it may be said that “such that a second quorum rule determines the selections of the second partial transfer signatures that are sufficient to develop at least a transfer signature for transfer from the second ledger account to at least a ledger account different from the first ledger account and different from the second ledger account” to mean similar to that already described with reference to FIGS. 61A-C, box 6440, here for a second set of partial transfer signatures, as will be understood.

Referring now more particularly to FIG. 62E, and more specifically to box 6570, it may here be said that “such that the combination of the first quorum rule and the second quorum rule ensuring a predetermined minimum number of refund agents in the intersection of substantially any quorum allowed simultaneously by the first quorum rule and any quorum allowed by the second quorum rule” to mean that at least the two quorum rules, the first quorum rule and the second quorum rule, but it is anticipated that there can be more quorum rules, are such that there is in practice some refund agents that are in any two quora (here used as plural for quorum). The principle that majorities overlap is well known; it is believed advantageous for refund agents subsets that are selected to allow related refunds to be coordinated by refund agents in the intersection of the sets, for instance so that the actions are coordinated and/or not hidden from each other. For instance, it is anticipated that one refund should in some example configurations not be conducted if another refund is also conducted, for example when the two refund scenarios are mutually exclusive. Accordingly, all refund rules for related transaction portions are believed at least potentially advantaged by rules that ensure overlap. The amount of overlap can, for instance, be specified by a minimum size of the overlap. It will however be appreciated overlap can be substantially enough if, for instance it is large enough for almost all cases and/or if the trustworthiness of the refund agents varies the amount of overlap may be reduced if those in a particular overlap are more trustworthy.

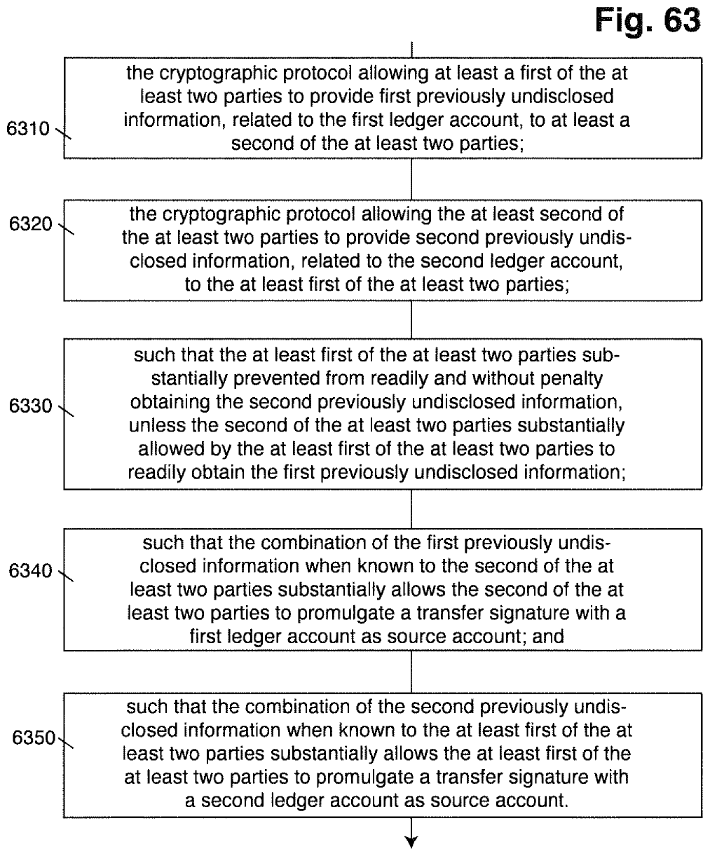

Turning now to FIG. 63, a combination flow-chart and block diagram for an exemplary exchange cryptographic protocol in accordance with aspects of the present invention will be described.

Referring now more specifically to box 6610, it may here be said that “the cryptographic protocol allowing at least a first of the at least two parties to provide first previously undisclosed information, related to the first ledger account, to at least a second of the at least two parties” to mean that at least one of the at least two parties can provide to at least a second of the at least two parties “previously undisclosed information” allowed by the cryptographic protocol, thereby presumably giving the second party enough cumulative combined information to allow, at least in some example scenarios described here, the second party to move value from the first account.

Referring now more particularly to box 6620, it may be said that “the cryptographic protocol allowing the at least second of the at least two parties to provide second previously undisclosed information, related to the second ledger account, to the at least first of the at least two parties” to mean that the protocol allows the second of the parties access to information for provision to the first of the parties that, thereby presumably giving the first of the parties enough cumulative combined information to allow, at least in some example scenarios described here, the first party to move value from the second account. Boxes 6610 and 6620 are similar but with different parties and accounts, as will be appreciated.

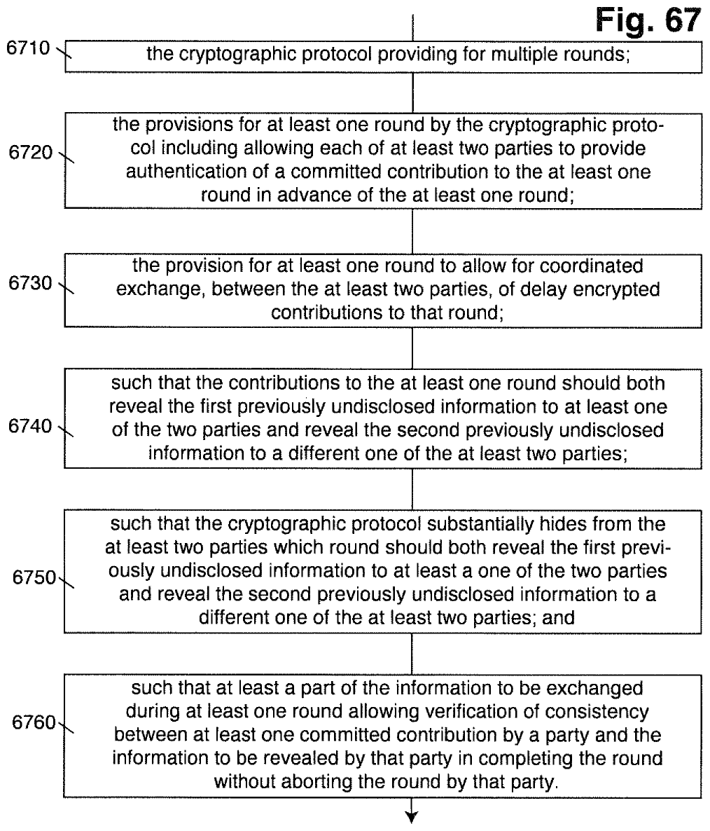

Referring now more particularly to box 6630, it may be said “such that the at least first of the at least two parties substantially prevented from readily and without penalty obtaining the second previously undisclosed information, unless the second of the at least two parties substantially allowed by the at least first of the at least two parties to readily obtain the first previously undisclosed information” to mean that each of the two parties allows the other of the two (or each of the three or more parties and/or in whatever groupings and/or configurations), what may be referred to as a “mutual allowance,” to obtain the respective previously undisclosed information. Much as will also be described with reference to FIG. 67, box 7040, the parties will both get the previously undisclosed information from the corresponding counterparty or neither get the previously undisclosed information from the counterparty; the case that one party receives the previously undisclosed information and the other party does not is believed explicitly excluded here.

Referring now more particularly to box 6640, it may be said that “such that the combination of the first previously undisclosed information when known to the second of the at least two parties substantially allows the second of the at least two parties to promulgate a transfer signature with a first ledger account as source account” to mean that the second of the at least two parties obtains information sufficient, when combined with other information available to that party, such as information conferred by and/or already used in cooperation with the cryptographic protocol, to enable the second of the at least two parties to obtain in effect a digital signature requesting a transfer from the first ledger account. The transfer can, in some examples, advantageously identify the destination account to ensure that when presented to the corresponding ledger the value will be moved to the corresponding predetermined account.

Referring now more particularly to box 6650, it may be said “such that the combination of the second previously undisclosed information when known to the at least first of the at least two parties substantially allows the at least first of the at least two parties to promulgate a transfer signature with a second ledger account as source account” to mean much as already described with reference to box 6640, but in this case for the second of the at least two parties as the recipient of the information and the first ledger account as the source account.

Turning now to FIGS. 64A-64C, a combination flow-chart and block diagram for exemplary aspects of forming of handover and attesting in accordance with aspects of the present invention will be described. FIG. 64A is a flowchart for allowing handover of accounts; FIG. 64B shows a flowchart for allowing use of attesting by other parties; and FIG. 67C is a flowchart for allowing attesting parties to be pre-determined.

Referring now more particularly to FIG. 64A, and more specifically to box 6710, it may here be said that “the cryptographic protocol allowing the designation of at least a third ledger account by cooperation of at least a third party with at least a second of the two parties” to mean that at least a third party, potentially not initially included in the at least two parties, of the at least two parties to the cryptographic is able to participate in a cryptographic protocol with at least the second of the at least two parties to develop an account public key

Referring now more particularly to box 6720, it may be said that “such that the at least third party of the at least two parties differs from at least a first one of the at least two parties and differs from at least a second one of the at least two parties” to mean that the three parties can be distinct parties.

Referring now more particularly to box 6730, it may be said that “the cryptographic protocol allowing a transfer from the first ledger account to the third ledger account” to mean that value can be moved between the first ledger account and the third ledger account by cooperation of at least the first of the at least two parties and the second of the at least two parties.

Referring now more particularly to box 6740, it may be said that “such that the role of the at least a first one of the at least two parties in at least a portion of the cryptographic protocol is substantially handed over from the at least a first one of the at least two parties to the at least third party of the at least two parties” to mean that at least at this point what the first party could have done had it not handed over its role in the cryptographic protocol to the third party can now be done by the third party and, as will be understood to be implied, the third party at least not capable of at least a portion of this before the handover.

Referring now more particularly to FIG. 64B, and more specifically to box 6750, it may here be said that “the cryptographic protocol responsive to cryptographic authentication by at least a quorum of parties from a third collection of parties attesting that at least one party conducting the cryptographic protocol has deviated from following the cryptographic protocol” to mean that at least a predefined quorum, optionally within a larger set of potential participants, has provided at least self-authenticating information or the like to attest that one or more parties to the cryptographic protocol have deviated from, or what may also be called violated, the cryptographic protocol. Examples of such deviations include, but are not limited to, not posting or otherwise making at least certain information available by a required time and/or block height, information that is authenticated as contained in a cryptographic commitment that when opened does not verify, and/or that insufficient or no value was transferred to a particular ledger account.

Referring now more particularly to FIG. 64C, and more specifically to box 6760, it may here be said that “the third collection of parties in effect predetermined” to mean that the third parties are able to form a single value and/or a value from a small enough or structured enough set that the cryptographic protocol can take the attestation from the third parties as input and be responsive to that input. For instance, as just one non-limiting example, the quorum of parties from a third collection of box 6750 can develop a value that the cryptographic protocol takes “in effect” as compelling enough proof that a particular account was not funded by a time certain and the cryptographic protocol can release a refund signature or the like in that case. Other examples include allowing an option contract to be exercised in one of more than one potential ways and/or more generally allowing a branch of a graph of transfers to be followed.

Turning now to FIG. 65, a combination flow-chart and block diagram for an exemplary variation on an exchange cryptographic protocol in accordance with aspects of the present invention will be described.

Referring now more particularly to FIG. 65, and more specifically to box 6810, it may here be said that “a cryptographic protocol between at least two parties using at least one ledger, the at least one ledger comprised of ledger accounts, with transfers between the ledger accounts performed according to transfer signatures authenticatable using public keys associated with the respective ledger accounts, and with the cryptographic protocol able to allow parties to create public keys corresponding to ledger accounts of the at least one ledger” to mean a cryptographic protocol conducted (in whatever portions or parts or phases or segments, to whatever extent parallel or serial, homogenous or involving subsets, based on computational assumption and/or not with statistical properties and/or incorporating elements with physical properties) by two or more parties (or whatever entities of whatever type, human, legal/organizational construct and/or automaton) interacts with and/or has some relation with one or more ledgers. The ledgers can, for instance but without limitation be secured by blockchains and/or multiparty computations and/or trusted hardware, or the like, as are well known. The ledgers can be homogenous or heterogenous and/or hierarchically or otherwise organized, such as for instance also including so-called side chains, para-chains and sharding. Ledgers are typically said to sharing include accounts, or separately controlled registers or stores of value or the like, whether as numbers and/or other symbols and/or formulas or the like. Each account has one or more information items associated with it for the purposes of showing ownership and/or other rights with respect to an account or collection of accounts however organized. In some examples so-called public keys and/or other data are associated with an account (such as also a hash or fingerprint or other compression of a public key) at least for the purpose of allowing ownership or other rights to the account to be shown and/or associated with requests related to an account. In some examples transfer of values between accounts are initiated by presenting what may be called generally signatures related to public key of the account, to mean any kind of authentication of rights (whether consumed, ephemeral, and/or enduring) to authorize the transfer from at least one account to at least one account. The so-called public key of an account can be created in whole or in part by a cryptographic protocol, as is known; in such cases, the parties to the protocol may retain information allowing them to make certain signatures related to the public keys (or in an inventive step, to use novel protocols to make signatures at least not immediately known to them).

Referring now more particularly to box 6820, it may be said that “the cryptographic protocol at least cooperating in creating a first public key corresponding to a first ledger account” to mean that the cryptographic protocol is involved in the creation of a public key or other authentication information related to an account on the at least one ledger. Such protocols are known, as will be appreciated, and referenced elsewhere here. Additional cooperation and/or participation in the creation of the public key corresponding to the ledger account, such as associating a suitable key, once it has been created by a protocol involving two or more parties, with a blockchain can, for instance, include cooperation of constituents of the blockchain.

Referring now more particularly to box 6830, it may be said that “the cryptographic protocol at least cooperating in creating a second public key corresponding to a second ledger account” to mean a similar cooperation as just described with reference to box 6820, but involving a different account, a potentially at least different ledger, and one or more different parties, as will be understood.

Referring now more particularly to box 6840, it may be said that “the cryptographic protocol allowing at least a first of at least two parties to provide first previously undisclosed information, related to the first ledger account, to at least a second of the at least two parties” to mean that whatever may be known to what may here be referred to as a first of the at least two parties (to include subsets of parties) that was known prior to, input to, and/or learned by that party during participation in the cryptographic protocol generating the public key, as described with reference to box 6810 and/or 6820 above, but that at some point in the protocol is believed at least by some parties and/or with significant probability not to have yet been made available to what may here be referred to as at least a second of the at least two parties (to include subsets of parties).

Referring now more particularly to box 6850, it may be said that “the cryptographic protocol allowing the at least second of the at least two parties to provide second previously undisclosed information, related to the second ledger account, to the at least first of the at least two parties” to mean a similar provision as just described with reference to box 6840, but involving a different account and one or more different parties, as will be understood.

Referring now more particularly to box 6860, it may be said that “such that the combination of the first previously undisclosed information when known to the second of the at least two parties substantially allows the second of the at least two parties to promulgate a transfer signature with a first ledger account as source account” to mean that by combining information received and now available to the second of the at least two parties, the second of the at least two parties is able to create sufficient information to provide authentication for a request to the corresponding ledger to at least in effect move and/or transfer (with or without fees or the like) value from the first ledger account.

Referring now more particularly to box 6870, it may be said that “such that the combination of the second previously undisclosed information when known to the at least first of the at least two parties substantially allows the at least first of the at least two parties to promulgate a transfer signature with a second ledger account as source account” to mean a similar allowance as just described with reference to box 6860, but involving a different account and different parties, as will be understood.

Referring now more particularly to box 6880, it may be said “such that at least the first of the at least two parties substantially prevented from readily and without penalty obtaining the second previously undisclosed information, unless the second of the at least two parties substantially allowed by the at least first of the at least two parties to readily obtain the first previously undisclosed information” to mean that there are impediments imposed on the first party and/or the first party has limited capability to obtain the second previously undisclosed information without allowance by the first of the at least two parties for the second of the at least two parties to obtain the first previously undisclosed value. The use of the term substantially is intended to include, for instance but without limitation, options where the information could be had by an amount of computation and/or by an amount of luck and/or by an act of compromise by a number of parties and/or by corruption of parties and so forth. By readily obtaining it can be meant for instance that there is at least one at least mainly known approach to obtaining that is likely enough at last and with resources affordable, such as time and computation. By without penalty, it can be meant for instance but without limitation that there is no special fee or other adverse and/or inhibitory and/or costly and/or slowing effect on the party, other than what may be regarded as the “cost of doing business” and/or otherwise would be incurred at least with similar probability in other cases as well.

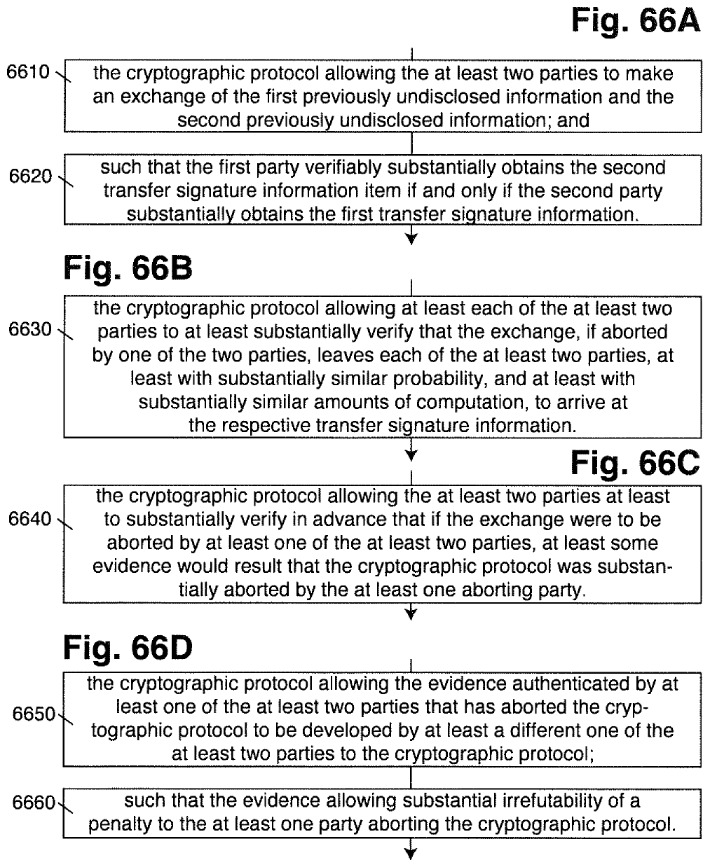

Turning now to FIGS. 66A-66D, a combination flow-chart and block diagram for exemplary aspects of fair exchange by and evidence of abort of the cryptographic protocols in accordance with aspects of the present invention will be described. FIG. 66A is a flowchart for allowing verifiable exchange; FIG. 66B shows allowing verification that abort will result in fairness; FIG. 66C shows allowing verification that abort will result in evidence; and FIG. 66D shows a flowchart for allowing the development of evidence and penalty for abort.

Referring now more particularly to FIG. 66A, and more specifically to box 6910, it may here be said that “the cryptographic protocol allowing the at least two parties to make an exchange of the first previously undisclosed information and the second previously undisclosed information” to mean that each of the two parties allows the other of the two (or each of the three or more parties and/or in whatever groupings and/or configurations), what may be referred to as “mutual allowance,” to obtain the respective previously undisclosed information.

Referring now more particularly to box 6920, it may be said “such that the first party verifiably substantially obtains the second transfer signature information item if and only if the second party substantially obtains the first transfer signature information” to mean that the at least two parties and/or other parties are able to verify, at least with some probability and under some acceptable assumptions, that the previously undisclosed information that is to be made available will allow the respective party or parties to readily obtain the “transfer signature information,” which information at least readily allows provision of the authenticatable transfer order to the ledger.

Referring now more particularly to FIG. 66B, and more specifically to box 6930, it may here be said that “the cryptographic protocol allowing at least each of the at least two parties to at least substantially verify that the exchange, if aborted by one of the two parties, leaves each of the at least two parties, at least with substantially similar probability, and at least with substantially similar amounts of computation, to arrive at the respective transfer signature information” to mean that the at least two parties can check and/or confirm and/or audit and/or otherwise obtain some reasonable verification of the what may be called “fairness” of the exchange as described with reference to box 6910 above. One aspect of such fairness is believed to be that if either party aborts, which can include voluntary stopping of sending messages and/or sending of incorrect messages and/or stop responding and/or is kept from completing the protocol, then the other party is not dramatically or severely or significantly disadvantaged relative to the party that has stopped. For instance, the cryptographic exchange protocol can admit a proof that stopping does not give a high-probability of dramatic benefit. Other types of verification include so-called cut-and-choose techniques where some of the submissions of each party are picked, at random and/or by the other party, for opening. Yet other examples can include physical means such as short straws in a hat, and so forth. Some known protocols, described earlier here, ensure that each party is left with similar, though not exactly the same, amount of computational work to reach the transfer signatures; other examples protocols, also referred to, attempt to keep probabilities of success and/or penalty similar.

Referring now more particularly to FIG. 66C, and more specifically to box 6940, it may here be said that “the cryptographic protocol allowing the at least two parties at least to substantially verify in advance that if the exchange were to be aborted by at least one of the at least two parties, at least some evidence would result that the cryptographic protocol was substantially aborted by the at least one aborting party” to mean that the verification, such as already described with reference to FIG. 66B above, that a party aborting, and/or otherwise stopping and/or being stopped, would leave some evidence, such as a digital signature and/or a commitment that if opened would reveal a value that should have been but was not used in an exchange message and/or an inability to form a proof, whether interactive and/or non-interactive, that the participation was correct according to protocol and/or to values that are or are to become public and/or known to the parties.

Referring now more particularly to FIG. 66D, and more specifically to box 6950, it may here be said that “the cryptographic protocol allowing the evidence authenticated by at least one of the at least two parties that has aborted the cryptographic protocol to be developed by at least a different one of the at least two parties to the cryptographic protocol” to mean that the evidence mentioned earlier in the present FIG. 66 can be obtained by and put in a form that can convincingly be shown, for example even used as input to the cryptographic protocol, by at least one of the parties that has been disadvantaged by the abortion of the protocol by at least one other party.

Referring now more particularly to box 6960, it may be said that “such that the evidence allowing substantial irrefutability of a penalty to the at least one party aborting the cryptographic protocol” to mean that the evidence establishes or at least with high-probability and/or at least based only on reasonable and/or acceptable and/or pre-agreed assumptions, is enough to cause the application of a penalty. Examples of such penalty, include without limitation: the withholding of value, withholding a portion of value, and/or access to further instances and/or opportunities to obtain value, as well as making a mark against a reputation of and/or inhibiting a further transaction aspect or portion or subsequent related activity by and/or destroying all or a part of value owned or controlled or escrowed by the party or parties receiving the penalty. Moreover, it is anticipated and will be understood that all or part of a penalty and/or more than the penalty extracted and/or a different kind of compensation can in some examples be provided to the counterparties who may have been harmed or disadvantaged in some way by the aborting and/or the protocol step not completing.

Turning now to FIG. 67, a combination flow-chart and block diagram for an exemplary alternate variation on an exchange cryptographic protocol in accordance with aspects of the present invention will be described.

Referring now more particularly to FIG. 67, and more specifically to box 7010, it may here be said that “the cryptographic protocol providing for multiple rounds” to mean as will be understood that the cryptographic protocol can allow one or more rounds to be conducted, where a round will be understood to mean a repetition or repeat or instantiation similar to be not necessarily the same as a previous or potential future round. In some examples just one or the first of a series of rounds may turn out to be enough, a priori or dynamically, to complete or detect abortion of the protocol by one or more parties; in other examples, for instance, without limitation, there may be a predetermined number of repetitions with stopping at an intermediate round when one of those completes the protocol or always completing the fixed number.

Referring now more particularly to box 7020, it may be said that “the provisions for at least one round by the cryptographic protocol including allowing each of at least two parties to provide authentication of a committed contribution to the at least one round in advance of the at least one round” to mean that parties supply cryptographically derived values, as well as possibly other values, at least to each other, as part of setting up for a round. A commitment is used here to suggest that the cryptographic values are subject to what may be called “opening” and/or “verification,” to establish that they had in effect locked in or otherwise constrained the values to be opened. Non-limiting examples of commitments are images under one way functions that are later opened by revealing the corresponding pre-image, values that have not been signed have their cryptographic signature (with bijective signature schemes, such as RSA) as in effect the value that can be revealed in opening, and as just another example a typical symmetrically-encrypted message has the message as an opening value. In some examples, as referred to earlier, the opening of a commitment can be by so-called zero-knowledge or minimum disclosure proof, whether interactive or non-interactive, where even only a portion and/or selection among one or more otherwise hidden value is shown as the value opened.

Referring now more particularly to box 7030, it may be said that “the provision for at least one round to allow for coordinated exchange, between the at least two parties, of delay encrypted contributions to that round” to mean that values, at least two and at least each from at least a different one of the at least two parties, in at least one round, are sent from the one party to the other party and vice versa with two properties. The first property is that both values are encrypted with, or otherwise include, what is known in the art as a delay function and/or delay encryption and/or iterated encryption so that the amount of time to decrypt one of them is believed increased above a certain amount of time. The second property, also as mentioned elsewhere here, is that the timing of the sending is believed to be such that the messages arrive at the counterparty each within the same agreed time interval or what can be called a window (this as will be understood assumes that the clocks of the counterparties are synchronized, which can be done to an agreed degree adequate for the tolerances here, especially as the delay is long enough, as will be understood). The combination of the two properties is believed to provides assurance that parties should send before they can decrypt what they will receive. Additional parties and/or monitoring entities can be required to be sent to as well, providing it is believed evidence if the sending is not done according to agreed timing and/or later also allowing what was sent to be opened or otherwise checked.

Referring now more particularly to box 7040, it may be said that “such that the contributions to the at least one round should both reveal the first previously undisclosed information to at least one of the at least two parties and reveal the second previously undisclosed information to a different one of the at least two parties” to mean that if the contributions are properly formed, what may be called according to protocol, and each party sends the contribution properly as part of the round, it is believed that the parties will both get the previously undisclosed information from the corresponding counterparty or neither party will get the previously undisclosed information from the counterparty; the case that one party receives the previously undisclosed information and the other party does not is explicitly excluded here, at least with high probability and under the cryptographic assumptions.

Referring now more particularly to box 7050, it may be said that “such that the cryptographic protocol substantially hides from the at least two parties which round should both reveal the first previously undisclosed information to at least a one of the two parties and reveal the second previously undisclosed information to a different one of the at least two parties” means that neither party should, it is believed, be able to unilaterally determined which round will reveal the previously undisclosed information (at least they will not be able to unilaterally determine this, with high-probability and achievable computation under the assumptions as will be understood, before they participate in that round to the point where they have already decided whether to participate properly or to withhold information, for instance by not participating in time and/or by sending improperly formed information that does not open the corresponding commitment or that does not match when the corresponding commitment is opened).

Referring now more particularly to box 7060, it may be said that “such that at least a part of the information to be exchanged during at least one round allowing verification of consistency between at least one committed contribution by a party and the information to be revealed by that party in completing the round without aborting the round by that party” to mean that the “committed contribution” for a round are checkable as corresponding to the information the party reveals to the at least one other party to the round as a consequence of completing the round. It is believed that this ensures that parties are not able to contribute improperly formed information to a round without a significant chance that such information will be revealed as inconsistent with previous commitments by that party.

Although the invention has been described with reference to a particular embodiment, this description is not meant to be construed in a limiting sense. Various modifications of the disclosed embodiments as well as alternative embodiments of the invention will become apparent to persons skilled in the art. As one example, the exclusive or operation can be included and blinded by exclusive-or'ing a blinding value in and then exclusive-or'ing it out again afterwards. As another example, in some cases the blinding values can be provided by one or more orchestrators, whereas in other examples the pseudonymous parties can create the blinding factors; however, if the factors are provided and the instructions are audited, then the orchestrator can provide the same value when it is required more than once. As yet another non-limiting example, any number of parties can participate in any number of computations that are connected through any number of intermediate values. It is therefore contemplated that the appended claims will cover any such modifications or embodiments that fall within the scope of the invention.

The following describes various aspects of the inventions described hereinabove.

1. In a cryptographic multiparty computation system, including:

establishing digital pseudonyms for each of a set of respective hardware devices;

determining a set of operations;

assigning the operations determined to respective pseudonyms established;

so that which hardware device is assigned which operation is substantially hidden by the establishing of the digital pseudonyms;

so that which hardware device is assigned which operation is substantially unmanipulatable by the determining of the set of operations;

the hardware devices, using the respective digital pseudonyms and corresponding to the respective operations, receiving inputs under the digital pseudonyms and providing outputs responsive to the respective inputs; and so that at least some of the hardware devices remain unlinkable by at least some of the hardware devices.

2. In the cryptographic multiparty computation system of 1, including where at least some instructions include multiplying at least two blinded multiplicand inputs and producing at least one blinded product output.
3. In the cryptographic multiparty computation system of 1, including where at least some instructions include adding at least two blinded summand inputs and producing at least one blinded sum output.
4. In the cryptographic multiparty computation system of 1, including where at least some sets of instructions include at least an additively blinded input and producing at least a multiplicatively blinded output.
5. In the cryptographic multiparty computation system of 1, including where at least some sets of instructions include at least a multiplicatively blinded input and producing at least an additively blinded output.
6. In the cryptographic multiparty computation system of 1, including where at least one instruction at one position includes determining at least one substantially unpredictable blinding value and providing it to at least two other instructions at at least two other instruction positions.
7. In the cryptographic multiparty computation system of 1, including where at least some instructions comprise comparing at least two blinded inputs and selecting at least one of more than one nodes to which to provide the output of the operation.
8. In the cryptographic multiparty computation system of 1, including a set of operations comprised of blinding a plurality of values, permuting the blinded values, and unblinding the values responsive to both the permutation and to the blinding information.
9. In the cryptographic multiparty computation system of 1, including where at least some set of instructions include, responsive to values received as messages and values computed, outputting at least one signature responsive to at least the values.
10. In the cryptographic multiparty computation system of 1, including establishing by mixing an input batch of encrypted digital pseudonyms to an output batch of unencrypted digital pseudonyms.
11. In the cryptographic multiparty computation system of 1, including communicating by a first node to a second node by the first node encrypting a message provided to the input batch of a mix network and the second node obtaining the message from the output batch of the mix network.
12. In the cryptographic multiparty computation system of 1, including first instructions for encrypting information by nodes in a first instance and later, in a second instance, decrypting the encrypted information by nodes according to second instructions.
13. In the cryptographic multiparty computation system of 1, including providing input to the computation by multisig.
14. In the cryptographic multiparty computation system of 1, including providing output from the computation by multisig.
15. In the cryptographic multiparty computation system of 1, including more than one level of blinding so that at least some confidential information is protected against collusion of a number of nodes greater than one.
16. In the cryptographic multiparty computation system of 1, including more than one level of intermediary so that at least some confidential information is protected by isolating a pair of nodes, such that the communication between the pair is through at least one additional node and such that the nodes of the pair know each other and can only recognize each other with the collaboration of at least the one intermediary node.
17. In the cryptographic multiparty computation system of 1, including opening at least some unpredictable sample of cryptographically hidden instructions and auditing those opened instructions and completing the computation based on at least some of the instructions that remain cryptographically hidden.
18. In a system for performing a computation by plural nodes including:

defining a graph of operations (including an inherent labelling);

posting by nodes, substantially untraceably, of public key(s);

establishing a mapping, substantially unpredictably, between operations and public keys;

nodes performing one or more operations mapped to them; nodes using public keys, at least of other nodes, to send messages for performing the operations;

nodes using public keys, at least including their own, to receive messages for performing the operations; and

so that the computation of the graph is performed without the particular nodes performing the particular functions being readily reachable by other than by the corresponding nodes of the graph.

19. In the system of 18, including: the posted public keys encrypted with at least one additional secret key and when nodes send to other nodes the additional key being applied as well.
20. In the system of 18 or 19, the additional keys being included by nodes performing the mixing of messages sent to the nodes.
21 In the system of 18, 19, or 20, including: the mapping being known to the nodes on a substantially need to know basis.
22. In the system of 18, 19, 20, or 21 including: providing by second nodes at least to first nodes substantially of pseudonyms.
23. In the system of 18, 19, 20, 21 or 22 including: providing by first nodes, using the pseudonyms, of operations and associated public keys to second nodes.
24. In the system of 18, 19, 20, 21, 22 or 23 including: the pseudonyms of the second nodes substantially blinded.
25. In the system of 18, 19, 20, 21, 22, 23 or 24 including: the public keys provided by the first nodes to the second nodes being substantially blinded.
26. In a system for performing the operations defined by a wiring between the operations:

publishing a collection of gate operations and the pattern of input and output wires of the gate operations;

publishing, by each of multiple nodes, a first set of pseudonym public keys;

publishing a substantially unpredictable mapping from the gate operations to the first pseudonym public keys;

each of the first nodes communicating using the pseudonym public keys to establish an unpredictable key for each of the wires;

publishing, by each of the first node, a second pseudonym public key;

publishing, by each of multiple nodes, third pseudonyms;

publishing an unpredictable mapping between the second pseudonyms and the third pseudonyms;

the nodes of the second pseudonyms each sending to respective mapped nodes of the third pseudonyms respective operation and wire keys;

performing of the operations by the nodes of the third pseudonyms using the wire keys for the respective communication; and

so that the computation defined by the operations and wires is conducted substantially hiding which nodes have access to which values.

27. In the system of 26, one or more nodes each performing the operations of more than one gate.
28. In the system of 26 or 27, the third nodes creating substantially unpredictable wire keys and sending them to a fourth set of nodes mapped unpredictably to them.
29. In the system of 28, wherein the step of 28 is repeated more than once for successive sets of nodes.
30. In a cryptographic protocol system comprised of at least two parties and at least two blockchains, the improvement comprising:

the at least two parties create a public key for each of at least a respective first and a second chain, where the corresponding private keys are secret from the two parties unilaterally;

transfer of value made to the first public key on the first chain and separate value transfer made to the second public key on the second chain;

the at least first and second parties create jointly blocked transfer signatures for at least each of the two public keys;

the at least first and second parties mutually release blocking on the at least two signatures so that neither party obtains substantial advantage in unblocking unilaterally; and

the at least first party obtains value on the second chain and the second party obtains value on the first chain.

31. In an atomic swap between a first blockchain and second blockchain, the steps comprising:

party e and party a conduct first and second instances of a public key generation protocol to obtain walletIDs on the first and second blockchains respectively;

value is transferred on the first blockchain into a respective first walletID and value is transferred on the second blockchain into a respective second walletID;

party e and party a conduct first and second instances of a two-party signature with identifiable abort protocol for mutually-agreed respective transfer-out messages up to sending the final signature s;

party e proves to party a that sₑ is at least likely within a range of successively smaller possible values at each of a series of mutually realized time steps;

party a proves to party e that sₐ is at least likely within a successively smaller range of possible values at each of roughly the same series of mutually realized time steps;

party e obtains the transfer-out signature for the first walletID by combining sₑ with sₐ obtained from party a; and

party a obtains the transfer-out signature for the second walletID by combining sₐ with sₑ obtained from party e.

32. In the atomic swap protocol of 31, the improvement comprising: more than two parties compute the public keys and release the signatures for two wallet IDs.
33. In the atomic swap protocol of 31 or 32, the improvement comprising: more than two walletIDs are created.
34. In the atomic swap protocol of 31, 32 or 33, the improvement comprising: more than two walletIDs are created on more than two blockchains.
35. In a system where each of a set of entities has a respective public key and there are conditions for making decryptions related to the public key available to allow at least one party to check and/or recover a secret under at least a condition, including:

a first party verifiably dividing a secret into shares according to a threshold and encrypting each share with a respective one of the public keys of the set;

a selection of the encryptions, of a quantity below the threshold, optionally being made for decryption in a way that at least is not significantly manipulatable by the first party providing the decryption of the selected encryptions to the second party;

the second party verifying substantially that the decryptions were properly formed; and

in case the respective condition applies, at least a quorum of the entities of the set of entities decrypting the encryptions and making the decryptions available to at least the second party.

36. In the system of 35, the first and the second party conducting an atomic swap and the secret being at least sufficient to recover the value locked up if the counterparty does not participate fully in the atomic swap.
37. In a system where each of a set of entities has a respective public key and each entity is to under a condition make decryptions related to the public key available to allow at least one party to recover a secret under the condition, including:

a first party verifiably dividing a secret into shares and encrypting each share with a respective one of the public keys of the set;

the second party verifying that the shares were properly formed; and

provisions, in case the condition applies, for at least a quorum of the entities of the set of entities decrypting the encryptions and making the decryptions available to at least the second party.

38. In the system of 37, the first and the second party conducting an atomic swap and the secret being at least sufficient to recover the value related to the second party that is locked up if the first party does not participate properly in the atomic swap.
39. In a cryptographic system for swapping cryptographic items of value between at least two parties, including:

a first party and a second party each respectively lock up a fixed amount with a respective public key, a′ and b′, a first and a second lockup, for which each party knows a respective private key, a and b;

a first party signs with a and makes available to other parties a signed offer that includes at least an identifier, x, and the value definitions, c and d, to be swapped;

the second party signs, with b, and provides to the first party, an accept that includes x, c and d,

the first party and the second party coordinately release signatures signed by a and b respectively, for transition to first phase of x and public keys C′ and D′ for jointly controlled accounts, the accounts to hold the value c and d, respectively;

the first party transfers value c to C′ and the second party transfers value d to D;

the first party secret-shares keys, for transfer of the value c in C′ to an account E′ supplied by the second party, to a set of nodes substantially unpredictable to the first party and at least substantially proof to this effect provided to the second party.

the second party secret-shares unlock keys, for transfer of value din D′ to an account F′ supplied by the first party, to a set of nodes substantially unpredictable to the second party and at least substantially proofs to this effect provided to the first party; and

the first party and the second party coordinately releasing signatures signed with a and b, respectively, for finality of x and signatures authorizing transfer of c from C′ to E′, a suitable account supplied by the second party, and transfer of d from D to F′, a suitable account supplied by the first party.

40. In the system of 39, including if an initial lockup receives a signature completing the first phase it changes state to the second phase.
41. In the system of 39 or 40, including if a lockup remains in the second phase past a timeout, the value locked up is returned to the system.
42. In the system of 39, 40 or 41, including if a lockup remains in the second phase past a timeout, the nodes at least attempt to return the value c to the first party and the value d to the second party.
43. In the system of 39, 40, 41 or 42, including if a lockup in the second phase receives corresponding signatures finalizing the second phase, at least a portion of the value of the first lockup is released back to the first party and that of the second lockup to the second party.
44. In a cryptographic swap protocol, including:

at least a first and a second party jointly computing public keys for a pair of holding accounts, transfer signatures from the holding accounts and secret sharing of the transfer signatures to a number of nodes,

the at least two parties being substantially convinced that the public keys require secrets of both the first and the second party to make corresponding transfer signatures;

the at least two parties being substantially convinced that desired transfer signatures have been secret-shared to a number of nodes so that at least combination patterns of those nodes agreed by the first and second party can substantially recover the transfer signatures; and

the first and second party exchanging keys substantially sufficient to allow them to determine the transfer signatures.

45 In the cryptographic protocol of 44, including a mutual release of transfer signatures.
46. In the cryptographic protocol of 44 or 45, including that if the nodes are provided with the encrypted secret shares after a predetermined time the nodes reveal at least one of the secret signatures.
47. In the cryptographic protocol of 44, 45 or 46, including at least one offline digital cash signature from one party to the other party to the swap and the challenge portion of the signature including at least a portion of the parameters of the trade.
48. In a cryptographic protocol for swap of value from a first chain to a second chain:

an authenticated offer emitted by a first party;

an authenticated acceptance emitted by a second party;

at least an authenticated closing emitted by the first party and including information related to the offer and acceptance;

joint computation between the first and at least the second party of a set of shares for transfer of a first value and a second value from jointly controlled destinations;

a portion of the shares for transfer of the first value substantially verifiably offline key transferred to plural nodes;

a portion of the shares for transfer of the second value substantially verifiably offline key transferred to plural nodes;

the first and second party transferring value to the respective jointly controlled destinations; and

at least one of the first and second parties transferring value from joint control to control by the opposite party that transferred that value to joint control.

49. In the protocol of 48, a subset of the nodes being substantially capable of transferring value from joint control to control by the opposite party that transferred that value to joint control.
50. In the protocol of 48, a subset of the nodes being substantially capable of transferring value from joint control to control for refund to the party that transferred that value to joint control.
51. In the protocol of 48, 49 or 50, at least one party making transfers incrementally responsive to transfers by the opposite party.
52. In a blockchain system where wallets with value balances on a ledger have respective associated public keys, including:

receiving a first signature of first public key corresponding to the public key of a wallet, where the first signature at least characterizes a second one-way image;

changing the wallet state to locked;

at least including the characterization of the second one-way image in the wallet state on the blockchain ledger;

changing responsively the wallet state on the blockchain ledger to a penalty state, if and when a second signature verifiable with the first public key received, the signature characterizing at least a one-way image distinct from the first and the second one-way image; and

changing responsively the wallet state to unlocked, if and when at least a qualified one of a corresponding authentication checkable with the second one-way image received.

53. In the blockchain system of 52, including the wallet state indicating at least a hold preventing the value from being moved at least until a future system time.
54. In the blockchain system of 52 or 53, including indicating that the hold is related to at least an aspect of value proposed to be traded.
55. In the blockchain system of 52, 53 or 54 including changing the wallet state to unlocked after a predefined at least system time interval.
56. In the blockchain system of 52, 53, 54 or 55 including changing the wallet state to unlocked when a corresponding authentication checkable with the second one-way image received during the interval until the predefined system time.
57. In the blockchain system of 52, 53, 54, 55 or 56 including changing the wallet state to unlocked when receiving a corresponding authentication checkable with the second one-way image with an aspect of value proposed to be traded.
58. In the blockchain system of 52, 53, 54, 55, 56 or 57 including at least two linked authentications checkable with the second one-way image and at least a second linked authentication changing the wallet state to unlocked.
59. In the blockchain system of 52, 53, 54, 55, 56, 57 or 58 the one-way image comprising at least the public key of a digital signature scheme.
60. In the blockchain system of 52, 53, 54, 55, 56, 57 or 58 the one-way image comprising the image under a hash function.
61. In a transaction system with a ledger readable by multiple parties and multiple parties able to make multiple offers and multiple replies to the offers, including:

at least one offer including a digital signature on transaction parameters;

at least on acceptance including a digital signature on transaction parameters and the information signed related to the at least one offer;

recording hash information on a ledger responsive to the offer and to at least one acceptance;

such that the state of parties can be maintained by presenting at most a single signature per state update.

62. In a transaction system of 61, including at least a pre-image of a substantially one-way function releasing at least one state transition on the ledger for at least one party.
63. In the transaction system of 62, including a pre-pre-image corresponding to the pre-image releasing at least a second state transition on the ledger for at least one party.
64. In the transaction system of 63, including a pre-pre-pre-image corresponding to the pre-image releasing at least a second state transition on the ledger for at least one party.
65. In the transaction system of 61, including at least a first type of signature issuable by at least a first party that transitions the state of the first party, where checking for conflicting signatures can be accomplished against a hash stored on the ledger for any party for which a state transition is enabled by the signature.
66. In the transaction system of 61, including two pre-images each of the two respective pre-images known to a respective one of two parties to a transaction, the pre-images readily checkable against the ledger; the pre-images in encrypted form readily checkable by the respective counter-parties; and where the two pre-images are mutually released by the two parties.
67. In the transaction system of 61, including a hold state that is released to an unlocked state on the ledger after a predetermined hold time.
68. In the transaction system of 61, including where a first party can sign an offer, at least one party can sign a corresponding bid, and the first party can sign an acceptance, such that at least the two parties can be confident that if either party has signed more than one such transaction part that each such multiple signature can at least be subject to the cost of a corresponding separate ledger entry.
69. In the transaction system of 61, including that party can be released substantially immediately from authentications a hold state by the release of a pre-image by another party.
70. In the transaction system of 61, such that for each transaction and each ledger entry at most one signature check ensures stake locking and unlocking.
71. In the transaction system of 61, a cancel transaction signed by the issuer of the offer.
72. A system of multiple hardware nodes where at least some of the nodes forming a series of states by consensus, including:

nodes recording stake value with associated public keys, where the respective owners of the recorded stake values have respective private keys;

owners of stakes issuing offers signed with private keys corresponding to the public keys of their respective stakes;

owners of stakes issuing bids, where the bids correspond to particular of the offers, the bids signed with respective private keys of the owner of the stake issuing the bids; and

owners of stakes issuing acceptances, where the acceptances corresponding to at least one bid made on a corresponding offer of the owner, signed with the acceptances signed with respective private keys of the offerer.

73. In the system of 72, the offer and the bid of an acceptance related to a pair of value types to be traded by the respective owners.
74. In the system of 73, including owners of stakes choosing at least one node to communicate an offer to and to receive corresponding bids from.
75. In the system of 74, the choice of nodes being from a set determined for a particular pair type to be traded.
76. In the system of 75, the consensus of nodes issuing at least from time to time a procedure whereby at least an owner is to compute at least responsive to the particular value type pair to be traded by the owner, a set of nodes the owner is to communicate with about with respect to the particular value type pair to be traded.
77. In the procedure of 76, including selection for at least some owners of more than one node for a particular pair, including where at least owners can cross-check the operation between at least two nodes.
78. In the procedure of 76 or 77, including selection for at least some owners of different proper subsets of a set of nodes for a particular pair, in order to balance load on the nodes.
79. In the system of 74, including nodes providing signatures from owners to the consensus for inclusion in updating the state.
80. In the system of 79, including nodes communicating to other nodes information about public keys that a node has received signatures checkable with, such that when a public key is used for different pairs this has a substantial probability of being recognized by such communicating between nodes; and the nodes reporting such multiple use to the consensus.
81. In a swap system between two values stored on respective first and second distributed ledgers, the system:

establishing holding accounts by an aspect of a cryptographic protocol between two parties, where a first holding account is on the first distributed ledger and the respective value is to be swapped by the first party and a second holding account is on the second distributed ledger and the respective value is to be swapped by the second party;

wherein a first destination account is on the second distributed ledger of the second holding account and a second destination account is on the first distributed ledger of the first holding account;

establishing transfer signatures by another aspect of the establishing cryptographic protocol between the two parties, where a first transfer signature transfers value on the first distributed ledger from the first holding account to the second destination account and a second transfer signature transfers value on the second distributed ledger from the second holding account to the first destination account;

such that information allowing transfer of value from the holding accounts is secured by the first party from unilateral access by the second party and information allowing transfer of value from the holding accounts is secured by the second party from unilateral access by the first party; and

such that a result of a completed execution of the cryptographic protocol is that the first party has keys granting access to the value supplied by the second party in the first destination account on the second distributed ledger and the second party has keys granting access to the value supplied by the first party in the destination account on the first distributed ledger.

82. The swap system as in 81, wherein the system establishes the first and second destination accounts by yet another aspect of the cryptographic protocol.
83. The swap system as in 81, wherein the first and second destination accounts are input by the respective parties.
84. The swap system as in 81, wherein the first and second destination accounts preexist and are controlled at least in part by the respective parties.
85. The swap system as in any one of 81-84, including: staking by the first and the second party to facilitate swapping of the two values, where a first party stake is locked by an image corresponding to a pre-image known to the second party and a second party stake is locked by an image corresponding to a pre-image known to the first party, a further result of the complete execution of the cryptographic protocol including the parties receiving return of at least a portion of their respective stakes.
86. The swap system as in any one of 81-85, including: establishing refund transfer signatures by still yet another and further aspect of the establishing cryptographic protocol between the two parties, where a first refund transfer signature transfers value on the first distributed ledger from the first holding account to a refund account of the first party via refund agents and a second refund transfer signature transfers value on the second distributed ledger from the second holding account to a refund account of the second party via the refund agents.
87. The swap system as in 86, including: if a first one of the two parties supplies the respective value to the respective holding account by a respective deadline and a second one of the two parties fails to supply the respective value to the respective holding account by at least a respective deadline, then a majority of the refund agents are to refund the value and stake to the first one of the two parties.
88. The swap system as in 87, including that if a party disrupts at least one establishing cryptographic protocol by providing a signed but improperly formed message as a protocol portion by the respective deadline for that protocol portion by that party, then the stake of that party is subject to impinging.
89. The swap system as in 87 including that if a party disrupts at least one establishing cryptographic protocol by the absence of a message for a respective protocol portion by the respective deadline for that protocol portion by that party, then the stake of that party is subject to impinging.
90. The system as in any one of 86-89, wherein the identities of the refund agents for at least a first of the two parties are at least partly hidden from at least one of the two parties.
91. The system as in any one of 86-89, wherein the identities of the refund agents for at least a first of the two parties are at least partly hidden from the two parties.
92. The system as in any one of 81-92, including that the first party and the second party communicate at least a portion of protocol messages through at least one of a set of nodes.
93. The system of 92, wherein the parties can cross-check an operation of more than one node in the set.
94. The system as in any one of 92 and 93, including: the set of nodes determined as a proper subset of a larger subset of nodes at least responsive to the selection of the first distributed ledger and the second distributed ledger.
95. The system as in 85, including: that the first party and the second party communicate at least a portion of the protocol messages through at least one of a set of nodes, the nodes submitting signatures by the parties to at least one blockchain to update a state of the staking.
96. The system of 92, including: the nodes computing hash structures including messages received and the nodes periodically supplying the hashes to at least one blockchain and the hashes available for use in adjudicating when messages were received by the nodes from the parties.
97. The system of 85, including: that the first party and the second party communicate at least a portion of protocol messages through at least one of a set of nodes, the nodes detecting at least a single stake that is used in more than one message that can be locked and the nodes then providing signature evidence of the multiple use of the at least single stake to at least a blockchain and the blockchain impinging the at least single stake accordingly.
98. In a system for value swap, where at least two accounts each suitable for holding at least a respective conformant value and for control of the transfer of that value out of the respective account at least responsive to each of at least two respective controlling pieces of information, including:

a first party and a second party each having joint custody of a first account;

a first party and a second party each having joint custody of a second account;

the first party funds the first account with first value conformant to the first account;

the second party funds the second account with second value conformant to the second account;

the first party provides to the second party a series of information aspects revealing enough to allow the second party to obtain the value in the first account;

the second party provides to the first party a series of information aspects revealing enough to allow the second party to obtain the value in the first account;

plural transfers, substantially divided into more than one step, of information between the first party and the second party and of information between the second party and the first party;

the first party at least being able to check, before participating in the next step, at least the validity of the transfer from the second party to the first party in at least a previous step;

the second party at least being able to check, before participating in the next step, at least the validity of a transfer from the first party to the second party in at least a previous step;

such that if the plural steps are substantially completed, the first party obtains access to the second value and the second party obtains access to the first value;

such that earlier completed steps by the second party at least with some probability facilitating the obtaining of the value by the first party in the case the second party does not complete the steps;

and such that earlier completed steps by the first party at least with some probability facilitating the obtaining of the value by the second party in the case the first party does not complete the steps.

99. In the system of 98, the obtaining of access by at least one of the two parties in the form of substantially obtaining the controlling information for the account of the other of the two parties.
100. In the system of 98, the obtaining of access by at least one of the two parties in the form of information authorizing transfer of the value to an account at least potentially controlled by the one of the two parties.
101. In the system of 98, 99 or 100, including a commit key revealed from one of the two parties to the other of the two parties by completion of the information transfer steps.
102. In the system of 98, 99 or 100, including substantially a proof, from at least a one of the two parties to at least a second of the two parties, that a quorum of agents can return access to the value to the first of the parties.
103. In the system of 98, 99, 100, 101 or 102, including information revealed in an information transfer between a one of the two parties to another of the two parties, including at least one node of an access tree.
104. In the system of 103 including at least one node of an access tree allowing the other of the two parties to limit the key space search need to obtain access.
105. In the system of 103 including at least one node of the access tree requiring all of its direct descendants in order to be used to obtain access.
106. In the system of 103 including at least one node of the access tree allowing any one of its direct descendants in order to be used to obtain access.
107. In the system of 103 including at least one node allowing a pre-defined access control rule of subsets of its descendants to contribute to whether the key can be recovered.
108. In the system of 103 including at least one node allowing a pre-defined party to contribute to whether access can be obtained.
109. In the system of 103 including at least one descendant node with a fixed probability of its descendants being used to obtain access and the fixed probability being shown by the one party of the two to the other party and the actual outcome of the experiment with the associated probability being hidden by the one of the two parties from the other of the two parties.
110. In the system of 102 including at least some of the agents are pseudonymous to at least one of the two parties.
111. In a cryptographic protocol between two parties for conducting a fair exchange of at least temporarily secret values, where the first party has a public key and corresponding secret exponent and the second party has a public key and corresponding secret exponent and the first party has a secret value at least temporarily kept from the second party and the second party has a secret value at least temporarily kept from the first party, including:

the first party substantially convincing the second party that components of a first vector are each formed from a hidden permutation of members of a set of images;

the second party substantially convincing the first party that components of a second vector are each formed from a hidden permutation of different elements of the first vector;

the first party proving to the second party, using the public key of the first party, that the secret kept from the second party is decryptable from a value supplied by the first party to the second party when a distinguished component of the initial vector is raised to a secret exponent of the first party;

the second party proving to the first party, using the public key of the second party, that the secret kept from the first party is decryptable from a value supplied by the second party to the first party when the same distinguished component of the initial vector is raised to a secret exponent of the second party;

the first and second party conducting, for at least one corresponding component of the second vector, until the of the second vector is the distinguished component, at a coordinated time per component of the second vector, an exchange of values; and

such that a properly formed instance of the exchange of values corresponding to the distinguished component revealing to the second party the value kept from the second party and the same instance of the exchange of values revealing to the first party the value kept from the first party.

112. In the fair exchange protocol of 111, where the revealing includes a time delay by encryption arranged for that purpose.
113. In the fair exchange protocol of 111, where the revealing includes a time delay caused by the speed of light in the configuration arranged for that purpose.
114. In the fair exchange protocol of 111, 112 or 113, the proof that the first vector is a permutation of encryptions of the set of images including forming plural candidates by the prover and the choice of which of the candidates are opened outside the control of the prover.
115. In the proof of 114, the unopened candidates used in subsequent steps combined multiplicatively according to permutations supplied by the prover.
116. In the fair exchange protocol of 114 or 115, the proof that the second vector is a permutation of encryptions of the components of the first vector including forming plural candidates by the prover and the choice of which of the candidates are opened outside the control of the prover.
117. In the proof of 116, the unopened candidates used in subsequent steps combined multiplicatively according to permutations supplied by the prover.
118. In the swap of 1 through 117, including the exchanged value secrets including keys that give control over stored value.
119. In the swap of 118, including the exchanged value secrets including keys that release control over stake locked by each party back to the respective party.
120. In the swap of 119, the value of the stake substantially I/O of the value of the stored value.
121. In a cryptographic protocol, including:

each party forming an encrypted message and sending to each other party such that to receive and decrypt the encrypted message sent by other parties, each party is believed to take longer than a party is to wait after sending before accepting a message received.

122. In the protocol of 121, including

each party fixing a random value from an agreed set;

information in each of the encryptions so that each party receiving properly formed messages is able to obtain a pre-defined value if the random values fixed by each party satisfy a pre-arranged relationship.

123. In the Protocol of 122, a valuable stake that will be lost by a party if that party fails to send a properly formed encrypted message in time for it to be accepted.
124. In the Protocol of 122, the value of the stake greater than the average value that would be obtained by a party improperly forming a message.
125. In a system with plural providers each having at least a public key and users being able to encrypt messages for decryption by the providers, including:

mixing the public keys of the providers by a mix operated by mix nodes;

re-encrypting the public keys output by one mix, by one or more intermediate entities;

the one or more intermediate parties providing the re-encrypted public keys to a second mix operated by mix nodes;

mixing the public keys received from the one or more intermediate entities by a mix operated by mix nodes;

such that users do not know how to contact at least some providers that they select without involving plural intermediate nodes.

126. In the system of 125, intermediate mixes between more than two.
127. In a system with plural providers each having at least a public key and users being able to encrypt messages for decryption by the providers, including:

making public keys available to users that that each include public key contributions from more than one anonymous party;

so that a user communicating with a provider associated anonymously with a public key requires cooperation of one or more intermediate parties.

128. In a multi-party cryptographic protocol,

establishing by two parties of a first joint custody account on a first distributed ledger and second joint custody account on a second distributed ledger;

establishing by the two parties of a first committed value, committed to by the first party, and

establishing by the two parties of a second committed value, committed to by the second party;

the first committed value giving access to the value in the first joint custody account and the second committed value giving access to the value in the second joint custody account;

at least the first party substantially convincing at least the second party that the first committed value does give access to the value at least, in the first joint custody account, at least the second party substantially convincing at least the first party that the second committed value does give access to the value in the second joint custody account; and

the first and the second party mutually releasing at least to each other information opening the first commitment to the second party and information opening the second commitment to the first party.

129. In the multi-party cryptographic protocol of 128, including: where the second value controlled is transferred to a third party by the second committed value comprising a signature transferring value from the second joint custody account to an account designated by the third party.
130. In the multi-party cryptographic protocol of 128, where the second value controlled is transferred to the first party by the committed value comprising a signature transferring value from the second joint custody account to an account controlled by the first party.
131. In the multi-party cryptographic protocol of 128, 129 or 130, where the first value controlled is transferred to the second party by the committed value comprising signing information for controlling the first joint custody account.
132. In the multi-party cryptographic protocol of 128, 129 or 130, where the first value controlled is transferred to the second party by providing a signature made using the signing information controlling the first joint custody account authorizing transfer of the value from the first joint custody account to an account controlled by the second party.
133. In a system for transferring value from a second ledger to a third party by a first party transferring value to a second party on a first ledger, including:

a first and a second party agree on parameters, including: a backing value, a first time and a second time, first and second public key information, a first amount corresponding to a first ledger and its source and destination wallets, and a second amount corresponding to a second ledger and its source and destination wallets;

the first party substantially provides cryptographic proof to the second party that a third party has private key information related to at least a portion of the first public key information and related to at least some of the parameters;

the second party substantially provides cryptographic proof to the first party that a fourth party has private key information related to at least a portion of the first public key information and related to at least some of the parameters;

the first party, before the first time, to have established the backing along with the parameters and the first public key to a wallet of the third ledger;

the second party, before the first time, to have established the backing along with the parameters and the second public key to a wallet of the third ledger;

the first party, before the second time, to transfer the first value on the first ledger from the respective source wallet to the respective destination wallet;

the second party, before the second time, to transfer the second value on the second ledger from the respective source wallet to the respective destination wallet;

unlocking a wallet on the third ledger when at least one private value corresponding to at least one public value is provided;

if the third party after the second time determines that the transfer on the first ledger remains to be completed, then the third party requesting that at least a portion of the value in the first wallet on the third ledger be refunded to the second wallet on the third ledger; and

if the fourth party after the second time determines that the transfer on the second ledger remains to be completed, then the fourth party requesting that at least a portion of the value in the second wallet on the third ledger be refunded to the first wallet on the third ledger.

134. In the system of 133, including at least the state of one of the wallets on the third ledger prior to time one substantially ensuring value will be transferred to the destination wallet on the second chain.
135. In the system of 133, including unlocking a wallet on the third ledger in case no matching wallet is locked for the same parameters by the first time.
136. In the system of 133, including a hash of a pre-image received from a payee in with the locking of a wallet and unlocking that wallet if the pre-image is supplied.
137. In a transfer of value from a first party to a third party through a second party where the second party is to translate value from the first party to the third party before a predetermined time, and where the transfer from the first party to the third party is committed with value on a third ledger, including:

the first party populating a first wallet on a third ledger that includes at least substantially a public key, a value, a destination wallet address on a second ledger and at least implicitly the predetermined time;

the third party checking authentication information from the third ledger to ensure that it indicates that the first party is committed to transfer an amount to the second wallet on the second ledger;

the first party providing a digital signature including designating a second party to populate a second wallet on the third ledger that includes the public key of the first wallet on the third ledger, a first wallet address on a first ledger to receive an indicated first value, and the same second destination wallet address on the second ledger and the same at least implicit time;

the first party to transfer on the first ledger to the second wallet on the first ledger the amount effective before the predetermined time;

the second party to transfer on the second ledger to the second wallet on the second ledger the amount effective before the predetermined time;

when the second party requests a correction from at least a selected correction party before the predetermined time and the at least selected correction party determines that sufficient value has been transferred to the second wallet of the second ledger effective by the predetermined time and that insufficient value has been transferred to the second wallet of the first ledger effective by the predetermined time, the correction party signs a judgement instructing the third ledger to transfer the value from the first wallet on the third ledger to the second wallet on the third ledger;

when the third party requests a correction from at least a selected correction party before the predetermined time and the at least selected correction party determines that insufficient value has been transferred from the first wallet of the second ledger to the second wallet of the second ledger effective by the predetermined time, then the correction party signs a judgement instructing the third ledger to transfer the value from the first wallet to a third wallet of the third ledger that is at least selected by the third party; and

at the predetermined time both any value remaining in the first wallet on the third ledger unlocked and any value remaining in the second wallet of the first ledger unlocked.

138. A cryptographic value exchange protocol including at least two parties establishing at least two joint custody accounts and the protocol establishing at least one digital signature for at least one of the joint custody accounts, the digital signature being sufficient to move value out from the at least one of the joint custody accounts to an account selectable by one of the parties, and the digital signature encrypted so that it can be decrypted once at least one of the joint custody accounts meets a pre-defined value storage condition.
139. In the cryptographic protocol of 138, including: the pre-defined value storage condition including that a first of the joint custody accounts has a pre-defined value present during at least one of a pre-defined set of block heights and the digital signature such that value is transferred out from the second joint custody account to an account selectable by the first party.
140. In the cryptographic protocol of 138, including: the pre-defined value storage condition including substantially zero value in the first joint custody account during at least a pre-defined set of block heights and the value to be transferred to an account selectable by the second party and the transfer substantially a refund to the second party from the second joint custody account.
141. In a cryptographic protocol between at least two parties and including at least one ledger and at least two ledger accounts and a plurality of agents:

at least two of the parties capable of conducting at least a protocol portion that transfers value from the first of the at least two accounts to the at least second of the two accounts;

a quorum of the agents provided by the parties with agent information enabling transfer of value from at least one account; and

such that the agent information sufficient to transfer only to predetermined accounts.

142. The protocol of 141, wherein:

the parties are capable of transferring from a third account to a fourth account; and

the cryptographic protocol substantially ensuring that if one such transfer occurs then either party can ensure that both transfers occur.
143. The protocol of 141 or 142, wherein:
the quorum of agents ensuring that if a transfer from one account occurs then either party can ensure that both transfers occur.
144. The protocol of 141, 142 or 143 wherein:
the quorum of agents ensuring that if exactly one transfer from one account occurs by a prearranged time, then a transfer of substantially similar value is made to an account responsive the party that transferred to the one account.
145. The protocol of 141, 142, 143, or 144 wherein:
the cryptographic protocol providing at least one party the ability to make any transfer from a one of the accounts.
146. The protocol of 141, 142, 143, 144, 145 wherein:
the cryptographic protocol transferring value from at least one account to an account substantially controlled by one of the parties.
147. The protocol of 141, 142, 143, 144, 145 or 146, wherein:
the cryptographic protocol enabling, by provision of agent information, a quorum of agents to transfer from at least one of the accounts to an account substantially controlled by one of the parties.
148. The protocol of 141, 142, 143, 144, 145, 146 or 147 wherein:
at least one account has plural sources of value.
149. The protocol of 141, 142, 143, 144, 145, 146, 147 or 148, wherein:
at least one account has plural destinations that its value can be transferred to by the parties using the cryptographic protocols.
150. The protocol of 141, 142, 143, 144, 145, 146, 147, 148, or 149, wherein:
at least one account has plural destinations that its value can be transferred to by the quorum of agents using the agent information.
151. The protocol of 141, 142, 143, 144, 145, 146, 147, 148, 149 or 150 wherein:
at least one account can be increased in value by a first of the parties.
152. The protocol of 141, 142, 143, 144, 145, 146, 147, 148, 149, 150 or 151 wherein:
at least one account that can be increased in value by a first of the parties can be increased by the parties plural times.
153. The protocol of 152, wherein:
the at least one account that can be increased can be decreased in value by the cooperation of at least two of the parties using the cryptographic protocol.
154 The protocol of 153, wherein:
the at least one account that can be increased can be decreased in value plural times by the cooperation of at least two of the parties using the cryptographic protocol.
155. The protocol of 141, 142, 143, 144, 145, 146, 147, 148, 149, 150, 151, 152 or 153 wherein:
the cryptographic protocols provide the two parties the ability to transfer from an account to one of at least two predetermined accounts.
156. The protocol of 155, wherein:
the cryptographic protocol ensures that only one of the two transfer pairs it enables can be conducted.
157. The protocol of 141, 142, 143, 144, 145, 146, 147, 148, 149, 150, 151, 152, 153 or 156, wherein: the cryptographic protocols provide the two parties the ability to transfer from an account whose value can be decreased by the first party to the one of at least two predetermined accounts.
158. The protocol of 157, wherein:
the cryptographic protocols provide the two parties the ability to transfer from an account whose value is changed exactly once during the cryptographic protocol to at least two predetermined accounts.
159. The protocol of 141, 142, 143, 144, 145, 146, 147, 148, 149, 150, 151, 152 or 153 wherein: they cryptographic protocol such that if all three parties contributions are made by a predetermined time, then the second party receives value from the first party and the third party receives value from the second party and the first party receives value from the third party.
160. The protocol of 159, wherein:
they cryptographic protocol such that if less than three transfers of value to the three predetermined accounts by a predetermined time, then all three contributions are enabled to be refunded at least by the agents.
161 The protocol of 141, 142, 143, 144, 145, 146, 147, 148, 149, 150, 151, 152, 153 or 156, wherein: a second pair of transfers enabled by the cryptographic protocol and the cryptographic protocol ensuring that only one of the two transfer pairs can be conducted.
162. The protocol of 141, 142, 143, 144, 145, 146, 147, 148, 149, or 150, wherein:
unless evidence is at least made available to the agents that the third party account was transferred to, and at least linked to, the escrow account and at least by a predetermined time, then the agents transfer from the escrow account to an account designated by the third party.
163. The protocol of 162 wherein:
the cryptographic protocol ensures that if a third party with a predetermined account is transferred to by the second party before a predetermined time and the transfer is linked to an escrow account, evidence is obtained by at least the first party that the third party received the funds corresponding to the escrow account.
164. The protocol of 141, 142, 143, 144, 145, 146, 147, 148, 149, or 150, wherein:
the agent quorums selected for multiple sets of agent transfer options, selected to provide consensus by at least including overlap in at least some agent.
165. A cryptographic protocol between at least two parties and using at least one ledger, the ledger comprised of ledger accounts with transfers of value between ledger accounts being performed according to digitally authenticated messages from parties, including:

the cryptographic protocol at least cooperating in creation of at least one ledger account authenticator;

the cryptographic protocol at least cooperating in creation of a plurality of partial signatures;

each partial signature encrypted by the cryptographic protocols at least for decryption by one of plural refund agents; and

a quorum of the partial signatures being sufficient to develop at least an authenticator for transferring value from the at least one ledger account to at least a predetermined ledger account controlled by a first one of the two parties.

166. The cryptographic protocol of 165, including:

the cryptographic protocol at least cooperating in creation of a second transfer signature permitting transfer of value to a second ledger account; and

the second ledger account substantially controlled by a second one of the at least two parties.

167. The cryptographic protocol of 165 or 166 including:

the cryptographic protocol providing a first of the at least two parties information that party can be provided to the second of the at least two parties;

the information at least previously secret from the second of the two parties; and

so that with provision of the information the second of the two parties substantially provided the ability to at least create at least one authenticator for transfer of value from the first account.

168. The cryptographic protocol of 165, 166 or 167, including:
the cryptographic protocol between the at least two parties at least cooperating in creating in addition to the first account, a second account.
169. The cryptographic protocol of 168, wherein:

the cryptographic protocol permits at least a fair exchange of secrets between the at least two parties;

so that both a second of the at least two parties substantially likely to be able to substantially readily obtain value from the corresponding first account as a first transfer of value and a first of the at least two parties substantially likely to be able to substantially readily obtain value as a second transfer of value from the corresponding second account.

170. The cryptographic protocol of 169, wherein the cryptographic protocol permits the second transfer of value to a third ledger account, different from the first and the second ledger accounts, so that the third ledger account is substantially controlled by at least a third party.
171. The cryptographic protocol of 170, wherein:

the cryptographic protocol permits including information as part of the transfer to the third party account; and

the information linking to an escrow account.

172. The cryptographic protocol of 165, 166, 167, 168 or 169, wherein:
the cryptographic protocol permits at least a first of the at least two parties to be able to add value to at least one account plural times.
173. The cryptographic protocol of 172, wherein:
the cryptographic protocol permits the second of the at least two parties to be able to refund at least portions of the added value to the first party.
174. The cryptographic protocol of 165, 166, 167, 168, 169, 170, 171, 172 or 173 wherein:
the cryptographic protocol permits a second one of the at least two parties and a third party, different from the first and the second party, to at least cooperate in creation of a replacement account.
175. The cryptographic protocol of 174, wherein:
the cryptographic protocol allowing at least cooperation of the first party and the second party to transfer value that was jointly controlled by the first party and the second party to the replacement account jointly controlled by the second party and the third party.
176. The cryptographic protocol of 165, 166, 167, 168, 169, 170, 171, 172, 173, 174 or 175 wherein: at least one transfer in a first direction is matched by a refund transfer in the opposite direction.
177. The cryptographic protocol of 176, wherein: substantially all the value contributed by at least a first party can be refunded when value to be provided by a second party is absent at least some account by at least by a predetermined point in the transaction.
178. The cryptographic protocol of 165, 166, 167, 168, 169, 170, 171, 172, 173, 174, 175, 176 or 177 wherein: a party can provide information allowing refund to a second party.
177. The cryptographic protocol of 176, wherein:
a party providing information allowing refund to a second party and receiving a reduced penalty relative to refund by contact with refund agents.
178. The cryptographic protocol of 165, 166, 167, 168, 169, 170, 171, 172, 173, 174, 175, 176 or 177 wherein: a refund agent having, in addition to an encrypted partial key, a proof of refundability related to the refund decision.
179. The cryptographic protocol of 178, wherein: the proof of refundability obtained by the refund agent from items selected from the group including: generate the proof itself, from the ledger, from the party requesting the refund; from the party helping the requesting party obtain the refund, and/or from an unrelated but correspondingly incentivized party.

1-179. (canceled)

180. A cryptographic protocol between at least two parties using at least one ledger, the at least one ledger comprised of ledger accounts, with transfers between the ledger accounts performed according to transfer signatures authenticated using public keys associated with the respective ledger accounts, and with the cryptographic protocol able to allow parties to create public keys corresponding ledger accounts of the at least one ledger, including:
the cryptographic protocol at least cooperating in creating a first public key corresponding to a first ledger account;
the cryptographic protocol at least cooperating in creating a plurality of partial transfer signatures related to the ledger account public key of the first ledger account;
the plural partial transfer signatures allowed by the cryptographic protocol to be encrypted such that substantially these keys are decryptable using keys at least including those of at least a first collection of agents; and
such that a first quorum rule determines the selections of partial transfer signatures that are sufficient to develop at least a transfer signature for transferring value from the first ledger account corresponding to the first public key to at least a different ledger account on the first ledger.

181. The cryptographic protocol of claim 180, including:
the cryptographic protocol allowing cooperation of the at least two parties to form at least one transfer signature with the first ledger account as the source account of the transfer.

182. The cryptographic protocol of claim 181, including:
the cryptographic protocol allowing previously undisclosed information known to at least one of the at least two parties to the cryptographic protocol to be made known to at least a different party to the cryptographic protocol, the previously undisclosed information unknown initially to the at least a different party to the cryptographic protocol;
such that when the previously undisclosed information is known to the at least a different party to the cryptographic protocol, the at least a different party to the cryptographic protocol enabled to form at least one transfer signature having the first ledger account as source account of the corresponding transfer.

183. The cryptographic protocol of claim 181, including:
the cryptographic protocol allowing the first destination account of the first transfer signature at least in part to be selectable by at least one of the at least two parties.

184. The cryptographic protocol of claim 181, including:
the cryptographic protocol allowing the first destination account of the first transfer signature to be selected at least in part by the cryptographic protocol and outside the control of either one of the at least two parties.

185. The cryptographic protocol of claim 181 including:
the cryptographic protocol allowing at least two of the parties to cooperate in creating a public key corresponding to a second ledger account.

186. The cryptographic protocol of claim 185, including:
the cryptographic protocol at least cooperating in creating a second plurality of partial transfer signatures related to at least a public key of the second ledger account;
the second plural partial transfer signatures allowed by the cryptographic protocol to be encrypted such that substantially these keys can be decrypted at least in part by agents using keys at least including those of a second collection of agents; and
such that a second quorum rule determines the selections of the second partial transfer signatures that are sufficient to develop at least a transfer signature for transfer from the second ledger account to at least a ledger account different from the first ledger account and different from the second ledger account.

187. The cryptographic protocol of claim 186, including:
such that the combination of the first quorum rule and the second quorum rule ensuring a predetermined minimum number of agents in the intersection of substantially any quorum allowed simultaneously by the first quorum rule and any quorum allowed by the second quorum rule.

188. The cryptographic protocol of claim 185, including:
the cryptographic protocol allowing at least a first of the at least two parties to provide first previously undisclosed information, related to the first ledger account, to at least a second of the at least two parties;
the cryptographic protocol allowing the at least second of the at least two parties to provide second previously undisclosed information, related to the second ledger account, to the at least first of the at least two parties;
such that the at least first of the at least two parties substantially prevented from readily and without penalty obtaining the second previously undisclosed information, unless the second of the at least two parties substantially allowed by the at least first of the at least two parties to readily obtain the first previously undisclosed information;
such that the combination of the first previously undisclosed information when known to the second of the at least two parties substantially allows the second of the at least two parties to promulgate a transfer signature with a first ledger account as source account; and
such that the combination of the second previously undisclosed information when known to the at least first of the at least two parties substantially allows the at least first of the at least two parties to promulgate a transfer signature with a second ledger account as source account.

189. The cryptographic protocol of claim 188, including:
the cryptographic protocol allowing for provision for multiple rounds;
the provisions for at least one round including allowing each of the at least two parties to provide authentication of a contribution to the round in advance of the round;
the provision for at least one of the rounds including allowing for coordinated exchange, between the at least two parties, of delay encrypted contributions to the round;
such that at least one round of the multiple rounds should reveal the first previously undisclosed information to at least the second of the at least two parties and reveal the second previously undisclosed information to at least the first of the at least two parties;
such that the cryptographic protocol substantially hides from the at least two parties which round is the at least substantially one round that would reveal previously undisclosed account information; and
such that the cryptographic protocol allows for provision of penalty to at least a one of the at least two parties in case it were shown to provide invalid input to at least one round.

190. The cryptographic protocol of claim 185, including:
the cryptographic protocol allowing the designation of at least a third ledger account by cooperation of at least a third party of the at least two parties with at least a second of the two parties;
such that the at least third party of the at least two parties differs from at least a first one of the at least two parties and differs from at least a second one of the at least two parties;
the cryptographic protocol allowing a transfer from the first ledger account to the third ledger account; and
such that the role of the at least a first one of the at least two parties in at least a portion of the cryptographic protocol is substantially handed over from the at least a first one of the at least two parties to the at least third party of the at least two parties.

191. The cryptographic protocol of claim 181, including: the cryptographic protocol responsive to cryptographic authentication by at least a quorum of parties from a third collection of parties attesting that at least one party conducting the cryptographic protocol has deviated from following the cryptographic protocol.

192. The cryptographic protocol of claim 191, including: the third collection of parties in effect predetermined.

193. A cryptographic protocol between at least two parties using at least one ledger, the at least one ledger comprised of ledger accounts, with transfers between the ledger accounts performed according to transfer signatures authenticatable using public keys associated with the respective ledger accounts, and with the cryptographic protocol able to allow parties to create public keys corresponding to ledger accounts of the at least one ledger, including:
the cryptographic protocol at least cooperating in creating a first public key corresponding to a first ledger account;
the cryptographic protocol at least cooperating in creating a second public key corresponding to a second ledger account;
the cryptographic protocol allowing at least a first of at least two parties to provide first previously undisclosed information, related to the first ledger account, to at least a second of the at least two parties;
the cryptographic protocol allowing the at least second of the at least two parties to provide second previously undisclosed information, related to the second ledger account, to the at least first of the at least two parties;
such that the combination of the first previously undisclosed information when known to the second of the at least two parties substantially allows the second of the at least two parties to promulgate a transfer signature with a first ledger account as source account; and
such that the combination of the second previously undisclosed information when known to the at least first of the at least two parties substantially allows the at least first of the at least two parties to promulgate a transfer signature with a second ledger account as source account,
such that at least the first of the at least two parties substantially prevented from readily and without penalty obtaining the second previously undisclosed information, unless the second of the at least two parties substantially allowed by the at least first of the at least two parties to readily obtain the first previously undisclosed information.

194. The cryptographic protocol of claim 193, including:
the cryptographic protocol allowing the at least two parties to make an exchange of the first previously undisclosed information and the second previously undisclosed information; and
such that the first party verifiably substantially obtains the second transfer signature information item if and only if the second party substantially obtains the first transfer signature information.

195. The cryptographic protocol of claim 194, including:
the cryptographic protocol allowing at least each of the at least two parties to at least substantially verify that the exchange, if aborted by one of the two parties, leaves each of the at least two parties, at least with substantially similar probability, and at least with substantially similar amounts of computation, to arrive at the respective transfer signature information.

196. The cryptographic protocol of claim 19p4, including:
the cryptographic protocol allowing the at least two parties at least to substantially verify in advance that if the exchange were to be aborted by at least one of the at least two parties, at least some evidence would result that the cryptographic protocol was substantially aborted by the at least one aborting party.

197. The cryptographic protocol of claim 196, including:
the cryptographic protocol allowing the evidence authenticated by at least one of the at least two parties that has aborted the cryptographic protocol to be developed by at least a different one of the at least two parties to the cryptographic protocol;
such that the evidence allowing substantial irrefutability of a penalty to the at least one party aborting the cryptographic protocol.

198. The cryptographic protocol of claim 197, including:
the cryptographic protocol providing for multiple rounds;
the provisions for at least one round by the cryptographic protocol including allowing each of at least two parties to provide authentication of a committed contribution to the at least one round in advance of the at least one round;
the provision for at least one round to allow for coordinated exchange, between the at least two parties, of delay encrypted contributions to that round;
such that the contributions to the at least one round should both reveal the first previously undisclosed information to at least one of the at least two parties and reveal the second previously undisclosed information to a different one of the at least two parties;
such that the cryptographic protocol substantially hides from the at least two parties which round should both reveal the first previously undisclosed information to at least a one of the two parties and reveal the second previously undisclosed information to a different one of the at least two parties; and
such that at least a part of the information to be exchanged during at least one round allowing verification of consistency between at least one committed contribution by a party and the information to be revealed by that party in completing the round without aborting the round by that party.

199. The cryptographic protocol of claim 190, including:
the cryptographic protocol allowing the designation of at least a third ledger account of at least a third party different from the at least two parties; and
the cryptographic protocol allowing a transfer from the first ledger account to the third ledger account.

200. The cryptographic protocol of claim 199, including either:
the cryptographic protocol being such that the role of the at least a first one of the at least two parties in at least a portion of the cryptographic protocol is substantially handed over from the at least a first one of the at least two parties to the at least third party of the at least two parties; or
the cryptographic protocol allowing the linking of the transfer to the destination ledger account of the third party to a guarantee; and
the cryptographic protocol allowing the guarantee to be obviated when the transfer to the destination ledger account of the third party is made.

201. The cryptographic protocol of claim 186, including:
the cryptographic protocols allowing a least one intermediary party to be required for communication between at least one agent and at least one of the at least two parties.

202. A method of transferring value between accounts using the cryptographic protocol between at least two parties of claim 180, the method comprising at least one of the at least two parties participating in the cryptographic protocol to transfer the value from the first ledger account.

203. A method of transferring value between accounts using the cryptographic protocol between at least two parties of claim 180, the method comprising at least one of the first collection of agents participating in the cryptographic protocol as part of an attempted transfer of the value from the first ledger account.

204. The method of claim 203, wherein the cryptographic protocol allows:
cooperation of the at least two parties to form at least one transfer signature with the first ledger account as the source account of the transfer;
at least two of the parties to cooperate in creating a public key corresponding to a second ledger account;
at least cooperating in creating a second plurality of partial transfer signatures related to at least a public key of the second ledger account; the second plural partial transfer signatures allowed by the cryptographic protocol to be encrypted such that substantially these keys can be decrypted at least in part by agents using keys at least including those of a second collection of agents; and such that a second quorum rule determines the selections of the second partial transfer signatures that are sufficient to develop at least a transfer signature for transfer from the second ledger account to at least a ledger account different from the first ledger account and different from the second ledger account; and
at least one of the at least two parties participates in the cryptographic protocol to transfer the value from the second ledger account to at least a ledger account different from the first ledger account and different from the second ledger account.

205. The method of claim 180, wherein the cryptographic protocol allows:
cooperation of the at least two parties to form at least one transfer signature with the first ledger account as the source account of the transfer;
at least two of the parties to cooperate in creating a public key corresponding to a second ledger account; and
the designation of at least a third ledger account by cooperation of at least a third party of the at least two parties with at least a second of the two parties; such that the at least third party of the at least two parties differs from at least a first one of the at least two parties and differs from at least a second one of the at least two parties; the cryptographic protocol allowing a transfer from the first ledger account to the third ledger account; such that the role of the at least a first one of the at least two parties in at least a portion of the cryptographic protocol is substantially handed over from the at least a first one of the at least two parties to the at least third party of the at least two parties, and
at least one of the at least two parties participating in the cryptographic protocol to transfer the value from the first ledger account to a third ledger account.

206. A method of transferring value between accounts using the cryptographic protocol between at least two parties of claim 193, the method comprising at least one of the at least two parties participating in the cryptographic protocol to transfer the value between ledger accounts.

207. A method of transferring value between accounts using the cryptographic protocol of claim 193, the method comprising at least one of the at least two parties participating in the cryptographic protocol to transfer the value from the first ledger account.

208. A method of transferring value between accounts using the cryptograph protocol of claim 200, the method comprising at least a party providing the guarantee participating in the cryptographic protocol by guaranteeing the transfer to the destination ledger account conditioned on the linked transfer failing to complete according the cryptographic protocol.

209. A method of transferring value between accounts using the cryptograph protocol of claim 201, comprising at least the intermediary party participating in the cryptographic protocol to guarantee the transfer to the destination ledger account by forwarding requests for agent action from at least one party to at least one agent.
